(19) United States
(12) Patent Application Publication
(10) Pub. No.: US 2025/0350902 A1
(43) Pub. Date: Nov. 13, 2025

(54) METHODS OF PRESENTING DYNAMIC SOUNDSCAPES FOR VIRTUAL ENVIRONMENTS

(71) Applicant: Apple Inc., Cupertino, CA (US)

(72) Inventors: Kirsty KEATCH, Cupertino, CA (US); Danielle M. PRICE, Los Gatos, CA (US); William A. SORRENTINO, III, Kentfield, CA (US); James M. DESSERO, Morgan Hill, CA (US); Jeffrey S. ALLEN, San Jose, CA (US); Hana Z. WANG, Novato, CA (US)

(21) Appl. No.: 19/202,883

(22) Filed: May 8, 2025

Related U.S. Application Data
(60) Provisional application No. 63/645,771, filed on May 10, 2024.

(51) Int. Cl. H04S 7/00; G06T 13/20

(52) U.S. Cl. CPC H04S 7/304; G06T 13/20; H04S 2400/11; H04S 2400/13

(57) ABSTRACT

Some examples are directed to systems and methods for presenting spatial audio at a plurality of locations based upon movement of a user viewpoint. Some examples are directed to systems and methods for presenting spatial audio with a level of detail based upon a distance between a location corresponding to spatial audio and a user viewpoint. Some examples are directed to systems and methods for changing a level of audio of an audio component associated with a virtual environment in response to a request to change a level of immersion of the virtual environment.

### CROSS REFERENCE TO RELATED APPLICATIONS

This application claims the benefit of U.S. Provisional Application No. 63/645,771, filed May 10, 2024, the content of which is herein incorporated by reference in its entirety for all purposes.

### TECHNICAL FIELD

The present disclosure relates generally to computer systems that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted device (HMD), a display, a projector, a touch-sensitive display (also known as a “touch screen” or “touch-screen display”), or other device or component that presents visual content to a user, for example on or in the display generation component itself or produced from the display generation component and visible elsewhere).”). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a computer system presents audio with a simulated spatial quality corresponding to locations within a three-dimensional environment of a user of the computer system. In some embodiments, the computer system moves the location corresponding to spatial audio in accordance with a determination that a movement of the user's viewpoint includes movement is a distance greater than a threshold distance. In some embodiments, the computer system moves a plurality of locations corresponding to a plurality of spatial audio sources. In some embodiments, the locations move as the viewpoint of the user moves. In some embodiments, the locations move in accordance with a lagging behavior. In some embodiments, a magnitude and/or direction of movement of the locations correspond to a magnitude and/or direction of movement of the user's viewpoint. In some embodiments, the locations recenter to correspond to the user's viewpoint in response to detecting movement of the viewpoint. In some embodiments, the movement of the locations includes rotation of the spatial audio relative to the three-dimensional environment.

In some embodiments, a computer system changes a level of detail of audio presented with a simulated spatial quality. In some embodiments, the changing of the level of detail includes adding and/or removing sound components included in the audio. In some embodiments, the level of detail increases as movement of a viewpoint of the user decreases a distance between the viewpoint and a location corresponding to a spatial audio source. In some embodiments, the level of detail decreases as movement of the viewpoint of the user increases the distance between the viewpoint and the location corresponding to the spatial audio source. In some embodiments, the computer system changes the level of detail in accordance with a linear or non-linear function. In some embodiments, the rate of change of the level of detail changes based upon the distance between the viewpoint of the user and the location corresponding to the spatial audio source. In some embodiments, the computer system additionally or alternatively changes a volume of the audio. In some embodiments, the level of detail is associated with a level of immersion of a three-dimensional environment. In some embodiments, the computer system changes a level of detail of a plurality of audio.

In some embodiments, a computer system displays a virtual environment at a level of immersion and presents different audio components associated with the virtual environment. In some embodiments, a computer system changes levels of audio of the audio components in response to requests to change the level of immersion of the virtual environment. In some embodiments, different audio components are presented at different levels of immersion of the virtual environment. In some embodiments, audio components are moved in simulated spatial location in response to a request to change the level of immersion of the virtual environment.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3A is a block diagram illustrating a display generation component of a computer system that is configured to provide a visual component of the XR experience to the user in accordance with some embodiments.

FIGS. 3B-3G illustrate the use of Application Programming Interfaces (APIs) to perform operations.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7K illustrate examples of a computer system presenting spatial audio at a plurality of locations based upon movement of a user viewpoint in accordance with some embodiments.

FIG. 8 is a flow diagram illustrating examples of a computer system presenting spatial audio at a plurality of locations based upon movement of a user viewpoint in accordance with some embodiments.

FIGS. 9A-9G illustrate examples of a computer system presenting spatial audio with a level of detail based upon a distance between a location corresponding to spatial audio and a user viewpoint in accordance with some embodiments.

FIG. 10 is a flow diagram illustrating examples of presenting spatial audio with a level of detail based upon a distance between a location corresponding to the spatial audio and a user viewpoint in accordance with some embodiments.

FIGS. 11A-11Y illustrate examples of a computer system displaying a virtual environment at different levels of immersion and presenting different audio components associated with the virtual environment, and further illustrates examples of the computer system changing levels of audio of the audio components in response to requests to change the level of immersion of the virtual environment in accordance with some embodiments.

FIG. 12 is a flow diagram illustrating examples of changing a level of audio of an audio component associated with a virtual environment in response to a request to change a level of immersion of the virtual environment in accordance with some embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system presents audio with a simulated spatial quality corresponding to locations within a three-dimensional environment of a user of the computer system. In some embodiments, the computer system moves the location corresponding to spatial audio in accordance with a determination that a movement of the user's viewpoint includes movement is a distance greater than a threshold distance. In some embodiments, the computer system moves a plurality of locations corresponding to a plurality of spatial audio sources. In some embodiments, the locations move as the viewpoint of the user moves. In some embodiments, the locations move in accordance with a lagging behavior. In some embodiments, a magnitude and/or direction of movement of the locations correspond to a magnitude and/or direction of movement of the user's viewpoint. In some embodiments, the locations recenter to correspond to the user's viewpoint in response to detecting movement of the viewpoint. In some embodiments, the movement of the locations includes rotation of the spatial audio relative to the three-dimensional environment.

In some embodiments, a computer system changes a level of detail of audio presented with a simulated spatial quality. In some embodiments, the changing of the level of detail includes adding and/or removing sound components included in the audio. In some embodiments, the level of detail increases as movement of a viewpoint of the user decreases a distance between the viewpoint and a location corresponding to a spatial audio source. In some embodiments, the level of detail decreases as movement of the viewpoint of the user increases the distance between the viewpoint and the location corresponding to the spatial audio source. In some embodiments, the computer system changes the level of detail in accordance with a linear or non-linear function. In some embodiments, the rate of change of the level of detail changes based upon the distance between the viewpoint of the user and the location corresponding to the spatial audio source. In some embodiments, the computer system additionally or alternatively changes a volume of the audio. In some embodiments, the level of detail is associated with a level of immersion of a three-dimensional environment. In some embodiments, the computer system changes a level of detail of a plurality of audio.

In some embodiments, a computer system displays a virtual environment at a level of immersion and presents different audio components associated with the virtual environment. In some embodiments, a computer system changes levels of audio of the audio components in response to requests to change the level of immersion of the virtual environment. In some embodiments, different audio components are presented at different levels of immersion of the virtual environment. In some embodiments, audio components are moved in simulated spatial location in response to a request to change the level of immersion of the virtual environment.

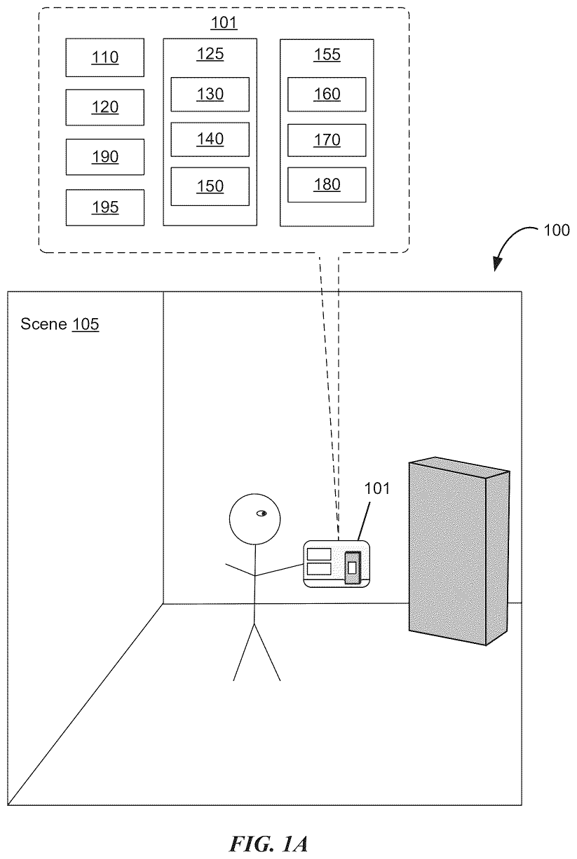

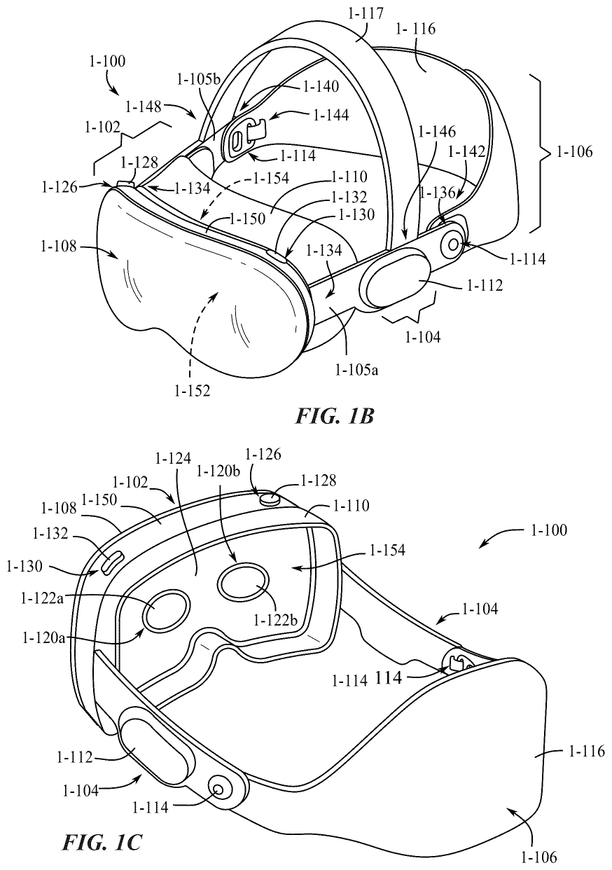

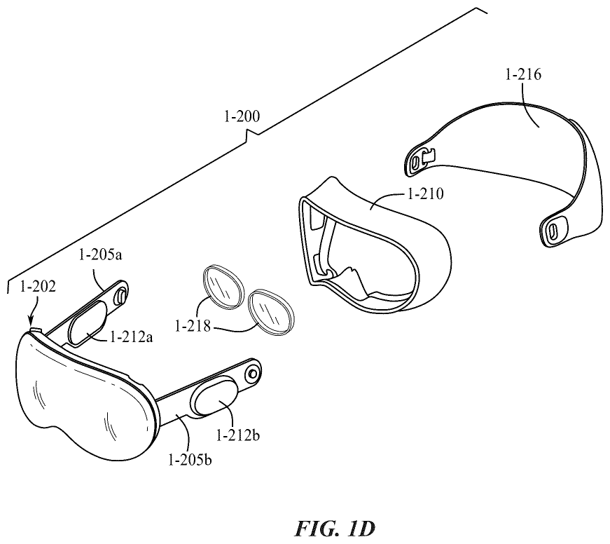

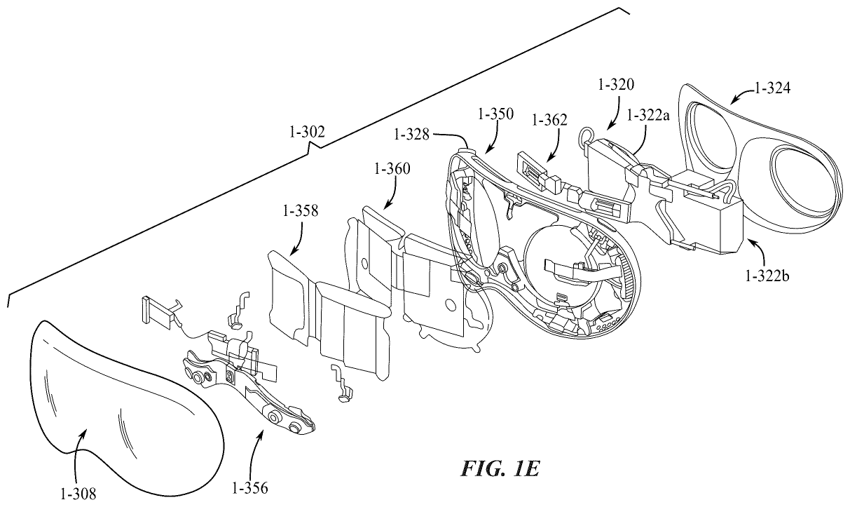

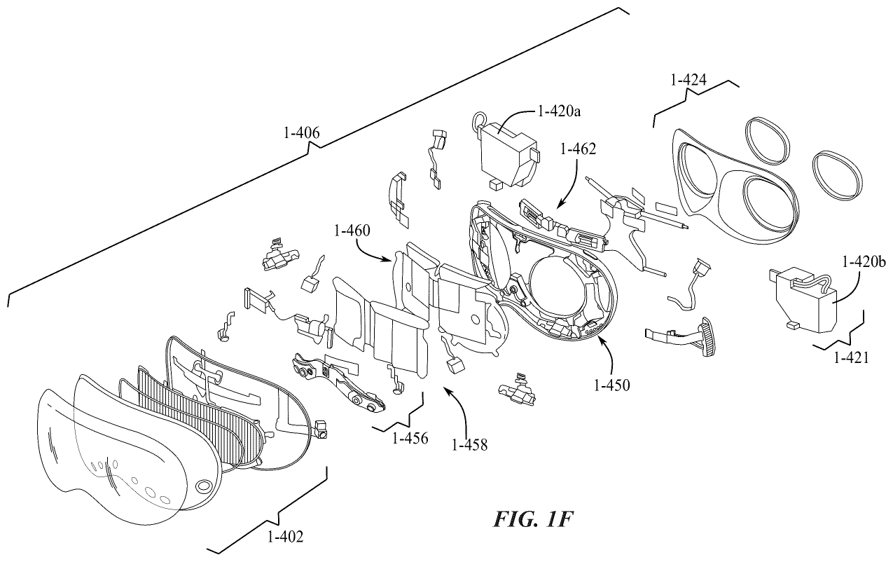

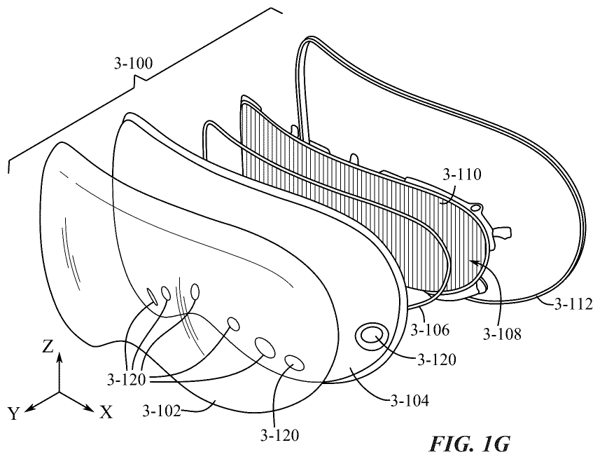

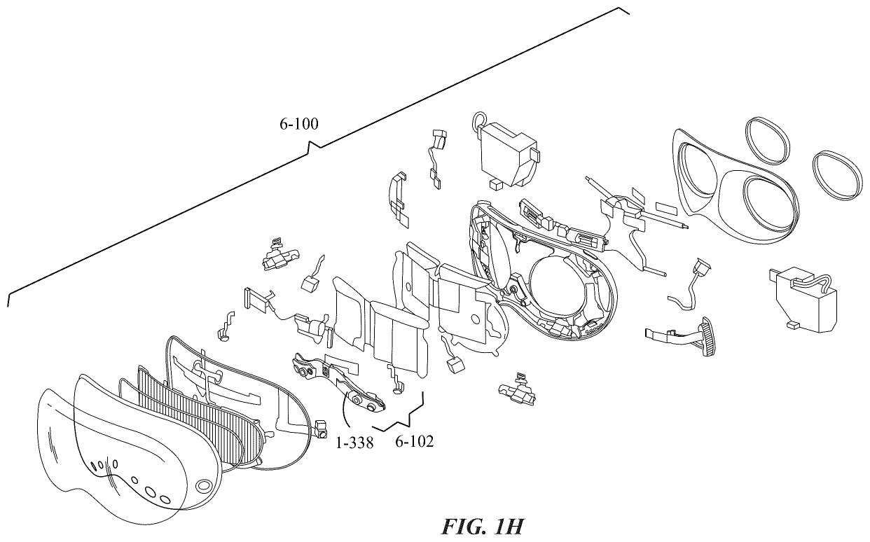

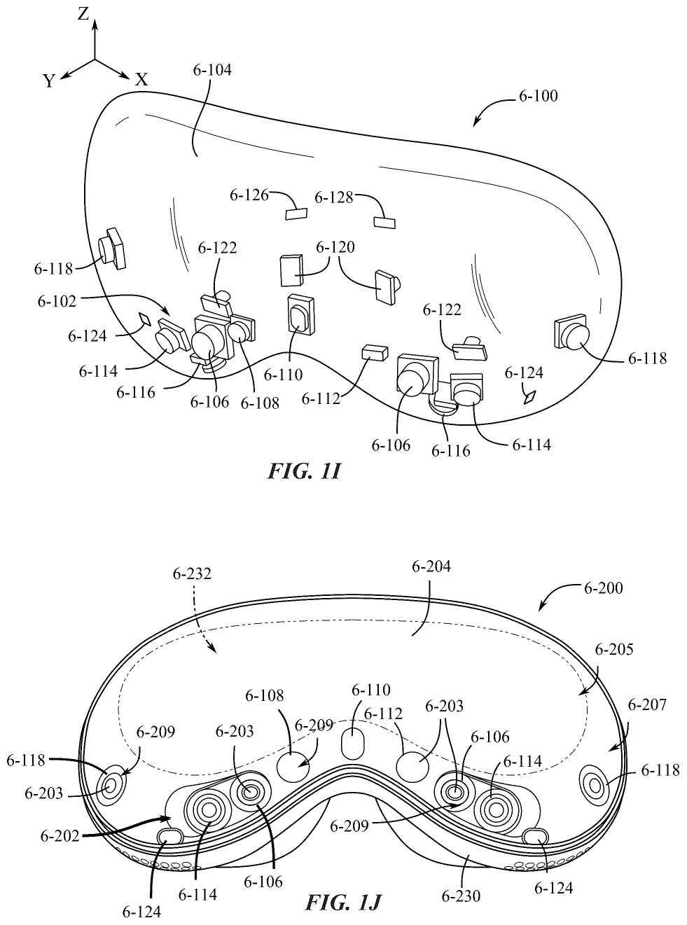

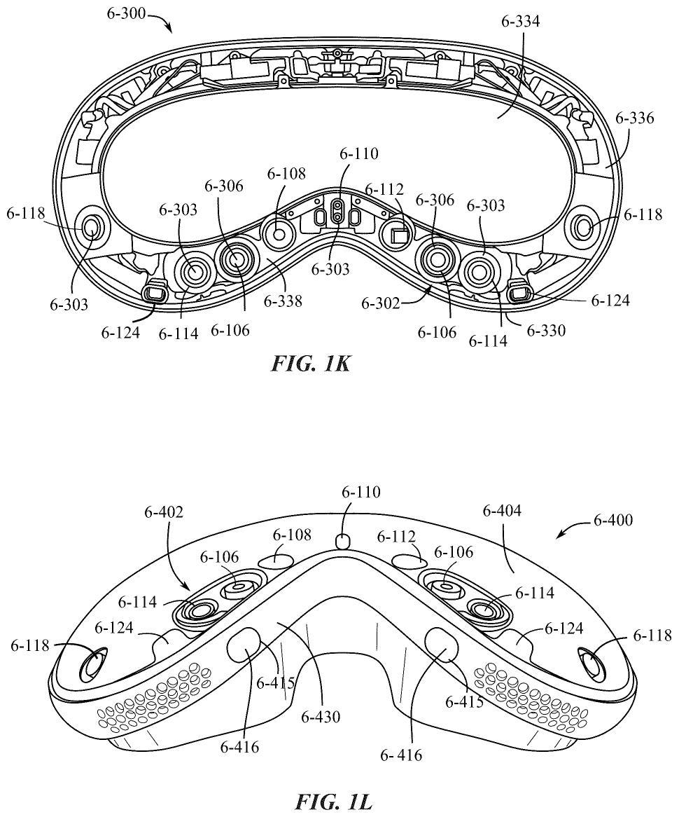

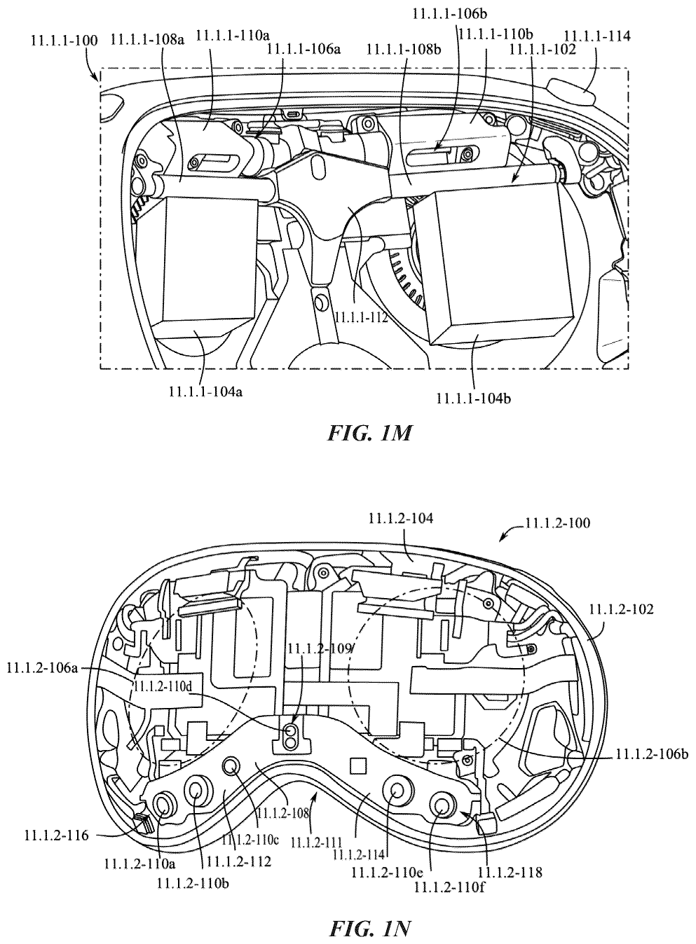

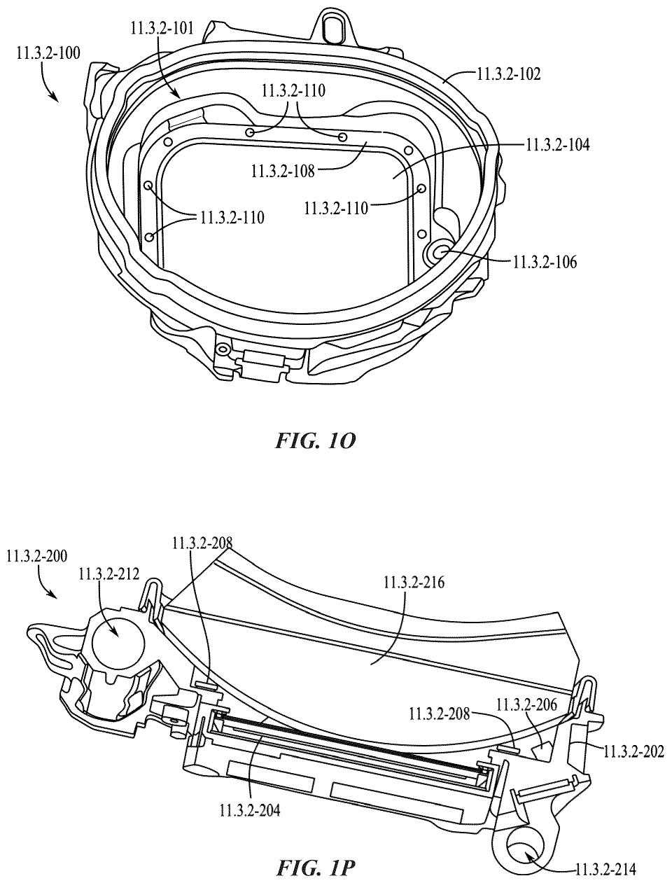

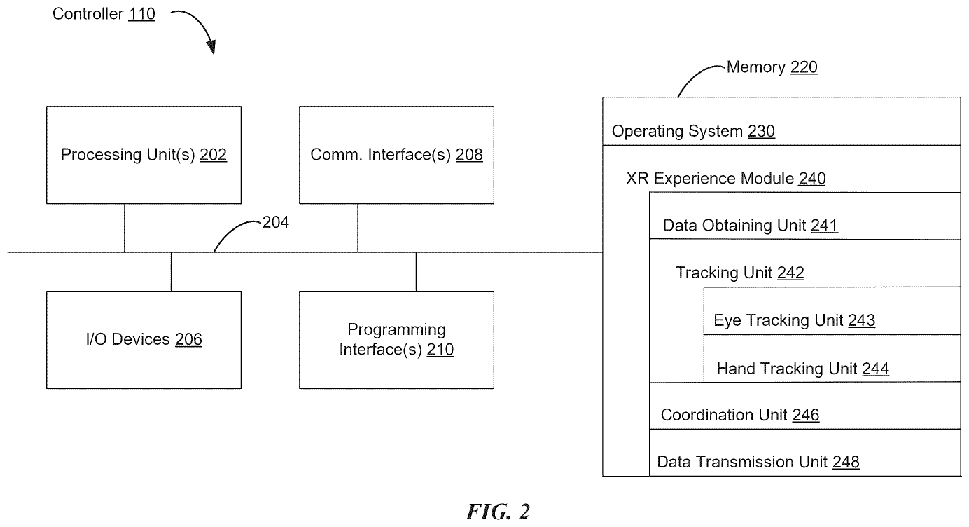

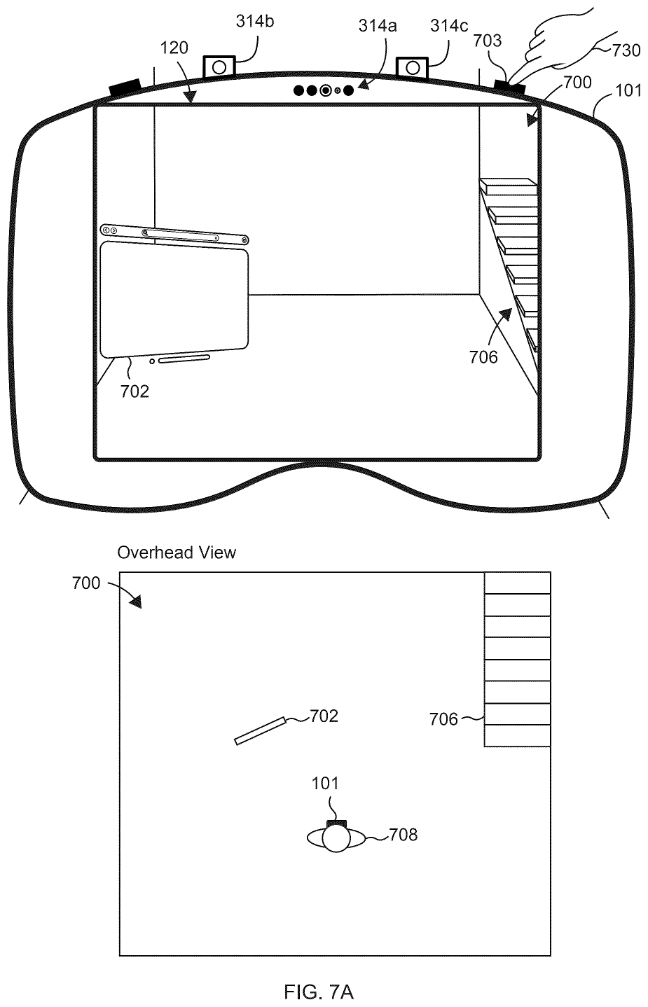

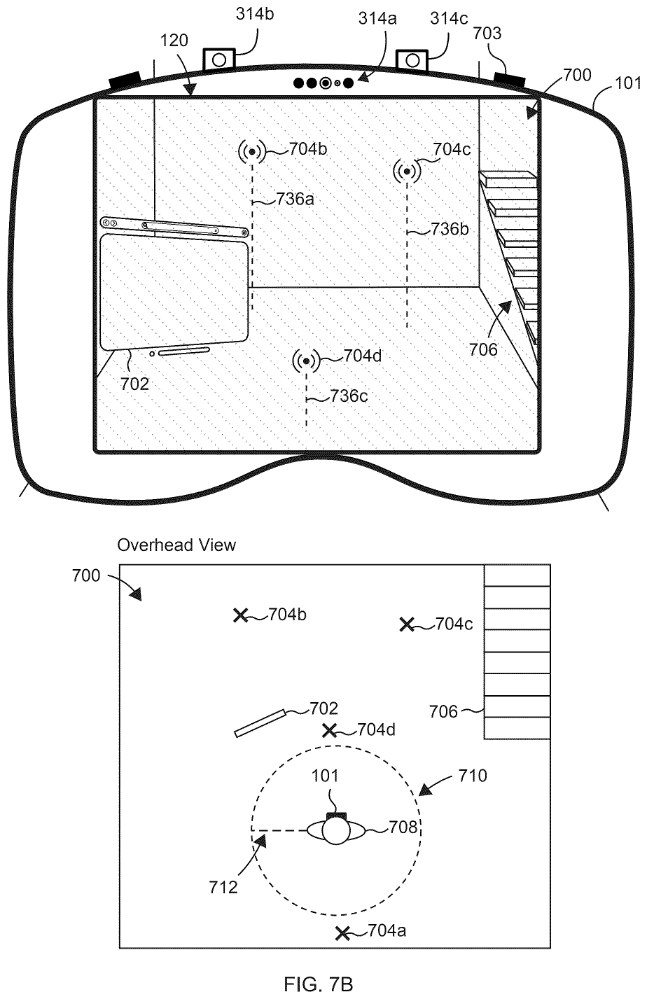

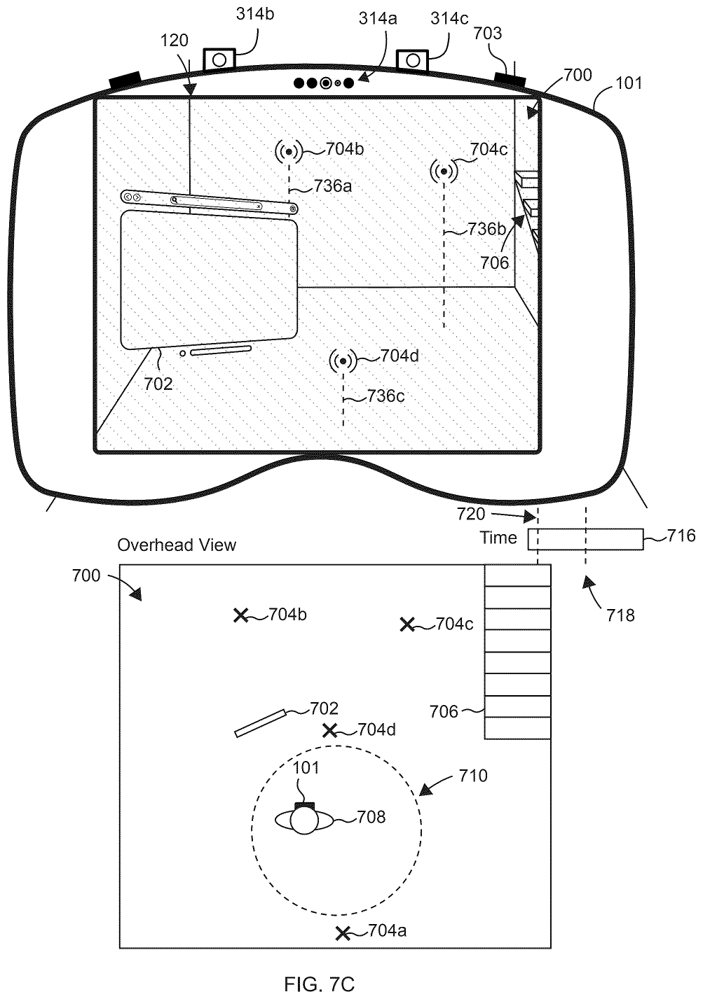

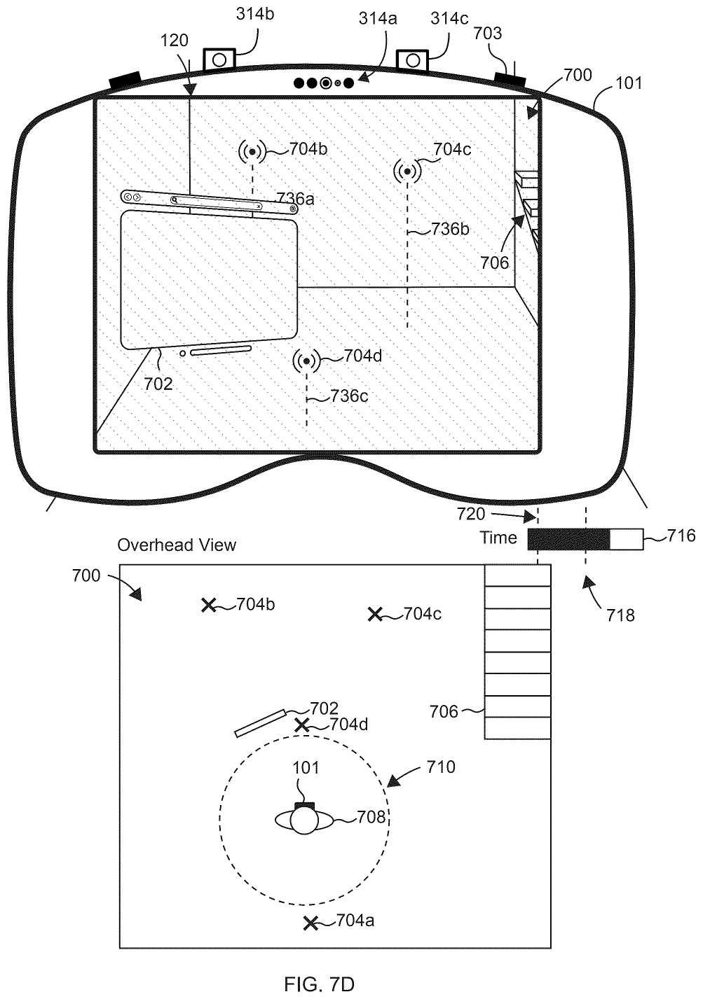

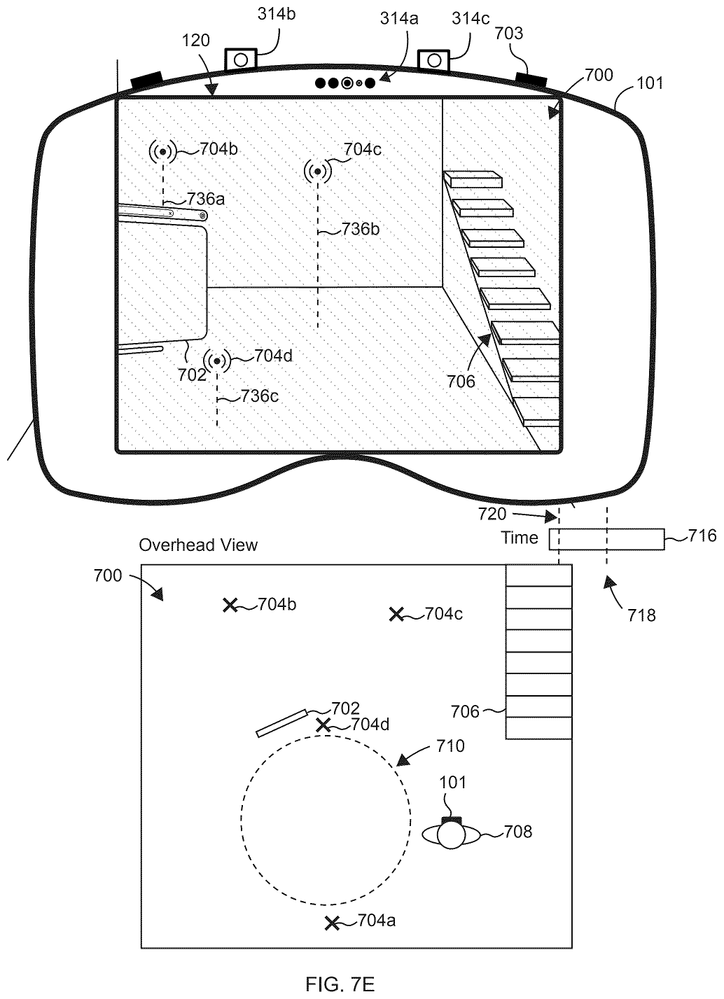

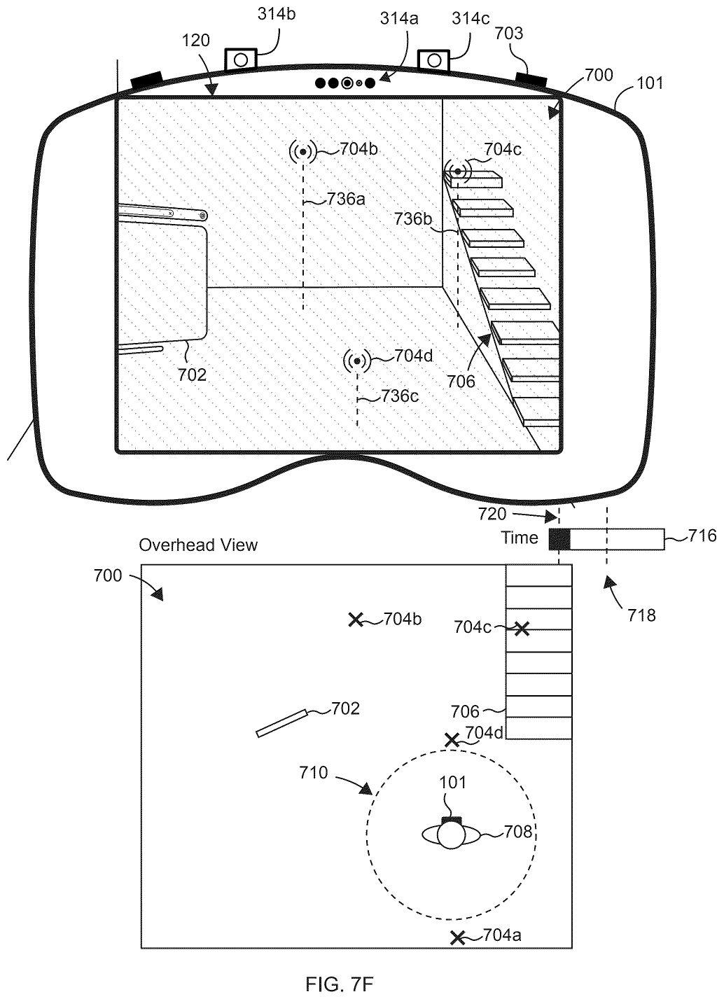

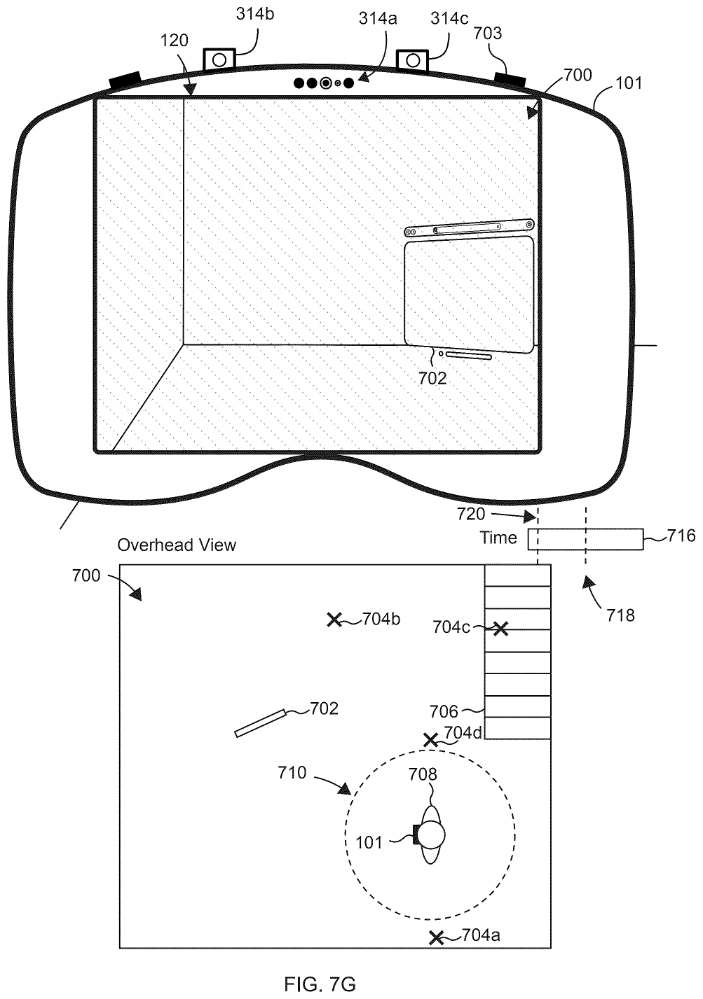

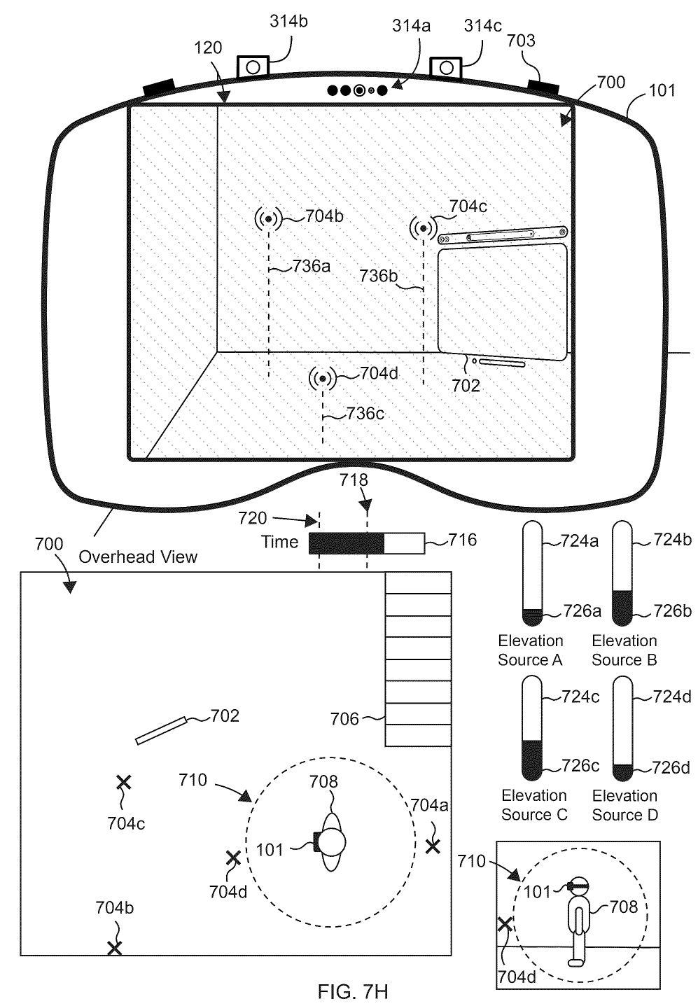

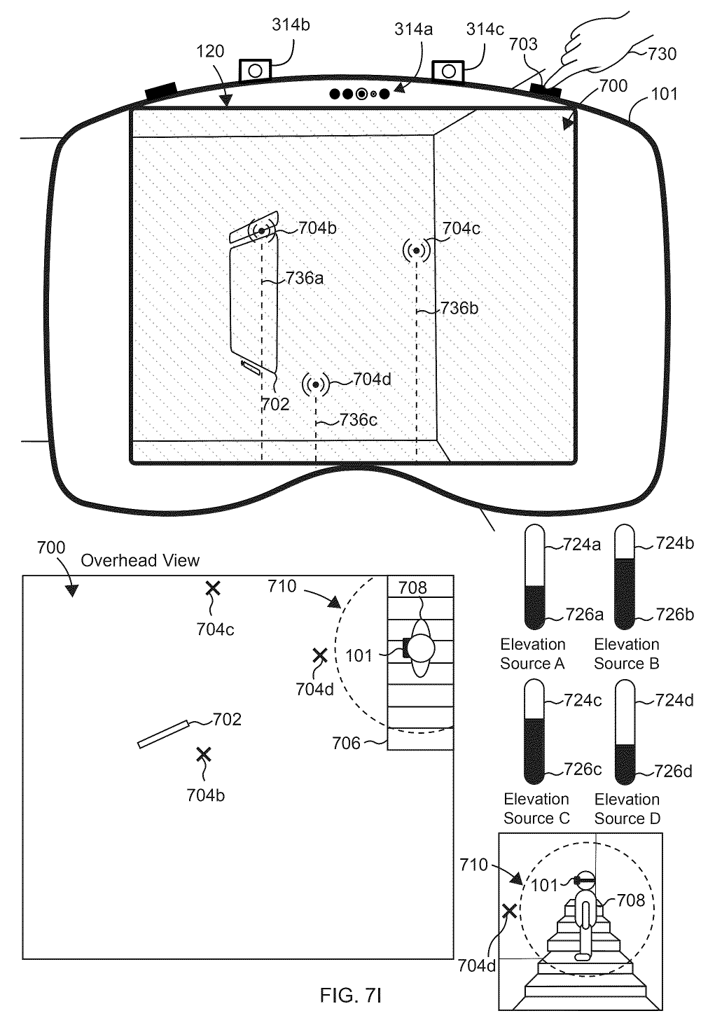

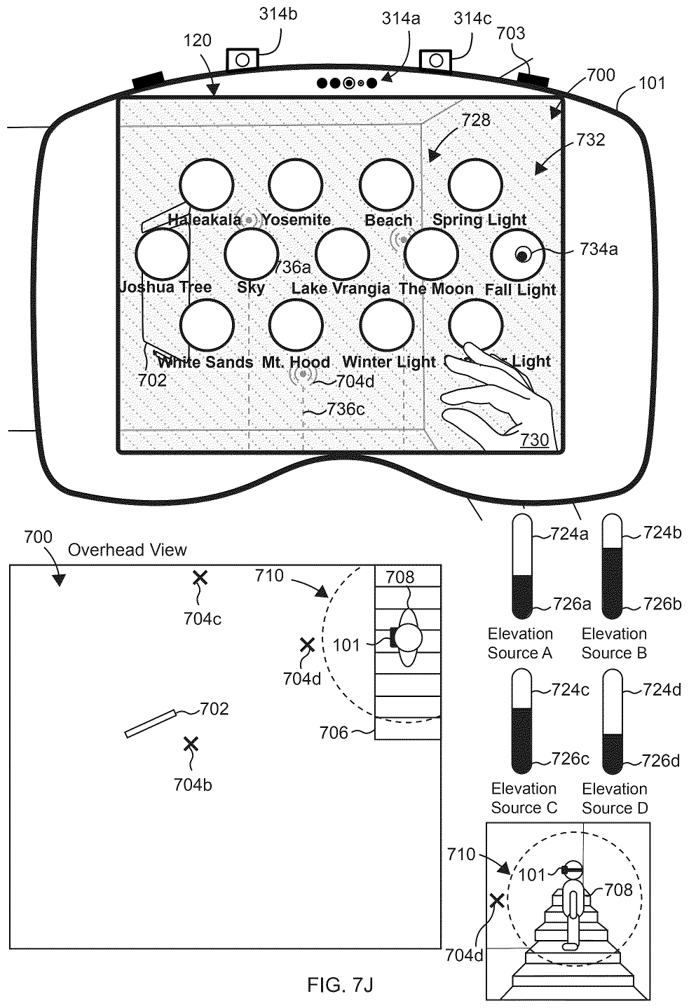

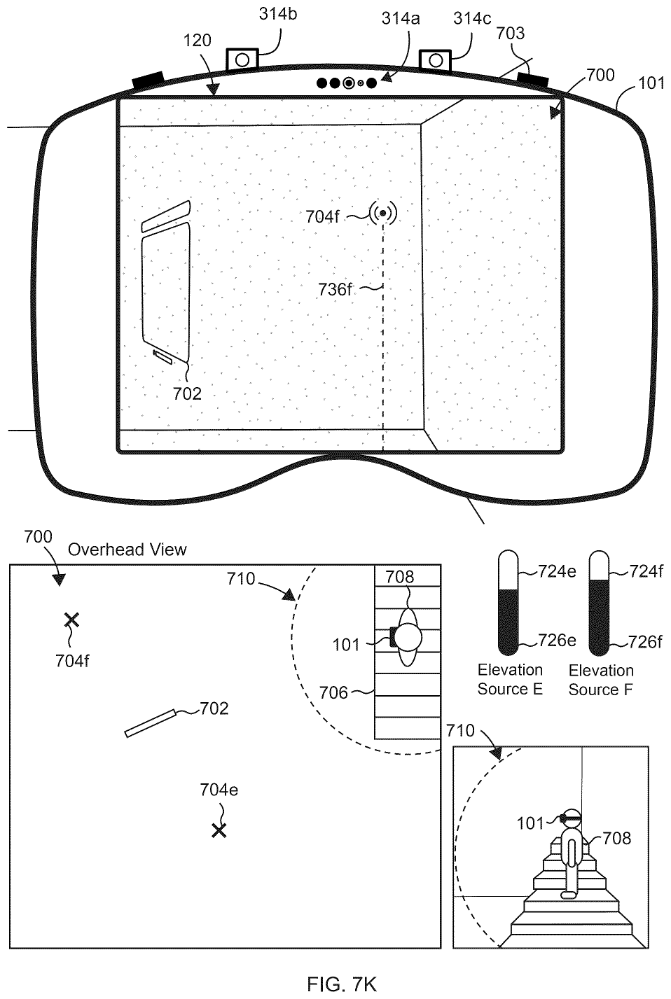

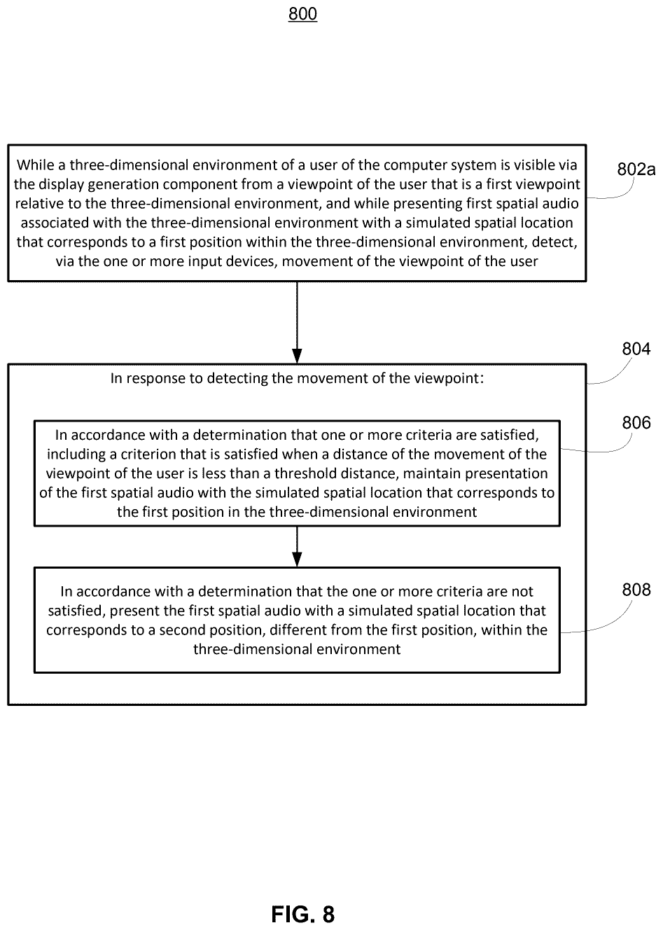

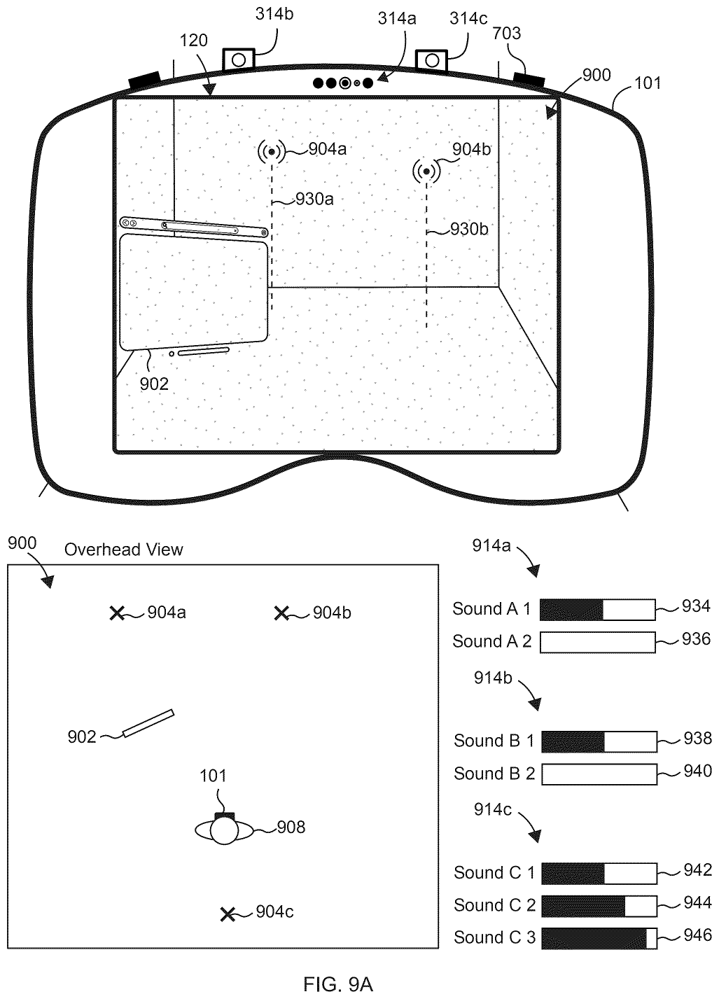

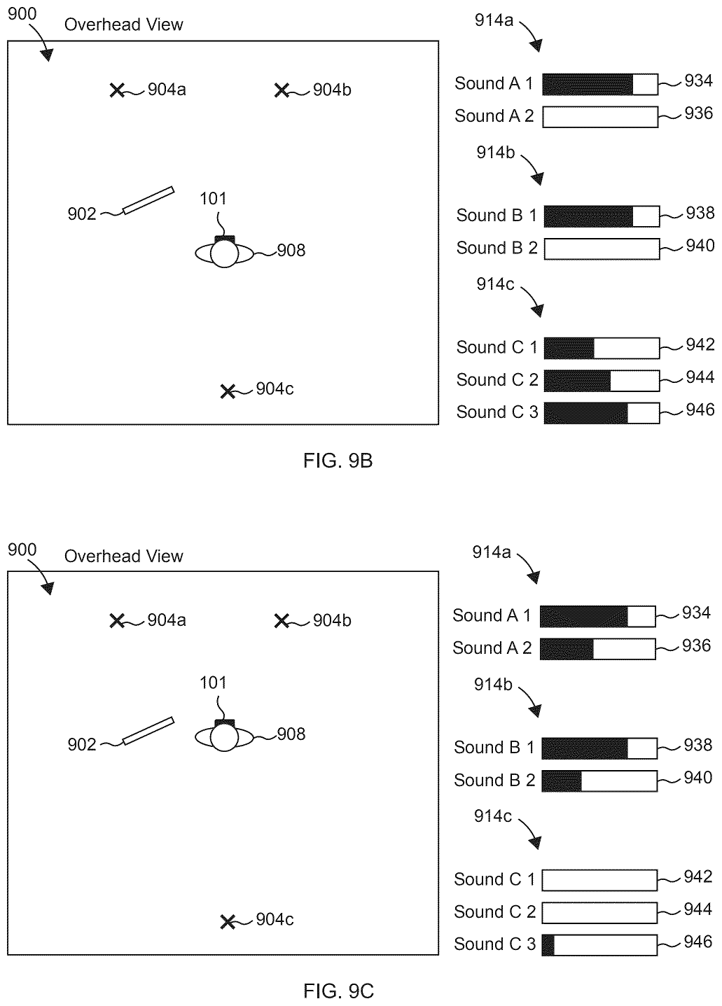

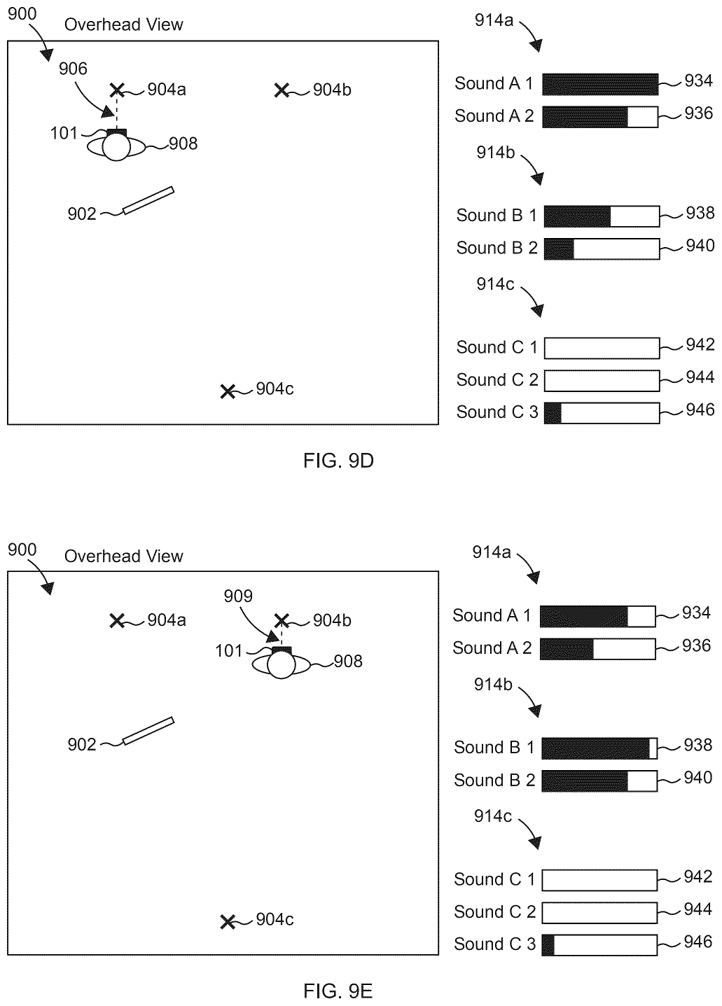

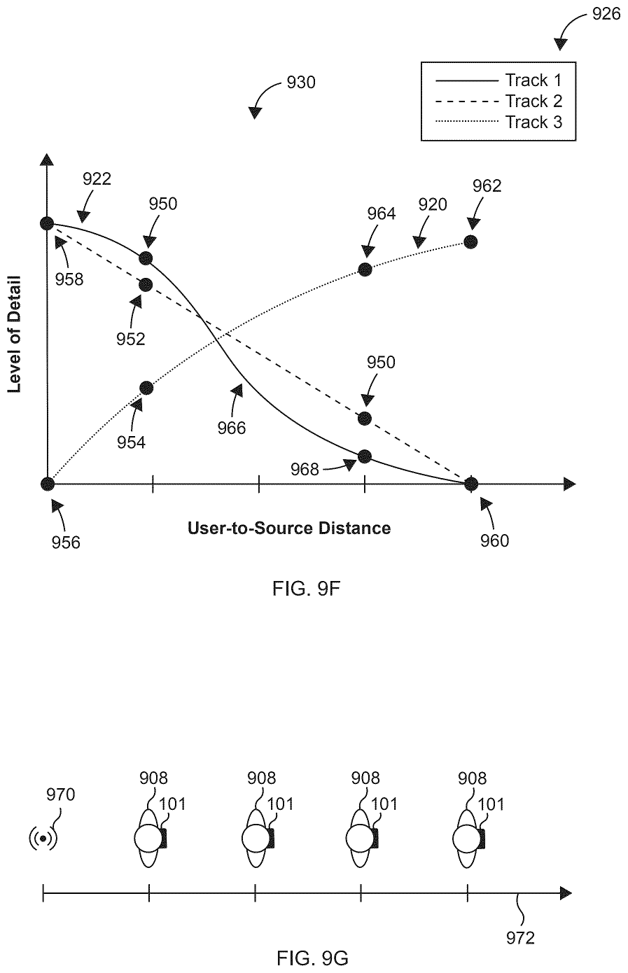

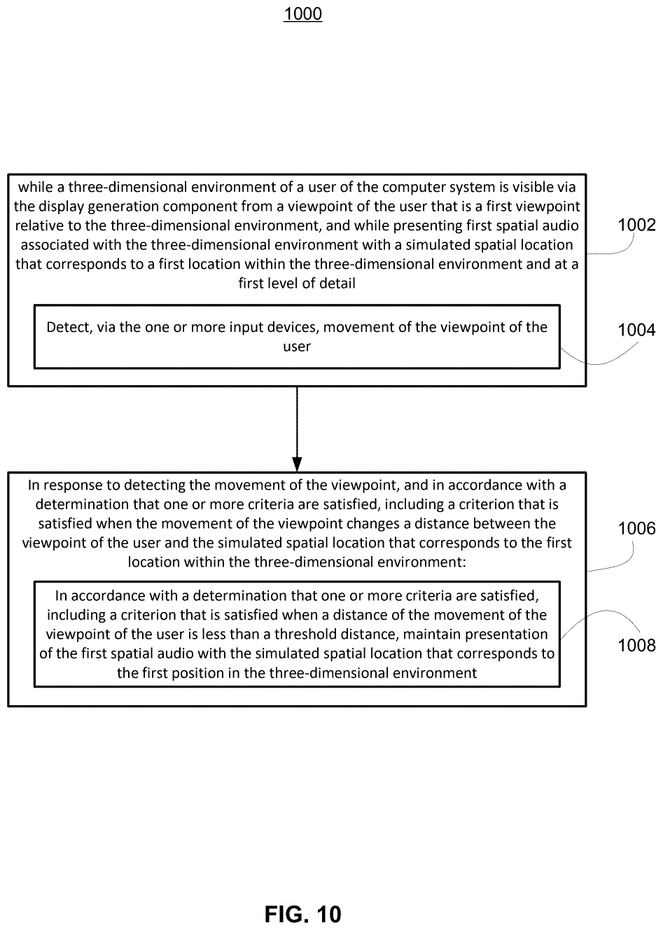

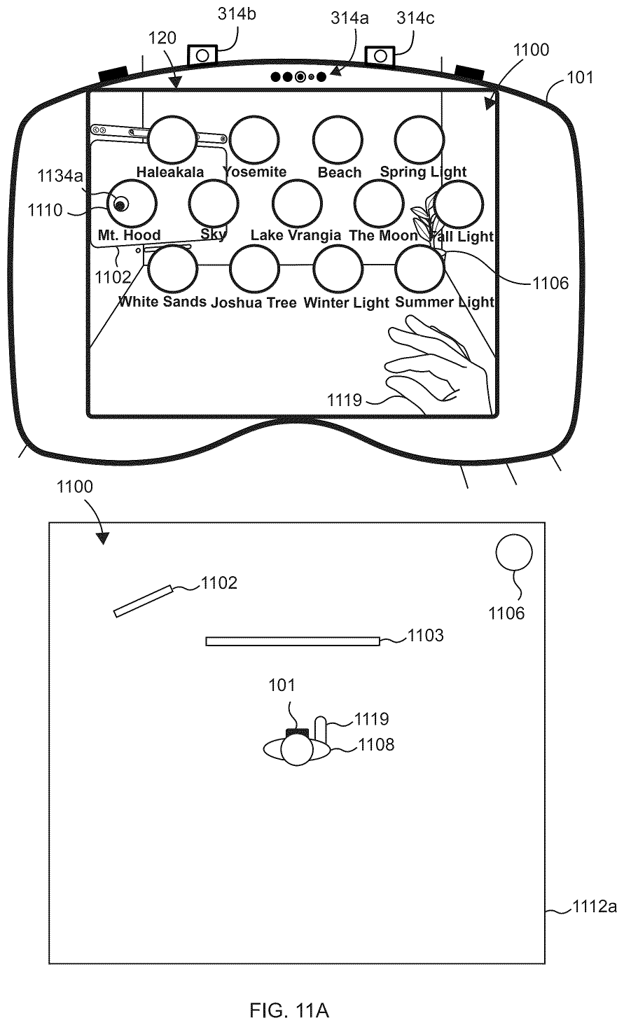

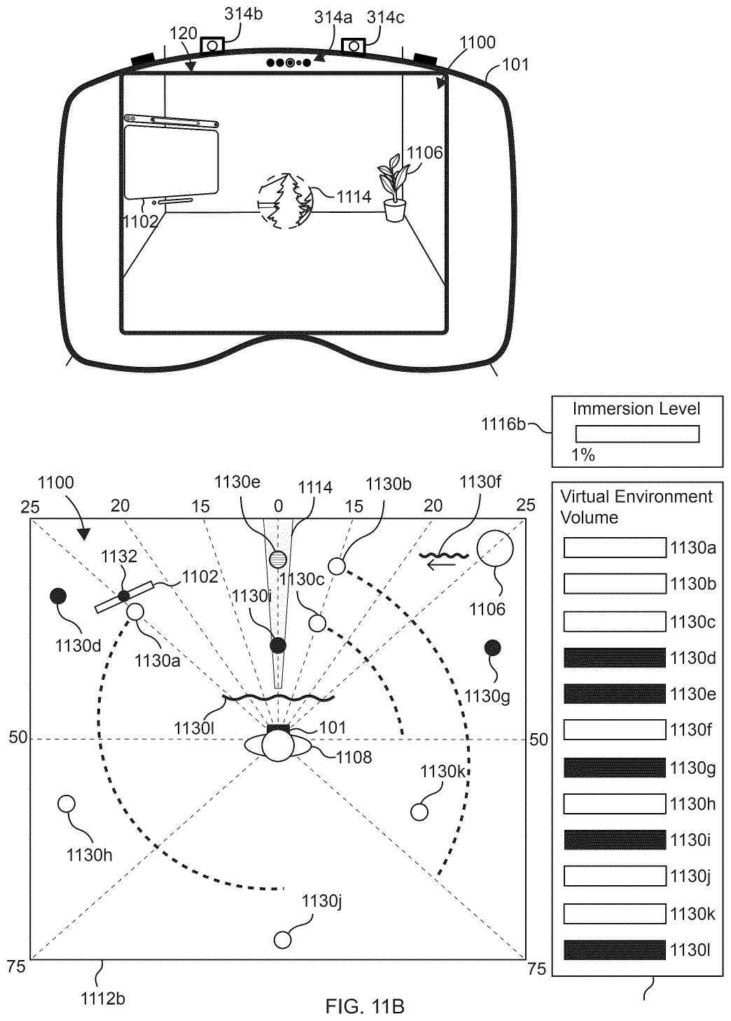

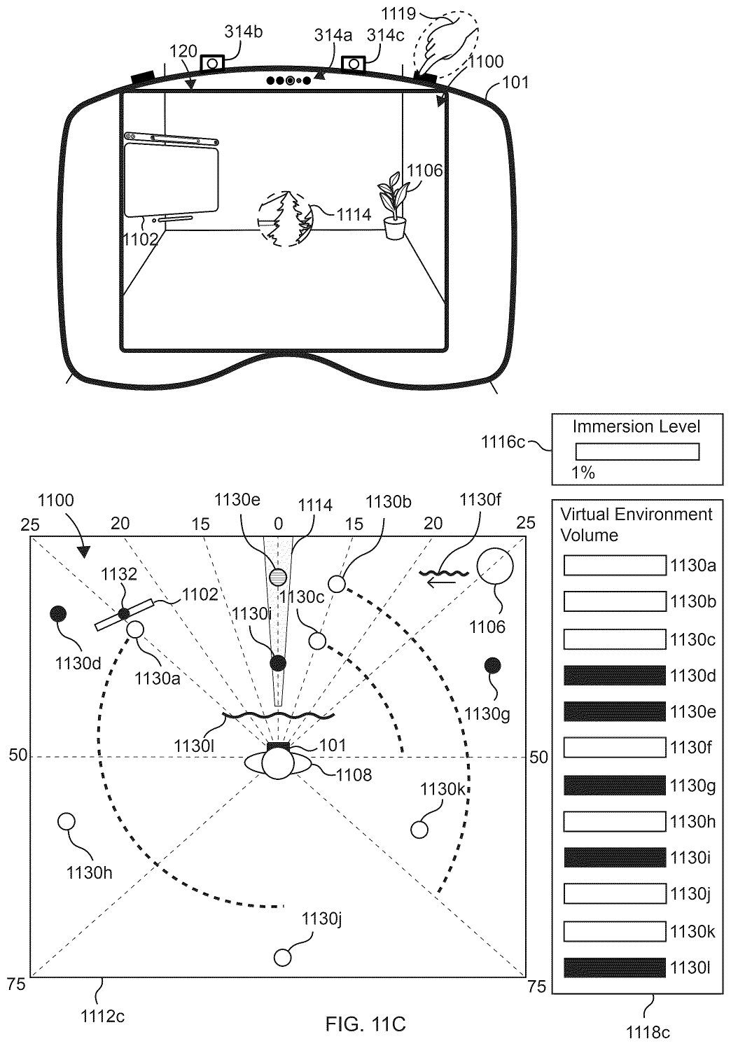

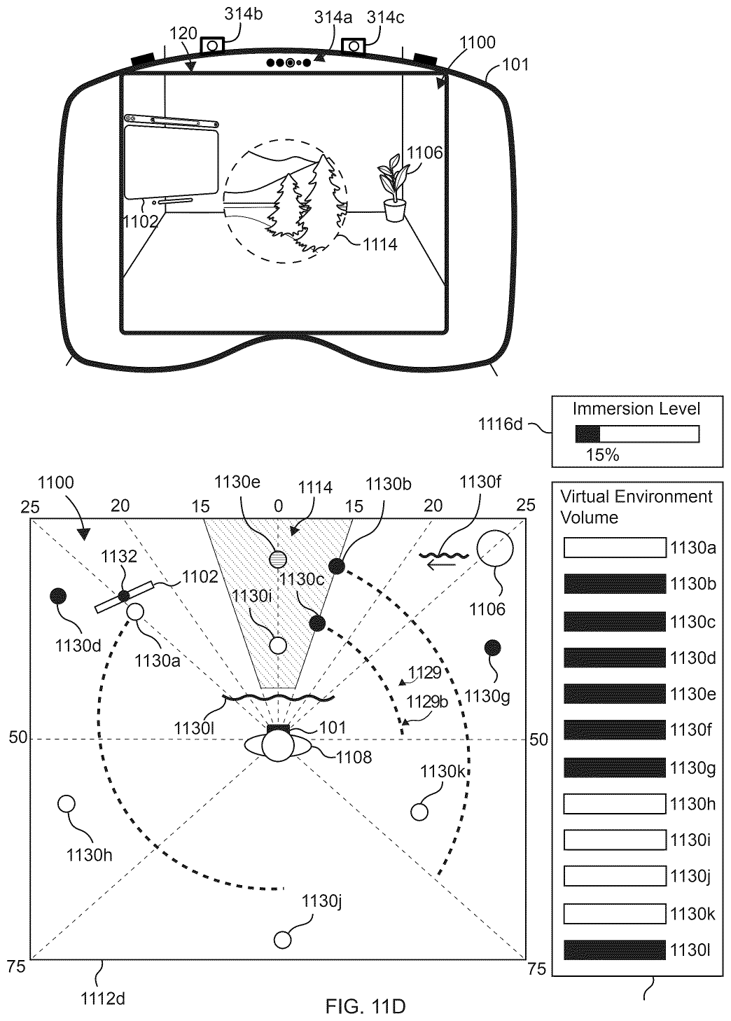

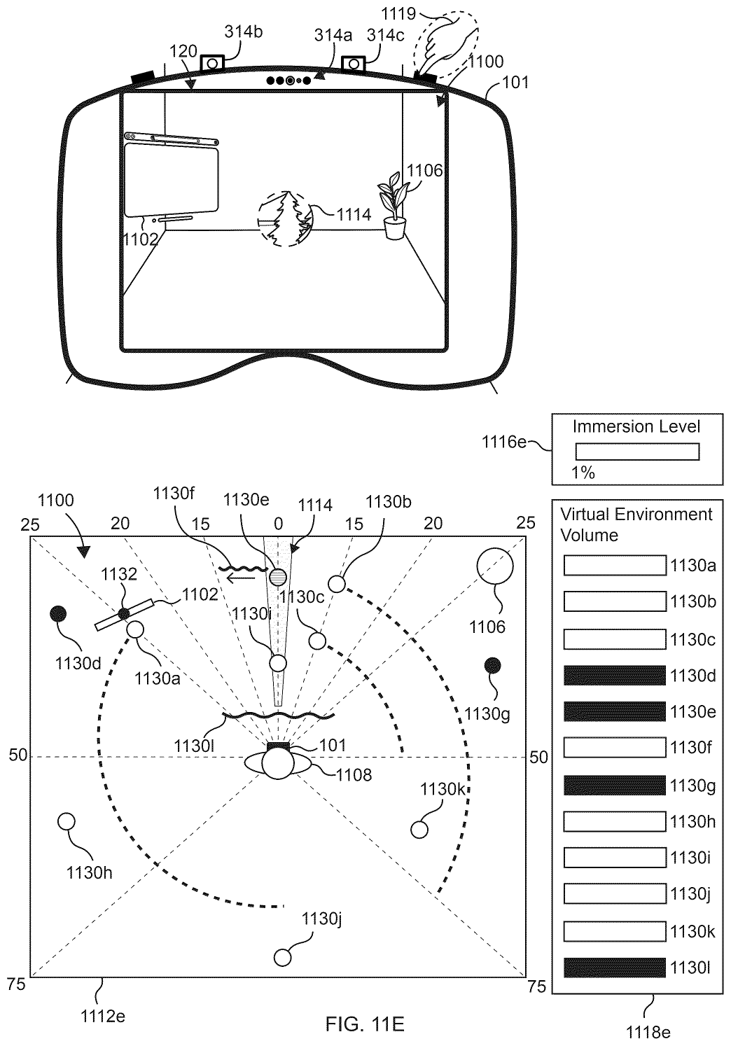

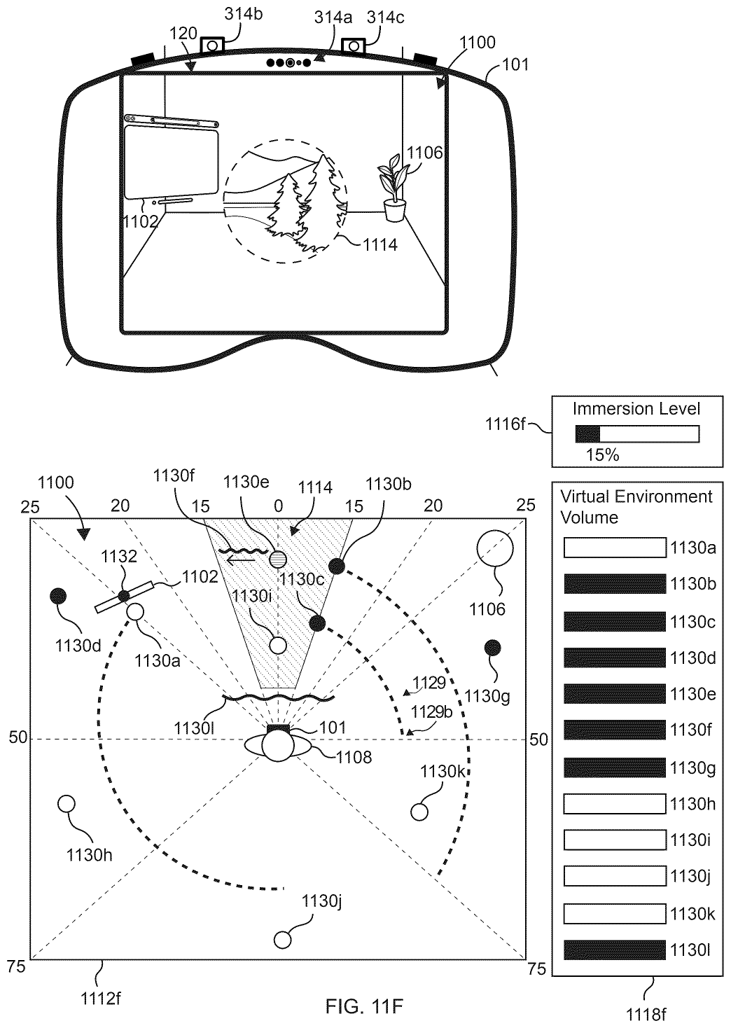

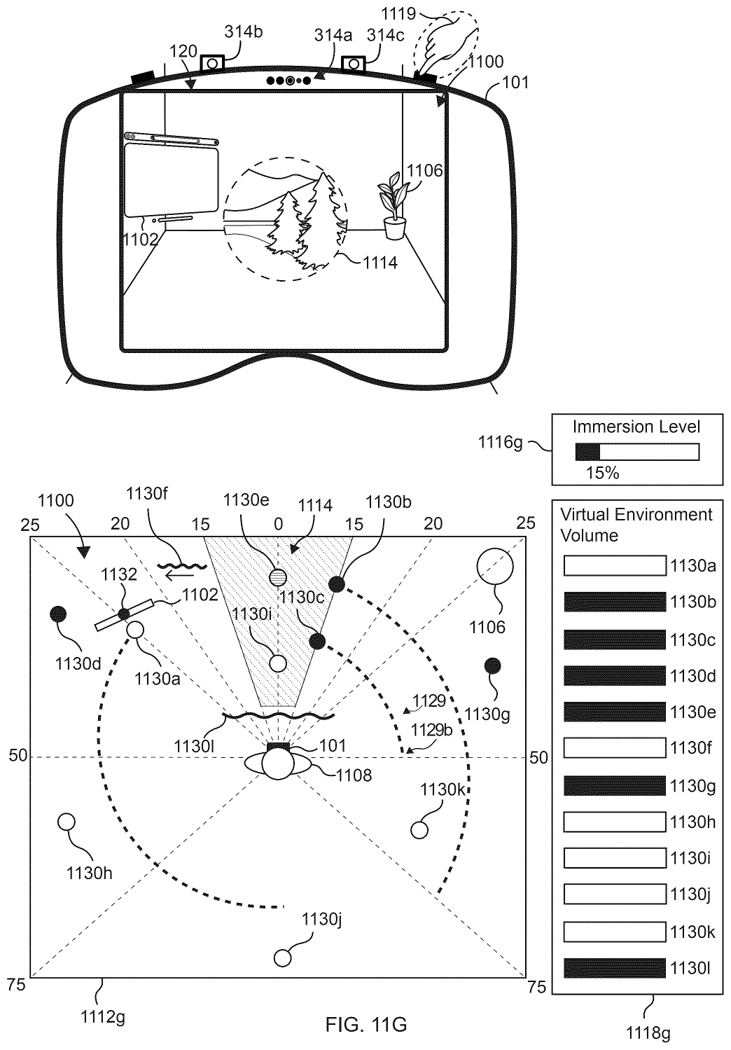

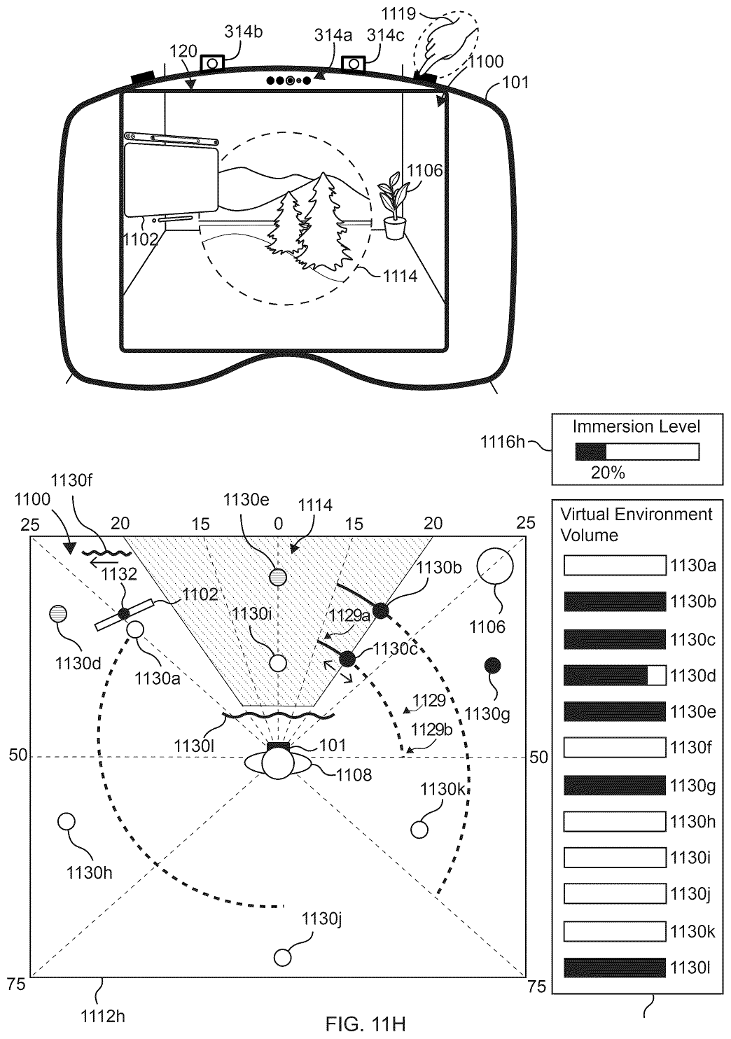

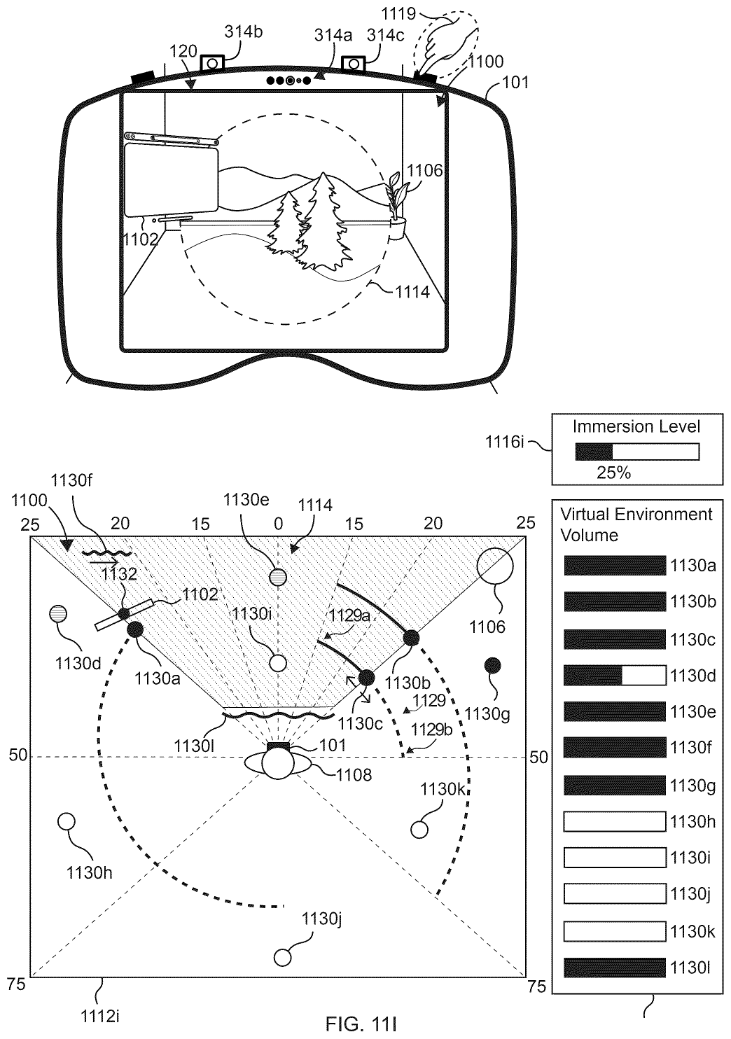

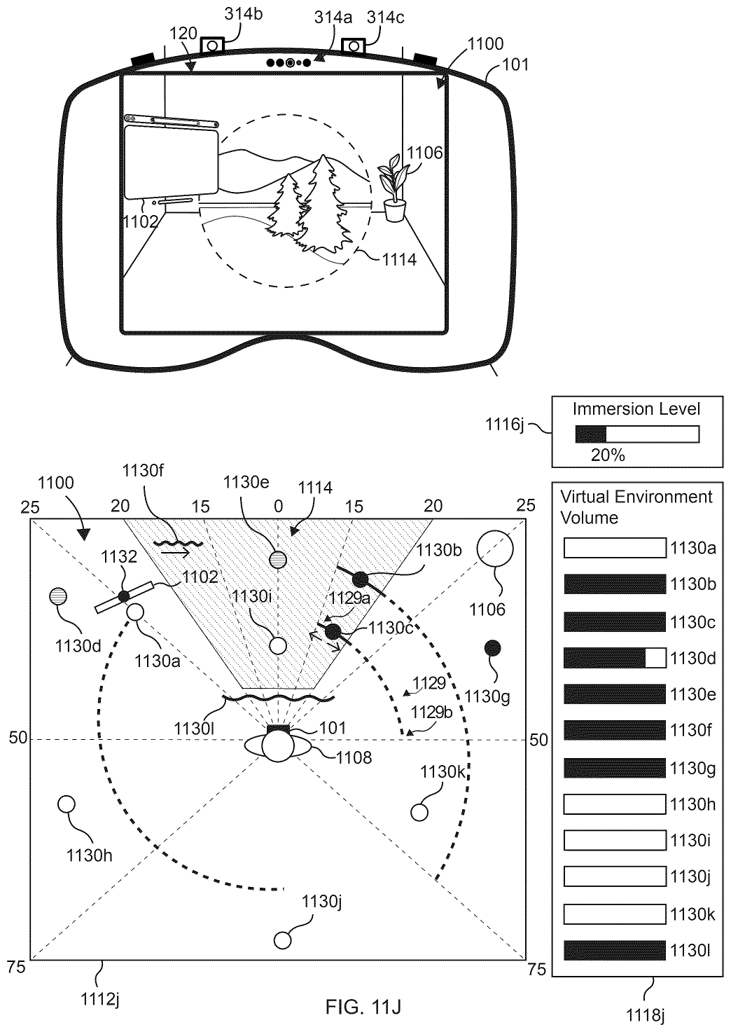

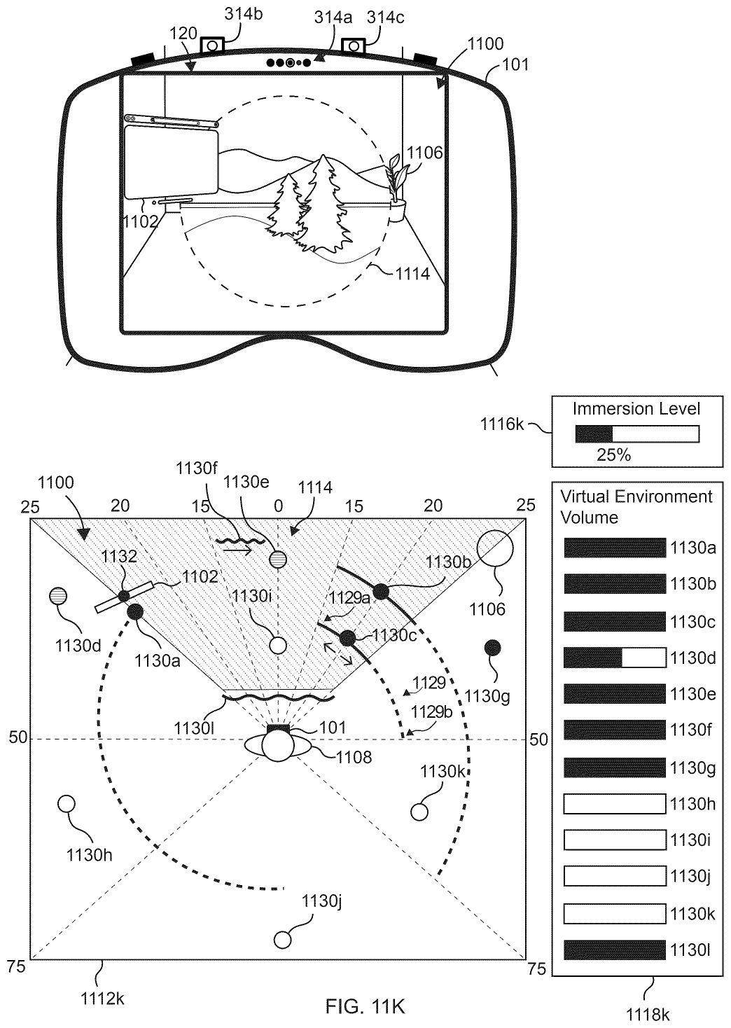

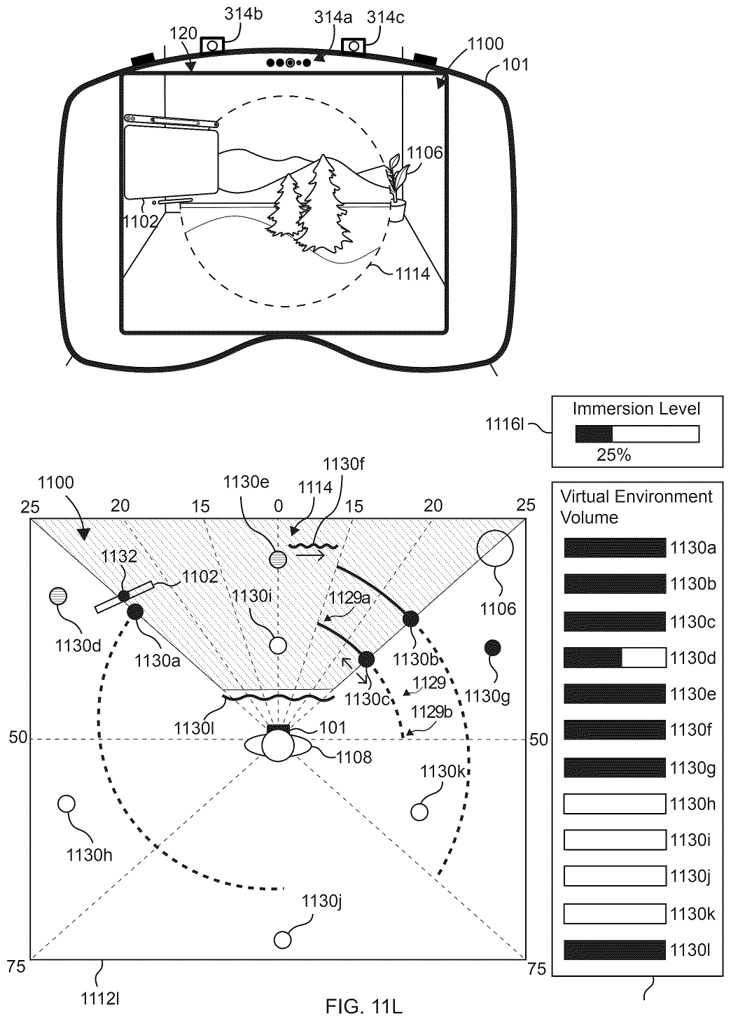

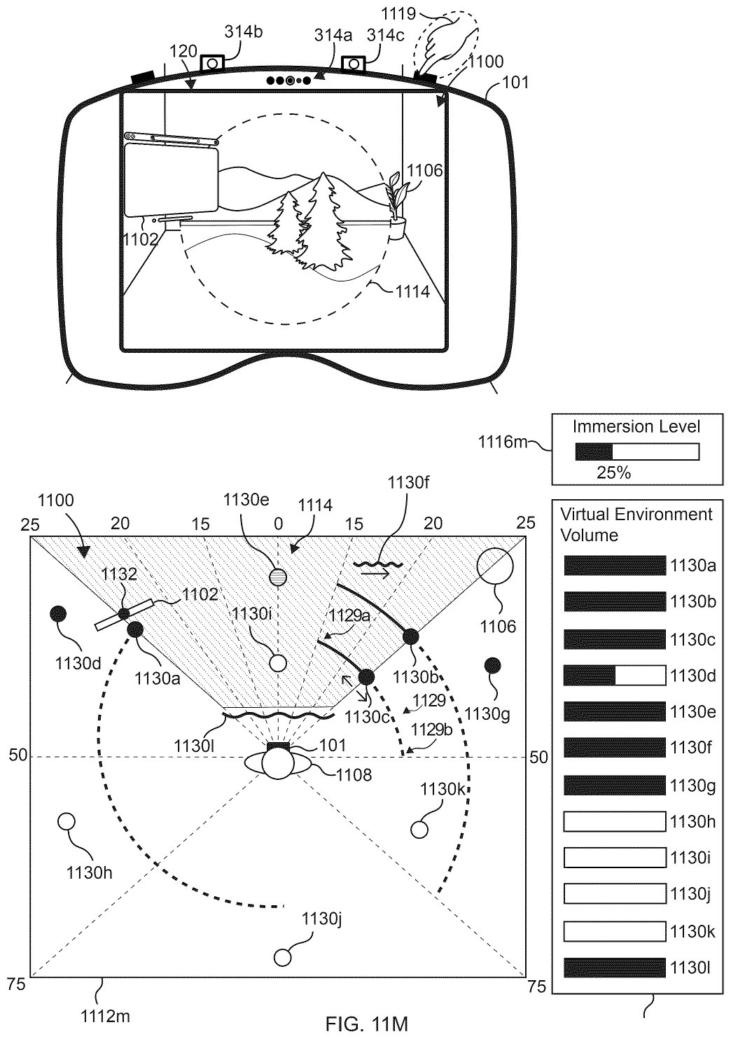

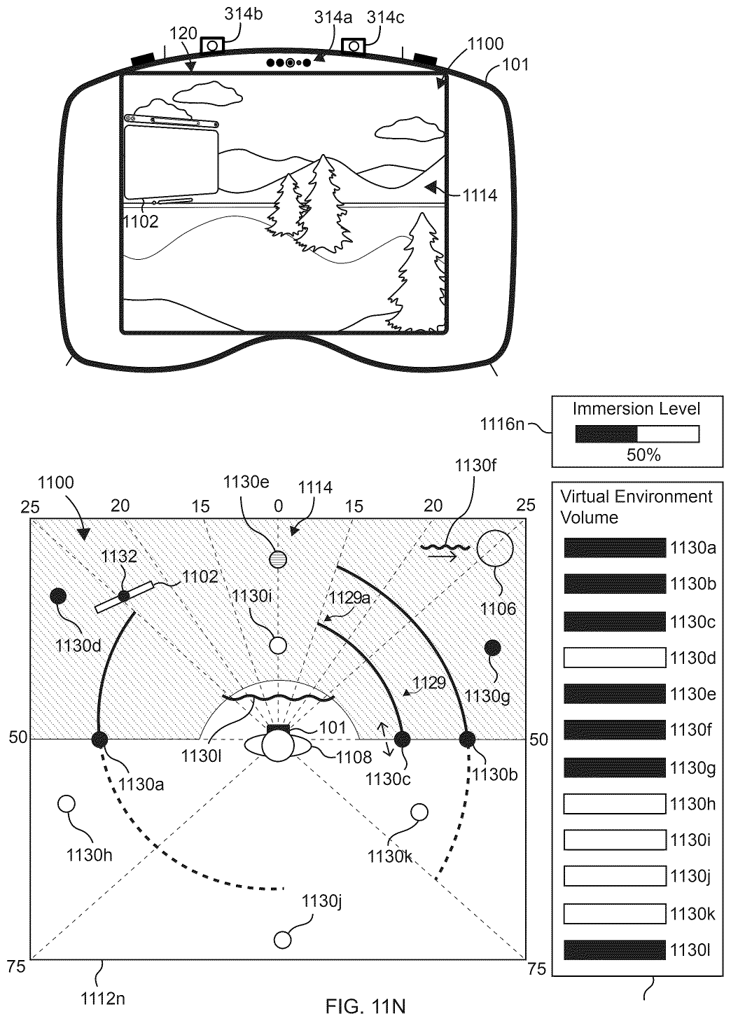

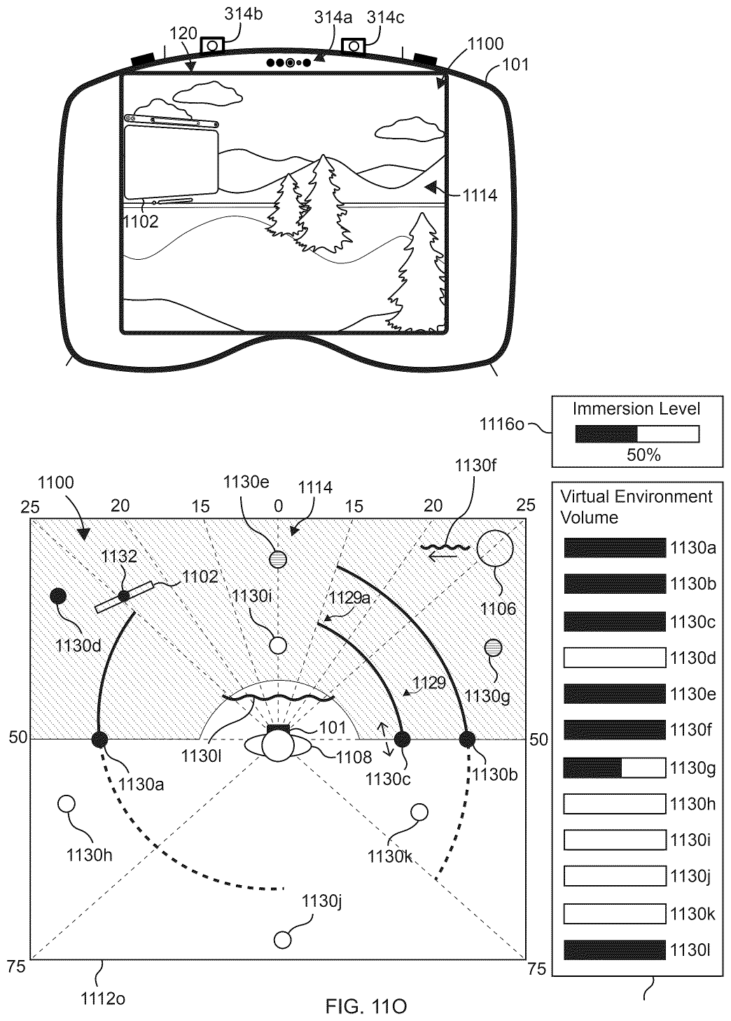

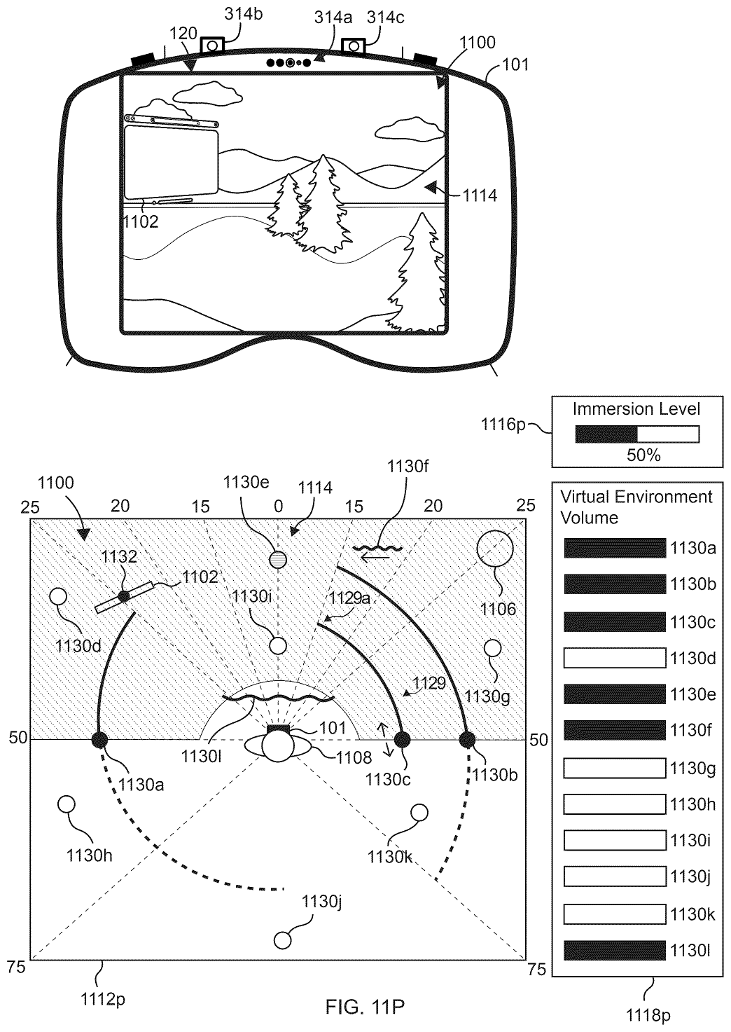

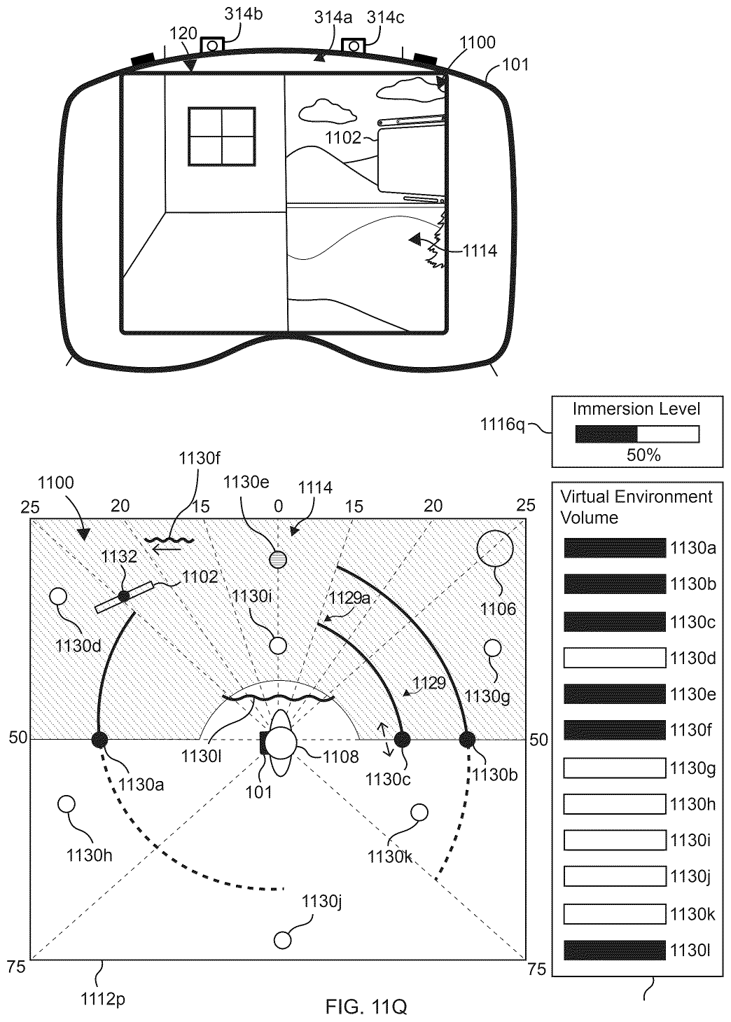

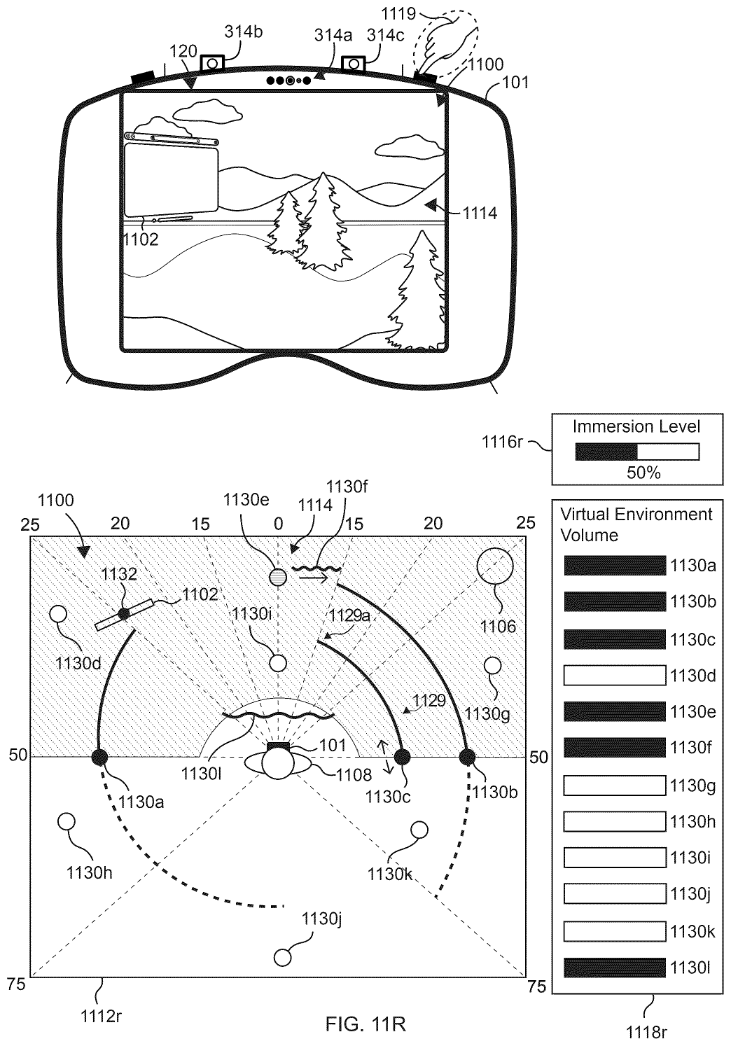

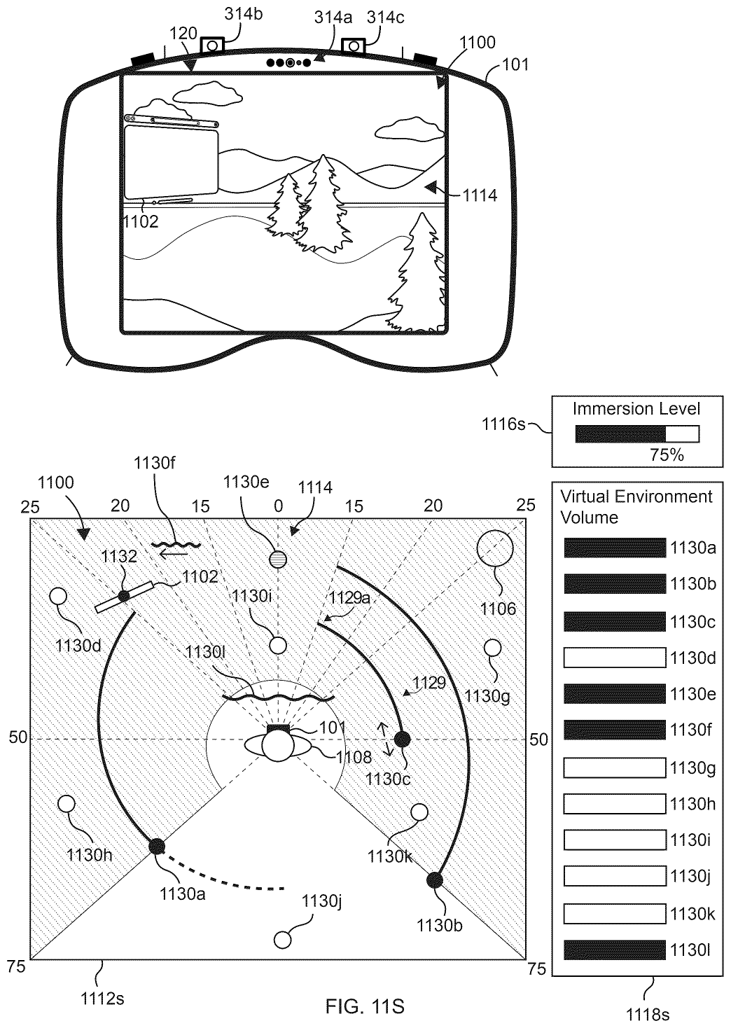

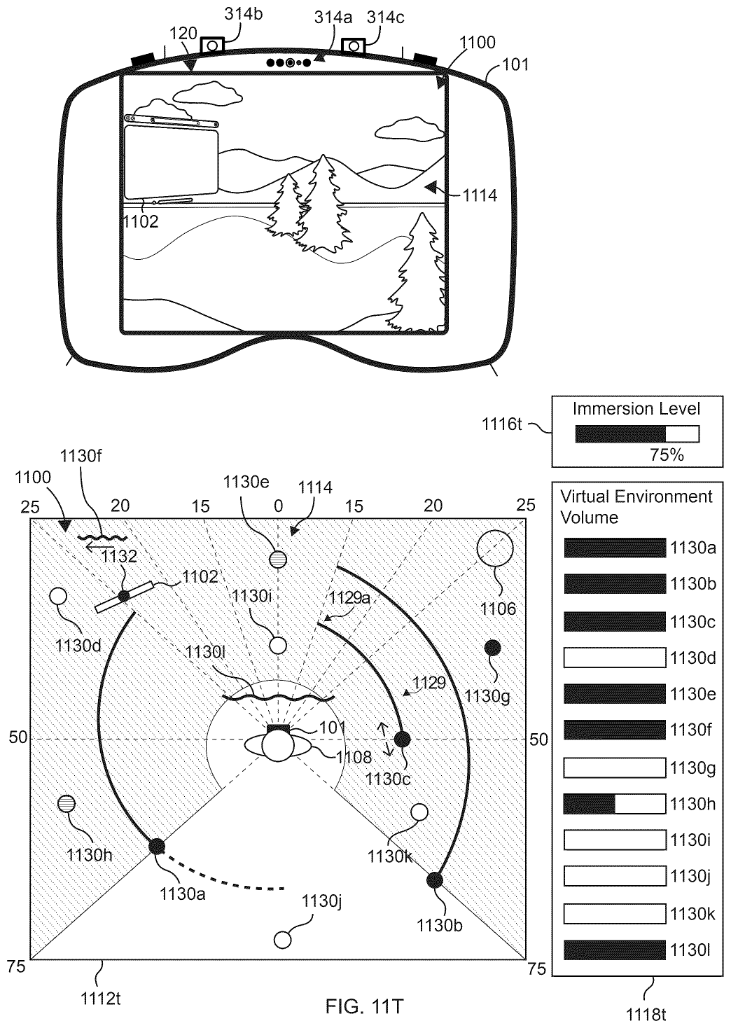

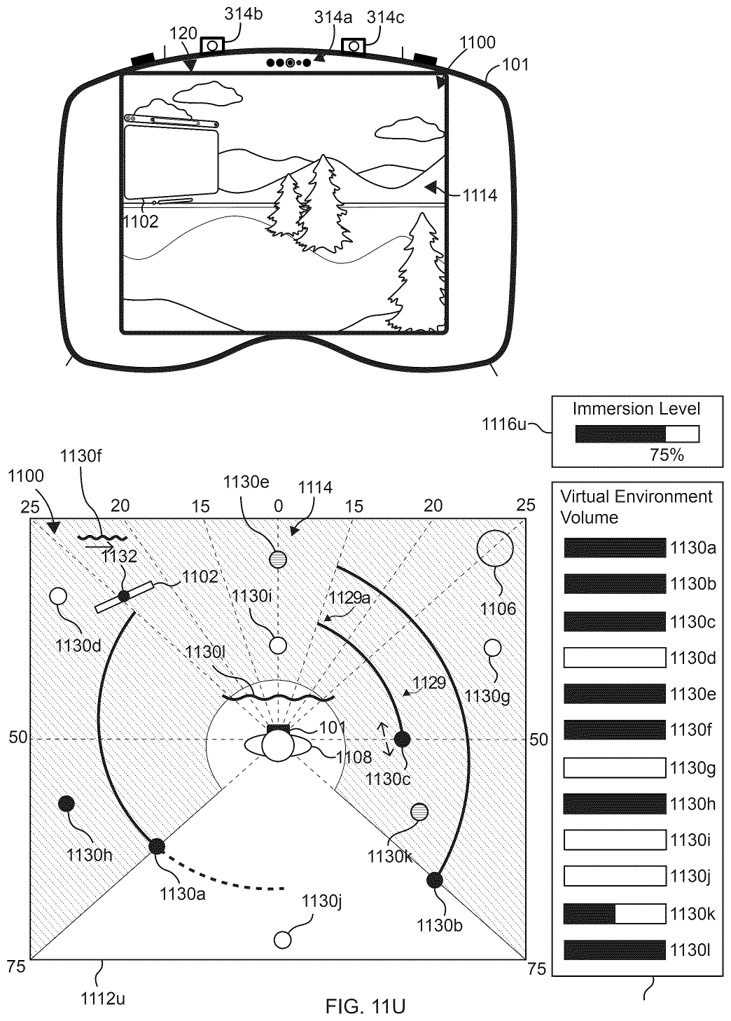

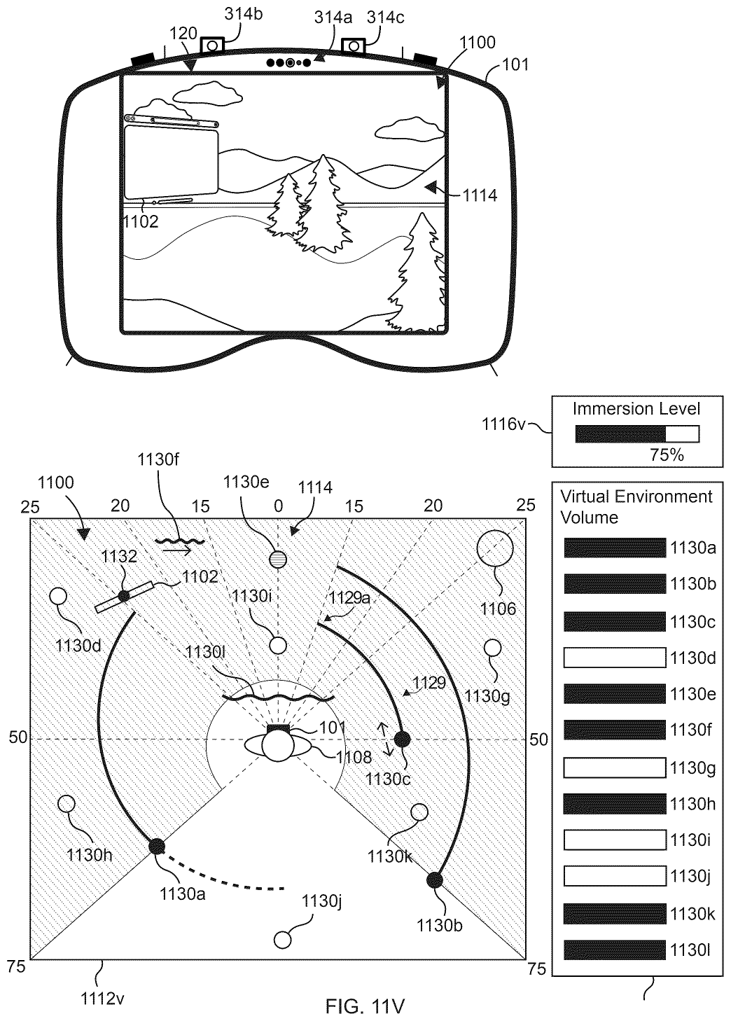

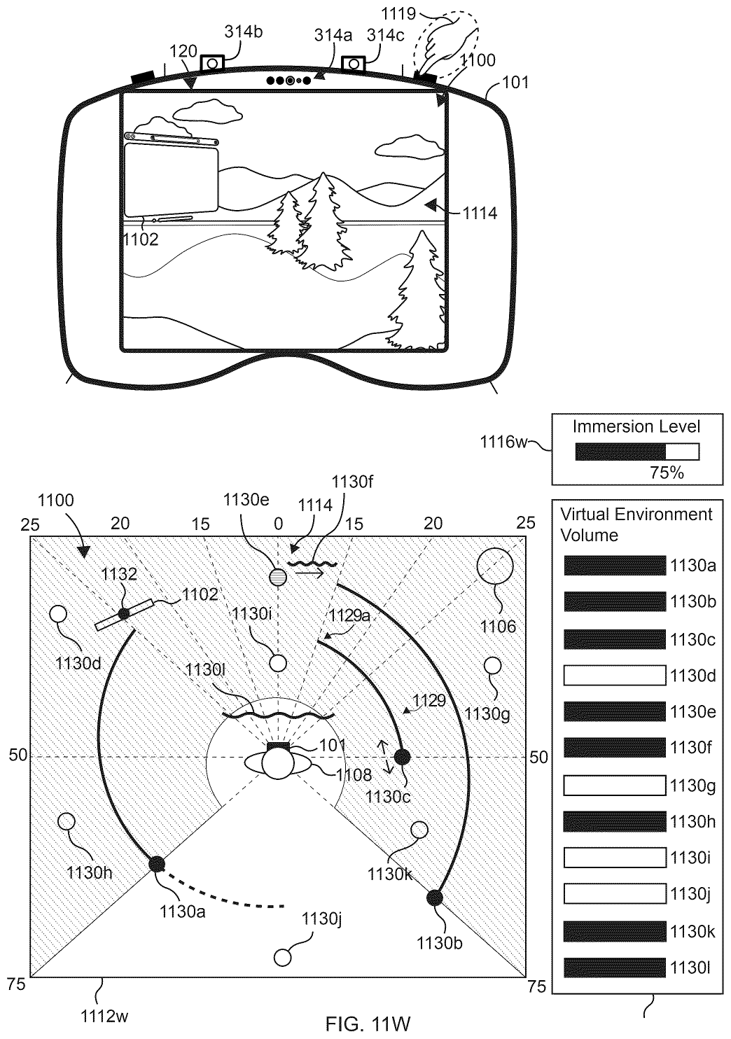

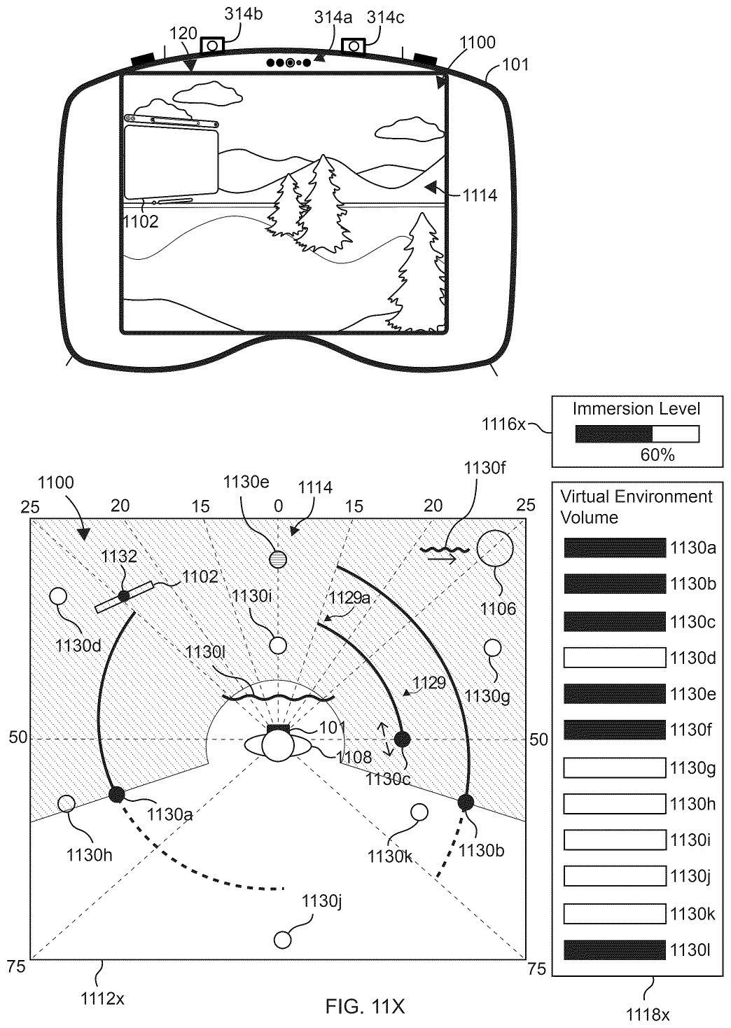

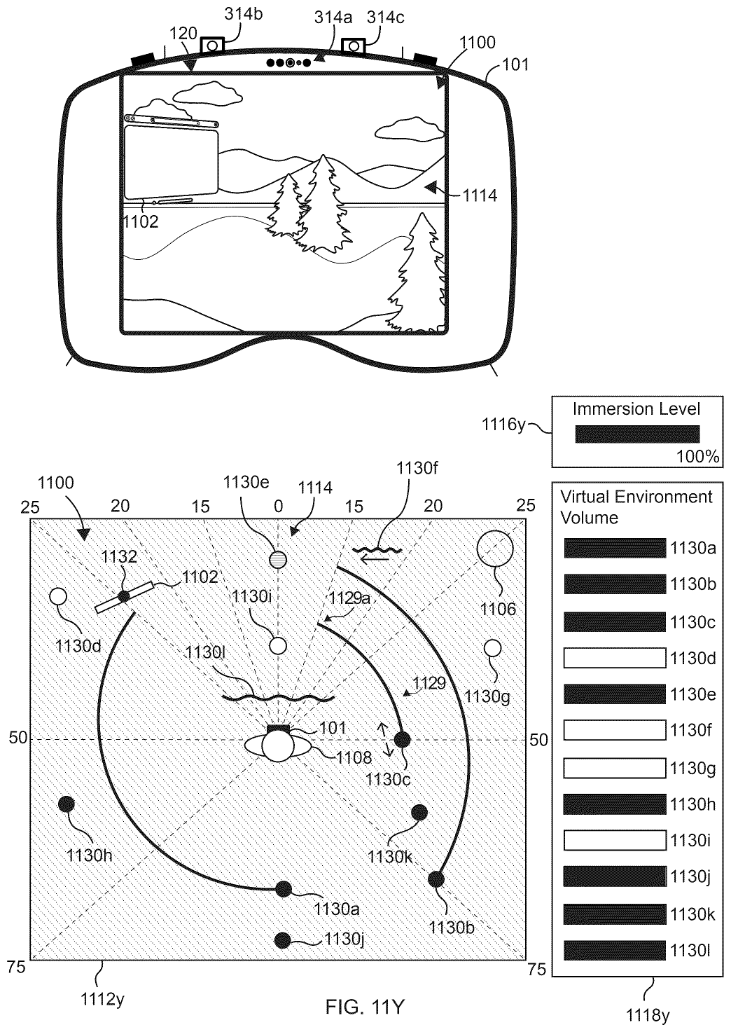

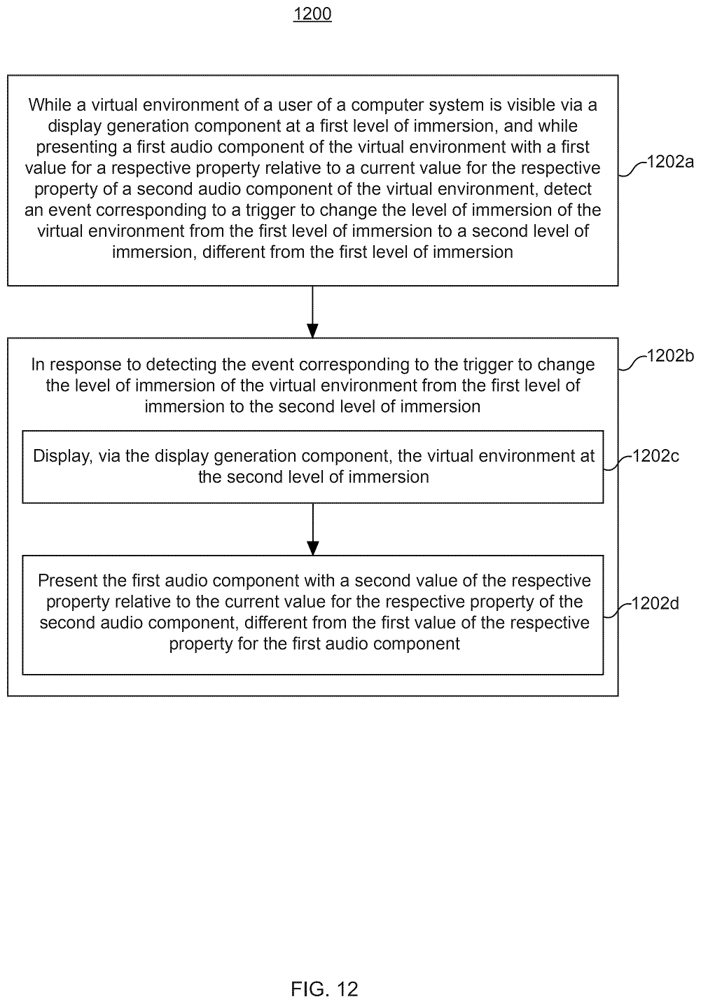

FIGS. 1A-6 provide a description of example computer systems for providing XR experiences to users (such as described below with respect to methods 800 1000, and/or 1200). FIGS. 7A-7K illustrate example techniques for presenting spatial audio at a plurality of locations based upon movement of a user viewpoint, in accordance with some embodiments. FIG. 8 illustrates a flow diagram of methods presenting spatial audio at a plurality of locations based upon movement of a user viewpoint, in accordance with some embodiments. The user interfaces in FIGS. 7A-7K are used to illustrate the processes in FIG. 8. FIGS. 9A-9G illustrate example techniques for presenting spatial audio with a level of detail based upon a distance between a location corresponding to spatial audio and a user viewpoint, in accordance with some embodiments. FIG. 10 illustrates a flow diagram of methods of presenting spatial audio with a level of detail based upon a distance between a location corresponding to spatial audio and a user viewpoint, in accordance with various embodiments. The user interfaces in FIGS. 9A-9G are used to illustrate the processes in FIG. 10. FIGS. 11A-11Y illustrate example techniques for displaying a virtual environment and changing levels of audio of audio components associated with the virtual environment in response to requests to change a level of immersion of the virtual environment in accordance with some embodiments. FIG. 12 illustrates a flow diagram of methods of changing a level of audio of an audio component associated with a virtual environment in response to a request to change a level of immersion of the virtual environment in accordance with some embodiments. The user interfaces in FIGS. 11A-11Y are used to illustrate the processes in FIG. 12.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specfies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typcially move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display.

Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

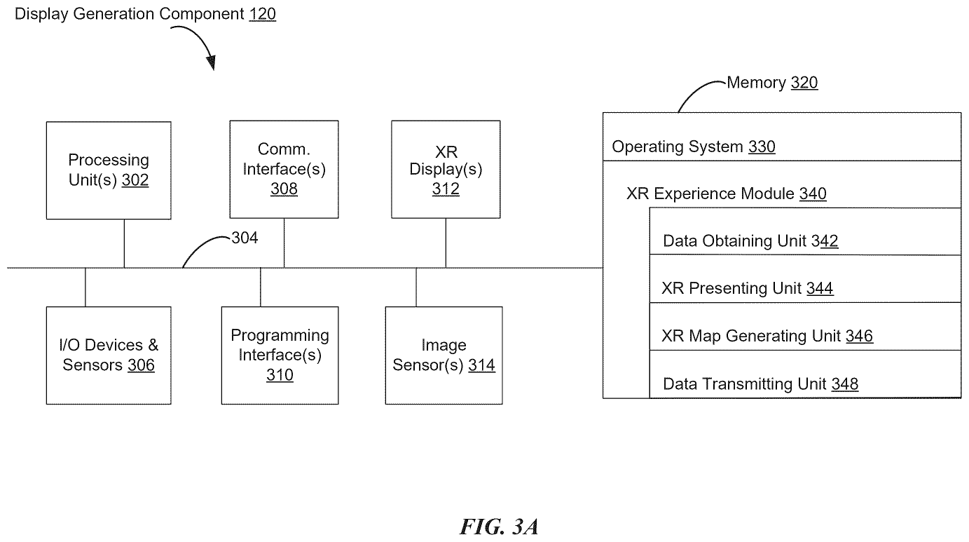

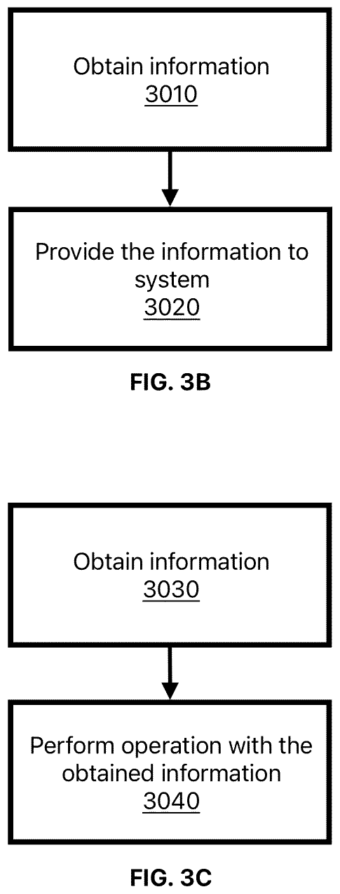

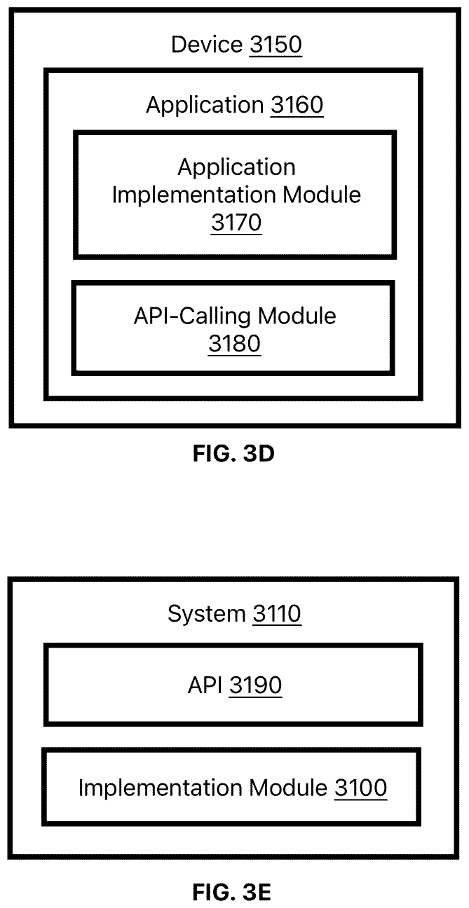

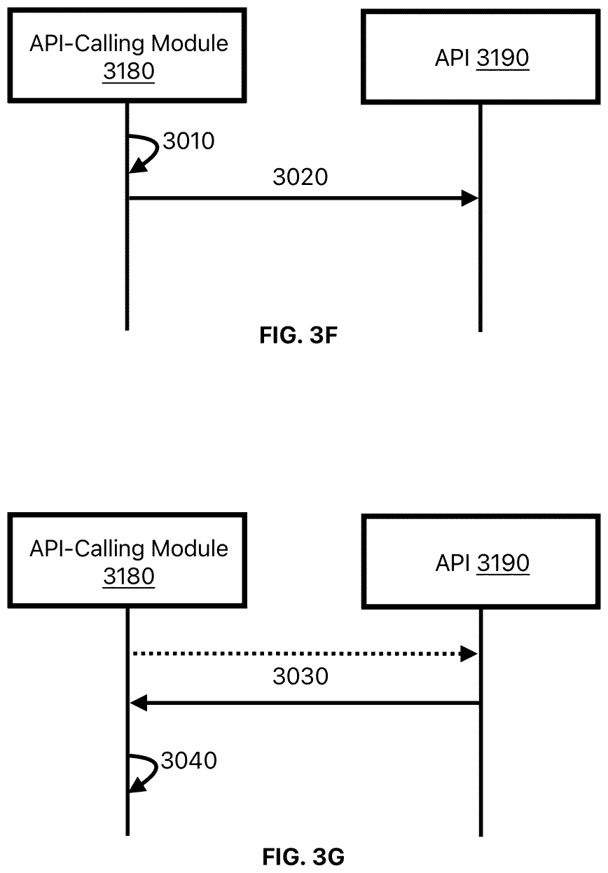

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3A. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. U ser interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 10) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HM D 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to F IGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HM D device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 1I and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 10 illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 10 can be replicated in another (e.g., second) optical module disposed with the HMD to interact (e.g., project light and capture images) of another eye of the user.

Any of the features, components, and/or parts, including the arrangements and configurations thereof shown in FIG. 10 can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 10.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

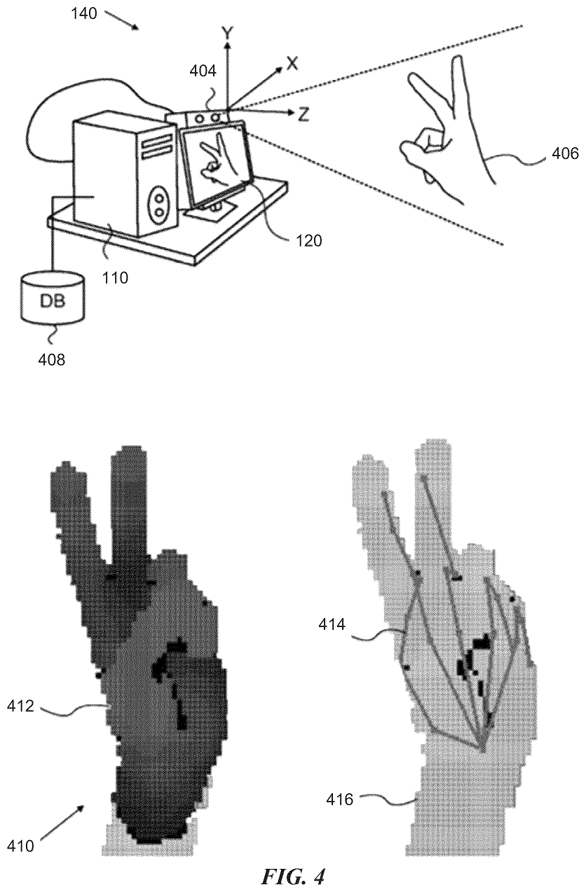

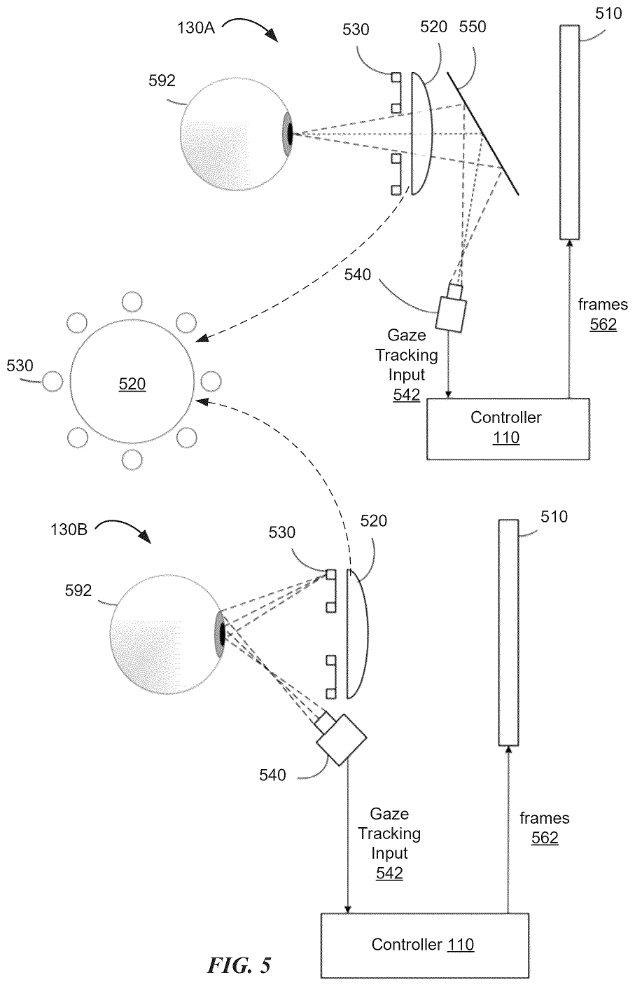

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3A is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting M R and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CM OS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3A is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3A could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIK it API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some A Pls enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more A Pls (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 700 (FIG. 7) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIK it API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., based on gaze) to determine the target of the user input (e.g., for direct inputs, as described below). Thus, in implementations involving air gestures, the input gesture is, for example, detected attention (e.g., based on gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., based on gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., based on gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each of lenses 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

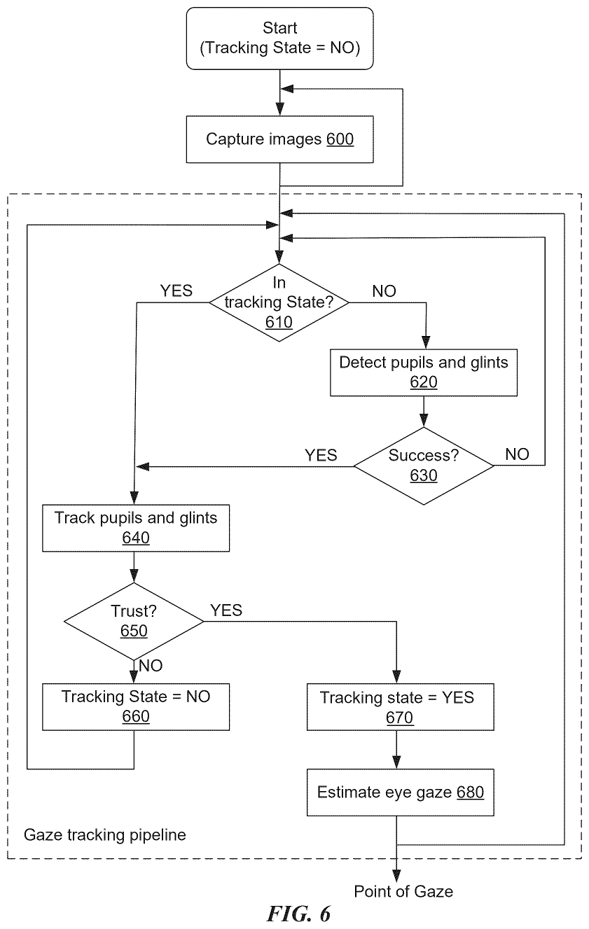

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or more cameras.

FIGS. 7A-7K illustrate methods of and systems for changing a level of detail of spatial audio based upon movement of a viewpoint of a user in accordance with some embodiments of the disclosure.

FIG. 7A illustrates a computer system 101 (e.g., tablet, smartphone, wearable computer, or head mounted device) (e.g., an electronic device) displaying, via a display generation component (e.g., display generation component 120 of FIG. 1A such as a computer display, touch screen, or one or more display modules of a head mounted device), a three-dimensional environment 700 (e.g., an AR, AV, VR, MR, or XR environment) from a viewpoint of the user of the computer system 101 (e.g., tablet, smartphone, wearable computer, or head mounted device) (e.g., facing a back wall of the physical environment in which computer system 101 (e.g., tablet, smartphone, wearable computer, or head mounted device) is located). In some embodiments, computer system 101 (e.g., tablet, smartphone, wearable computer, or head mounted device) includes a display generation component 120 (e.g., a computer display, touch screen, or display module of a head mounted device) and a plurality of image sensors 314a-314c (e.g., image sensors 314 of FIG. 3A). The image sensors optionally include one or more of a visible light camera, an infrared camera, a depth sensor, or any other sensor the computer system 101 (e.g., tablet, smartphone, wearable computer, or head mounted device) would be able to use to capture one or more images of a user or a part of the user (e.g., one or more hands of the user) while the user interacts with the computer system 101 (e.g., tablet, smartphone, wearable computer, or head mounted device). In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user), and/or attention (e.g., based on gaze) of the user (e.g., internal sensors facing inwards towards the face of the user).

As shown in FIG. 7A, computer system 101 (e.g., tablet, smartphone, wearable computer, or head mounted device) captures one or more images of the physical environment around computer system 101 (e.g., tablet, smartphone, wearable computer, or head mounted device), including one or more objects in the physical environment around computer system 101. In some embodiments, computer system 101 displays representations of the physical environment included in three-dimensional environment 700. For example, three-dimensional environment 700 includes a flight of stairs 706, which is optionally a representation of stairs (e.g., video, pictures, and/or a view of the stairs via transparent materials) in the physical environment.

In FIG. 7A, three-dimensional environment 700 also includes one or more virtual objects. For example, as shown in FIG. 7A, the computer system 101 is displaying a virtual object 702 in the three-dimensional environment 700 (e.g., an AR, AV, VR, MR, or XR environment). In some embodiments, the virtual object is or includes one or more of user interfaces of an application (e.g., an application running on the computer system 101 (e.g., tablet, smartphone, wearable computer, or head mounted device)) containing content (e.g., windows displaying photographs, playback user interface displaying content, and/or web-browsing user interface displaying text), three-dimensional objects (e.g., virtual clocks, virtual balls, and/or virtual cars) or any other element displayed by computer system 101 (e.g., tablet, smartphone, wearable computer, or head mounted device) that is not included in the physical environment of display generation component 120.

In FIG. 7A, as shown in the overhead view, the computer system displays virtual object 702 and displays stairs 706 from a viewpoint of the user 708 relative to three-dimensional environment 700. In some embodiments, the viewpoint of the user 708 includes a position and/or an orientation of the user 708 relative to three-dimensional environment 700. In FIG. 7A, computer system 101 detects an input provided by hand 730 directed to a button 703 included in computer system 101. The input optionally corresponds to one or more inputs requesting display of an at least partially immersive three-dimensional environment, as described further herein. It is understood that such an input is merely an example of a plurality of different events and/or inputs that optionally cause display of an at least partially immersive virtual content and/or and at least partially immersive three-dimensional environment (e.g., an AR, AV, VR, MR, or XR environment). As described with reference to method 1200, such immersive virtual content is optionally displayed at a level of visual prominence relative to the three-dimensional environment 700, including, but not limited to what percentage, region, and/or region(s) of a viewport of the computer system 101 is consumed by the immersive virtual content. It is understood embodiments described herein referencing “immersive” environments and/or content optionally refers to virtual content and/or virtual environments that computer system 101 is able to display with a level of immersion, as described with reference to method 800 and/or 1200, and does not preclude the possibility of displaying such virtual content and/or virtual environments that is not entirely immersive (e.g., displayed consuming a portion, rather than all of a viewport of computer system 101). In some embodiments, computer system 101 detects additional or alternative input(s) requesting display of the immersive virtual content and/or immersive environment. For example, the computer system optionally detects a voice command, and air gesture (e.g., an air pinch include a contacting of a plurality of fingers of hand 730, and air pointing of one or more fingers, and air splaying of one or more fingers, and/or some combination thereof), a selection of a virtual button (e.g., using an air gesture, optionally while attention (e.g., based on gaze) of the user is directed to the virtual button), a rotating of an electromechanical crown button, and/or some combination thereof.

In FIG. 7B, computer system 101 displays an at least partially immersive three-dimensional environment 700 via display generation component 120 in response to detecting the input in FIG. 7A. For example, as described with reference to method 800, the three-dimensional environment 700 in FIG. 7B optionally includes an atmospheric effect that overlays representations of the user's physical environment. For example, the computer system 101 optionally displays a virtual tinting, dimming, color, pattern, and/or a virtual blurring overlaying one or more representations of the user's physical environment. In some embodiments, the atmospheric effect is displayed overlaying virtual content, including virtual object 702 in FIG. 7B, as illustrated by the fill pattern overlaying the virtual object 702. Further, stairs 706 are displayed with the fill pattern overlaying the representation of the physical features of stairs 706 in FIG. 7B. Thus, the computer system 101 in FIG. 7B fills the user's three-dimensional environment 700 with a simulated environment, as though the user 708 were engulfed and/or immersed in a virtual environment.

In some embodiments, computer system 101 presents simulated spatial audio in conjunction with an at least partially immersive environment. For example, in FIG. 7B, three-dimensional environment 700 includes a plurality of locations corresponding to simulated spatial audio sources, including locations virtually occupied by source 704a, source 704b, source 704c, and source 704d shown in an overhead view of three-dimensional environment 700. As described with reference to method 800, the computer system 101 optionally presents (e.g., generates) audio via one or more audio channels, with time delay(s) and/or including modification of audio volume(s) of the channels to simulate the perception that physical sound sources were presenting audio in the three-dimensional environment 700. Accordingly, in FIG. 7B, sources 704b-d optionally are not displayed, but user 708 is able to hear sound as though emanating from the locations corresponding to source 704a-d, thus the spatial audio sources virtually “occupy” the locations. In such an example, computer system 101 presents spatial audio using one or more directional filters to simulate the effect spatial audio emanating from the locations, as though sources 704a-d respectively “generate” audio, as though the audio were provided by a physical speaker at the locations that correspond to each source 704a-d. It is understood that description herein of a spatial audio source “generating” spatial audio optionally corresponds to spatial audio that computer system 101 generates and configures as though a simulated spatial audio source (e.g., 704a-d) is physically generating the spatial audio. Such sounds and/or audio emanating from sources 704a-d are optionally associated with the currently displayed immersive environment. For example, in FIG. 7B, three-dimensional environment 700 optionally corresponds to a golden colored environmental overlay, and the sources 704a-d optionally virtually generate sounds including music, intermittent environmental sounds, and/or additional or alternative sound described with reference to method 800.

In some embodiments, the locations corresponding to three-dimensional environment 700 are elevated and/or offset from a floor of the three-dimensional environment 700, as described with reference to FIG. 7H. For example, source 704b is a first elevation 736a away from a floor of three-dimensional environment 700, source 704c is a second, different elevation 736b, and source 704d is a third, also different elevation 736c in FIG. 7B. Although not illustrated, source 704a is optionally a fourth elevation away from the floor.

In some embodiments, each source is optionally a particular distance away from a viewpoint of user 708 when the immersive environment is displayed, such as beyond threshold 710 in FIG. 7B. For example, the locations that correspond to sources 704a-d in FIG. 7B are beyond the threshold 710, a spherical or circular region including a radius 712—which optionally corresponds to a two or three-dimensional threshold within which spatial audio sources are typically not located. In some embodiments, threshold 710 is not displayed. Presenting the spatial audio via sources 704a-d at respective distances beyond threshold 710 relative to the viewpoint of user 708 optionally reduces the likelihood that spatial audio sources correspond to simulated locations that potentially cause discomfort and/or disorientation of user 708. It is understood that threshold 710 is merely representative of a threshold region, and that a spatial profile of the threshold 710 optionally is different dependent upon the displayed immersive environment in FIG. 7B and/or other environments described herein. For example, the threshold 710 optionally is cone-shaped, includes a plurality of volumetric shapes and/or curves, and/or is asymmetric relative to the user's viewpoint.

The audio optionally includes ambient sound effects that are intermittently and/or constantly played, as described with reference to method 800, including a river flowing, wind whipping, ocean waves lapping, raindrops falling, and/or some combination thereof. The audio optionally relates to what displayed in three-dimensional environment 700 in FIG. 7B (e.g., a virtual feature such as a river and/or a streak of color representative of the river), and/or optionally does not correspond to displayed virtual content (e.g., a virtual tree branch creaking that is not displayed, but relates to the underlying immersive three-dimensional environment). In some embodiments, each source of sources 704a-d provide a different audio track, and/or include a combination of audio tracks and/or sounds. Thus, computer system 101 simulates the perception that user 708 is immersed by sound sources in FIG. 7B, lending realism to the immersive portions of the three-dimensional environment 700. Mechanics concerning what tracks, and details of such tracks are described with reference to at least method 1000. In some embodiments, computer system 101 maintains the position of spatial audio sources in response to detecting movement of the user's viewpoint such as illustrated in FIG. 7C.

In FIG. 7C, computer system 101 maintains display of virtual content and maintains presentation of spatial audio when detecting movement of the viewpoint of user 708, which optionally includes movement of the user's body relative to three-dimensional environment 700. In FIG. 7C, computer system 101 detects movement of the viewpoint of user 708 from as shown in FIG. 7B, to a location that is within the region of the three-dimensional environment bound by threshold 710. From FIG. 7B to FIG. 7C, an orientation of the user 708 is maintained relative to the three-dimensional environment 700. In some embodiments, computer system 101 maintains the position of virtual content such as virtual object 702 relative to the three-dimensional environment 700 in response to detecting viewpoint movement. For example, from FIG. 7B to FIG. 7C, computer system 101 displays the virtual object 702 corresponding to a same location as illustrated in the overhead view of three-dimensional environment 700 via display generation component 120. Additionally, in some embodiments, the computer system at least temporarily maintains the locations of spatial audio sources 704a-d relative to the three-dimensional environment in response to detecting movement of the user's viewpoint similar to or the same as the aforementioned movement relative to threshold 710. For example, because the viewpoint movement from FIG. 7B to FIG. 7C does not include movement beyond the threshold 710, the computer system 101 maintains the locations that correspond to the sources 704a-d, as illustrated in the overhead view. Timer 716 in FIG. 7C—representative of an amount of time that the viewpoint of user 708 has remained at its depicted position and/or orientation—is not yet filled, indicating that the viewpoint of the user has settled at its position and/or orientation relative to three-dimensional environment 700 (e.g., or that the user's viewpoint movement is ongoing) in FIG. 7B. As described further with reference to the following figures, timer 716 is associated with one or more thresholds (e.g., time threshold 718 and threshold 720) that respectively relate to updating the position and/or orientation of the spatial audio sources relative to the three-dimensional environment 700 and/or the user's viewpoint. In some embodiments, after the user's viewpoint dwells at a particular position and/or orientation, computer system 101 recenters the spatial audio to correspond to the user's viewpoint, as illustrated in FIG. 7D.

In FIG. 7D, the viewpoint of the user 708 is maintained for a period of time greater than a threshold period of time. For example, from FIG. 7C to FIG. 7D, the viewpoint of the user is maintained, as indicated by the filling of timer 716, for a period of time greater than threshold 718. In response to detecting the maintenance of the user's viewpoint relative to three-dimensional environment for such a period of time, computer system 101 “moves” the spatial audio sources to assume the arrangement illustrated in FIG. 7D. For example, computer system 101 optionally changes the location of sources 704a-d to updated positions and/or orientations relative to the three-dimensional environment 700, and/or relative to the viewpoint of user 708. Such moving optionally includes continuing to present the audio (e.g., continue to play a track provided by a given source), and optionally changing the spatial filtering of the audio to mimic the perception that a physical sound source is moving within the three-dimensional environment 700. It is appreciated, however, that the audio optionally cross-fades from its former position and/or orientation, to an updated position and/or orientation to restore a previous spatial arrangement between the user's viewpoint and spatial audio sources to as illustrated in FIG. 7B, without simulating the continuous movement of the audio.

In FIG. 7D, computer system 101 performs an operation—at times referred to herein as a “recentering”—of the spatial audio sources. Recentering optionally refers to scenarios in which virtual content such as the locations corresponding to sources 704a-d are moved to correspond to an updated viewpoint of the user, such that the sources 704a-d have updated positions and/or orientations. In FIG. 7D, the spatial relationship between the sources 704a-d as shown in FIG. 7D is the same as the spatial arrangement between the sources at 704a-d in FIG. 7C; thus, the spatial relationship between the viewpoint of the user 704a-d and the sources 704a-d is updated from FIG. 7C to FIG. 7D, but the spatial relationship between sources 704a-d is maintained relative to one another. Thus, in response to detecting the movement of the user's viewpoint, the computer system 101 forgoes changing of the spatial relationship between a plurality of spatial audio sources, and updates the spatial relationship between the viewpoint of user 708 and the spatial audio sources 704a-d when the viewpoint of the user remains in an updated position relative to the three-dimensional environment 700, independently of whether the updated position is within threshold 710. For example, the computer system 101 in FIG. 7D restores the spatial arrangement between the sources and the viewpoint to be similar to or the same as when the immersive environment was initially displayed in FIG. 7B. Accordingly, the spatial audio sources 704a-d in FIG. 7D are again centered (e.g., “recentered”) on the user's viewpoint in FIG. 7D, due to the user's dwelling at its position for period of time depicted in timer 716 greater than a threshold 718 period of time. Recentering, as referred to herein, optionally includes moving locations corresponding to virtual content such as spatial audio sources to assume a spatial arrangement relative to a viewpoint of the user. In some embodiments, such a spatial arrangement of the locations corresponds to an arrangement that was defined prior to detecting one or more inputs. For example, the relative arrangement of spatial audio sources relative to the viewpoint of user 708 is a first spatial arrangement in FIG. 7B (e.g., the spatial audio sources 704a-d are placed at first locations and/or first orientations relative to the viewpoint of the user 708). In response to movement of the viewpoint of user 708 in FIG. 7C, the relative arrangement of spatial audio sources 704aa-d correspond to a second, different spatial arrangement relative to the viewpoint of user 708 (e.g., the spatial audio sources 704a-d are placed at second locations and/or second orientations relative to the viewpoint of the user 708). In FIG. 7D, the relative arrangement of spatial audio sources is changed to again-correspond to the first spatial arrangement in response to detecting the movement of the viewpoint of user 708 form as shown in FIG. 7C to as shown in FIG. 7D. In some embodiments, the computer system 101 maintains the locations corresponding to spatial audio sources in response to detecting movement of the user's viewpoint outside of the region bound by threshold 710 as illustrated in FIG. 7E.

In FIG. 7E, the computer system 101 displays representations of virtual content in response to detecting an updating of the user's viewpoint. From FIG. 7D to FIG. 7E, computer system 101 detects one or more inputs, such as walking of the user laterally, requesting rightward movement of the user relative to three-dimensional environment 700. In response to detecting the movement, the computer system 101 again maintains the locations corresponding to spatial audio sources 704a-d (e.g., forgoes changing of such locations). Additionally, computer system 101 partially displays virtual object 702, as though the virtual object was instead a physical object that was partially outside of a viewport of computer system 101 (e.g., and thus, is partially not displayed) in FIG. 7E. In FIG. 7E, timer 716 is again not filled, due to the user's movement being ongoing and/or ceasing at the illustrated viewpoint relative to the three-dimensional environment 700.

In FIG. 7F, computer system 101 updates the locations corresponding to the spatial audio sources 704a-d in response to detecting, and in accordance with movement of the viewpoint of the user 708 beyond threshold 710. In some embodiments, the computer system 101 moves spatial audio in response to detecting movement beyond the threshold 710, and is not moved (e.g., at least temporarily) in response to detecting movement within the threshold 710. In some embodiments, the movement of the spatial audio sources is instantaneous, or is performed rapidly in response to detecting movement of the viewpoint (e.g., spatial audio is moved from as illustrated in FIG. 7D to as illustrated in FIG. 7F, not including the dwelling of the viewpoint described with reference to FIG. 7E).

In some embodiments, the spatial audio source moves and/or recenters around the user's viewpoint in accordance with a lagging behavior. For example, after detecting movement of the viewpoint of user 708 from FIG. 7D to FIG. 7E, the computer system 101 maintains the locations corresponding to spatial audio sources 704a-d. Thus, from the perspective of user 708, the spatial audio sources remain in place in response to detecting one or more inputs moving the user's viewpoint, lagging behind the user's viewpoint movement. After the viewpoint dwells at its updated position in FIG. 7E for a period of time in timer 716 that exceeds threshold 720 (e.g., shown in FIG. 7F), computer system 101 updates the simulated spatial locations corresponding to audio sources 704a-d. In FIG. 7F, the sources 704a-d have recentered about the user's viewpoint relatively more quickly in response to detecting movement beyond the threshold 710, as compared to relatively more slowly in response to detecting movement from FIG. 7C to FIG. 7D. In particular, the threshold 720 is relatively less than threshold 718, such that computer system 101 facilitates a rapid recentering of spatial audio when the user's viewpoint moves beyond threshold 710. Thus, although computer system 101 does not detect additional movement of the viewpoint of user 708 from FIG. 7E to FIG. 7F, computer system 101 moves the locations corresponding to sources 704a-d, causing the spatial audio sources to “catch up” with previous movement of the user. Additionally, the threshold 710 is recentered on the user's viewpoint in FIG. 7F, for similar reasons, optionally concurrent with the moving of the audio sources 704a-d.

In some embodiments, the computer system 101 does not wait until the user viewpoint dwells at a particular position before initiating movement of the spatial audio sources. For example, the computer system 101 immediately initiates movement of the spatial audio sources in response to detecting movement of the user's viewpoint beyond threshold 710. For example, the spatial audio source movement is initially moved at the instant the user 708 crosses threshold 710, at a rate (e.g., time-based and/or distance-based rate) that is less than the rate of change of the user's viewpoint relative to the three-dimensional environment 700. In other embodiments, the spatial audio source movement is initiated in response to detecting the movement of the user's viewpoint, independently of whether the viewpoint is moving beyond threshold 710. Thus, the movement of the spatial audio sources optionally lags behind movement of the user's viewpoint, and optionally recenters on user's viewpoint (e.g., when the user's viewpoint dwells for some period of time, and/or catches up to the user's updated viewpoint while viewpoint movement is ongoing).

In some embodiments, computer system 101 moves the simulated locations corresponding to spatial audio in accordance with rotation of the user's viewpoint relative to the three-dimensional environment 700, as illustrated from FIGS. 7G-7H. In FIG. 7G, computer system 101 maintains the locations corresponding to spatial audio sources 704a-d in response to detected movement of the viewpoint of user 708. For example, from FIG. 7F to FIG. 7G, the locations corresponding to sources 704a-d are maintained in the overhead view of three-dimensional environment 700, despite detecting the user rotate counter-clockwise relative to the overhead view of the three-dimensional environment 700. In FIG. 7G, the timer 716 is not filled, illustrating that the rotation has concluded recently and/or is ongoing. From FIG. 7G to FIG. 7H, the viewpoint of the user 708 is maintained, and time elapses as illustrated by the filling of timer 716. Similar to as described with reference to other movements of the user's viewpoint, computer system 101 optionally rotates the locations corresponding to sources 704a-d in accordance with a determination that the viewpoint of the user in FIG. 7H is maintained for a period of time that exceeds threshold 718. It is understood that a timer related to viewpoint rotation is optionally different from description of timer 716. For example, rotation of the spatial audio is optionally performed by computer system 101 in response to detecting that the viewpoint dwells at a given viewpoint for a threshold period of time that is different in value than threshold 718 and/or threshold 720 (e.g., less than or greater than such thresholds). In some embodiments, computer system 101 forgoes rotation of the spatial audio sources relative to three-dimensional environment 700 in response to detecting any rotation of the viewpoint of the user, and/or after detecting any rotation of the viewpoint of the user. In such embodiments, computer system 101 optionally moves the spatial audio sources upward, downward, and/or laterally relative to a floor of the three-dimensional environment 700 in response to detecting movement of the user's viewpoint, and forgoes movement in accordance with the user rotating along a vector extending normal to the floor of the three-dimensional environment 700. In some embodiments, computer system 101 elevates or lowers the locations corresponding to spatial audio sources in response to detecting elevation or lowering of the user's viewpoint relative to the three-dimensional environment as illustrated in FIGS. 7H-7I.

FIG. 7H includes additional depictions of three-dimensional environment 700. For example, FIG. 7H includes a profile view, looking toward a left shoulder of user 708 standing within three-dimensional environment 700. The profile view also illustrates that threshold 710 is optionally centered on the user's body (e.g., the user's torso). In some embodiments, threshold 710 is optionally centered on the computer system 101. As illustrated by the x-shape in the profile view, source 704d is relatively close to the viewpoint of the user, and corresponds to a location having an elevation 726d, as illustrated by the elevation plot 724d. Although the sources 704a-c are not depicted in the profile view (e.g., because those sources are relatively further away from the user's viewpoint in FIG. 7H than source 704d), sources 704a-c are located with various elevations 726a-c, depicted in the elevation plots 724a-c. In some embodiments, the sources 704a-d move upwards or downwards, away or toward a floor of the three-dimensional environment 700 in accordance with movement of the viewpoint upwards or downwards relative to the floor. In some embodiments, computer system 101 elevates the locations corresponding to spatial audio sources in response to detecting elevation of the user's viewpoint relative to the three-dimensional environment as illustrated in FIG. 7I.

In FIG. 7I, computer system 101 detects movement of the viewpoint of user 708 and accordingly moves spatial audio sources upwards. For example, from FIG. 7H to FIG. 7I, computer system 101 detects the user 708 climb stairs 706, moving upwards relative to the floor, and beyond an upper bound of threshold 710 (e.g., the upper bound of the sphere formed by threshold 710) (e.g., in addition to translation of the viewpoint relative to the overhead view of three-dimensional environment 700). In such an example, the computer system 101 moves the virtual sound sources upwards by the elevation change of the viewpoint, as illustrated by the increasing of elevations 726a-d.

In some embodiments, the spatial relationship between the viewpoint of the user 708 and the sources (e.g., sources 704a-d) are maintained in response to detecting the increase in elevation of the viewpoint of user 708. For example, from FIG. 7H to FIG. 7I, in response to the detecting the elevating of the user's viewpoint, computer system 101 elevates spatial audio sources 704a-d relative to a floor of the three-dimensional environment 700. From FIG. 7H to FIG. 7I, a difference in elevations between the viewpoint of user 708 and the spatial audio sources are maintained. It is understood that in response to detecting a decrease in elevation of the viewpoint of user 708 relative to three-dimensional environment 700, computer system 101 optionally decreases the elevation of sources 704a-d in accordance with the viewpoint movement, and optionally maintains the difference in elevation between sources 704a-d and the viewpoint of user 708.

In FIG. 7I, sources 704a-d are elevated by a same amount, but it is understood that the sources 704a-d optionally move by different amounts. It is further understood that in response to detecting movement of the viewpoint of user 708 downward, toward the floor of the three-dimensional environment 700, computer system 101 optionally moves sources 704a-d downwards toward the floor of the three-dimensional environment 700, similar to or the same as described with reference to other movements of locations corresponding to sources 704a-d herein.

From FIG. 7G through FIG. 7I, computer system 101 additionally detects translation of the viewpoint of the user relative to the floor of the three-dimensional environment 700 (e.g., moving the user upwards, and to the right of the overhead view), and accordingly moves the sources 704a-d upwards, and to the right relative to the overhead view of three-dimensional environment 700 in accordance with the translation. Thus, the computer system 101 optionally moves the spatial audio sources 704a-d in one or more directions—up to three directions—relative to three-dimensional environment 700. In FIG. 7I, computer system 101 detects an input provided by hand 730, which optionally has one or more characteristics of additional or alternative inputs directed to computer system 101 described herein. Such an input optionally includes a request to initiate a changing of the current, immersive three-dimensional environment. In some embodiments, in response to detecting an input direction to button 703, computer system 101 displays an environmental picker user interface as illustrated in FIG. 7J.

In FIG. 7J, computer system 101 displays a user interface 728 in response to an input. For example, user interface 728 is displayed in response to the input provided by hand 730 in FIG. 7I. In some embodiments, user interface 728 includes virtual content that the user 708 is able to interact with, such as selectable options to change a currently displayed immersive environment, and/or modify the currently displayed immersive environment. In some embodiments, the user interface 728 includes one or more selectable options 732. The selectable options 732 include media such as a picture, text, video, simulated video, and/or some combination thereof, and respectively are optionally selectable to replace display of a current immersive environment with another immersive environment. In some embodiments, user interface 728 and/or selectable options 732 overlay other aspects of three-dimensional environment 700, including representation of physical objects and/or virtual objects like virtual object 702. In FIG. 7J, computer system 101 detects attention 734a of the user 708 directed to a selectable option (e.g., “Fall Light”), and/or concurrently detects an air pinch gesture performed by hand 730 while displaying the user interface 728, optionally corresponding to and/or including a request to change the current immersive environment. In some embodiments, the spatial audio sources and/or threshold associated with an immersive environment changes when the user selects a new immersive environment as illustrated in FIG. 7K.

In FIG. 7K, computer system 101 displays three-dimensional environment 700 including virtual content corresponding to a second immersive environment, different than a previously displayed immersive environment. For example, in response to the selection of the “Fall Light” selectable option (e.g., in FIG. 7J), computer system 101 optionally ceases display of the previous atmospheric effect shown in FIG. 7J, and initiates display of a new atmospheric effect in FIG. 7K (e.g., indicated by the fill pattern overlaying content displayed by display generation component 120). In some embodiments, the newly selected immersive environment is associated with an additional or alternative threshold. For example, threshold 710 in FIG. 7K is a larger size than as illustrated in FIG. 7J. Therefore, the location corresponding to spatial audio sources 704e and 704f are located at least beyond the updated dimensions of threshold 710 in FIG. 7K. Additionally, sources 704e and 704f each are presented at unique locations, such as different elevations 726e-f as illustrated by elevation plots 724e-724f. In some embodiments, the newly selected immersive environment includes different spatial audio (e.g., tracks, sources, number of sources, and/or audio tracks presented by the sources). For example, the sounds associated with the “Fall Light” atmospheric effect optionally include different nature sounds, different intermittent noises, different background music and/or vocalizations, and/or some combination thereof, as compared to spatial audio accompanying the atmospheric effect described with reference to FIGS. 7A-7J. In some embodiments, the computer system moves sources 704e-f in accordance with movement of the user's viewpoint, similar to or the same as described with reference to sources 704a-d, but based upon the size of threshold 710 depicted in FIG. 7K. Therefore, in response to detecting a changing of a currently selected immersive environment, computer system 101 optionally changes the threshold associated with moving spatial audio sources relative to the three-dimensional environment, and/or changes the spatial audio presented concurrently while displaying the selected immersive environment.

FIG. 8 is a flowchart illustrating a method of presenting spatial audio at a plurality of locations based upon movement of a user viewpoint, in accordance with some embodiments. In some embodiments, the method 800 is performed at a computer system (e.g., computer system 101 in FIG. 1A such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 800 is governed by instructions that are stored in a non-transitory computer-readable storage medium and that are executed by one or more processors of a computer system, such as the one or more processing units 202 of computer system 101 (e.g., control unit 110 in FIG. 1A). Some operations in method 800 are, optionally, combined and/or the order of some operations is, optionally, changed.

In some embodiments, a method 800 is performed at a computer system, such as computer system 101 as shown in FIG. 7A, in communication with one or more input devices, such as input devices 314a-c as shown in FIG. 7A, and a display generation component, such as display generation component 120 as shown in FIG. 7A. In some embodiments, the computer system is or includes an electronic device, such as a mobile device (e.g., a tablet, a smartphone, a media player, or a wearable device), or a computer. In some embodiments, the display generation component is a display integrated with the computer system (e.g., optionally a touch screen display), external display such as a monitor, projector, television, or a hardware component (e.g., optionally integrated or external) for projecting a user interface or causing a user interface to be visible to one or more users. In some embodiments, the one or more input devices include an electronic device or component capable of receiving a user input (e.g., capturing a user input or detecting a user input) and transmitting information associated with the user input to the electronic device. Examples of input devices include an image sensor (e.g., a camera), location sensor, hand tracking sensor, eye-tracking sensor, motion sensor w (e.g., hand motion sensor) orientation sensor, microphone (e.g., and/or other audio sensors), touch screen (e.g., optionally integrated or external), remote control device (e.g., external), another mobile device (e.g., separate from the electronic device), a handheld device (e.g., external), and/or a controller.

In some embodiments, while a three-dimensional environment, such as three-dimensional environment 700 as shown in FIG. 7A, of a user of the computer system, such as user 708 as shown in FIG. 7A, is visible via the display generation component from a viewpoint of the user that is a first viewpoint relative to the three-dimensional environment, such as the viewpoint of user 708 as shown in FIG. 7A, and while presenting first spatial audio associated with the three-dimensional environment, such as spatial audio source 704a as shown in FIG. 7B, with a simulated spatial location that corresponds to a first position within the three-dimensional environment, such as the position of spatial audio 704a as shown in FIG. 7B, the computer system detects (802), via the one or more input devices, movement of the viewpoint of the user, such as movement of the viewpoint of user 708 as shown from FIG. 7B to FIG. 7C and/or from FIG. 7C to FIG. 7D (e.g., from the first viewpoint to a second viewpoint, different from the first viewpoint). In some embodiments, the three-dimensional environment is generated, displayed, or otherwise caused to be viewable by the first computer system. For example, the three-dimensional environment is an extended reality (XR) environment, such as a virtual reality (VR) environment, a mixed reality (MR) environment, or an augmented reality (AR) environment. In some embodiments, the three-dimensional environment at least partially or entirely includes the physical environment of the user of the computer system. For example, the computer system optionally includes one or more outward facing cameras and/or passive optical components (e.g., lenses, panes or sheets of transparent materials, and/or mirrors) configured to allow the user to view the physical environment and/or a representation of the physical environment (e.g., images and/or another visual reproduction of the physical environment). In some embodiments, the three-dimensional environment includes one or more virtual objects and/or representations of objects in a physical environment of a user of the computer system. In some embodiments, the three-dimensional environment includes one or more characteristics of three-dimensional and/or virtual environments described with reference to methods 1000 and/or 1200.

In some embodiments, the computer system displays a simulated three-dimensional environment, such as a simulated portion of three-dimensional environment 700 as shown in FIG. 7B. In some embodiments, the three-dimensional environment includes a simulated and/or virtual three-dimensional environment that is displayed within the three-dimensional environment, optionally instead of the representations of the physical environment (e.g., full immersion) or optionally concurrently with the representation of the physical environment (e.g., partial immersion). Some examples of a virtual environment include a lake environment, a mountain environment, a sunset scene, a sunrise scene, a nighttime environment, a grassland environment, and/or a concert scene. In some embodiments, a virtual environment is based on a real physical location, such as a museum, and/or an aquarium. In some embodiments, a virtual environment is an artist-designed location. In some embodiments, the simulated portions of the three-dimensional environment (e.g., portions or all of a virtual environment) correspond to an environmental atmosphere applied to the three-dimensional environment. For example, the computer system optionally displays a virtual tinting (e.g., of physical representations of the user's physical environment and/or virtual content including virtual objects), one or more simulated lighting effects (e.g., virtual lighting simulating the appearance of physical light source(s) projecting light around the three-dimensional environment), virtual shadows (e.g., simulating the appearance of physical shadows caused by physical equivalents of the virtual lighting), and the like overlaying and/or applied to representations of the three-dimensional environment (e.g., the user's physical) environment. In some embodiments, applying an atmospheric effect to the three-dimensional environment includes modifying one or more visual characteristics of the three-dimensional environment such that it appears as if the three-dimensional environment is located at a different time, place, and/or condition (e.g., morning lighting instead of afternoon lighting, or sunny instead of overcast). In some embodiments, applying the atmospheric effect to the physical environment modifies the physical environment to appear dimly lit, and/or humid. In some embodiments, in response to detecting changes in the user's viewpoint relative to the three-dimensional environment, the computer system changes the presented perspective relative to the virtual portions of the three-dimensional environment, to simulate the user moving through a physical equivalent of the virtual environment. It is understood that description of three-dimensional environments, and presentation of audio (e.g., spatial audio) herein and described with reference to methods 1000 and/or 1200 optionally include audio presented while displaying an at least partially immersive virtual environment and/or a three-dimensional environment that includes a virtual tinting.

In some embodiments, the user has a current viewpoint relative to the three-dimensional environment (e.g., including a representation of the physical environment and/or the virtual environment), such as the viewpoint of user 708 as shown in FIG. 7B. In general, the viewpoint of the user optionally corresponds to the orientation and/or position of the user relative to the three-dimensional environment. In some embodiments, the computer system presents audio corresponding to the three-dimensional environment, such as ambient audio associated with the three-dimensional environment. In some embodiments, the audio corresponding to the three-dimensional environment (e.g., the first spatial audio) is a looping, randomly (e.g., or pseudo-randomly) presented, and/or intermittently presented audio track, based upon characteristics of the three-dimensional environment. For example, the computer system facilitates auditory passthrough to hear real-world sounds, in addition to or in the alternative to sounds that are virtually generated and associated with the virtual environment (e.g., the real-world sounds corresponding to audio in the user's physical environment detected by the computer system and reproduced by and/or otherwise presented to the user via an audio output device such as speakers, headphones, and/or earbuds). As additional examples, the computer system optionally presents sounds including a river flowing, waves crashing, animals crying out, vehicles moving, wind blowing, a fireplace crackling, and the like. In some embodiments, as described further herein, the computer system plays the sound as though the sounds were emanating from a specific position/location and/or region within the three-dimensional environment.

In some embodiments, the computer system presents (e.g., generates) spatial audio associated with the three-dimensional environment, such as spatial audio source 704a-d as shown in FIG. 7B. For example, the computer system optionally drives one or more sounds cells, changing the amplitude and/or delay of audio provided the one or more sound cells to mimic the sensation of being “immersed” and/or surrounded by sounds within a physical equivalent of their environment. In some embodiments, the “spatialization” of sounds includes configuring audio (e.g., the amplitude and/or delay of audio that played by the one or more sound cells) to correspond to (e.g., to be generated and/or presented as if emanating from) virtual positions relative to the user's viewpoint, within the three-dimensional environment (e.g., the sounds are generated/presented as if emanating from those virtual positions). At such virtual positions, the computer system optionally places a virtual sound source—optionally analogous to a physical a sound source—that optionally presents the audio, thus lending a perceived spatial quality to the audio—referred to herein as “spatial audio.” In some embodiments, the spatial audio is presented at a particular volume level (e.g., is presented at 0% volume relative to the three-dimensional environment (e.g., is not presented)), is presented at 100% volume relative to the three-dimensional environment (e.g., a maximum volume of audio) and/or is presented at a volume level intermediate to 0% or 100%. For example, a preset spatial audio optionally is presented as described further with reference to methods 1000 and/or 1200. In some embodiments the sound source presenting the first spatial audio is a first virtual sound source, at times referred to herein as a first sound source. In some embodiments, the computer system detects a change in viewpoint of the user (e.g., along a three-dimensional coordinate system mapping the three-dimensional environment of the user). In some embodiments, the computer system optionally changes the one or more characteristics (e.g., time delay and/or amplitude) of one or more channels of audio included in the first spatial audio in response to detecting such changes. In some embodiments, the changes to the one or more characteristics simulate the sensation of the user's viewpoint changing relative to a physical equivalent of the first sound source.

For example, the computer system detects movement of one or more portions of the user's body (e.g., the head, torso, neck, and/or entire body), optionally including a changing or maintaining of the user's position and/or orientation relative to the three-dimensional environment, optionally corresponding to corresponding changes of position and/or orientation of the viewpoint of the user relative to the three-dimensional environment. Additionally or alternatively, the movement of the viewpoint of the user is optionally virtual based upon one or more inputs other than movement of the user's body (e.g., movement of a joystick, input(s) requesting placement of the user at a particular position and/or orientation in the three-dimensional environment (e.g., a preset location, a virtual teleporting destination, and/or a voice command).

In some embodiments, in response to detecting the movement of the viewpoint (804), and in accordance with a determination that one or more criteria are satisfied, including a criterion that is satisfied when a distance of the movement of the viewpoint of the user is less than a threshold distance (e.g., the viewpoint moves less than 0, 0.05, 0.1, 0.2, 0.3, 0.4, 0.5, 0.6, 0.7, 0.8, 0.9, 1, 1.25, 1.5, or 3 m relative to and/or away from the first viewpoint in the three-dimensional environment), the computer system maintains (806) presentation of the first spatial audio with the simulated spatial location that corresponds to the first position in the three-dimensional environment, such as the maintaining of presentation of spatial audio source 704a corresponding to a location within three-dimensional environment 700 as shown from FIG. 7B to FIG. 7C in response to movement of the viewpoint of user 708 as shown from FIG. 7B to FIG. 7C. For example, the computer system optionally performs the operations described with reference to presenting the first spatial audio when the user's viewpoint moves, and without detecting additional or alternative intervening inputs. For example, when the computer system detects that the user's viewpoint moves less than the threshold distance, the computer system maintains a virtual position (e.g., the first position) of the sound source that is virtually presenting the first spatial audio and thereby changing a spatial relationship (e.g., relative position and/or orientation) between the viewpoint of the user and the virtual position of the sound source. It is understood at times that description of a “position” and/or “orientation” of spatial audio being changed or maintained optionally refers to the movement or maintenance of position and/or orientation of virtual sound sources that provide the spatial audio. In some embodiments, the computer system concurrently maintains presentation of a plurality of spatial audio sources corresponding to (e.g., as if emanating from) respective positions within the three-dimensional environment in response to the viewpoint movement, and in accordance with a determination that the one or more criteria are satisfied. Thus, the spatial arrangement of the sound sources relative to a position within the three-dimensional environment (and not relative to the user's viewpoint) optionally are maintained in response to the viewpoint movement that satisfies the one or more criteria.

In some embodiments, the threshold distance, such as threshold 710 as shown in FIG. 7B, corresponds to a boundary (e.g., a spherical, elliptical, and/or polygonal) threshold distance measured relative to a portion of the user's body, such as a center of the user's viewpoint (e.g., before the viewpoint of the user moves and/or the user's viewpoint when the virtual environment is initially displayed). When the computer system optionally detects that the user has not moved beyond the boundary, and optionally without moving the boundary, the computer system optionally maintains the position of the first spatial audio with respect to the three-dimensional environment. In some embodiments, the computer system forgoes movement of the boundary relative to the three-dimensional environment when the movement satisfies the one or more criteria.

In some embodiments, in response to detecting the movement of the viewpoint (804), and in accordance with a determination that the one or more criteria are not satisfied, the computer system presents (808) the first spatial audio with a simulated spatial location that corresponds to a second position, different from the first position, within the three-dimensional environment, such as the changing of presentation of spatial audio source 704a corresponding to a location within three-dimensional environment 700 as shown from FIG. 7C to FIG. 7D in response to movement of the viewpoint of user 708 as shown from FIG. 7C to FIG. 7D. For example, the computer system optionally moves the position of the first spatial audio (e.g., and/or additional or alternative spatial audio sources) within the three-dimensional environment when the viewpoint movement does not satisfy the one or more criteria (e.g., includes movement beyond the boundary described herein) such that the position of the first spatial audio with respect to the viewpoint of the user of the computer system is optionally maintained, or changes less than it would have if the one or more criteria were satisfied. In some embodiments, the movement of spatial audio includes movement by a distance and/or in one or more directions relative to the first position in the three-dimensional environment that match or otherwise correspond to the distance and/or one or more directions of movement of the user's viewpoint. For example, the computer system optionally moves the first spatial audio to correspond (e.g., virtually emanate from) the second position that is a particular distance, and in a particular direction relative to the first position that is a same distance, and that is in a same direction as the initial and terminal positions corresponding to movement of the user's viewpoint relative to the three-dimensional environment (e.g., from the first viewpoint to the second viewpoint), thus tracking the user's viewpoint movement. In some embodiments, the distance and/or direction between the first and the second position is based on a distance and/or direction that the user's viewpoint moves beyond the boundary (e.g., the computer system moves the sound source by a relatively greater distance in response to relatively greater movement of the viewpoint relative to the three-dimensional environment, and by a relatively smaller distance in response to relatively smaller movement of the viewpoint relative to the three-dimensional environment). For example, in accordance with a determination that the movement of the viewpoint is one meter beyond the boundary in a first direction relative to the three-dimensional environment, the sound sources are moved one meter in the first direction relative to the three-dimensional environment. In accordance with a determination that the movement of the boundary is additionally or alternatively one meter beyond the boundary in a second direction, different from the first direction, relative to the three-dimensional environment, the computer system optionally moves the sound sources one meter in the second direction relative to the three-dimensional environment. It is understood that the movement of the sound source optionally is based upon movement of the user's viewpoint, and/or a magnitude of the sound source movement (e.g., distance of movement) is optionally different from (e.g., greater than or less than) the magnitude of the viewpoint movement. For example, the virtual sound source is optionally moved by 0.5 m in response to detecting a 1 m change in the user's viewpoint, in accordance with a determination that the viewpoint of the user is at least partially moving through a region of the three-dimensional environment (e.g., a buffer region in which sound source(s) at least initially or always move less than the magnitude of the viewpoint of movement). In some embodiments, the movement of the sound source occurs concurrently with the movement of the viewpoint and/or in rapid succession after detecting the movement of the viewpoint. In some embodiments, as described further herein, the computer system temporally delays movement of the sound source in response to detecting the movement of the viewpoint. In some embodiments, the computer system concurrently moves a plurality of spatial audio sources in accordance with the movement of the viewpoint, maintaining the spatial arrangement between the plurality of spatial audio sources. Changing the distance between the first spatial audio source and the viewpoint of the user reduces the likelihood that the first spatial audio source is presented relatively too close to or conflicting with the viewpoint of the user, improves user comfort while moving within the three-dimensional environment, and reduces the need to move the first spatial audio source when the first spatial audio source is at a suitable distance from the viewpoint of the user.

In some embodiments, while the three-dimensional environment is visible from the first viewpoint of the user, and while presenting second spatial audio, different from the first spatial audio, such as the presenting of spatial audio source 704b as shown in FIG. 7B, associated with the three-dimensional environment with a simulated spatial location that corresponds to a third position within the three-dimensional environment, (e.g., optionally different from the first position) such as the location of spatial audio source 704b as shown in FIG. 7B, in response to detecting the movement of the viewpoint, and in accordance with the determination that the one or more criteria are satisfied, including the criterion that is satisfied when the distance of the movement of the viewpoint of the user is less than the threshold distance, such as the distance of the movement of the viewpoint of user 708 from as shown in FIG. 7B to as shown in FIG. 7C, the computer system maintains presentation of the second spatial audio with the simulated spatial location that corresponds to the third position in the three-dimensional environment, such as maintaining the location corresponding spatial audio source 704b as shown from FIG. 7B to FIG. 7C. In some embodiments, the second spatial audio has one or more characteristics similar to or the same as those described with reference to the first spatial audio described above. In some embodiments, the second spatial audio is spatial audio that corresponds to ambient and/or environmental audio included in an immersive virtual scene different from other spatial audio included in the virtual scene (e.g., different from the first spatial audio). For example, the second spatial audio is optionally a wave crashing, a river flowing, and/or a bird chirping, and/or the first spatial audio is optionally an object dropped into water, wind blowing, and/or a voice presented to simulate individuals nearly out of earshot of the user. Similar to as described with reference to the first spatial audio, characteristics of the second spatial audio are optionally configured to simulate a virtual sound source that is providing the second spatial audio at a respective position (e.g., the third position) in the three-dimensional environment. As described further herein, in response to detecting the viewpoint moving, the computer system optionally changes characteristics of the second spatial audio to simulate movement of the viewpoint relative to the virtual sound source that is generating the second spatial audio.

For example, in accordance with a determination that the viewpoint moves less than the threshold distance—including rotation and/or translation of the viewpoint relative to the three-dimensional environment—the computer system optionally presents the second spatial audio as though it continued to be generated by the audio source positioned at the third position. In some embodiments, the computer system forgoes changing of (e.g., maintains) positions of a plurality of spatial audio sources in response to detecting movement of the viewpoint of the user.

In some embodiments, in response to detecting the movement of the viewpoint of the user, the computer system moves one or more first spatial audio sources and forgoes movement of one or more second spatial audio sources, when one or more second criteria are satisfied, such as moving a location corresponding to spatial audio source 704a as shown in FIG. 7C to FIG. 7D while forgoing movement of a location corresponding to spatial audio source 704b as shown in FIG. 7B to FIG. 7C. For example, the one or more second criteria include a criterion that is satisfied when the distance of movement of the viewpoint of the user is greater than a respective threshold distance. In some embodiments, each of the respective threshold distances are different for respective spatial audio sources (e.g., 0.005, 0.01, 0.05, 0.1, 0.25, 0.5, 0.75, 1, 1.5, 3, or 5 m). Thus, the first threshold distance associated with the first spatial audio source is optionally determined and/or obtained, and is optionally unique to (e.g., but not necessarily a same value or a different value as) a second threshold distance corresponding to the second spatial audio source. For example, the one or more first spatial audio sources are optionally moved relative to the three-dimensional environment when the distance of the viewpoint movement is greater than a first threshold distance (e.g., 0.005, 0.01, 0.05, 0.1, 0.25, 0.5, 0.75, 1, 1.5, 3, or 5 m). Concurrently, the computer system optionally forgoes movement of one or more second spatial audio sources when the distance of the viewpoint movement is (e.g., optionally greater than the first threshold distance but) less than a second threshold distance (e.g., 0.01, 0.05, 0.1, 0.25, 0.5, 0.75, 1, 1.5, 3, 5, or 10 m).

Additionally or alternatively, the computer system optionally moves the one or more second spatial audio sources when the one or more second criteria are satisfied with respect to the one or more second spatial audio sources, and optionally forgoes movement (e.g., maintains the location) of the one or more first spatial audio sources when one or more criteria are not satisfied with respect to the one or more first spatial audio sources. Additionally or alternatively, when the distance of movement of the viewpoint of the user is less than the first and the second threshold distances, the computer system optionally forgoes movement of the respective locations corresponding to the first and the second spatial audio sources. When the distance of the movement of the viewpoint of the user and respective locations corresponding to the one or more first and second spatial audio sources is greater than the first and the second threshold distances, the computer system optionally moves the respective locations for both the first and second spatial audio sources.

In some embodiments, while the three-dimensional environment is visible from the first viewpoint of the user, and while presenting second spatial audio, different from the first spatial audio, such as the presenting of spatial audio source 704b as shown in FIG. 7B, associated with the three-dimensional environment with the simulated spatial location that corresponds to a third position within the three-dimensional environment, (e.g., optionally different from the first position) such as the location of spatial audio source 704b as shown in FIG. 7B, in response to detecting the movement of the viewpoint, and in accordance with the determination the one or more criteria are not satisfied, the computer system presents the second spatial audio with a simulated spatial location that corresponds to a fourth position, different from the third position, within the three-dimensional environment, such as the lack of satisfaction of the one or more criteria in response to detecting movement of the viewpoint of user 708 from as shown in FIG. 7B to as shown in FIG. 7C, and the maintaining of the location corresponding to spatial audio source 704c from as shown in FIG. 7B to FIG. 7C. For example, the presenting the second spatial audio with the simulated spatial location corresponding to the fourth position has one or more characteristics similar to or the same as described with reference to presenting the first spatial audio with the simulated spatial location that corresponds to the second position within the three-dimensional environment. Thus, the computer system optionally moves the simulated sound source(s) generating the first and/or the second spatial audio in response to detecting changes in the user's viewpoint, in accordance with changes in the user's viewpoint, and/or in accordance with the determination that the one or more criteria are not satisfied. In some embodiments, the first and the second spatial audio are moved by a same magnitude and/or in a same direction in response to detecting the viewpoint movement. Thus, the computer system optionally maintains a spatial arrangement between locations corresponding to one or more spatial audio sources and the viewpoint of the user in response to detecting movement of the viewpoint of the user. In some embodiments, the first and/or the second spatial audio are moved by different magnitudes and/or different directions. For example, the first spatial audio optionally rotates clockwise along an axis extending perpendicular to a floor of the three-dimensional environment, and the second spatial audio optionally rotates counter-clockwise along the axis by a rotational distance that is the same as or different from the rotational distance of the first spatial audio. As an additional example, in response to detecting the movement of the viewpoint, the computer system optionally moves the first spatial audio optionally along an axis extending from the viewpoint of the user toward the first position, and/or the second spatial audio optionally moves the second spatial audio along an axis extending from the viewpoint of the user toward the second position (e.g., closer to the viewpoint of the user, or further away from the viewpoint of the user). Moving additional spatial audio in response to detecting the movement of the viewpoint provides additional audio feedback indicative of the viewpoint movement relative to the three-dimensional environment, thus reducing the likelihood that the user moves erroneously relative to the three-dimensional environment and improving user comfort while moving within the three-dimensional environment, and thereby reducing processing required to perform operations based upon erroneous movement.

In some embodiments, while presenting the first spatial audio, such as spatial audio source 704a as shown in FIG. 7D and in accordance with the determination that the one or more criteria are not satisfied, such as the lack of satisfaction of the one or more criteria in response to viewpoint movement of user 708 from FIG. 7D to FIG. 7E, and in accordance with a determination that the movement of the viewpoint includes a first magnitude of movement, the second position is a first distance away from the first position, such as a distance between locations corresponding to spatial audio source 704a as shown in FIG. 7E and in FIG. 7F. In some embodiments, the computer system moves spatial audio in response to detecting changes in viewpoint and/or while the spatial audio is being presented. It is understood that presentation of spatial audio is not limited to merely generating sounds, but that moving spatial audio that includes silence for a period of time is also included in moving spatial audio “while presenting” the spatial audio. For example, the computer system optionally moves the first spatial audio by a magnitude (e.g., simulated distance, simulated velocity, and/or simulated acceleration) optionally based upon a detected magnitude of simulated distance, simulated velocity, and/or simulated acceleration of the viewpoint of the user and/or while optionally presenting the first spatial audio. For example, in response to response to detecting the viewpoint move by the first magnitude (e.g., a distance) relative to the three-dimensional environment, the computer system optionally moves the first spatial audio by the first distance to the second position. Additionally or alternatively, the virtual speed at which the computer system optionally moves the first spatial audio is based upon the magnitude of the viewpoint movement, and/or the virtual acceleration at which the computer system optionally moves the first spatial audio is optionally based upon the magnitude of the viewpoint movement. In some embodiments, the movement of the first spatial audio is performed while corresponding movement of the viewpoint is ongoing and/or is initiated in response to detecting the movement of the viewpoint. In some embodiments, the computer system continues to play the first spatial audio, and changes characteristics in response to the detected movement (e.g., changing amplitude and/or delay of the audio to simulate an ocean sound moving further away or closer to the user, decreasing or increasing a level of detail of the spatial audio as described further with reference to methods 1000 and/or 1200, and/or decreasing or increasing a volume of the spatial audio).

In some embodiments, while presenting the first spatial audio, such as spatial audio source 704a as shown in FIG. 7H and in accordance with the determination that the one or more criteria are not satisfied, such as the lack of satisfaction of the one or more criteria in response to viewpoint movement of user 708 from FIG. 7H to FIG. 7I, and in accordance with a determination that the movement of the viewpoint includes a second magnitude of movement, different from the first magnitude of movement, the second position is a second distance away from the first position, different from the first distance, such as a distance between locations corresponding to spatial audio source 704d from as shown in FIG. 7H to as shown in FIG. 7I. For example, the first spatial audio is moved by the second distance from the first position to the second position, and/or forgoes moving the spatial audio by the first distance. In some embodiments, in response to detecting a subsequent change in viewpoint that does not satisfy the one or more criteria, the computer system optionally moves the first spatial audio by a third magnitude in accordance with a determination that the subsequent viewpoint change includes a third magnitude of movement, and/or by a fourth magnitude in accordance with a determination that the subsequent viewpoint change includes a fourth magnitude of movement. Moving the first spatial audio by a first or a second magnitude based upon detecting a first or second magnitude of viewpoint movement indicates a spatial relationship between the viewpoint of the user and the three-dimensional environment, thus improving the likelihood the user moves within the three-dimensional environment in accordance with their desires and improving the user's comfort while moving within the three-dimensional environment, thereby reducing processing and power consumption responsive to correct for erroneous input(s) and/or movement relative to the three-dimensional environment.

In some embodiments, presenting the first spatial audio with the simulated spatial location that corresponds to the second position in the three-dimensional environment includes, while presenting the first spatial audio associated with the three-dimensional environment, such as spatial audio source 704a as shown in FIG. 7D, and in accordance with the determination that the one or more criteria are not satisfied, in accordance with a determination that the movement of the viewpoint of the user includes movement at a first rate, such as a first rate of movement of the viewpoint of user 708 from as shown in FIG. 7D to as shown in FIG. 7E, moving the first spatial audio from the first position to the second position at a second rate, different from the first rate, wherein the second rate is slower than the first rate, such as a rate of movement of the spatial audio source 704a different from the first rate of movement. For example, the one or more criteria including the criterion satisfied when the movement of the viewpoint is less than the threshold distance as described with reference to method 800.

In some embodiments, after moving the first spatial audio from the first position to the second position at the second rate, the computer system moves the first spatial audio at a first rate in response to detecting the movement of the viewpoint of the user, and later moves the first spatial audio at a second, relatively greater rate (e.g., a rate of movement that is greater than a rate of movement of the viewpoint of the user). For example, the computer system optionally detects a magnitude of movement of the viewpoint of the user (e.g., a first magnitude) relative to the three-dimensional environment, which optionally includes a rate (e.g., a first rate including a first speed and/or a first acceleration) and/or detects movement in first one or more directions relative to the three-dimensional environment. In some embodiments, in response to detecting the movement, the computer system moves the position corresponding to the first spatial audio from its initial position to an updated position with a magnitude based upon the rate of the viewpoint movement (e.g., a second magnitude and/or second rate, including a second speed and/or second acceleration in second one or more directions, optionally different from the first rate(s)). In some embodiments, moving the first spatial audio includes maintaining location corresponding to the first spatial audio in response to detecting movement of the viewpoint for a period of time greater than a threshold period of time (e.g., 0.001, 0.01, 0.05, 0.1, 0.25, 0.5, or 1 second) before moving the first spatial audio at the second rate. In such embodiments, the rate of movement of the first spatial audio is optionally a same rate relative to a unit of movement (e.g., described further herein) of the viewpoint relative to the three-dimensional environment, but the movement of the first spatial audio is optionally, temporally delayed from detecting the movement of the viewpoint. Additionally or alternatively, the computer system optionally, initially moves the first spatial audio at the first rate that is non-zero, slower than the second rate, in response to detecting the movement of the viewpoint of the user. Thus, computer system optionally moves the first spatial audio as though the first spatial audio is “catching up” with corresponding movement of the viewpoint, and does not necessarily keep the first spatial audio spatially fixed before initiating “catching up” with the movement of the viewpoint.

Thus, the computer system optionally moves the first spatial audio relative to the three-dimensional environment with a magnitude based upon a corresponding magnitude of movement of the viewpoint of the user. Such a magnitude of the first spatial audio is optionally proportional, inversely proportional, or otherwise based upon the magnitude of movement of the viewpoint. In some embodiments, the computer system moves a plurality of spatial audio sources from respective positions in accordance with the movement of the viewpoint. In some embodiments, moving the plurality of spatial audio sources includes moving the sources concurrently, by a same magnitude as each other, and/or by a different magnitude as each other. In some embodiments, moving the first spatial audio and/or other spatial audio includes moving in a direction that is the same as, similar to, in opposition to, or otherwise based upon movement of the viewpoint relative to the three-dimensional environment. In some embodiments, the computer system moves the plurality of spatial audio sources in a same one or more directions and/or in similar one or more directions. Moving the first spatial audio at a rate corresponding to a rate of movement of the viewpoint provides audio feedback of the viewpoint movement relative to the three-dimensional environment and improves user comfort while moving within the three-dimensional environment, thus reducing processing required to perform operations in response to detecting erroneous movement relative to the three-dimensional environment caused by ambiguities related to the spatial relationship between the viewpoint and the three-dimensional environment.

In some embodiments, the three-dimensional environment includes respective virtual visual content, such as virtual objects, textures, and/or overlays that are able to be displayed, such as within three-dimensional environment 700 as shown in FIG. 7B. For example, the three-dimensional environment optionally includes one or more virtual objects as described further with reference to method 800. In some embodiments, the virtual visual content includes an at least partially or fully immersive three-dimensional environment. In some embodiments, the virtual visual content includes virtual objects including user interfaces (e.g., such as content windows) of software applications. For example, the first spatial audio is optionally audio associated with virtual visual content presented via the virtual object (e.g., media in a user interface), and the simulated spatial location corresponding to the first spatial audio is optionally a center of the virtual object, or another location that the virtual object occupies (e.g., a corner, a border, and/or an edge). In some embodiments, the virtual visual content includes animations of virtual objects moving throughout the three-dimensional environment. In some embodiments, the virtual visual content includes representations of one or more other individuals within the physical environment of the user, such as images detected by one or more cameras and/or a view of the individuals via at least partially transparent materials. In some embodiments, the virtual visual content includes representations of users of computer system(s) in communication with the computer system. For example, the representation optionally is an avatar and/or a lifelike recreation of one or more portions of bodies of the users of other computer systems including one or more body parts that move relative to one another. In some embodiments, prior to displaying the three-dimensional environment including an at least partially immersive three-dimensional environment, some or all of the virtual visual content is not displayed (e.g., initiates display of a virtual window that is associated with the immersive environment). In some embodiments, in response to displaying the at least partially immersive environment, the computer system maintains visibility of the virtual visual content (e.g., maintains display of a virtual window). Including virtual content in the three-dimensional environment allows the use to concurrently view the three-dimensional environment and virtual visual content, thus reducing inputs required to separately display and/or inspect the three-dimensional environment and the virtual content and thereby reducing power consumption required for such separate display.

In some embodiments, the three-dimensional environment includes respective representations of one or more physical objects, such as a representation of stairs 706 as shown in FIG. 7A. For example, the three-dimensional environment optionally includes one or more images of objects physically within the user's three-dimensional environment. Additionally or alternatively, the three-dimensional environment optionally includes one or more images of objects within a physical environment of another computer system in communication with the computer system (e.g., a real time, or nearly real time communication session). In some embodiments, the three-dimensional environment includes visibility of physical objects via a transparent sheet, lens, and/or one or more mirrors. Including representations of the physical objects reduces user input required to separately view physical object(s) and virtual content, thus reducing inputs and thereby processing required to perform the separate viewing of the physical objects and virtual content.

In some embodiments, a spatial arrangement between the first viewpoint of the user and the first location corresponding to the simulated spatial location of the first spatial audio is a first spatial arrangement, such as the spatial arrangement between the viewpoint of user 708 and spatial audio sources 704a-d as shown in FIG. 7B. For example, the spatial arrangement optionally includes a position and/or orientation of the viewpoint relative to the first location within the three-dimensional environment.

In some embodiments, in response to detecting the movement of the viewpoint of the user to a second viewpoint, such as movement of the viewpoint of user 708 from FIG. 7B to the viewpoint shown in FIG. 7C, after presenting the first spatial audio with the simulated spatial location that corresponds to a second position in the three-dimensional environment, such as a location and/or position intermediate to (e.g., different from) the locations of spatial audio source 704a as shown in FIG. 7B and FIG. 7C, and in accordance with a determination that one or more second criteria are satisfied, different from the one or more first criteria, the computer system presents the first spatial audio at a simulated spatial location corresponding to a respective position in the three-dimensional environment, different from the first position, wherein a spatial arrangement between the second viewpoint of the user and the respective position is the first spatial arrangement, such as the position of spatial audio source 704a as shown in FIG. 7C. In some embodiments, the computer system moves one or more spatial audio sources to positions and/or orientations in response to detecting viewpoint movement (e.g., that does not satisfy the one or more criteria), thus restoring a spatial relationship between the one or more spatial audio sources and the viewpoint of the user. For example, the computer system optionally detects the movement of the viewpoint of the user from the first to the second viewpoint while the simulated spatial location of the first spatial audio corresponds to the first location and/or has a first orientation relative to the three-dimensional environment, and optionally moves the first spatial audio to a second position and/or second orientation relative to the three-dimensional environment. In some embodiments, the second position and/or second orientation is an intermediate position and/or orientation that the first spatial audio corresponds to before restoring the spatial relationship between the first spatial audio and the viewpoint of the user. In some embodiments, after moving the first spatial audio to the second position and/or second orientation, the computer system moves the first spatial audio to the respective position. In some embodiments, the spatial relationship between the spatial audio at the first position and/or orientation and the first viewpoint of the user is the same as the spatial relationship between the spatial audio at the second position and/or second orientation, and the second viewpoint of the user. In some embodiments, the spatial audio moves concurrently with the viewpoint movement, thus maintaining the spatial relationship between the first spatial audio throughout the viewpoint movement. In some embodiments, the computer system moves a plurality of spatial audio sources similar to or the same as described with reference to the first spatial audio (e.g., concurrently). In some embodiments, in response to detecting movement of the viewpoint that causes movement of the plurality of spatial audio sources, the computer system moves the plurality of spatial audio sources such that the plurality of spatial audio sources assume a same spatial relationship with each other and with the viewpoint of the user as before the movement is detected. In some embodiments, in accordance with a determination that the one or more second criteria are not satisfied, the computer system forgoes presenting the first spatial audio at the simulated spatial location corresponding to the respective position in the three-dimensional environment. Additionally or alternatively, the computer system optionally changes the spatial relationship between the first spatial audio and the viewpoint of the user (e.g., at the second viewpoint) to a second spatial relationship, different from a prior spatial relationship, in response to the detecting of the viewpoint movement that does not satisfy the one or more criteria described with reference to method 800. Presenting the first spatial audio at the respective position preserves an understanding of the viewpoint of the user relative to the three-dimensional environment after viewpoint movement is detected, thus improving user comfort while moving within the three-dimensional environment and reducing user input, and thereby power consumption required to process erroneously changing of the user's viewpoint relative to the three-dimensional environment.

In some embodiments, the one or more second criteria include a criterion that is satisfied while the viewpoint of the user is moving relative to the three-dimensional environment, (e.g., and a criterion that is satisfied when the one or more criteria are not satisfied), such as movement of the viewpoint of user 708 from FIG. 7D to FIG. 7E and corresponding movement of spatial audio source 704a. For example, the computer system optionally moves first spatial audio in response to and/or concurrently while detecting the movement of the viewpoint of the user. Thus, when the user moves relative to the three-dimensional environment in a manner that does not satisfy the one or more criteria (e.g., moves beyond the threshold distance), the computer system optionally moves the first spatial audio. In some embodiments, the computer system moves the first spatial audio in response to detecting movement of the viewpoint of the user, irrespective of whether the movement is beyond the threshold distance described with reference to method 800. Moving the first spatial audio when the viewpoint of the user is moving preserves the user's sense of their spatial relationship relative to the three-dimensional environment and improves the user's comfort while moving within the three-dimensional environment, thus minimizing erroneous inputs caused by misperceptions of the user's spatial relationship relative to the three-dimensional environment and thereby reducing computing resources associated with correcting erroneous input.

In some embodiments, the one or more second criteria include a criterion that is satisfied when the viewpoint of the user is maintained relative to the three-dimensional environment for a longer than a pre-defined threshold period of time after detecting the movement of the viewpoint of the user to the second viewpoint, such as movement of spatial audio source 704a from as shown in FIG. 7C to as shown in FIG. 7D in accordance with a determination that an amount of time indicated by timer 716 is greater than threshold 718 as shown in FIG. 7D. For example, in accordance with a determination that the movement of the viewpoint of the user does not satisfy the one or more criteria described with reference to method 800, and that the position and/or orientation of the user is maintained relative to the three-dimensional environment for a period of time greater than a threshold period of time (e.g., 0.05, 0.1, 0.25, 0.5, 0.75, 1, 1.25, 3, or 5 seconds), the computer system optionally moves the first spatial audio relative to the three-dimensional environment. Such movement optionally includes restoring a spatial relationship between the location and/or orientation of the first spatial audio at the second viewpoint that corresponds to (e.g., matches) the spatial relationship between the first viewpoint and the location and/or orientation of the first spatial audio before the viewpoint movement described with reference to method 800 is detected. Moving the spatial audio after the viewpoint of the user is maintained for a period of time reduces power consumption required to continuously determine and/or move an updated position and/or orientation of the first spatial audio.

In some embodiments, in accordance with the one or more second criteria being satisfied, in accordance with a determination that the movement of the viewpoint of the user is within a threshold distance (e.g., 0, 0.005, 0.01, 0.05, 0.1, 0.25, 0.3, 0.5, 1, or 3 m) of the first viewpoint, the computer system moves the respective simulated location of the first spatial audio from the first position to the second position after a first amount of time (e.g., at a first rate and/or after a first delay period), such as moving spatial audio source 704a from as shown from FIG. 7C to as shown in FIG. 7D when the dwell time indicated in timer 716 exceeds threshold 718. For example, the computer system optionally moves the first spatial audio with a magnitude that is based upon the viewpoint moving beyond and/or settling at a position beyond a respective threshold distance of the first viewpoint. In some embodiments, the computer system moves the first spatial audio at a first magnitude (e.g., first rate) in response to detecting the viewpoint movement that does not extend beyond a threshold distance from the initiation of the movement. The first magnitude optionally corresponds to a non-movement (e.g., a maintaining) of the first spatial audio. In some embodiments, the first magnitude is different from (e.g., less than or greater than) a second magnitude, described further herein. In some embodiments, the computer system temporally delays movement of the first spatial audio in accordance with a determination that detected movement of the user's viewpoint is less than the threshold distance. For example, the computer system optionally initiates movement of the first spatial audio after a first delay period of time after detecting movement of the user's viewpoint (e.g., 0.5, 1, 1.25, 1.5, 1.75, 2, 2.5, 3, 5, 7.5, or 10 seconds). In some embodiments, in accordance with a determination that the detected movement of the user's viewpoint is greater than or equal to the threshold distance, the computer system moves the first spatial audio after a second delay period of time, different from (e.g., greater than or less than) the first time in response to detecting the viewpoint movement (e.g., 1, 1.25, 1.5, 1.75, 2, 2.5, 3, 5, 7.5, 10, or 15 seconds).

In some embodiments, in accordance with a determination that the movement of the viewpoint of the user is beyond the threshold distance of the first viewpoint, the computer system moves the respective simulated location of the first spatial audio from the first position to the second position after a second amount of time that is different from the first amount of time (e.g., at a second rate, different from the first rate and/or after a second delay period that is different from the first delay period), such as movement of spatial audio sources 704a-704d from FIG. 7E to as shown in FIG. 7F based upon the time indicated in timer 716 exceeding threshold 720 (e.g., and not exceeding threshold 718). For example, the computer system optionally moves the first spatial audio at a relatively greater (e.g., or lesser) rate of movement relative to the first magnitude when the viewpoint of the user is beyond the threshold distance. In some embodiments, the computer system moves the first spatial audio at the first rate until the viewpoint of the user is beyond the threshold distance of the first viewpoint. In some embodiments, the computer system moves the first spatial audio at the second rate when the viewpoint of the user is beyond the threshold distance. Moving the first spatial audio by the first or second rate reduces the likelihood that the first spatial audio changes the user's understanding of their viewpoint relative to the three-dimensional environment, thus improving user comfort and reducing inputs erroneously changing the viewpoint, thereby reducing computer system power consumption.

In some embodiments, while presenting the first spatial audio, in response to detecting the movement of the viewpoint and in accordance the determination that the one or more criteria are not satisfied, in accordance with a determination that the movement of the viewpoint includes one or more first viewpoint movement characteristics, the computer system moves the first spatial audio from the first location to the second location according to one or more first audio movement characteristics, such as moving spatial audio source 704a in accordance with first one or more simulated velocities from as shown in FIG. 7C to as shown in FIG. 7D. For example, as described with reference to method 800. For example, the one or more first viewpoint movement and/or audio movement characteristics, and/or the second viewpoint movement and/or audio movement characteristics, optionally include one or more magnitudes (e.g., distances, velocities, and/or accelerations) and/or one or more directions of the movement of the viewpoint and/or movement of a location corresponding to spatial audio relative to the three-dimensional environment. For example, as described further herein with reference to the magnitude of audio movement of the first spatial audio, the computer system optionally moves the first spatial audio by a distance and/or in a direction based upon the distance and/or direction of viewpoint movement. As an example, in response to detecting the user stand up and walking forward relative to the three-dimensional environment, the computer system optionally moves the first spatial audio upwards away from a floor of the three-dimensional environment, and/or in the direction of the forward movement. In response to detecting the user sit down and walk in a direction relative to three-dimensional environment opposing the forward walking, the computer system optionally moves the first spatial audio downwards toward a floor of the three-dimensional environment and/or in the direction of the forward walking.

In some embodiments, while presenting the first spatial audio, in response to detecting the movement of the viewpoint and in accordance the determination that the one or more criteria are not satisfied, in accordance with a determination that the movement of the viewpoint includes one or more second viewpoint movement characteristics, different from the one or more first viewpoint movement characteristics, the computer system moves the first spatial audio from the first location to the second location according to one or more second audio movement characteristics, different from the first audio movement characteristics, such as moving spatial audio source 704a in accordance with second one or more simulated velocities from as shown in FIG. 7C to as shown in FIG. 7D, different from the first one or more simulated velocities. For example, the second viewpoint movement characteristics optionally correspond to a different one or more magnitudes and/or one or more directions of movement of the viewpoint than the one or more first viewpoint and/or the first sound movement characteristics. In some embodiments, the first spatial audio is moved based upon the second viewpoint movement characteristics, such as based upon second sound movement characteristics. For example, in accordance with a determination that the movement is in a first direction from the first viewpoint, the second position is optionally a respective first direction from the first viewpoint, based on the first direction. In some embodiments, in accordance with a determination that the movement of the viewpoint includes movement in a second direction from the first viewpoint, the second position is a respective second direction from the first viewpoint, based on the second direction of movement of the viewpoint. In some embodiments, in accordance with a determination that the movement of the viewpoint includes a first magnitude of the movement (e.g., a first distance), the second position is a respective first magnitude from the first viewpoint, based on the first magnitude (e.g., a respective first distance, based upon, different from, and/or equal to the first distance). In some embodiments, in accordance with a determination that the movement of the viewpoint includes a second magnitude of the movement (e.g., a second distance), the second position is a respective second magnitude from the first viewpoint, based on the second magnitude (e.g., a respective second distance based upon, different from, and/or or equal to the first distance and/or the second distance). Additionally or alternatively, the computer system optionally moves the first spatial audio with a speed and/or acceleration that is similar to, the same as, and/or otherwise based upon a speed and/or acceleration of movement of the viewpoint of the user. Moving the first spatial audio in a manner corresponding to the movement of the viewpoint lends realism to virtual content included in the three-dimensional environment and provides feedback about the user's movement relative to the three-dimensional environment while improving the user's comfort, thus reducing erroneous viewpoint movement and thereby power consumption of the computer system.

In some embodiments, the movement of the viewpoint of the user is detected while the three-dimensional environment includes first virtual content corresponding to a first simulated environment, and the threshold distance is a first distance, such as virtual portions of three-dimensional environment 700 as shown in FIG. 7B. For example, the first virtual content includes one or more virtual objects as described further herein that are associated with an at least partially immersive three-dimensional environment. In some embodiments, the threshold distance is a distance at which the computer system initiates movement of the first spatial audio relative to the three-dimensional environment. In some embodiments, a value of the threshold distance is associated with a current environment. For example, the current environment optionally is or includes an at least partially immersive three-dimensional environment such as an immersive virtual environment that is at least partially displayed, or active but not currently displayed (e.g., previously was displayed, while the computer system temporarily forgoes display such as in response to an input changing a level of immersion of the current environment relative to the three-dimensional environment to less than a threshold level of immersion). It is understood that the current environment is optionally a VR, XR, and/or MR environment, and that “virtual environments” at times refer broadly to an environment including virtual content. For example, as described with reference to method 800, 1000, and/or 1200, the computer system optionally presents a simulated environment such as an at least partially immersive three-dimensional environment, and/or a simulated atmospheric effect including an overlaying of virtual color, texture, pattern, and/or lighting overlaying representation of the user's physical environment and/or virtual content displayed prior to displaying the simulated atmospheric effect. In some embodiments, an environmental “type” at least partially dictates a value of the threshold distance described with reference to method 800. For example, at least partially immersive virtual environments are optionally associated with a first one or more threshold values of the threshold distance (e.g., non-zero or zero) and simulated atmospheric effects are optionally associated with second one or more threshold values (e.g., zero or non-zero). In some embodiments, the threshold distance value is independent of the “type” of simulated environment, such that an first atmospheric effect is optionally associated with a first value, a second atmospheric effect is optionally associated with a second, different value, a first simulated environment is optionally associated with a third value, optionally different from the first and/or second values, and/or a second simulated environment is optionally associated with a fourth value, different from the first, second, and/or third values.

In some embodiments, the computer system obtains one or more first inputs such as a voice command, a selection of a physical or virtual button, a gaze of the user targeting virtual content, and/or some combination of inputs thereof, such as input provided by hand 730 as shown in FIG. 7A. In response to detecting the one or more inputs, the computer system optionally displays an environmental selection user interface. In response to detecting second one or more inputs optionally having one or more characteristics of the one or more first inputs, the computer system optionally initiates display of a respective at least partially virtual environment. For example, the computer system optionally detects a voice command and/or a pressing of a rotatable and depressible input mechanism, and in response, optionally displays one or more selectable options. Such one or more selectable options optionally include an “environments” selectable option, which when selected (e.g., via a voice command, an air gesture (e.g., an air pinch, point, fist, and/or swipe), and/or gaze), optionally initiates display of an environments “picker” user interface including a plurality of selectable options corresponding to various environments. For example, the selectable option is optionally a virtual button, a picture corresponding to an environment, text, and/or some combination thereof. In response to detecting one or more inputs selecting a particular environment, the computer system optionally initiates display of virtual content included in the selected three-dimensional environment, such as the virtual desert described previously. It is understood that the particular user interfaces, selectable options, user input(s), and/or types of immersive environments are merely exemplary, and not limiting. It is further understood that various selectable options are optionally displayed and thus accessible to the user. For example, the computer system optionally displays a miniaturized menu which optionally includes a selectable option for specific one or more environments in response to one or more inputs, the menu different from the environments picker user interface.

In some embodiments, in response to detecting the movement of the viewpoint, in accordance with the three-dimensional environment corresponding to the first simulated environment, the computer system determines that the one or more criteria are satisfied when the distance of the movement of the viewpoint of the user is more than a first threshold distance, such as movement beyond threshold 710 from the location of user 708 as shown in FIG. 7I. For example, when the first virtual content includes a sky, floor, virtual rocks, and/or a virtual mesa, the threshold distance is a first distance, corresponding to a desert virtual scene. In such an example, the computer system or another computer system determines and/or shares an indication that the threshold distance associated with the desert virtual scene is the first threshold distance.

In some embodiments, in response to detecting the movement of the viewpoint, in accordance with the three-dimensional environment corresponding to a second simulated environment, different from the first simulated environment, the computer system determine that the one or more criteria are satisfied when the distance of the movement of the viewpoint of the user is more than a second threshold distance, different from the first threshold distance, such as movement beyond threshold 710 from the location of user 708 as shown in FIG. 7K, different from threshold 710 in FIG. 7I. For example, the computer system optionally detects a selection of a lake environment from the environment picker user interface, and in response optionally initiates display of a virtual lake, optionally forgoing display of the virtual desert. The virtual lake is optionally associated with a threshold distance for moving spatial audio that is different from (e.g., greater than, or less than) the threshold distance associated with the virtual desert. Accordingly, in response to detecting a first magnitude of movement of the user's viewpoint that is greater than the second threshold distance but less than the first threshold distance while the virtual lake is displayed, the computer system optionally moves the first spatial audio. In response to detecting a same movement of the user's viewpoint relative to the three-dimensional environment and while the virtual desert is displayed (e.g., while the virtual lake environment is not displayed), the computer system optionally forgoes moving of the first spatial audio. In some embodiments, the threshold associated with moving the spatial audio has a spatial profile relative to the three-dimensional environment dependent upon the active virtual environment. In some embodiments, additional simulated environment(s) are associated with respective threshold distances, similar to or the same as described with reference to the first and the second threshold distance. For example, a snowfield environment is optionally associated with a Om threshold distance, and a space station environment is optionally associated with an infinite threshold distance.

For example, while the three-dimensional environment of a user of the computer system is visible via the display generation component including second virtual content corresponding to a second simulated environment, while a viewpoint of the user is a second viewpoint relative to the three-dimensional environment, and while presenting second spatial audio associated with the second virtual content with a simulated spatial location that corresponds to a third position within the three-dimensional environment, the computer system detects, via the one or more input devices, movement of the viewpoint of the user from the second viewpoint, such as movement of the viewpoint of user 708 away from the location as shown in FIG. 7F (e.g., beyond or within threshold 710). In some embodiments, in response to detecting the movement of the viewpoint from the second viewpoint, in accordance with a determination that the one or more second criteria are satisfied, including a criterion that is satisfied when the movement of the viewpoint of the user from the second viewpoint is less than a second threshold distance, different from the first threshold distance, the computer system maintains presentation of the second spatial audio with the simulated spatial location that corresponds to the third position in the three-dimensional environment. In some embodiments, in response to detecting the movement of the viewpoint from the second viewpoint, and in accordance with a determination that the one or more second criteria are not satisfied, the computer system presents the second spatial audio with a simulated spatial location that corresponds to a fourth position, different from the third position, within the three-dimensional environment. Implementing different thresholds corresponding to different environments causes the relationship between viewpoint movement and movement of audio sources to correspond to a currently displayed immersive environment, thus reducing user input—and thereby processing for such input—erroneously moving the viewpoint of the user, such as to regions of the immersive environment that are not interactive.

In some embodiments, the movement of the viewpoint of the user includes a rotation of the viewpoint relative to the three-dimensional environment, and the second position corresponding to the first spatial audio is based upon an amount of the rotation of the viewpoint relative to the three-dimensional environment, such as rotation of the viewpoint of user 708 from as shown in FIG. 7F to as shown in FIG. 7G, and corresponding rotation of spatial audio source 704a as shown in FIG. 7H. In some embodiments, the threshold distance described with reference to method 800 includes a rotational distance of the user relative to the three-dimensional environment. For example, the computer system optionally detects a maintaining of position of the viewpoint relative to the three-dimensional environment and optionally detects a rotation along one or more axes, such as an axis extending normal to a floor of the three-dimensional environment. In some embodiments, the computer system detects a magnitude of rotation is less than a threshold magnitude, and forgoes rotation of the spatial audio (e.g., maintains the first spatial audio at its position and/or orientation). In some embodiments, the magnitude of rotation is more than the threshold magnitude, and the computer system rotates the first spatial audio in accordance with the rotation of the viewpoint. Thus, the computer system optionally rotates the first spatial audio in response to detecting sufficient rotation of the viewpoint beyond the threshold magnitude. Such a magnitude optionally includes a threshold angle of rotation (e.g., along a spherical coordinate system, such as 0, 2.5, 5, 7.5, 10, 15, 25, 35, 45, 50, 55, 60, 75, or 90 degrees). In other embodiments, the computer system rotates the first spatial audio in accordance with rotation of the user's viewpoint relative to the three-dimensional environment, independently of whether the viewpoint rotation is greater than a respective rotational threshold.

In some embodiments, when rotating the location corresponding to spatial audio relative to the viewpoint of the user, the computer system maintains a distance between the location and the viewpoint of the user, such as maintaining a distance between the viewpoint of user 708 and spatial audio source 704a as shown from FIG. 7G to FIG. 7H. For example, in response to detecting a viewpoint rotation along the floor-normal axis by 10 degrees, the computer system optionally rotates the first spatial audio corresponding to a location 5 m away from the viewpoint of the user by an angle relative to the floor-normal axis similar to or the same as the viewpoint rotation, while maintaining the 5 m distance from the viewpoint of the user. In response to detecting a viewpoint rotation along the floor-normal axis by 20 degrees, the computer system also maintains the 5 m distance between the location corresponding to the first spatial audio, and optionally rotates the first spatial audio by 20 degrees. In some embodiments, the computer system rotates spatial audio in response to rotation along a plurality of axes (e.g., along the floor-normal axis, along an axis parallel to the floor extending through a center of the viewpoint of the user, and/or some combination thereof). In some embodiments, the computer system rotates spatial audio in response to rotation along one or more axes and forgoes rotation of spatial audio along one or more other axes. For example, the computer system optionally rotates the spatial audio along the floor-normal axis, and optionally forgoes rotation along the axis parallel to the floor extending the center of the viewpoint (e.g., maintaining an angle of the spatial audio relative to the floor-parallel axis). It is understood that the computer system optionally also concurrently translates the first spatial audio in accordance with movement (e.g., translation) of the viewpoint relative to the three-dimensional environment as described with reference to method 800. In some embodiments, and when the first spatial audio has a first orientation relative to the viewpoint of the user, the computer system forgoes rotation of the spatial audio in response to detecting movement of the viewpoint less than the threshold distance described with reference to method 800, independently of the amount of rotation of the viewpoint relative to the three-dimensional environment. In some embodiments, in response to detecting the movement of the viewpoint beyond the threshold distance relative to the simulated spatial location corresponding to the first position in the three-dimensional environment, the computer system rotates the first spatial audio relative to the viewpoint of the user, such that the first spatial audio has an orientation similar to or the same as the first orientation, relative to the user's updated viewpoint. Rotating the spatial audio in accordance with rotation of the user's viewpoint provides additional feedback indicating the user's movement relative to the three-dimensional environment, thus improving user environmental awareness and/or comfort, and reducing user input required to correct for erroneous rotation relative to the three-dimensional environment, and thereby reducing power consumption.

In some embodiments, the movement of the viewpoint of the user that does not satisfy the one or more criteria includes a rotation of the viewpoint relative to the three-dimensional environment, and the second position corresponding to the first spatial audio is independent of an amount of the rotation of the viewpoint relative to the three-dimensional environment, such as the position of spatial audio source 704a from as shown in FIG. 7G to as shown in FIG. 7H. For example, the computer system optionally forgoes (e.g., maintains) a position and/or angle of the location corresponding to the first spatial audio in response to detecting rotation of the viewpoint of the user independently of changes in the position of the viewpoint relative to the three-dimensional environment. Thus, the computer system optionally forgoes rotation of one or more spatial audio sources relative to the three-dimensional environment (e.g., maintains an orientation of the one or more spatial audio sources relative to the three-dimensional environment), independently of any rotation of the viewpoint of the user relative to the three-dimensional environment. In some embodiments, the computer system moves the first spatial audio (e.g., and additional or alternative audio) relative to the three-dimensional environment, preserving positions and/or orientations of the first spatial audio relative to each other and to the three-dimensional environment. In such embodiments, the computer system optionally moves the first spatial audio based on displacement of the viewpoint away from a vector normal extending from a floor of the three-dimensional environment, and optionally forgoes movement of the first spatial audio based on a rotation around the vector normal. Maintaining the position of position of the first spatial audio in response to non-zero rotation of the viewpoint of the user preserves a sense of the user's position relative to the three-dimensional environment, thus improving the user's comfort and reducing erroneous viewpoint movement relative to the three-dimensional environment, and thereby processing required to detect the erroneous movement.

In some embodiments, the movement of the viewpoint includes movement in three directions relative to the three-dimensional environment, and the second position is displaced from the first position in the three directions relative to the three-dimensional environment in accordance with the movement of the viewpoint in the three directions, such as movement of spatial audio sources 704a-d from as shown in FIG. 7H to as shown in FIG. 7I. For example, the computer system optionally moves the first spatial audio along one or more axes in response to detecting viewpoint movement relative to the one or more axes (e.g., an X, Y, and/or Z direction relative to the three-dimensional environment). In some embodiments, magnitude(s) and/or direction(s) of the first spatial audio movement is the same as the magnitude and/or direction(s) of the detected viewpoint movement, relative to the three-dimensional environment. For example, the spatial audio is optionally moved away from a floor of the three-dimensional environment in response to detecting the user stand up away from the floor, as described further herein. In some embodiments, the magnitude(s) and/or direction(s) of the first spatial audio movement are different than those of the detected viewpoint movement (e.g., a relatively greater or lesser magnitude, in similar but different directions, in opposing directions, and/or some combination thereof). For example, in response to detecting the user stand upwards, the computer system optionally moves the spatial audio away from the viewpoint of the user, parallel to the floor of the three-dimensional environment (e.g., in addition to or in the alternative to moving the spatial audio away from the floor). Moving the first spatial audio based upon movement in one or more directions presents a consistent spatial arrangement of the spatial audio, lending a sensation of a large scale environment to the user and reducing prospective disorientation of the user, thereby improving the user's comfort while moving relative to the three-dimensional environment.

It should be understood that the particular order in which the operations in method 800 have been described is merely exemplary and is not intended to indicate that the described order is the only order in which the operations could be performed. One of ordinary skill in the art would recognize various ways to reorder the operations described herein.

FIGS. 9A-9G illustrate methods of and systems for changing a level of detail of spatial audio based upon movement of a viewpoint of a user in accordance with some embodiments of the disclosure.

FIG. 9A illustrates a computer system 101 (e.g., tablet, smartphone, wearable computer, or head mounted device) (e.g., an electronic device) displaying, via a display generation component (e.g., display generation component 120 of FIG. 1A such as a computer display, touch screen, or one or more display modules of a head mounted device), a three-dimensional environment 900 (e.g., an AR, AV, VR, MR, or XR environment) from a viewpoint of the user of the computer system 101 (e.g., facing a back wall of the physical environment in which computer system 101 is located). In some embodiments, computer system 101 includes a display generation component 120 (e.g., a computer display, touch screen, or display module of a head mounted device) and a plurality of image sensors 314a-314c (e.g., image sensors 314 of FIG. 3A). The image sensors optionally include one or more of a visible light camera, an infrared camera, a depth sensor, or any other sensor the computer system 101 would be able to use to capture one or more images of a user or a part of the user (e.g., one or more hands of the user) while the user interacts with the computer system 101 (e.g., tablet, smartphone, wearable computer, or head mounted device). In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user), and/or attention (e.g., based on gaze) of the user (e.g., internal sensors facing inwards towards the face of the user).

As shown in FIG. 9A, computer system 101 captures one or more images of the physical environment around computer system 101 (e.g., tablet, smartphone, wearable computer, or head mounted device), including one or more objects in the physical environment around computer system 101 (e.g., tablet, smartphone, wearable computer, or head mounted device). In some embodiments, computer system 101 displays representations of the physical environment included in three-dimensional environment 900. For example, three-dimensional environment 900 includes a flight of stairs 906, which is optionally a representation of stairs (e.g., video, pictures, and/or a view of the stairs via transparent materials) in the physical environment.

In FIG. 9A, three-dimensional environment 900 also includes one or more virtual objects. For example, as shown in FIG. 9A, the computer system 101 is displaying a virtual object 902 in the three-dimensional environment 900 (e.g., an AR, AV, VR, MR, or XR environment). In some embodiments, the virtual object is or includes one or more of user interfaces of an application (e.g., an application running on the computer system 101 (e.g., tablet, smartphone, wearable computer, or head mounted device)) containing content (e.g., windows displaying photographs, playback user interface displaying content, and/or web-browsing user interface displaying text), three-dimensional objects (e.g., virtual clocks, virtual balls, and/or virtual cars) or any other element displayed by computer system 101 that is not included in the physical environment of display generation component 120.

In FIG. 9A, as shown in the overhead view, the computer system 101 displays virtual object 902 and presents visibility of stairs 906 (e.g., displays an image, or facilitates visibility through a transparent material) from a viewpoint of the user 908 relative to three-dimensional environment 900. In some embodiments, the viewpoint of the user 908 includes a position and/or an orientation of the user 908 relative to three-dimensional environment 900. In FIG. 9A, computer system 101 displays immersive virtual content, including and/or corresponding to a virtual atmospheric effect described with reference to methods 800 and/or 1000 (e.g., an AR, AV, VR, MR, or XR environment). As described with reference to method 1200, such immersive virtual content is optionally displayed at a level of visual prominence relative to the three-dimensional environment 900, including, but not limited to what percentage, region, and/or region(s) of a viewport of the computer system 101 is consumed by the immersive virtual content. For example, the computer system 101 optionally displays a virtual tinting, dimming, color, pattern, and/or a virtual blurring overlaying one or more representations of the user's physical environment. In some embodiments, the atmospheric effect is displayed overlaying virtual content, including virtual object 902 in FIG. 9A, as illustrated by the fill pattern overlaying the virtual object 902. Further, stairs 906 are displayed with the fill pattern overlaying the representation of the physical features of stairs 906 in FIG. 9A. Thus, the computer system in FIG. 9A fills the user's three-dimensional environment 900 with a simulated environment, as though the user 908 were submerged and/or immersed in a virtual environment.

It is understood that embodiments described herein referencing “immersive” environments and/or content optionally refers to virtual content and/or virtual environments that computer system 101 is able to display with a level of immersion, as described with reference to methods 800, 1000, and/or 1200, and that such description does not preclude the possibility of displaying such virtual content and/or virtual environments that are not entirely immersive (e.g., displayed consuming a portion, rather than all of a viewport of computer system 101).

In some embodiments, computer system 101 presents simulated spatial audio in conjunction with an at least partially immersive environment. For example, in FIG. 9A, three-dimensional environment 900 includes a plurality of locations corresponding to simulated spatial audio sources, including locations virtually occupied by source 904a and source 904b shown in an overhead view of three-dimensional environment 900. As described with reference to method 800, method 1000, and/or FIGS. 7A-7K, the computer system 101 optionally presents (e.g., generates) audio via one or more audio channels, with time delay(s) and/or including modification of audio volume(s) of the channels to simulate the perception that physical sound sources were presenting audio in the three-dimensional environment 900. Accordingly, in FIG. 9A, sources 904a-b optionally are not displayed, but user 908 is able to hear sound as though emanating from the locations corresponding to source 904a-b. In such an example, sources 904a-b respectively “generate” audio, such that computer system 101 uses one or more directional filters to lend a spatial quality to the audio as though the audio were provided by a physical speaker at the locations that correspond to each source 904a-b. It is understood that computer system 101 is in fact generating the spatial audio with one or more characteristics such as using the spatial filters to simulate the perception that each source 904a-b is presenting spatial audio. Thus, at times, description of a spatial audio source “generating” audio is understood as the computer system 101 performing such operations to simulate the perception of source 904a-b generating audio. In some embodiments, the sounds and/or audio emanating from sources 904a-b are associated with the currently displayed immersive environment. For example, in FIG. 9A, three-dimensional environment 900 optionally corresponds to a golden colored environmental overlay including a simulated lighting effect mimicking physical light sources illuminating the user's environment, and the sources 904a-b optionally virtually generate sounds including music, intermittent environmental sounds, and/or additional or alternative sound described with reference to methods 800 and/or 1000.

In some embodiments, the locations corresponding to three-dimensional environment 900 are elevated and/or offset from a floor of the three-dimensional environment 900. For example, source 904a is a first elevation 930a away from a floor of three-dimensional environment 900, source 904b is a second, different elevation 930b, in FIG. 9A. Additional description of the locations including an elevation of such spatial audio sources is described with reference to method 800 and/or method 1000.

In some embodiments, the spatial audio includes ambient sound effects that are intermittently and/or constantly played, as described with reference to methods 800 and/or 1000, including a river flowing, wind whipping, ocean waves lapping, raindrops falling, and/or some combination thereof. The audio optionally relates to what immersive virtual content three-dimensional environment is displayed in three-dimensional environment 900 in FIG. 9A (e.g., a virtual feature such as a river and/or a streak of color representative of the river). In some embodiments, the spatial audio does not correspond to displayed virtual content (e.g., a virtual tree branch creaking that is not displayed, but relates to the underlying immersive three-dimensional environment).

In some embodiments, each source of sources 904a-b provide a different audio track, and/or include a combination of audio tracks and/or sounds. For example, as described with reference to method 1000, computer system 101 optionally generates audio that includes a plurality of audio tracks, the audio tracks respectively presented with a corresponding volume and/or level of detail. For example, Sound A 1 934 optionally corresponds to an audio track including ocean water swirling, and Sound A 2 936 optionally corresponds to an audio track including a wave periodically crashing. As indicated by the glyphs adjacent to the textual labels, the sounds respectively are presented at “levels of detail” described with reference to FIGS. 9A-9F, and described with reference to method 1000. In some embodiments, the audio tracks are not played, but are associated with a corresponding sound source. For example, source 904a optionally generates spatial audio including Sound A 1 934 and not yet including Sound A 2 936. In some embodiments, the aggregate audio that is “generated” by spatial audio source 904a corresponds to audio 914a, which includes the constituent audio tracks Sound A 1 934 and Sound A 2 936. Similarly, source 904b generates audio 914b, which includes Sound B1 938 and Sound B2 940. Additionally, source 904c generates audio 914c, which includes Sound C1 942, Sound C2 944, and Sound C3 946.

In FIG. 9A, sound A 1 (e.g., corresponding to audio source 904a) is presented with a first level of detail and/or with a first volume level, as described with reference to method 1000. The level of detail, for example, optionally includes a degree to which the user 908 is able to hear the details and/or sounds included in one or more audio tracks generated by a spatial audio source. As an example, computer system 101 optionally changes a roll-off of one or more digitals filters, changes a Q-factor of one or more digital filters, adds digital filtering, removes digital filtering, delays audio, adds or removes an echo effect, muffles or removes muffling, and/or some combination thereof to change the degree to which one or more audio tracks are clearly audible to the user. Such changes optionally are different from (e.g., but optionally related to) the volume that computer system 101 generates the track(s) and/or sounds. For example, source 904a in FIG. 9A is optionally presenting an ocean wave lapping from in front of the user's viewpoint with a first volume level and/or level of detail (e.g., a partially muffled, but audible ocean wave). Sound A 2 936, in contrast, is optionally not played, or optionally is almost entirely muffled sound of a bird tweeting from in FIG. 9A, corresponding to a second, different level of detail less than the first level of detail. Description of the changing of level of detail of audio 914a immediately follows, and description of additional or alternative spatial audio sources, such as audio 914b and audio 914c, is included further herein.

In FIG. 9A, computer system 101 presents audio 914b and 914c concurrently while presenting audio 914a. In FIG. 9A, each audio track is presented by a corresponding spatial audio source (e.g., audio 914b is presented as though emanating from the spatial location corresponding to source 904b, audio 914c is presented as though emanating from the spatial location corresponding to source 904c). In some embodiments, each of audio 914a, audio 914b, and audio 914c include respective audio tracks presented with respective levels of details. For example, audio 914b in FIG. 9A includes Sound B1 938 presented at a first level of detail, and further includes Sound B2 940 and audio 914c includes Sound C1 942, Sound C2 944, and Sound C3 946. It is understood that the level of detail of audio 914a, audio 914b, and audio 914c optionally includes the levels of the sounds respectively included in audio 914a, audio 914b, and audio 914c. For example, the level of detail of audio 914a increases when a level of detail of Sound A 1 934 and/or Sound A 2 936 increases, and the level of detail of audio 914a decreases when a level of detail of Sound A 1 934 and/or Sound A 2 936 decreases.

Some embodiments herein include description of a level of detail of spatial audio that increases or decreases. It is understood that the level of detail changing in a direction (e.g., increasing or decreasing) optionally includes a particular one or more audio tracks (e.g., Sound A 1) increasing in level of detail, independently of changes in levels of details of other audio tracks. For example, the level of detail of audio 914a optionally increases when the level of detail of Sound A 1 934 increases, or optionally decreases when the level of detail of Sound A 1 934 decreases. In other embodiments, the level of detail of audio 914a optionally increases based on a combined metric associated with a plurality of levels of detail of a plurality of audio tracks. For example, if the level of detail of Sound A 1 934 increases by an amount greater than an amount of decrease of the level of detail of Sound A 2 936, the level of audio 914a optionally increases (e.g., or vice-versa). Thus, in some embodiments, the change in level of detail of key audio tracks increases or decreases, the level of detail of spatial audio provided by a spatial audio source increases or decreases. In other embodiments, when a net change of level of detail of a plurality of tracks increase or decrease, the level of detail of the audio source increases or decreases.

In some embodiments, the level of detail of audio presented by a spatial audio source changes in response to detecting the user's viewpoint draw closer toward or move away from the location corresponding to the spatial audio source. For example, from FIG. 9A to FIG. 9B, computer system 101 detects movement of the viewpoint of user 908, including movement of the viewpoint closer toward the simulated location corresponding to spatial audio source 904a. In FIG. 9B, for example, the level of detail of Sound A 1 934 increases in response to detecting the change in viewpoint as the distance between the viewpoint of the user and the spatial audio source 904b decreases. For example, the audible fidelity (e.g., audible clarity of the ocean waves described previously) optionally increases, including attenuating different portions of the frequency content including in Sound A 1 934 and/or decreasing the attenuation of the different portions from FIG. 9A to FIG. 9B based upon the decrease in the distance. In some embodiments, the increase in level of detail of Sound A 1 934 and Sound A 2 936 is a same amount in response to a given movement of the user's viewpoint, and in some embodiments, the increase in level of detail is different in response to the given movement of the user's viewpoint as described further with reference to FIG. 9F.

In some embodiments, the level of detail of the audio of one or more tracks presented by a spatial audio source does not change in response to detecting the user's viewpoint draw closer toward, or away from the location corresponding to the spatial audio source. For example, from FIG. 9A to FIG. 9B, computer system 101 forgoes changing (e.g., maintains) the level of detail of the Sound A 2 936. As an example, in response detecting the decrease in the distance between the user's viewpoint and source 904b, the computer system 101 optionally continues to present the bird sound corresponding to Sound A 2 936 muffled to a same degree (e.g., maintains an attenuation of the frequency content of the sound) in FIG. 9A and FIG. 9B.

As described further herein, in some embodiments, the level of detail that was previously maintained in response to a first movement of the viewpoint changes in response to a second movement of the viewpoint relative to the spatial audio source. For example, from FIG. 9B to FIG. 9C, computer system 101 detects the user's viewpoint move closer toward spatial audio source 904a. In response to detecting the viewpoint movement from FIG. 9B to FIG. 9C, computer system 101 increases the level of detail of Sound A 1 934, and concurrently increases the level of detail of Sound A 2 936 due to the decrease in distance between the viewpoint and spatial audio source 904a. As an example, the ocean wave sound progressively becomes clearer from FIG. 9A through FIG. 9C, and from FIG. 9B to FIG. 9C, the computer system initiates presentation of the bird sound and/or progressively decreases a muffling of the bird sound corresponding to Sound A 2 936. From FIG. 9C to FIG. 9D, computer system 101 detects the user's viewpoint further move toward source 904a, decreasing the distance between the viewpoint and source 904a. In response to detecting the movement from FIG. 9C to FIG. 9D, computer system 101 increases the levels of detail of Sound A 1 934 and Sound A 2 936.

In some embodiments, the computer system 101 decreases the level of detail of one or more audio tracks in accordance with changes in distance between the viewpoint of the user 908 and a corresponding spatial audio source. For example, from FIG. 9D to FIG. 9E, computer system 101 detects the user's viewpoint move away from source 904a, increasing the distance between the viewpoint and source 904a. In response to detecting the viewpoint movement, the computer system 101 optionally decreases the level of detail of Sound A 1 934 and of Sound A 2 936 from FIG. 9D to FIG. 9E. The decrease in level of detail is optionally concurrent, and optionally includes changing of the frequency content of the audio and/or the digital filtering applied to the spatial audio presented by source 904a. In some embodiments, the decrease in level of detail of Sound A 1 934 and Sound A 2 936 is a same (e.g., or, alternatively, similar) amount in response to a given movement of the user's viewpoint, and in some embodiments, the decrease in level of detail is different, in response to the given movement of the user's viewpoint as described further with reference to FIG. 9F.

Thus, from FIGS. 9A-9D, the level of detail of audio 914a increases due to a progressively decreasing distance between the viewpoint of the user and spatial audio source 904a. From FIG. 9D to FIG. 9E, the level of detail of audio 914a optionally decreases due to an increase of the distance between the viewpoint of the user and spatial audio source 904a.

In some embodiments, concurrent with the changes in the level of detail of spatial audio corresponding to source 904a, the computer system 101 changes the level of detail of additional or alternative spatial audio sources (e.g., concurrently or sequentially). For example, in FIG. 9A, computer system 101 presents spatial audio 904b including Sound B1 938 at a level of detail similar to or the same as Sound A 1 934. Similarly, in FIG. 9A, computer system 101 presents spatial audio source 904b including Sound B2 940 at a level of detail similar to or the same as Sound A 2 936. In FIG. 9A, computer system 101 presents audio 914c including Sound C1 942, Sound C2 944, and Sound C3 946, each presented with different levels of detail. The sounds optionally correspond to audio tracks including bushes rustling, wind whistling, a dog barking, and/or some combination thereof.

It is appreciated, that the sound(s) that correspond to spatial audio source 904b and/or spatial audio source 904c are optionally different from those that correspond to spatial audio source 904a. For example, the Sound B1 938 optionally corresponds to a different wave crashing sound, and/or a sound including the wind whistling. In other embodiments, the sounds presented by different audio sources optionally, and at least partially, share a same set of tracks. For example, the Sound A 1 934 and Sound B1 938 optionally both correspond to a same wave crashing track that are spatially filtered to appear as though emanating from the location of source 904a and the location of source 904b, respectively. In such an example, the level of detail of the sounds optionally is based upon the distance between the user's viewpoint and the spatial audio source that is presenting the corresponding sound.

In some embodiments, the sound presented corresponding to spatial audio source 904b increases and/or decreases in levels of detail, similar to or the same as described with reference to spatial audio source 904b and/or audio 914a. For example, from FIG. 9A to FIG. 9B and FIG. 9B to FIG. 9C, computer system 101 detects the viewpoint of user 908 move closer toward the location corresponding to spatial audio source 904b, and accordingly increases the level of detail of audio 914b, Sound B1 938, and Sound B2 940 based upon the progressively decreasing distance between the viewpoint and the location corresponding to spatial audio source 904b. From FIG. 9C to FIG. 9D, computer system 101 detects viewpoint movement increasing the distance between the viewpoint of user 908 and spatial audio source 904b, and in response, computer system 101 decreases the level of detail of audio 914b, Sound B1 938, and Sound B2 940 based upon the distance increase. From FIG. 9D to FIG. 9E, computer system 101 detects viewpoint movement decreasing the distance between the viewpoint of user 908 and spatial audio source 904b, and in response, computer system 101 increases the level of detail of audio 914b, Sound B1 938, and Sound B2 940 based upon the distance decrease. Further, the audio tracks included in audio 914c in FIGS. 9A-9E progressively decrease in level of detail as distance between the spatial audio source 904c and the viewpoint of the user increases. For example, from FIG. 9A to FIG. 9B, the Sound C1 942, Sound C2 944, and Sound C3 946 optionally decrease in level of detail. From FIG. 9B to FIG. 9C, spatial audio 914c includes Sound C3 946, and muffles and/or does not include Sound C1 942 and Sound C2 944.

In some embodiments, as described with reference to FIG. 9F, the amount of change of level of detail and/or a rate of change of the level of detail differs between different audio sources and/or different audio tracks. For example, a first distance between the viewpoint of the user and spatial audio source 904a in FIG. 9D is similar to, or is the same as a second distance between the viewpoint of the user and spatial audio source 904b in FIG. 9E. Despite that similarity, computer system 101 optionally presents different levels of detail of related audio tracks. For example, a level of detail of Sound A 1 934 in FIG. 9D is different from the level of detail of Sound B1 938 in FIG. 9E. Similarly, a level of detail of Sound A 2 936 in FIG. 9D is different from the level of detail of sound B 2 940 in FIG. 9E. In some embodiments, the computer system 101 changes levels of detail of an audio track and/or spatial audio in accordance with a rate. The rate, for example, optionally includes an amount of level of detail change per change per unit distance (e.g., a simulated distance by which a magnitude of movement is normalized to). For example, the computer system optionally decreases the level of detail from 100% to 50% in response to detecting movement of the viewpoint 5 m away from a corresponding spatial audio source, relative to a simulated 1 m unit distance, or decreases from 100% to 20% in response to detecting the movement of the viewpoint by 8 m. Thus, in some embodiments, the rate of change of the level of detail of spatial audio per a change in unit distance between the spatial audio source and the viewpoint is different for different audio tracks and/or audio sources. Additionally or alternatively, the distance at which the computer system forgoes changing (e.g., maintains) a level of detail is optionally different for different audio tracks and/or spatial audio. In FIG. 9D, the computer system 101 determines that Sound A 1 934 is a maximum level of detail when the viewpoint of the user is the first distance away from the source 904a. in FIG. 9E, the computer system 101 determines that the Sound B1 938 is a 95% level of detail when the viewpoint of the user is the first distance away from the source 904b.

In some embodiments, the level of detail of one or more tracks included in spatial audio changes in accordance with a function, as described with reference to method 1000. For example, FIG. 9F illustrates a plot 930 indicating level of detail on a vertical axis (e.g., “Track Level of Detail”), and user viewpoint-to-spatial audio source distance on a horizontal axis, plotting several levels of detail of audio tracks (e.g., “Sound C1,” “Sound C2,” and/or “Sound C3”) of audio (e.g., audio 914a, audio 914b, and/or 914c) that increase or decrease as the user's viewpoint moves toward and/or away from a location corresponding to a spatial audio source (e.g., source 904a, source 904b, and/or source 904c). As illustrated by the legend 926, the curve 966, the curve 920, and the curve 922 respectively correspond to different spatial audio tracks (e.g., the “Sound A/B/C 1/2/3” in FIGS. 9A-9E) and/or respectively correspond to different spatial audio sources. Curve 922, for example, illustrates a level of detail to distance curve of a track (e.g., “Sound C1”). Curve 922 includes several datapoints, and illustrates that a level of detail of spatial audio is maximized when the user is standing at the location, or immediately near the location corresponding to a spatial audio source that corresponds to the spatial audio, as illustrated by datapoint 958. FIG. 9G is representative of a corresponding overhead view of a spatial audio source 970 and a viewpoint of a user 908 using computer system 101. Datapoint 958, for example, optionally represents the level of detail of a first audio track presented as corresponding to spatial audio source 970 when the user is standing at the location of spatial audio source 970, or immediately adjacent to such a location. As the user moves rightward in the overhead view of FIG. 9G, computer system 101 changes the level of detail along the curve 922. For example, the level of detail of “Track 1” corresponding to curve 922 is at a relatively lower level when the user's viewpoint to spatial audio source distance progressively increases, as illustrated by the datapoints 950, 968, and 960. The curve 922 is non-linear, such that the amount of change in level of detail differs per unit distance traveled (e.g., the horizontal distance between datapoint 958 and datapoint 950) changes as the user's viewpoint moves relative to the spatial audio source 970 in FIG. 9G.

In some embodiments, the level of detail of a given audio track changes along a linear function in accordance with changes in the user's viewpoint. For example, curve 966 is representative, and illustrates a scenario in which the change in level of detail of a track presented by spatial audio source 970 in FIG. 9G changes by a fixed amount per unit distance moved. For example, the level of detail changed from datapoint 958 to the datapoint 952 is optionally a same amount as the level of change between datapoint 950 and datapoint 960 in FIG. 9F. Thus, the computer system 101 in FIG. 9G optionally changes the level of detail of “Track 2” a scalar amount per unit distance, independently of the spatial relationship between a spatial audio source and the viewpoint of the user.

In some embodiments, the level of detail of a given audio track increases as the user moves away from a spatial audio source. For example, the curve 920 in FIG. 9F is representative, and illustrates that the level of detail is minimized at datapoint 956 (e.g., when the user is standing at the location of audio source 970 in FIG. 9G), and increases per unit distance (e.g., at datapoint 954, datapoint 964, and datapoint 962) along a logarithmic or logarithmic-type curve. Thus, the rate of change of level of detail of “Track 3” is dependent upon the distance between the user's viewpoint and the location corresponding to a spatial audio source as illustrated in FIG. 9F.

It is understood that description of level of detail as a function of distance between viewpoint of the user and a location associated with a corresponding spatial audio source is optionally similar to or the same as described with reference to the levels of detail here. For example, the FIGS. 9A-9G optionally additionally or alternatively depict changes in volume of spatial audio including one or more audio tracks. In some embodiments, the spatial audio volume and levels of detail changes in a similar direction (e.g., both increasing, decreasing, and/or some combination thereof) in response to detecting a change in distance between a viewpoint and a corresponding spatial audio source, but by a different proportion and/or amount. For example, in response to detecting a distance between the user's viewpoint and a spatial audio source decrease by 1 m, a level of detail of the spatial audio optionally decreases by 10%, and the volume decreases by 25%. Additionally or alternatively, in response to detecting the aforementioned distance between the user's viewpoint and the spatial audio source increase by 2.5 m, the level of detail of the spatial audio optionally increases by 20%, and the volume optionally increases by 30%.

FIG. 10 is a flowchart illustrating a method of presenting spatial audio with a level of detail based upon a distance between a location corresponding to spatial audio and a user viewpoint, in accordance with some embodiments. In some embodiments, the method 1000 is performed at a computer system (e.g., computer system 101 in FIG. 1A such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1000 is governed by instructions that are stored in a non-transitory computer-readable storage medium and that are executed by one or more processors of a computer system, such as the one or more processing units 202 of computer system 101 (e.g., control unit 110 in FIG. 1A). Some operations in method 1000 are, optionally, combined and/or the order of some operations is, optionally, changed.

In some embodiments, a method 1000 is performed at a computer system in communication with one or more input devices and a display generation component, such as computer system 101a, display generation component 120, and input devices 314a-c as shown in FIG. 9A. For example, the computer system, the one or more input devices, and/or the display generation component optionally have one or more characteristics similar to or the same as the computer system(s), one or more input devices, and/or display generation component(s), respectively described with reference to methods 800 and/or 1200.

In some embodiments, while a three-dimensional environment of a user of the computer system is visible via the display generation component from a viewpoint of the user that is a first viewpoint relative to the three-dimensional environment, such as the viewpoint of user 908 relative to three-dimensional environment 900 as shown in FIG. 9A, and while presenting first spatial audio associated with the three-dimensional environment with a simulated spatial location that corresponds to a first location within the three-dimensional environment and at a first level of detail (1002), such as audio corresponding to spatial audio sources 904a-c as shown in FIG. 9A, the computer system detects (1004), via the one or more input devices, movement of the viewpoint of the user, such as movement that changes the viewpoint of user 908 to be different from as shown in FIG. 9A. For example, the three-dimensional environment optionally has one or more characteristics similar to or the same as the three-dimensional environment(s) described with reference to methods 800 and/or 1200. Additionally or alternatively, the first viewpoint of the user optionally has one or more characteristics similar to or the same as the viewpoint(s) described with reference to methods 800 and/or 1200. In some embodiments, the first spatial audio has one or more characteristics similar to or the same as audio (e.g., spatial audio) described with reference to methods 800 and/or 1200. In some embodiments, the computer system presents (e.g., generates) first spatial audio associated with the three-dimensional environment, such as one or more ambient sounds that virtually emanate from virtual sound sources and/or from regions of the three-dimensional environment (e.g., sounds that optionally correspond to position(s) and/or region(s) of the three-dimensional environment). The ambient sounds, for example, optionally include sounds of animals, nature, vehicles, and the like, and optionally are related to virtual content included in the three-dimensional environment that is displayed (e.g., virtual portions of the three-dimensional environment, as described with reference to 800 and/or 1200). It is understood that the term “ambient” is merely exemplary, and that additional or alternative types of sounds associated with an environment are contemplated without departing from the scope of the disclosure. In some embodiments, as described further at least with reference to method 800, the computer system presents audio as though emanating from a particular position within the three-dimensional environment. For example, the computer system optionally presents the first spatial audio as though emanating from the first location within the three-dimensional environment (e.g., at a spatial arrangement (e.g., position and/or orientation) relative to the user's viewpoint, and optionally temporarily fixed relative to the three-dimensional environment). In some embodiments, the first spatial audio is associated with a particular level of detail. The level of detail, as an example, optionally controls what audio is presented to the user, such as particular sound effects (e.g., nature sounds, mechanical sounds, footsteps), a level of broadband noise (e.g., white noise, brown noise, and/or pink noise), simulated or real speech of individuals, and/or music (e.g., alone or in some combination), and/or a temporal frequency at which such audio is presented to the user. For example, in accordance with a determination that the first spatial audio is to be generated with the first level of detail, the first spatial audio optionally includes a wind sound effect presented via a virtual sound source placed at the first location including a low frequency hum. In accordance with a determination that the first spatial audio is to be generated with a second level of detail, greater than the first level of detail, the first spatial audio optionally includes additional frequency components lending additional realism to the wind sound effect, includes additional sounds (e.g., a sharp, intermittent whistling of the wind) that is not presented at the first level of detail, and/or includes forgoing presentation of a less-detailed sound (e.g., the low frequency hum) that is presented when the first spatial audio at the first level of detail. Additionally or alternatively, the computer system optionally presents the first spatial audio including a sound corresponding to a river flowing in the user's three-dimensional environment. In some embodiments, presenting the first spatial audio including the river with the first level of detail includes playing a first set of sounds, such as a first audio track including water flowing. In some embodiments, presenting the first spatial audio including the river sounds with the second level of detail includes a second set of sounds, such as a second, different audio track including different water flow sounds, and/or a second audio track that is intermittently played concurrently while the first audio track is played (e.g., a splashing of water over a surface and/or a gentle bobbing of an object in the water to convey a relatively greater level of detail, and/or a forgoing of playing a portion of the first audio track to convey a relatively lesser level of detail). It is understood that changing of the level of detail is optionally different from toggling between presenting, or not presenting particular spatial audio. In some embodiments, movement of the viewpoint of the user includes changing of a position and/or orientation of one or more portions of the user's body and/or of the computer system relative to the three-dimensional environment, which optionally correspond to corresponding changes in the position and/or orientation of the viewpoint of the user relative to the three-dimensional environment. Similar to or the same as a described with reference to method 800, it is understood that the movement of the viewpoint optionally includes virtual movement.

In some embodiments, in response to detecting the movement of the viewpoint, and in accordance with a determination that one or more criteria are satisfied, including a criterion that is satisfied when the movement of the viewpoint changes a distance between the viewpoint of the user and the simulated spatial location that corresponds to the first location within the three-dimensional environment (1006), the computer system changes (10008) a level of detail of the first spatial audio from the first level of detail to a second level of detail, different from the first level of detail, such as the level of detail of audio 914a as shown in FIG. 9A changing to as shown in FIG. 9B. For example, the computer system detects and/or obtains an indication that the user viewpoint moves further away from the first location or closer to the first location (e.g., a second distance away from the first location), optionally while the first spatial audio continues to correspond to the first location (e.g., the position of the virtual sound source generating the first spatial audio is maintained while the viewpoint changes). In some embodiments, the movement includes rotation without including translation of the viewpoint relative to the three-dimensional environment (e.g., while an orientation is maintained), includes translation of the viewpoint without including rotation of the viewpoint relative to the three-dimensional environment, or includes both translation and rotation of the viewpoint relative to the three-dimensional environment. In some embodiments, in accordance with a determination that the distance changes in a first direction by a first magnitude, the computer system changes the level of detail of the first spatial audio by a first magnitude and/or in a first direction. In accordance with a determination that the distance changes by a second direction and/or by a second magnitude, different from the first direction and/or the first magnitude, the computer system optionally changes the level of detail of the first spatial audio by a second magnitude and/or in a second direction, different from the first magnitude and/or the first direction.

For example, the computer system optionally increases the level of detail in accordance with a determination that the movement of the viewpoint of the user decreases the distance between the viewpoint of the user and the first location, or decreases the level of detail in accordance with a determination that the viewpoint of the user increases the distance between the viewpoint of the user and the first location, such as the movement of the viewpoint of user 908 from as shown in FIG. 9A relative to spatial audio source 904a to as shown in FIG. 9B. In some embodiments, the level of detail is different from a change in a volume level of the first spatial audio. For example, in response to the change in viewpoint, the volume level of the first spatial audio is maintained, and the level of detail (e.g., the sounds, the frequency content, the rate of sounds that are played intermittently, and/or the audio fidelity of the first spatial audio) optionally changes. Further, the change in the level of detail is optionally different from changing a perceived location of the virtual sound source “presenting” the first spatial audio. For example, the time delay and/or frequency content of the first spatial audio may change in response to the viewpoint of the user changing (e.g., to the extent that is optionally required to change the user's perception of a spatial location of the sound), but until the viewpoint of the user draws closer to the first location of the first spatial audio, the particular sounds included in the first spatial audio and/or the audio fidelity of the first spatial audio are optionally maintained. In such an example, in response to detecting the distance relative to the first location user's viewpoint decrease (e.g., or increase), the computer system optionally adds or removes sounds included in the first spatial audio and/or optionally changes the audio fidelity (e.g., how muffled and/or clearly the first spatial audio is perceived) of the first spatial audio.

Additionally or alternatively, the computer system optionally changes the level of detail in response to viewpoint of the user turning toward or away from the first spatial audio, thus changing an angular distance between a vector extending from the user's viewpoint (e.g., a normal vector corresponding to the center of viewport corresponding to the viewpoint) and a vector extending between the user's viewpoint and the position of the first spatial audio, such as rotation of the viewpoint of user 908 from as shown in FIG. 9A toward spatial audio source 904a and/or 904b. For example, in response to detecting a decrease in the angular distance between the viewpoint of the user and the first location, the computer system optionally increases (e.g., or decreases) the level of detail, and in response to an increase in the angular distance, optionally decreases (e.g., or increases) the level of detail. In some embodiments, the computer system maintains a volume of the first spatial audio relative to the three-dimensional environment, while changing the level of the detail of the first spatial audio in response to the movement of the viewpoint. In some embodiments, the computer system progressively changes the level of detail as the user's viewpoint moves closer to or further from the first location (e.g., to a third level of detail, different from the first and second levels of detail, in accordance with a determination that the viewpoint and the first location are a third distance away from one another). In some embodiments, the one or more criteria additionally or alternatively include a criterion that is satisfied when the viewpoint of the user is within a range of distances from the first location. For example, the computer system optionally forgoes changing (e.g., maintains) the level of detail included in the first spatial audio in accordance with a determination that the viewpoint of the user moves beyond a first threshold distance (e.g., 0.5, 0.6, 0.7, 0.8, 0.9, 1, 1.25, 2.5, 5, 10, 15, or 20 m) of the first location and/or in accordance with a determination that the viewpoint of the user moves within a second threshold distance (e.g., 0.01, 0.02, 0.03, 0.04, 0.05, 0.075, 0.1, 0.2, 0.3, 0.5, or 1 m) of the first location. In some embodiments, the computer system changes the level of detail without detecting an express input (e.g., a selection of a physical or virtual button, a voice command, an air gesture, and/or a rotating of an electromechanical crown button) requesting a changing of the first spatial audio. Changing a level of detail included in the first spatial audio in accordance with a determination that the user's viewpoint moves relative to the first location provides auditory feedback concerning the user's movement relative to the three-dimensional environment that is illustrative of the user's spatial relationship with the first spatial audio, thus improving the user's comfort while moving within the three-dimensional environment and reducing the likelihood the user erroneously moves toward or away from the first spatial audio, and thereby reduces power consumption required to perform operations in response to detecting the erroneous movements.

In some embodiments, presenting the first spatial audio at the first level of detail includes presenting the first spatial audio with a first set of audio components, such as audio 914c including Sound C1 942, Sound C2 944, and Sound C3 946 as shown in FIG. 9A, and changing the level of detail of the first spatial audio from the first level of detail to the second level of detail includes presenting the first spatial audio with a second set of audio components, different from the first set of audio components, such as shown from FIG. 9B to FIG. 9C. For example, the computer system optionally changes a level of detail included in the first spatial audio as described with reference to method 1000. In some embodiments, such changing includes adding sound and/or components of sound included in the first spatial audio. For example, the computer system optionally changes characteristics of one or more digital filters applied to the first spatial audio, changing a warmth, depth, and/or muffling effect of the first spatial audio. Thus, the first and the second set of audio components optionally include different, respective frequency content, and optionally corresponds to different levels of detail of the first spatial audio. In some embodiments, the first and second set of audio components include different sounds. For example, a bird chirping intermittently optionally is included in the first set of audio components, and optionally not the second set of audio components, or vice-versa, and/or a sound of a tree branch creaking optionally is included in the first set of audio components, and optionally is not included in the second set of audio components. As a further example, the computer system optionally changes a looping sound of ocean waves crashing on a shoreline from a first looping sound including a periodic, booming crash, to a second looping sound that does not include the booming crash, and alternatively includes a series of smaller crashes, when transitioning from presenting the first set of audio components to presenting the second set of audio components. In some embodiments, changing from presenting at the first to the second level of detail includes gradually or abruptly ceasing presentation of one or more audio components included in the first spatial audio. For example, the computer system gradually or suddenly decreases a volume of an audio component when transitioning from presenting the first set of audio components to presenting the second set of audio components, and/or gradually or suddenly increases a volume of an audio component included in the second set of audio components (e.g., not included in the first set of audio components). Gradually transitioning between levels of detail optionally includes changing the volume and/or audio fidelity of respective audio components at a rate slow enough for the user of the computer system to recognize such change, and suddenly transitioning between the levels of detail optionally includes changing the volume and/or audio fidelity of the respective audio components abruptly, without changing between intermediate levels of volume and/or audio fidelity. Additionally or alternatively, the computer system optionally forgoes presentation of an intermittent sound (e.g., sound component) when it is determined (e.g., by the computer system) that the first spatial audio will be presented with the second set of audio components, that otherwise is presented when presenting the first spatial audio with the first set of audio components. In some embodiments, the computer system changes a level of detail of one or more additional or alternative spatial audio sources, concurrently with, before, and/or after changing the level of detail of the first spatial audio. In some embodiments, the computer system maintains the simulated spatial location of the first spatial audio when transitioning from presenting the first set of audio components to presenting the second set of audio components. It is understood that description of the levels of detail and/or audio components described with reference to the first spatial audio optionally applies to additional or alternative spatial audio associated with the three-dimensional environment described with reference to method 1000. Presenting the first spatial audio with different levels of detail indicates a spatial relationship between the user's viewpoint relative to the three-dimensional environment, thus reducing the likelihood of detecting erroneous viewpoint movement while improving user comfort while interacting with the three-dimensional environment, and thereby reducing processing required to detect the erroneous movement.

In some embodiments, changing the level of detail includes applying a cross-fading effect, wherein the cross-fading effect includes decreasing a volume of one or more of the first set of audio components and increasing a volume of one or more of the second set of audio components, such as decreasing a volume of audio 914a and decreasing a volume of audio 914c as shown from FIG. 9A to FIG. 9B. For example, the computer system optionally performs a cross-fading effect, including changing one or more first characteristics of some or all of the one or more first set of audio components and changing one or more second characteristics of some or all of the one or more second set of audio components. Such changing optionally includes decreasing a volume of the first set of audio components, and rapidly (e.g., and/or concurrently) increasing a volume of the second set of audio components, thereby fading between audio (e.g., audio tracks) included in the first spatial audio. It is understood that description of the first set, the second set, and additional or alternative “sets” of audio components, audio tracks, sounds, and the like optionally include one or more components, tracks, and/or sounds, and that “set” optionally includes a plurality (e.g., or a single) of such audio components. In some embodiments, audio components shared between tracks included in the first spatial audio are maintained, increased, and/or decreased in audio fidelity while applying the cross-fading effect. In some embodiments, one or more first and/or second characteristics include one or more characteristics configured to change audio fidelity of spatial audio, as described with reference to method 1000.

In some embodiments, the computer system changes a level of one or more of the herein described characteristics of the first and/or second spatial audio in accordance with the viewpoint movement. For example, the computer system optionally increases a volume of a leaf fluttering periodically by a first amount (e.g., 5%, 10%, 15%, 25%, 40%, 50%, 60%, 75%, or 90%) and optionally decreases a volume of a branch periodically creaking by a similar or different amount in response to detecting a first magnitude (e.g., distance, speed, and/or acceleration) of the viewpoint movement. In some embodiments, in accordance with a determination that the viewpoint of the user is maintained, the computer system maintains (e.g., forgoes changing of) the respective levels of the one or more characteristics of the first and/or second audio components. In some embodiments, the cross-fading effect is performed in response to detecting movement of the viewpoint, and continues while the viewpoint of the user is maintained. For example, the computer system optionally detects the viewpoint of the user moving to a first location within the three-dimensional environment that is toward the simulated location of the first spatial audio, and in response, optionally decreases volume of a sound of a bird chirping and optionally increases volume of a sound of a river flowing. While the viewpoint of the user is maintained at the first location, the computer system optionally continues to decrease the audio fidelity and/or volume of the bird chirping, and/or optionally continues to increase the audio fidelity and/or volume of the river flowing. Thus, movement of the viewpoint of the user is optionally a trigger for changing one or more characteristics of spatial audio, and the computer system optionally continues to change the one or more characteristics of the spatial audio without detecting additional movement of the viewpoint. Cross fading between levels of detail and/or sounds included in the first spatial audio indicates the gradual movement of the viewpoint relative to the three-dimensional environment, reinforcing the user's spatial relationship relative to the three-dimensional environment and improving the comfort of the user while moving within the three-dimensional environment, thus reducing the likelihood of detecting erroneous viewpoint movement, and thereby reducing processing required to detect the erroneous movement.

In some embodiments, changing the level of detail of the first spatial audio from the first level of detail to the second level of detail comprises, in accordance with a determination that the movement of the viewpoint decreases the distance between the viewpoint of the user and the simulated spatial location that corresponds to the first location, increasing the level of detail of the first spatial audio, such as increasing the level of detail included in audio 914a (e.g., increasing the level of detail of Sound A 1 934 and/or Sound A 2 936) in response to movement of the viewpoint of user 908 from FIG. 9A to FIG. 9B. For example, as described with reference to at least method 1000. For example, the computer system optionally increases the level of detail of the first spatial audio in response to detecting the viewpoint of the user draw closer toward the simulated spatial location that corresponds to the first location. Thus, the computer system optionally audio fidelity of the first spatial audio when the user moves closer to the first location, as described with reference to at least method 1000. Increasing the level of detail of the first spatial audio when the viewpoint of the user draws closer toward the first position indicates that the user is moving toward a portion of the three-dimensional environment that corresponds to the first spatial audio, thus indicating the user's spatial relationship to such a portion, and thereby reducing the likelihood the user undesirably moves toward—or away from—the portion of the three-dimensional environment while also improving the user's comfort when interacting with the three-dimensional environment.

In some embodiments, the changing of the level of detail of the first spatial audio from the first level of detail to the second level of detail comprises, in accordance with a determination that the movement of the viewpoint increases the distance between the viewpoint of the user and the simulated spatial location that corresponds to the first location, decreasing the level of detail of the first spatial audio, such as decreasing the level of detail included in audio 914c (e.g., decreasing the level of detail of Sound C1 942 and/or Sound C2 946) in response to movement of the viewpoint of user 908 from FIG. 9A to FIG. 9B. For example, as described with reference to at least method 1000. For example, the computer system optionally decreases the level of the first spatial audio in response to detecting the viewpoint of the user draw further away from the simulated spatial location that corresponds to the first location. Thus, the computer system optionally decreases audio fidelity of the first spatial audio when the user moves away from the first location, as described with reference to at least method 1000. Decreasing the level of detail of the first spatial audio when the viewpoint of the user moves further away from the first position indicates that the user is moving away from a portion of the three-dimensional environment that corresponds to the first spatial audio, thus indicating the user's spatial relationship to such a portion and decreasing audio of spatial audio that is less relevant to the user's current spatial relationship, and thereby reducing the likelihood the user undesirably moves toward—or away from—the portion of the three-dimensional environment and improving the user's comfort while interacting with and/or moving relative to the three-dimensional environment.

In some embodiments, the changing of the level of detail is performed gradually in accordance with changes in the distance between the viewpoint of the user and the simulated location that corresponds to the first location, such as the gradual changes in levels of detail of sounds included in audio 914a from FIG. 9A to FIG. 9B, and/or based upon the plot 930 as shown in FIG. 9F. For example, the computer system optionally changes the level of the detail of the first spatial audio (e.g., and/or additional or alternative spatial audio) in accordance with changes in a distance between the viewpoint of the user and the first location (e.g., and/or locations corresponding to the additional or alternative spatial audio). A function defining such changes in distance and/or detail optionally is determined by the computer system and/or obtained from another device that provides virtual content corresponding to the first spatial audio, such as a server or another computer system similar to the computer system providing an immersive spatial environment. In some embodiments, the function is defined such that the computer system changes the level of detail by a respective amount in response to detecting a unit of movement (e.g., a unit distance between the viewpoint of the user and the first location). As an example, the computer system optionally changes the level of detail by a magnitude that is linear function of a number of units of the movement changed between the viewpoint of the user and the first location. It is understood that a “unit of movement” such as a “unit distance” described herein optionally refers to a reference value that the computer system optionally uses to define an amount of movement relative to a coordinate system mapping virtual and/or physical aspects of the three-dimensional environment, optionally akin to magnitude of a unit vector in conventional physics and mathematical applications. As described further herein, the function defining the change in level of detail is optionally linear. For example, the computer system optionally changes level of detail by an amount in response to detecting the movement by the unit distance, independently of the distance between the viewpoint and the first location, and scales the amount of change in level of detail in accordance with number and/or proportion of unit distances moved relative to the three-dimensional environment. In response to detecting another movement of the viewpoint by the same unit distance toward or away from the first location, the computer system optionally changes the level of detail by the unit amount. In some embodiments, the function defining the change in level of detail is non-linear. For example the computer system optionally changes the level of detail by a first amount in response to detecting the change by the unit movement and in accordance with a determination that the distance between the viewpoint of the user and the first location is a first distance. In such an example, in accordance with a determination that the distance between the viewpoint of the user and the first location is a second, different distance, the computer system optionally changes the level of detail by a second amount, different from the first amount (e.g., greater than, or less than the first amount). Changing the level of detail gradually in accordance with changes in distance between the viewpoint of the user and a simulated spatial location corresponding to respective spatial audio provides gradual feedback about the user's spatial relationship with the simulated spatial location, thus improving the user's ability to adjust the spatial relationship while moving within the three-dimensional environment and improving the comfort of the user while moving within the three-dimensional environment.

In some embodiments, the movement of the viewpoint includes a first portion and a second portion, such as a first movement of the viewpoint of user 908 from as shown in FIG. 9A to as shown in FIG. 9B, and/or from as shown in FIG. 9B to as shown in FIG. 9C. In some embodiments, the computer system uses a non-linear function to define changes in level of detail as a function of changes in distance between the viewpoint of the user and the first simulated location corresponding to the first spatial audio. As an example, the computer system optionally uses quadratic function, logarithmic function, step function, exponential function, and/or some combination using one or more of such functions. Described an additional way, in response to detecting a change in viewpoint that changes a distance between the viewpoint of the user and the first location, the computer system optionally changes a level of detail by a respective amount per unit of movement, different than a scalar value (e.g., at a rate dependent upon the viewpoint-to-spatial audio location distance). In accordance with a determination that the distance between the viewpoint and the first location is a first distance from the viewpoint when the movement of the viewpoint is detected, the computer system optionally changes the level of detail in accordance with a first rate in response to detecting a unit distance traveled. In accordance with a determination that the distance between the viewpoint and the first location is a second distance from the viewpoint when the change in viewpoint is detected, the computer system optionally changes the level of detail in accordance with a second rate, different from (e.g., greater than or less than) the first rate in response to detecting the unit distance traveled. Additionally or alternatively, the computer system optionally changes the level of detail in accordance with a non-linear function that is not strictly based upon the distance between the viewpoint of the user and the first location. As an example, the first portion of the movement optionally includes a first magnitude of movement relative to the first location and the second portion of the movement optionally includes a second magnitude of movement (e.g., the same as the first magnitude) relative to the first location. In some embodiments, the first portion and/or the second portion of movement includes movement in a same direction, such as both increasing or both decreasing the distance between the viewpoint of the user and the simulated spatial location corresponding to the first spatial audio.

In some embodiments, in response to detecting the first portion of the movement, the computer system changes the level of detail from the first level of detail to a first respective level of detail, different from the first level of detail, at a first rate per unit movement during the first portion of the movement, such as a difference between the levels of detail of Sound A 1 934 and/or Sound A 2 936 (e.g., and/or some combination thereof) from as shown in FIG. 9A to FIG. 9B, the difference based upon a distance of viewpoint movement of the user 908 between FIGS. 9A and 9B. For example, the computer system optionally changes the level of detail by a first amount per unit of movement of the viewpoint relative to the three-dimensional environment in response to detecting a first change in distance between the viewpoint and the first location corresponding to the first spatial audio. Thus, the first rate optionally corresponds to the first amount of detail changed relative to a first one or more units of distance moved toward or away from the first location.

In some embodiments, in response to detecting the second portion of the movement, the computer system changes the level of detail from the first respective level of detail to a second respective level of detail, different from the first respective level of detail, at a second rate, different from the first rate, per unit movement during the second portion of the movement, such as a difference between the levels of detail of Sound A 1 934 and/or Sound A 2 936 (e.g., and/or some combination thereof) from as shown in FIG. 9B to FIG. 9C, the difference based upon a distance of viewpoint movement of the user 908 between FIGS. 9B and 9C. For example, the computer system optionally changes the level of detail by a second amount per unit of movement of the viewpoint relative to the three-dimensional environment in response to detecting a second change in distance between the viewpoint and the first location corresponding to the first spatial audio. In such an example, the second change in distance is optionally a same distance traveled and/or in a same direction as the first portion of the movement, optionally initiated from the ending of the first portion of the movement. Thus, the second rate optionally corresponds to the second amount of detail changed relative to the first one or more units of distance moved toward or away from the first location. Changing the level of detail in accordance with a non-linear function provides a distance-sensitive rate of change of detail of spatial audio per unit of movement of the viewpoint relative to the three-dimensional environment, thus suppressing the spatial audio rapidly and/or more gradually compared to a distance-insensitive rate of change, thereby reinforcing the user's spatial relationship relative to the spatial audio and improving the user's comfort while interacting with and/or moving relative to the three-dimensional environment.

In some embodiments, the movement of the viewpoint includes a first portion and a second portion, such as movement of the viewpoint of user 908 from as shown in FIG. 9A, to as shown in FIG. 9B, and/or subsequently to another location closer to spatial audio sources 904a and/or 904b than as shown in FIG. 9B. In some embodiments, the computer system uses a linear function to define changes in level of detail as a function of changes in distance between the viewpoint of the user and the first simulated location corresponding to the first spatial audio. Described an additional way, in response to detecting a change in viewpoint that changes a distance between the viewpoint of the user and the first location by a unit distance, the computer system optionally changes a level of detail a same amount, independently of the distance between the viewpoint and the first location when the change is initiated. For example, in response to detecting a change in the distance between the viewpoint and the first location corresponding to the first spatial audio, the computer system optionally changes the level of detail by an amount corresponding to the number of unit distance(s) traveled relative to a predetermined rate associated with the first spatial audio. Thus, in accordance with a determination that the distance between the viewpoint and the first location is a first distance or is a second distance when the change is initiated, the computer system changes the level of detail by a first amount per unit of movement of the viewpoint. In some embodiments, such a rate is different for different spatial audio sources (e.g., more rapid for some audio sources, more gradual for other audio sources, relative to a unit of movement).

In some embodiments, in response to the first portion of the movement, the computer system changes the level of detail from the first level of detail to a first respective level of detail, different from the first level of detail, based upon the first rate per unit of movement of the viewpoint, such as a difference between the levels of detail of Sound A 1 934 and/or Sound A 2 936 (e.g., and/or some combination thereof) from as shown in FIG. 9A to FIG. 9B, the difference based upon a distance of viewpoint movement of the user 908 between FIGS. 9A and 9B. For example, the respective rate during the first portion of the movement is a first rate of change in the level of detail.

In some embodiments, in response to the second portion of the movement, such as in response to a movement of the viewpoint of the user from as shown in FIG. 9B by a distance similar to or the same as shown from FIG. 9A to FIG. 9B, the computer system changes the level of detail from the first respective level of detail to a second respective level of detail, different from the first respective level of detail, based upon the first rate per unit of movement of the viewpoint, such as a change in level of detail that is determined based on a same rate of change per unit of movement as illustrated from FIG. 9A to FIG. 9B. Additionally or alternatively, the level of detail optionally changes from as shown from datapoint 958 to datapoint 952 as shown in FIG. 9F. For example, the respective rate during the first portion of the movement is the first rate of change in the level of detail. Changing the level of detail by a distance-insensitive rate in response to detecting distance between the viewpoint of the user and a simulated location corresponding to spatial audio indicates a distance traveled relative to the simulated location, thereby improving the user's comfort based upon an improved understanding of the user's spatial relationship with the spatial audio.

In some embodiments, while changing the level of detail of the first spatial audio, in accordance with a determination that the distance between the viewpoint of the user and the simulated spatial location is a first distance, the computer system changes the level of detail of the first spatial audio at a first rate per unit movement of the viewpoint, such as a rate (e.g., a slope) of change of the level of detail when a viewpoint of the user is a distance from a sound source between datapoint 950 and datapoint 960, as shown in FIG. 9F. For example, the computer system optionally changes the level of detail of the first spatial audio at a rate per unit of movement of the viewpoint corresponding to a distance between the viewpoint of the user and the location corresponding to the first spatial audio. In some embodiments, the rate of change per unit of movement of the viewpoint in the level of detail is relatively greater (e.g., or lesser) when the viewpoint of the user is a first distance away from the first location, as compared to the rate of change per unit of movement of the viewpoint in level of detail when the viewpoint of the user is a second distance, different away from the first location.

In some embodiments, while changing the level of detail of the first spatial audio, in accordance with a determination that the distance between the viewpoint of the user and the simulated spatial location is a second distance, different from the first distance, the computer system changes the level of detail of the first spatial audio at a second rate, different from the first rate, per unit movement of the viewpoint, such as a rate (e.g., a slope) of change of the level of detail when a viewpoint of the user is a distance from a sound source between datapoint 950 and datapoint 968, as shown in FIG. 9F. For example, the computer system optionally changes the level of detail in accordance with distance between the viewpoint of the user and the first simulated location, as described with reference to the non-linear function(s) and/or linear function(s) herein. Changing the level of detail in accordance with a function based upon the distance between the viewpoint of the user and the location corresponding to the spatial audio, thus providing feedback that the viewpoint of the user is quickly moving toward, or away from, such a location, thereby improving the user's understanding of the spatial relationship between the user's viewpoint and locations corresponding to spatial audio and improving the user's comfort while interacting with the three-dimensional environment.

In some embodiments, in response to detecting the movement of the viewpoint, and in accordance with a determination that one or more second criteria are satisfied, the computer system changes a volume of the first spatial audio, such as a change in volume similar to or the same as illustrated with respect to level of detail of Sound A 1 934 from as shown in FIG. 9A to FIG. 9B. For example, the computer system optionally changes the volume of the first spatial audio in accordance with the changes in the distance between the viewpoint of the user and the first location corresponding to the first spatial audio. As an example, the one or more second criteria optionally include one or more criteria similar to or the same as described with reference to method 1000. In some embodiments, in accordance with a determination that the second one or more criteria are not satisfied, the computer system forgoes changing of the volume of the first spatial audio. As described further herein, in such embodiments, the computer system optionally forgoes changing of the volume of the first spatial audio. In some embodiments, one or more characteristics of changing volume of the first spatial audio is similar to or the same as described with reference to changes in the level detail. For example, the computer system optionally increases the volume of the first spatial audio in response to detecting the viewpoint of the user decrease (e.g., or increase) the distance between the viewpoint and the first location corresponding to the first spatial audio. In some embodiments, conditions that trigger changing the volume and/or how the volume is changed is different from as described with reference to changes in the level of detail. Changing volume of the first spatial audio provides additional feedback about the user's spatial relationship relative to location(s) corresponding to spatial audio, thus guiding the user toward or away from portions of the three-dimensional environment and improving the comfort of the user while moving within the three-dimensional environment.

In some embodiments, the one or more second criteria include a criterion that is satisfied when a distance between the viewpoint and the first location is less than a threshold distance, such as a distance between the viewpoint of user 908 and spatial audio source 904b as shown in FIG. 9E, and changing the volume of the first spatial audio in accordance with the determination that the one or more second criteria are satisfied was at a first rate of change, greater than a second rate of change, associated with the one or more second criteria not being satisfied because the distance between the viewpoint and the first location is greater than the threshold, such as the rate of range of the level of detail of audio 914b from as shown in FIG. 9A to as shown in FIG. 9B. For example, the threshold distance is optionally different from, similar to, or the same as the first and/or second threshold distances described with reference to method 1000. As an example, the first location is optionally associated with a threshold distance having a value described with reference to the first threshold distance. In some embodiments, the computer system changes the rate at which volume changes in response to detecting viewpoint movement relative to the first location corresponding to the first spatial audio. As an example, the computer system optionally decreases the rate that volume is changed per unit of movement (e.g., increased or decreased) when the user's viewpoint moves beyond the threshold distance of the first spatial audio. As another example, the computer system decreases the volume of the first spatial audio at a slower rate per unit of movement of the viewpoint of the user as the user moves further away from the first location at a first distance from the first location (e.g., 0.5%, 1, 5%, 10%, 25%, 40%, 50%, or 60% change in level of detail per unit of movement), as compared to a quicker rate per unit of movement as the user moves further away from the first location at a second distance (e.g., 5%, 10%, 25%, 40%, 50%, 55%, 60%, or 70% change in level of detail per unit of movement). In some embodiments, the rate is based upon a distance between the viewpoint of the user and the first location corresponding to the first spatial audio. As an example, the rate at which the volume of the first spatial audio is changed per unit distance of viewpoint movement is optionally a respective first rate when the viewpoint of the user is a first distance away from the first location corresponding to the first spatial audio. In such an example, the rate that the first spatial audio is changed per unit distance of viewpoint movement is optionally a respective second rate when the viewpoint of the user is a second distance from the first location. In some embodiments, the first distance is greater (e.g., or less than) than the second distance, and the first rate is less than (e.g., or greater than) the second rate. In some embodiments, the computer system changes the volume at a same rate while the viewpoint of the user is within the threshold distance of the first location (e.g., forgoes changing of the rate and/or maintains the rate), and changes (e.g., increases or decreases) the rate in response to detecting movement beyond the threshold distance. Changing the rate at which volume is changed based upon a distance between the user's viewpoint and the first location preserves volume and/or audio fidelity of the first spatial audio when moving relatively far away from the first location, thus improving the user's awareness of a spatial relationship between the user's viewpoint and locations corresponding to spatial audio, thereby improving the user's comfort while moving relative to the three-dimensional environment.

In some embodiments, the second rate of change is a zero rate of change, such as a maintaining of level of detail of sounds included in audio 914b in response to detecting movement of the viewpoint of user 908 from as shown in FIG. 9E drawing closer toward audio 914b. For example, the computer system optionally ceases changing of (e.g., maintains) the volume of the first spatial audio when the viewpoint of the user is a respective threshold distance away from the first spatial audio. As an example, the computer system optionally establishes a near-field, and/or far-field distance thresholds relative to the first location. In some embodiments, in response to detecting movement of the viewpoint, and in accordance with a determination that the user viewpoint is within the near-field threshold distance and/or in accordance with a determination that the user viewpoint is beyond the far-field threshold distance (e.g., 0.005, 0.01, 0.05, 0.1, 0.25, 0.5, 0.75, 1, 1.25, 1.5, or 3 m, and 1, 2.5, 5, 7.5, 10, 15, 20, 25, 50, 75, or 100 m, respectively) relative to the first location corresponding to the first spatial audio, the computer system forgoes changing of the volume of the first spatial audio. A s an example, the rate of change per unit of movement is zero change. In some embodiments, when the viewpoint of the user moves to a distance that is between the near-field and far-field threshold, the computer system resumes changing of the volume of the first spatial audio in accordance with viewpoint movement. Ceasing changing of the volume of spatial audio ensures that the user is able to hear the spatial audio, and/or that the spatial audio remains at a level that is less than a threshold level to preserve the user's ability to hear other sounds as compared to the less spatially relevant spatial audio, thus improving the user's awareness of a spatial relationship between the user's viewpoint and the three-dimensional environment, thereby improving the user's comfort while moving relative to the three-dimensional environment.

In some embodiments, the one or more second criteria include a criterion that is satisfied when a distance between the viewpoint and the first location is greater than a threshold distance, such as a threshold distance originating from a location corresponding to spatial audio source 904c, the computer system changes the volume of the first spatial audio in accordance with the determination that the one or more second criteria are satisfied was at a first rate of change, greater than a second rate of change associated with the one or more second criteria not being satisfied because the distance between the viewpoint and the first location is less than the threshold, such as changing the level of detail of audio included in audio 914c from FIG. 9A to FIG. 9B, and maintaining of the level of detail of audio included in audio 914c from FIG. 9C to FIG. 9D. For example, the threshold distance is optionally different from, similar to, or the same as the first and/or second threshold distances described with reference to method 1000. As an example, the first location is optionally associated with a threshold distance having a value described with reference to the first threshold distance. In some embodiments, the threshold distance is a near-field threshold, as described further herein. In some embodiments, the computer system decreases the rate at which volume is changed (e.g., increased or decreased) per unit of movement of the viewpoint as the viewpoint of the user moves closer to the location corresponding to the spatial audio, and/or after the viewpoint crosses to within the near-field threshold distance of the location corresponding to the spatial audio.

In some embodiments, the computer system changes the rate per unit of movement at which volume is changed in response to detecting viewpoint movement relative to the first location corresponding to the first spatial audio, such as illustrated by the slopes of curves as shown in FIG. 9F. As an example, the computer system optionally increases or decreases the volume at the first rate per unit of movement until crossing within the threshold distance of the first spatial audio, and optionally increases or decreases the volume at the second rate per unit of movement (e.g., or forgoes decreasing or increasing of the volume) after crossing within the near-field threshold distance of the first spatial audio. As another example, the computer system optionally increases the volume of the first spatial audio at a slower rate per unit of movement of the viewpoint as the user moves closer toward the first location at a first distance from the first location, as compared to increasing the volume at a quicker rate per unit of movement as the user moves toward the first spatial audio from a second distance, further from the first location than the first distance. In some embodiments, the rate is based upon a distance between the viewpoint of the user and the first location corresponding to the first spatial audio. As an example, the rate at which the volume of the first spatial audio is changed per unit distance of viewpoint movement is optionally a respective first rate when the viewpoint of the user is a first distance away from the first location corresponding to the first spatial audio. In such an example, the rate that the first spatial audio is changed per unit distance of viewpoint movement is optionally a respective second rate when the viewpoint of the user is a second distance from the first location. In some embodiments, the first distance is greater than the second distance, and the first rate is greater than the second rate. In some embodiments, the computer system changes the volume at a same rate while the viewpoint of the user is within the threshold distance of the first location (e.g., forgoes changing of the rate and/or maintains the rate), and changes (e.g., increases or decreases) the rate in response to detecting movement beyond the threshold distance. Changing the rate at which volume is changed based upon a distance between the user's viewpoint and the first location reduces the likelihood that the spatially relevant first spatial audio is obscured by other, less spatially relevant audio and improving the comfort of the user while moving within the three-dimensional environment.

In some embodiments, the second rate of change is a zero rate of change, such as the maintaining of level of detail of Sound C3 946 from as shown in FIG. 9D to FIG. 9E. As described further herein, the computer system optionally establishes a near-field and/or far-field threshold relative to the first location corresponding to the first spatial audio, and optionally forgoes (e.g., ceases) changing of the volume of the first spatial audio when within the near-field threshold (e.g., and/or beyond the far-field threshold). For example, the computer system optionally maintains a volume of the first spatial audio at a 100% level when the viewpoint is within the near-field threshold distance of the location corresponding to the first spatial audio, and optionally maintains volume of the first spatial audio at a 0%, or near 0% level when moving beyond the far field threshold of the location corresponding to the first spatial audio. Ceasing changing of the volume of spatial audio ensures that the user is able to hear the spatial audio, and/or that the spatial audio remains at a level that is above a threshold level to preserve the user's ability to hear the first spatial audio as compared to less spatially relevant spatial audio, thus improving the user's awareness of a spatial relationship between the user's viewpoint and the locations corresponding to spatial audio, thereby improving the user's comfort while moving within the three-dimensional environment.

In some embodiments, while the three-dimensional environment is visible via the display generation component, while the viewpoint of the user is the first viewpoint of the user relative to the three-dimensional environment, such as the viewpoint of user 908 relative to three-dimensional environment 900 as shown in FIG. 9A, and while presenting the first spatial audio with the simulated spatial location that corresponds to the first location within the three-dimensional environment and at the first level of detail, such as the location of spatial audio source 904b as shown in FIG. 9A, the computer system detects an event corresponding to a change in a level of immersion of virtual content included in the three-dimensional environment, such as a voice input and/or a turning of a crown button included in computer system 101. For example, virtual content associated with a three-dimensional environment and display of such virtual content such as displaying an environment with a level of immersion is described further with reference to at least method 1200. In some embodiments, the computer system detects one or more inputs and/or one or more events (e.g., indications of inputs from other computer systems) requesting changing of a level of immersion of the virtual content associated with the three-dimensional environment, as described with reference to method 1200. In such embodiments, the computer system is able to change or forgo changing (e.g., maintaining) of the level of detail of the first spatial audio described with reference to method 1000.

In some embodiments, in response to detecting the event corresponding to the change in the level of immersion of virtual content included in the three-dimensional environment, the computer system displays, via the display generation component, the virtual content with an updated level of immersion relative to the three-dimensional environment based on the event, such as decreasing the level of immersion of virtual portions of an environment included in three-dimensional environment 900, different from as shown in FIG. 9A. For example, as described further with reference to method 1200.

In some embodiments, while changing the level of detail of the first spatial audio, the computer system forgoes changing of the level of detail of the first spatial audio, such as forgoing the change of (e.g., maintaining the) level of detail of Sound A 1 934. For example, the computer system optionally maintains the level of detail, including audio fidelity of one or more sounds included in the first spatial audio, frequency characteristic(s) of the first spatial audio, and/or the rate at which such sounds are presented in response to detecting the one or more inputs and/or events described herein. In some embodiments, the computer system moves the location corresponding to the first spatial audio to a respective location, as described with reference to method 1200, while concurrently maintaining the level of detail of the first spatial audio. Preserving a level of detail of spatial audio in response to detecting changes in the level of immersion preserves the user's sense of their spatial relationship relative to virtual content included in the three-dimensional environment, thus providing feedback of their spatial relationship when the virtual content is displayed at a level of immersion less than a threshold level of immersion, such as when the virtual content consumes a modest percentage of the viewport of the computer system, and improving the user's comfort while interacting with the three-dimensional environment.

In some embodiments, while the three-dimensional environment is visible via the display generation component, while the viewpoint of the user is the first viewpoint of the user relative to the three-dimensional environment, and while presenting second spatial audio at a third level of detail and with a simulated spatial location that corresponds to a second location within the three-dimensional environment, such as while three-dimensional environment 900 is visible and generating audio corresponding to spatial audio source 904c, the computer system detects, via the one or more input devices, respective movement of the viewpoint of the user changing a distance between the viewpoint of the user and the second location, such as movement of the viewpoint of user 908 from as shown in FIG. 9A to as shown in FIG. 9B. For example, as described with reference to method 1000, the computer system optionally controls a level of detail of a plurality of spatial audio sources. For example, the second spatial audio optionally has one or more characteristics similar to or the same as the first spatial audio, the third level of detail optionally has one or more characteristics similar to or the same as the first and/or second levels of detail, the location corresponding to the second spatial audio optionally has one or more characteristics similar to or the same as the location corresponding to the first spatial audio, and/or the second location optionally has one or more characteristics similar to or the same as the first location. In some embodiments, the second spatial audio is presented concurrently with the first spatial audio. In some embodiments, the respective movement of the viewpoint of the user is similar to, or the same as the movement of the viewpoint of the user described with reference to method 1000. It is understood that the movement of the viewpoint optionally changes a distance between the second spatial audio source and does not change a distance between the viewpoint and the first spatial audio source. In such embodiments, the computer system optionally forgoes changing of the level of detail of the first spatial audio source (e.g., maintains the level of detail), and optionally changes the level of detail of the second spatial audio source. In such embodiments, the computer system optionally additionally or alternatively changes the level of detail of the first spatial audio (e.g., optionally concurrent with changing the level of detail of the second spatial audio) in accordance with changes in distance between the simulated spatial location corresponding to the first spatial audio and the viewpoint of the user.

In some embodiments, in response to detecting the respective movement of the viewpoint, and in accordance with a determination that one or more second criteria are satisfied, including a criterion that is satisfied when the movement of the viewpoint changes a distance between the viewpoint of the user and the simulated spatial location that corresponds to the second location within the three-dimensional environment, such as the change in distance between the location corresponding to spatial audio source 904c and the viewpoint of user 908 from FIG. 9A to FIG. 9B, the computer system changes a level of detail of the second spatial audio from the third level of detail to a fourth level of detail, different from the third level of detail, such as the level of detail of sounds included in audio 914c, including changes to Sound C1 942, from FIG. 9A to FIG. 9B. For example, the one or more second criteria are similar to, or the same as the one or more criteria described with reference to method 1000. For example, the computer system optionally changes the level of detail of the first and/or the second spatial audio in response detecting the viewpoint of the user move relative to the three-dimensional environment. The fourth level of detail optionally has one or more characteristics similar to or the same as the other levels of detail described herein. For example, the difference of level of detail between the third and the fourth levels of detail is optionally similar to or the same as the difference of level of detail between the first and the second levels of detail described with reference to method 1000. Additionally or alternatively, the rates of change of the levels of detail of the second spatial audio are optionally similar to or the same as the rates of change of the levels of detail of the first spatial audio. The difference of levels of detail optionally further include different levels of volume, different magnitudes of audio effects (e.g., reverberation, muffling, filtering, and/or some combination thereof), and/or different distributions of magnitudes of sound frequency. Thus, the computer system optionally changes the level of detail of a plurality of spatial audio sources when the viewpoint of the user moves relative to the three-dimensional environment, changing a distance between such spatial audio sources. Changing the level of detail of the second spatial audio reinforces the feedback provided by changes in detail of the first spatial audio, thus reducing the likelihood the viewpoint moves erroneously relative to the three-dimensional environment, thereby reducing power consumption required to process the erroneous movement and improving the user's comfort while moving within the three-dimensional environment.

In some embodiments, changing the level of detail of the first spatial audio is performed in a first manner in accordance with the movement of the viewpoint, such as the changing of level of detail of sounds included in audio 914a from as shown in FIG. 9A to as shown in FIG. 9B.

In some embodiments, changing the level of detail of the second spatial audio is performed in a second manner, different from the first manner, in accordance with the movement of the viewpoint, such as changing of level of detail of sounds included in audio 914c from as shown in FIG. 9A to as shown in FIG. 9B. For example, the computer system optionally changes the level of detail of the first spatial audio by a first amount (e.g., the first manner) and optionally changes the level of detail of the second spatial audio by a second amount (e.g., the second manner). In some embodiments, the respective amounts are different from each other (e.g., greater or lesser than each other) in response to a same detected movement of the viewpoint. For example, both levels of detail optionally increase, decrease, one increases while the other decreases (e.g., or vice-versa), and/or some combination of such changes based upon the distance between the viewpoint and the corresponding spatial audio source.

In some embodiments, the rate of change of the level of detail and/or a function defining changes in the rate of change is different for a plurality of spatial audio sources, such as spatial audio sources 904a-c as shown from FIG. 9A through FIG. 9E. For example, when the viewpoint of the user moves a unit distance toward the first spatial audio source, the computer system optionally changes the level of detail by a first amount. In such an example, when the viewpoint of the user moves the unit distance toward the second spatial audio source, the computer system optionally changes the level of detail by a second amount, different from the first. In this example, the viewpoint is optionally a respective distance away from the first location corresponding to the first spatial audio, and is optionally the respective distance away from the second location corresponding to the second spatial audio. Thus, the computer system optionally changes levels of detail of the first and second spatial audio sources differently in response to a similar or same change in the user's viewpoint relative to a respective location that corresponds to respective spatial audio. Therefore, functions and/or curves defining the amount of detail change per unit distance changed for each spatial audio source is optionally different from each other. Additionally or alternatively, the rate of change of level of detail and/or the function defining changes in the rate of change associated with respective spatial audio sources optionally include different maximum and/or minimum values (e.g., maximized when within the near-field threshold and/or minimized when beyond the far-field threshold relative to a respective audio source). In some embodiments, a given function corresponding to a spatial audio source includes one or more inflection points, including a change in concavity of the given function at a level of detail different from one or more inflection points associated with a different function that corresponds to a different spatial audio source. Additionally or alternatively, the slope and/or rate of change of a series of tangent lines intersecting the function optionally are different (e.g., greater or lesser in value) for different functions corresponding to different spatial audio sources. In some embodiments, the first and/or second spatial audio are each associated with different linear or non-linear functions (e.g., described further herein with reference to gradually changing the level of detail per unit of movement of the viewpoint) between level of detail and changes in the distance between the viewpoint and the corresponding locations associated with respective spatial audio. For example, the first spatial audio source optionally increases level of detail exponentially per unit distance moved, and the second spatial audio source optionally increases level of detail linearly per unit distance moved. It is appreciated that in some embodiments, a plurality of audio sources share a same function and/or curve defining the amount of detail change per unit distance changed. Determining different rates and/or functions defining rates of change in level of detail for different spatial audio sources allows the computer system to increase or decrease detail based upon importance of the spatial audio as it relates to realism of the three-dimensional environment, and/or provides feedback that the user's viewpoint will approach a region of the three-dimensional environment that is more or less relevant to their interests, and additionally improves the user's comfort while moving relative to the three-dimensional environment.

It should be understood that the particular order in which the operations in method 1000 have been described is merely exemplary and is not intended to indicate that the described order is the only order in which the operations could be performed. One of ordinary skill in the art would recognize various ways to reorder the operations described herein.

FIG. 11A shows an example of a computer system 101 detecting and responding to an input directed to a user interface element 1110 corresponding to a virtual environment, in accordance with some embodiments. FIGS. 11B through 11Y generally illustrate examples of a computer system 101 displaying a virtual environment 1114 at different levels of immersion and presenting different audio components associated with the virtual environment 1114, and further illustrates examples of the computer system changing levels of audio of the audio components in response to requests to change the level of immersion of the virtual environment 1114, in accordance with some embodiments. In some embodiments, in response to detecting the input directed to the user interface element 1110 illustrated in FIG. 11A, the computer system 101 initiates a process to display a virtual environment at a specific level of immersion. In some embodiments, the computer system 101 initiates a process to display a virtual environment at a specific level of immersion in response to an input different from the input directed to the user interface element 1110 illustrated in FIG. 11A.

FIG. 11A illustrates a computer system 101 (e.g., an electronic device) displaying, via a display generation component (e.g., display generation component 120 of FIG. 1A), a three-dimensional environment 1100 from a viewpoint of a user 1108 (e.g., facing the back wall of the physical environment in which computer system 101 is located). In some embodiments, computer system 101 includes a display generation component (e.g., a touch screen) and a plurality of image sensors (e.g., image sensors 314 of FIG. 3). The image sensors optionally include one or more of a visible light camera, an infrared camera, a depth sensor, or any other sensor the computer system 101 would be able to use to capture one or more images of a user or a part of the user (e.g., one or more hands of the user) while the user interacts with the computer system 101. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user), and/or attention (e.g., based on gaze) of the user (e.g., internal sensors facing inwards towards the face of the user).

In some embodiments, computer system 101 captures one or more images of the physical environment around computer system 101 (e.g., operating environment 100), including one or more objects in the physical environment of computer system 101. In some embodiments, computer system 101 displays representations of the physical environment in three-dimensional environment 1100. For example, display generation component 120 includes display and/or presentation of physical plant 1106, which corresponds to a physical plant in the real-world physical environment.

For the purpose of illustration, FIG. 11A includes a top-down view 1112a of the three-dimensional environment 1100 that indicates the positions of various objects in the three-dimensional environment 1100 in a horizontal dimension and a depth dimension. Additionally, FIG. 11A includes a view of the three-dimensional environment 1100 through display generation component 120 that indicates the positions of various objects in the three-dimensional environment 1100 in a horizontal dimension and a vertical dimension. The top-down view of the three-dimensional environment 1100 further includes an indication of the viewpoint of the user 1108 of the computer system 101. For example, the computer system 101 displays the view of the three-dimensional environment 1100 visible through the display generation component 120 from the viewpoint of the user 1108 illustrated in the top-down view 1112a of the three-dimensional environment 1100.

In FIG. 11A, the computer system 101 displays user interface 1102 and user interface 1103. User interface 1102 is optionally a user interface of an application. For example, user interface 1102 is optionally a user interface of a movie application, a gaming application, web-browsing application containing website content, such as text, images, video, hyperlinks, and/or audio content, from the website, or a user interface of an audio and/or video playback application. U ser interface 1103 includes a plurality of selectable options corresponding to different virtual environments that are selectable by the user. It should be understood that the user interfaces and content discussed above is exemplary and that in some embodiments, additional and/or alternative content and/or user interfaces may be displayed by the computer system 101, such as the content described below with reference to method 1200.

In FIG. 11A, gaze 1134a of the user 1108 is directed to a user interface element 1110 of the user interface 1103. User interface element 1110 corresponds to a virtual environment, namely to a virtual simulation of location “Mt. Hood”. In response to detecting that hand 1119 of the user is performing an air gesture (e.g., such as an air pinch) while gaze 1134a of the user 1108 is directed to user interface element 1110, the computer system 101 optionally initiates presentation of the virtual environment that corresponds to the selection, which is a virtual environment simulating Mt. Hood, Oregon, USA.

FIGS. 11B through 11Y generally illustrate examples of a computer system displaying a virtual environment 1114 at different levels of immersion and presenting different audio components associated with the virtual environment 1114, and further illustrates examples of the computer system changing levels of audio of the audio components in response to requests to change the level of immersion of the virtual environment 1114 in accordance with some embodiments. It should be noted that various levels of immersion (e.g., and optionally the corresponding audio behaviors) illustrated and described herein with reference to FIGS. 11B through 11X are optionally transitory between different steady-state levels of immersion and/or transitory to a steady-state level of immersion. For example, the indicated immersion level of FIG. 11B (e.g., which is 1% as indicated by sign 1116b, which would correspond to the virtual environment 1114 occupying 2.7 degrees (e.g., of a 360-degree field of view) if full immersion is 270 degrees (e.g., of a 360-degree field of view) or would correspond to the virtual environment 1114 occupying 3.6 degrees (e.g., of a 360-degree field of view) if full immersion is 360 degrees (e.g., of a 360-degree field of view)) is optionally a transitory immersion level of the virtual environment 1114 and the indicated immersion level in FIG. 11B is optionally a steady-state level of immersion such that in response to the input directed toward the user interface element 1110 described in FIG. 11A, the computer system 101 automatically progresses the immersion level of the virtual environment 1114 through the indicated immersion level in FIG. 11B to get to the immersion level indicated in FIG. 11I (e.g., which is 25% as indicated by sign 1116i), without an additional input. As another example, the virtual environment 1114 occupying 30 degrees (e.g., of a 360-degree field of view) is optionally the virtual environment at the minimum level of immersion, the virtual environment 1114 occupying 90-120 degrees (e.g., of a 360-degree field of view) is optionally the virtual environment at a medium level of immersion, and the virtual environment 1114 occupying 180-360 degrees (e.g., of a 360-degree field of view) is optionally the virtual environment 1114 at a high level of immersion. Continuing with this example, in response to input corresponding to a request to increase the level of immersion of virtual environment 1114 from the minimum level of immersion (e.g., 30 degrees) to 100 degrees (e.g., a medium level of immersion), the computer system 101 optionally automatically visually progresses the immersion level of the virtual environment 1114 through the intermediate and/or transitory levels of immersion in between 30 degrees (e.g., the minimum level of immersion) and 100 degrees (e.g., in between 30-100 degrees) to get to virtual environment 1114 occupying 100 degrees (e.g., of a 360-degree field of view). Further, various immersions levels of immersion (e.g., and optionally the corresponding audio behaviors) illustrated and described herein with reference to FIGS. 11B through 11X are optionally transitory between different steady-state level of immersion independent of a direction of immersion level change (e.g., increase or decrease). In some embodiments, one or more of the illustrated immersion levels are intermediate or transitory and one or more of the illustrated immersion levels are steady-state level immersion levels.

FIGS. 11B through 11Y are described further with reference to method 1200. For the purpose of illustration, FIGS. 11B through 11Y include top-down views 1112b through 1112y of the three-dimensional environment 1100 that indicate the positions of various objects and audio components in the three-dimensional environment 1100 in a horizontal dimension and a depth dimension, respectively. Additionally, FIGS. 11B through 11Y include a view of the three-dimensional environment 1100 through display generation component 120 that indicates the positions of various objects in the three-dimensional environment 1100, including of the virtual environment 1114, in a horizontal dimension and a vertical dimension relative to the viewpoint of the user 1108n in the respective figure. The top-down views 1112b through 1112y of the three-dimensional environment 1100 includes an indication of the viewpoint of the user 1108 of the computer system 101 in the respective figure. For example, in the respective figure, the computer system 101 displays the view of the three-dimensional environment 1100 visible through the display generation component 120 from the viewpoint of the user 1108 illustrated in the top-down view of the three-dimensional environment 1100. In FIGS. 11B through 11Y, each of top-down views 1112b through 1112y of the three-dimensional environment 1100 includes reference lines 0, 15, 20, 15, 50, and 75. These reference lines correspond to the locations of the lateral boundaries of a virtual environment 1114 at the respective level of immersion (e.g., the respective percentages of full immersion) and are provided as examples. An immersion level optionally corresponds to an amount of space that is or would be consumed by the virtual environment 1114 relative to a position of user of the computer system and optionally provided that the user is facing the virtual environment 1114 (e.g., provided that the viewpoint of the user includes the virtual environment 1114). Changing an immersion level of a virtual environment 1114 optionally includes changing the amount of space that is or would be consumed by the virtual environment 1114. Further, changing an immersion level of virtual environment 1114 optionally includes moving (e.g., enlarging or contracting) boundaries of virtual environment 1114. For example, as shown in FIG. 11D, when the virtual environment is at 15% immersion (e.g., which would optionally correspond to the virtual environment 1114 occupying 40.5 degrees (e.g., of a 360 degree field of view) if full immersion is 270 degrees (e.g., of a 360-degree field of view) or would optionally correspond to the virtual environment 1114 occupying 54 degrees (e.g., of a 360-degree field of view) if full immersion is 360 degrees), virtual environment 1114 is bounded (e.g., edged) at (e.g., between) reference lines 15 in the top down 1112d, and as shown in FIG. 11H, when the virtual environment 1114 is at 20% immersion (e.g., which would optionally correspond to the virtual environment 1114 occupying 54 degrees (e.g., of a 360-degree field of view) if full immersion is 270 degrees (e.g., of a 360-degree field of view) or would optionally correspond to the virtual environment 1114 occupying 72 degrees (e.g., of a 360-degree field of view) if full immersion is 360 degrees), virtual environment 1114 is 1114 is bounded (e.g., edged) at (e.g., between) references line 20 in the top down 1112h. In FIG. 11B, virtual environment 1114 is at 1% immersion (e.g., which would optionally correspond to the virtual environment 1114 occupying 2.7 degrees (e.g., of a 360-degree field of view) if full immersion is 270 degrees (e.g., of a 360-degree field of view) or would optionally correspond to the virtual environment 1114 occupying 3.6 degrees (e.g., of a 360-degree field of view) if full immersion is 360 degrees), so the edges of virtual environment 1114 in top-down view 1112b are at their respective illustrated positions in between the 0 and 15 reference lines. Immersion levels are further described with reference to method 1200.

Referring back to the example of FIG. 11A, in response to receiving a selection of user interface element 1110, computer system 101 displays a virtual environment 1114 as illustrated in FIG. 11B. It should be noted that computer system 101 can display the virtual environment 1114 at any level of immersion in response to detecting the input of FIG. 11A. For example, in response to the input of FIG. 11A, the computer system 101 optionally displays the virtual environment at 20%, 25%, 40%, 50%, 60%, 75%, 80% of full immersion, or another level of immersion. In some embodiments, in response to detecting the input of FIG. 11A, the computer system 101 displays the virtual environment 1114 at its minimum level of immersion. In some embodiments, in response to detecting the input of FIG. 11A, the computer system 101 displays the virtual environment 1114 at its maximum level of immersion. In some embodiments, in response to detecting the input of FIG. 11A, the computer system 101 displays the virtual environment 1114 at a level that is in between its minimum and maximum levels of immersion. It should also be noted that computer system 101 can display virtual environment 1114 in response to an interaction, trigger, or request detected based on user interaction with user interface 1102. For example, user interface 1102 is optionally a movie playback user interface, and when computer system 101 detects a request to initiate playback of a movie on user interface 1102, the computer system 101 optionally displays virtual environment 1114. FIG. 11B illustrates an example of a computer system displaying a virtual environment 1114 at a level of immersion and presenting different audio components associated with the virtual environment in accordance with some embodiments.

In FIG. 11B, the computer system displays virtual environment 1114 at 1% immersion level and displays user interface 1102 (e.g., since at 1% immersion, virtual environment 1114 does not obscure user interface 1102). In addition, plant 1106 is visible via the display generation component 120. Virtual environment 1114 optionally corresponds to the virtual environment selected by the user in FIG. 11A. FIG. 11B includes sign 1116b indicating that a level of immersion of the virtual environment 1114 in FIG. 11B is 1% of full immersion of the virtual environment 1114 (e.g., virtual environment 1114 occupying 2.7 degrees (e.g., of a 360-degree field of view) if full immersion is 270 degrees (e.g., of a 360-degree field of view) or occupying 3.6 degrees (e.g., of a 360-degree field of view) if full immersion is 360 degrees). Throughout FIGS. 11B through 11Y, signs 1116b through 1116y are provided to indicate the level of immersion of the virtual environment 1114 in the respective figure. It should be noted that the illustrated percentages are provided as examples and are nonlimiting. In FIG. 11B, virtual environment 1114 is at 1% immersion, so the edges of virtual environment 1114 in top-down view 1112b are at their respective illustrated positions in between the 0 and 15 reference lines. In addition, as shown in both top-down view 1112b and display generation component 120 in FIG. 11B, user interface 1102 and plant 1106, are outside of the virtual environment 1114. As such, in FIG. 11B, the user 1108 can optionally observe both the physical environment and the virtual environment 1114 in the viewpoint of the user.

In FIG. 11B, virtual environment 1114 is displayed at a particular three-dimensional location (e.g., having a range of X, Y, and Z coordinates) relative to the physical environment of the user. In some embodiments, the location at which virtual environment 1114 is displayed is based on the viewpoint of the user when the request to display the virtual environment 1114 is received. For example, if the viewpoint of the user 1108 is a first viewpoint when the request is received, the location at which virtual environment 1114 is displayed is a first location, and when the viewpoint of the user is a second viewpoint, different from the first viewpoint, when the request is received, the location at which virtual environment 1114 is displayed is a second location, different from the first location.

In some embodiments, virtual environment 1114 includes one or more (e.g., or all of) audio components 1130a through 1130l. For example, the computer system 101 optionally presents ambient sounds and/or point sources of audio that correspond to the location to which the virtual environment 1114 corresponds. Since virtual environment 1114 corresponds to a virtual simulation of Mt. Hood (e.g., Mt. Hood, Oregon, USA), the audio components optionally include sounds of winds, water motion down a cliff of a mountain, bugs, birds, and/or other sounds typical of Mt. Hood, optionally based on the season at which virtual environment 1114 is simulating at Mt. Hood, and the computer system optionally presents these various sounds at different levels of audio based on the immersion level of virtual environment 1114. Audio components associated with a virtual environment are further described with reference to method 1200.

FIG. 11B includes schematic 1118b indicating the absolute and/or relative volume levels of audio components 1130a through 1130l of the virtual environment 1114. For example, in schematic 1118b in FIG. 11B, audio components 1130a through 1130c, 1130f, 1130h, 1130j, and 1130k of virtual environment 1114 are not being presented while audio components 1130d, 1130e, 1130g, 1130i, and 1130l of virtual environment 1114 are being presented. Throughout FIGS. 11B through 11Y, signs 1116b through 1116y indicate the level of immersion of the virtual environment in the respective figure and schematics 1118b through 1118y indicate the relative audio levels of audio components 1130a through 1130l of the virtual environment 1114 in the respective figure. Also, throughout FIGS. 11B through 11Y, in any of schematics 1118b through 1118y, a volume level indicator is illustrated relative to a minimum volume level (e.g., a mute level, such as shown by the volume level indicator of audio components 1130a indicating that the volume level of audio components 1130a through 1130c being mute in schematic 1118b in FIG. 11B) and a maximum volume level for audio component, such as shown by the volume level of audio component 1130d in schematic 1118b in FIG. 11B. In some embodiments, the maximum volume level for a first component is optionally different in loudness than a maximum volume level for a second component. For example, the computer system optionally displays a virtual environment optionally corresponds to a view that is close to a waterfall (e.g., within 2 meters at the location where the water from the waterfall reaches a pool of water) and optionally presents a first audio component that corresponds to a sound of the waterfall and a second audio component optionally corresponds to chirping of birds that are further away from the viewpoint of the user than the location of the waterfall. Continuing with this example, when the computer system presents the audio components at their maximum volume level, such as illustrated with schematic 1118b show the volume level of audio component 1130i and 1130g being at their respective maximum volume level), the sound sourcing from the stimulated waterfall is optionally louder than the sound of the chirping of the birds, optionally simulating that a user who is at a large waterfall would hear the waterfall overwhelmingly louder than the sound of birds chirping further away from the waterfall. In some embodiments, computer system 101 allows the user to control (e.g., set or change (e.g., increase or decrease)) a total volume level of the virtual environment 1114, which would optionally result in a changing of the total volume level of the virtual environment 1114 while maintaining the relative volume levels of the respective audio components of virtual environment 1114.

In FIG. 11B, top-down view 1112b shows audio components 1130a through 1130l associated with virtual environment 1114. In a respective top-down view (e.g., top-down view 1112b), when an audio component is represented as a hollow circle, such as audio components 1130a through 1130c in top-down view 1112b, the computer system 101 is not presenting the audio component; when an audio component is represented as a solid circle, such as audio components 1130d/1130e in top-down view 1112b, the computer system is presenting the audio component (e.g., the audio is perceptible to the user); when an audio component is represented as a circle that is pattern-filled, such as audio component 1130d, the computer system is presenting the audio component at a volume level lower than a maximum level for the audio component and/or the audio component itself is an intermittent audio component (e.g., an audio source that turns off and then comes back on after a period of time). In FIG. 11B, top-down view 1112b also includes audio component 1132 associated with user interface 1102. Audio component 1132 is optionally being presented or not based on user interaction with the user interface 1102. For example, audio component 1132 optionally corresponds to audio of a movie being played on user interface 1102, and in FIG. 11A, the movie is not playing and the audio component 1132 is not being presented, and in FIG. 11B (e.g., and/or FIGS. 11C through 11Y), the movie is playing and the audio component 1132 is being presented.

It should be noted that throughout the present discussion with reference to FIGS. 11B through 11Y some audio components are discussed (e.g., and/or illustrated) as having certain locations (e.g., relative to the viewpoint of the user 1108 and/or relative to the virtual environment 1114). It should be noted that a location of an audio component (e.g., a spatial audio component) is optionally a simulated spatial location by which the computer system presents the audio component. For example, if the location of a first audio component is a first location (e.g., relative to a reference in the physical environment of the user), the computer system optionally presents the first audio component as if the sound of the first audio component is emanating (e.g., sourcing) from the first location, and if the location of the first audio component is a second location (e.g., relative to the reference in the physical environment of the user), different from the first location, the computer system optionally presents the first audio component as if the sound of the first audio component is emanating (e.g., sourcing) from the second location.

Audio components 1130a through 1130l optionally have different behaviors and/or the computer system 101 optionally treats (e.g., presents) different sets of one or more audio components differently. For example, audio components 1130a through 1130c are initially presented and move when the immersion level of the virtual environment 1114 is at the respective reference line of the virtual environment in top-down view 1112b that intersects with the respective audio component 1130a through 1130c, respectively. Audio components 1130a through 1130c each move along a predefined curved dotted line path (e.g., shown in top-down view 1112b). These paths correspond to movement trajectories of the respective audio components under certain conditions that will be discussed further herein.

As another example, audio components 1130d and 1130g are presented when the immersion level of the virtual environment 1114 is below a threshold immersion level. For example, the threshold immersion level of audio components 1130h and 1130k is 50% (e.g., virtual environment 1114 occupying 135 degrees (e.g., of a 360-degree field of view) if full immersion is 270 degrees (e.g., of a 360-degree field of view) or occupying 180 degrees (e.g., of a 360-degree field of view) if full immersion is 360 degrees), and since the current immersion level is below 50% in FIG. 11B, audio components 1130d and 1130g are presented in the example of FIG. 11B. Likewise, audio components 1130h and 1130k are presented when the immersion level of the virtual environment 1114 is at or above a threshold immersion level. For example, the threshold immersion level for audio components 1130h and 1130k is 75%, and since the current immersion level is below 75% in FIG. 11B, audio components 1130h and 1130k are not being presented in FIG. 11B. It should be noted that the threshold immersion levels described herein are provided by way of example. More details regarding audio components 1130d, 1130g, 1130h, 1130k will be described further herein.

As another example, audio component 1130l is presented independent of the immersion level and is adjusted in gain based on immersion level. In some embodiments, audio component 1130l is representative of ambient sounds of the virtual environment 1114. In some embodiments, the computer system 101 presents or forgoes presenting audio component 1130l based on the immersion level of the virtual environment 1114. Ambient sounds are further described with reference to method 1200.

As another example, audio component 1130e is presented when the location of the audio component 1130e is inside of the virtual environment 1114. For example, as shown in FIG. 11B, in top-down view 1112b, audio component 1130e is inside the virtual environment 1114; as such, computer system 101 presents audio component 1130e in FIG. 11B. If audio component 1130e was outside of the virtual environment 1114 in FIG. 11B, then the computer system 101 would not present audio component 1130e in FIG. 11B. Thus, in some embodiments, the computer system 101 presents audio components based on their locations relative to a location of virtual environment 1114. As such, some audio components of the computer system can be presented based on their locations relative to a location of virtual environment 1114.

As another example, audio components 1130i and 130j each are audio components that are configured to indicate that the virtual environment 1114 is at a particular level of immersion. For example, the computer system presents audio component 1130i when the level of immersion of virtual environment 1114 is a minimum level of immersion (e.g., 1% immersion), and the computer system 101 presents audio component 1130j when the level of immersion of virtual environment 1114 is a maximum level of immersion (e.g., 100% immersion). In FIG. 11B, the level of immersion of the virtual environment is optionally a minimum level of immersion of virtual environment 1114; as such, the computer system 101 presents audio component 1130i in FIG. 11B, without presenting audio component 1130j. It should be noted that a minimum level of immersion of a virtual environment can be any percentage less than 100% (e.g., 5%, 20%, 40%, 50%, or another minimum level of immersion). Respective audio components that indicate that the virtual environment is at a particular level of immersion are described further reference to method 1200.

As another example, audio component 1130f is presented when the current immersion level of the virtual environment is an immersion level of a set of one or more immersion levels. The audio component 1130f is optionally associated with the set of one or more immersion levels. For example, when the virtual environment 1114 is at an immersion level of the set of one or more immersion levels, the computer system 101 presents the audio component 1130f, and when the virtual environment 1114 is not an immersion level that is within the set of one or more immersion levels, the computer system 101 does not present the audio component 1130f. Additionally, the computer system 101 optionally moves audio component 1130f independent of whether it is being presented or not. For example, audio component 1130f optionally follows a path (e.g., a trajectory, such as a linear or circular trajectory, or another type of trajectory). For example, audio component 1130f optionally corresponds to a wind sound of the virtual environment 1114 moving around the user and is enabled or disabled in presentation based on the current immersion level. As another example of movement of audio component 1130f, in FIG. 11X audio component 1130f is moving in a first direction at a first time, and then, in FIG. 11Y, audio component 1130 is moving in a second direction at a second time different from the first time. In some embodiments, the computer system 101 maintains the movement of the audio component 1130f independent of the immersion level of the virtual environment. For example, in FIG. 11X, the computer system 101 optionally maintains the movement of audio component 1130f such that the audio component 1130f would eventually be at the location of the audio component 1130f in FIG. 11Y. In FIG. 11B, the computer system 101 is not presenting audio component 1130f optionally because the current immersion level is not one of the one or more respective immersion levels. Audio component 1130f is further described with reference to FIGS. 11C through 11F.

FIGS. 11C through 11F illustrate computer system 101 presenting audio component 1130f at different locations relative to a reference (e.g., in the physical and/or virtual environment of the user) based on when an event for increasing the level of immersion (e.g., expanding the virtual environment) is detected, in accordance with some embodiments.

In the example of FIG. 11C, while audio component 1130f is at the illustrated spatial location (e.g., as shown in top-down view 1112c) and is not being presented (e.g., as shown in schematic 1118c), computer system 101 detects an event (e.g., an input from the hand 1119 of the user, which as illustrated is an optional input, directed at one or more buttons, knobs, digital crowns of computer system 101, an event corresponding to an initiation of playing of content of user interface 1102, or another type of event, such as described with reference to method 1200) corresponding to a request to increase the immersion level of the virtual environment 1114 from 1% (e.g., 2.7 degrees (e.g., of a 360-degree field of view) if full immersion is 270 degrees (e.g., of a 360-degree field of view) or 3.6 degrees (e.g., of a 360-degree field of view) if full immersion is 360 degrees (e.g., of a 360-degree field of view)) to 15% (e.g., 40.5 degrees (e.g., of a 360-degree field of view) if full immersion is 270 degrees (e.g., of a 360-degree field of view) or 54 degrees (e.g., of a 360-degree field of view) if full immersion is 360 degrees (e.g., of a 360-degree field of view)), such as to expand the virtual environment 1114 (e.g., expanding the view of virtual environment 1114 relative to a position of the user)). In response, in FIG. 11D, computer system 101 changes the immersion level to 15% and presents audio component 1130f (e.g., as shown in schematic 1118d) at the illustrated spatial location in FIG. 11D (e.g., as shown in top-down view 1112d), which is optionally based on the spatial location of the audio component 1130f when the event is detected.

As another example, the computer system 101 optionally detects the event corresponding to the request to increase the immersion level of the virtual environment 1114 from 1% to 15% while the audio component 1130f is at a different location than in FIG. 11C. For example, in FIG. 11E, while audio component 1130f is at the illustrated spatial location (e.g., as shown in top-down view 1112e) and while audio component 1130f is not being presented (e.g., as shown in schematic 1118e), computer system 101 detects an event (e.g., an input from the hand 1119 of the user, which as illustrated is an optional input, directed at one or more buttons, knobs, digital crowns of computer system 101, an event corresponding to an initiation of playing of content of user interface 1102, or another type of event, such as described with reference to method 1200) corresponding to the request to increase the immersion level of the virtual environment 1114 from 1% to 15%. In response, in FIG. 11F, computer system 101 changes the immersion level to 15% and presents audio component 1130f at the illustrated spatial location in FIG. 11F, which is optionally based on the spatial location of the audio component 1130f when the event is detected and is different from the location of presentation of audio component 1130f in FIG. 11D.

Additionally or alternatively, in some embodiments, the computer system 101 presents audio component 1130f when the simulated spatial location of audio component 1130f is within the reference lines (e.g., spatial boundary) of virtual environment 1114 at the immersion level of the virtual environment 1114. For example, in FIG. 11G, the computer system 101 optionally does not present audio component 1130f because audio component 1130f is not located within the reference lines 15, which is where virtual environment 1114 is located, while in FIG. 11F, the computer system optionally presents audio component 1130f because audio component 1130f is located within the reference lines 15, which is where virtual environment 1114 is located. Additionally, it should be noted that in FIGS. 11D and 11F, computer system 101 initiates presentation of audio components 1130b/1130c (e.g., as shown in schematics 1118d/1118f in the respective figure) optionally because virtual environment 1114 (e.g., edges of virtual environment 1114) intersects with the stimulated spatial location of the audio components 1130b/1130c.

FIGS. 11G through 11I illustrate computer system 101 detecting events corresponding to requests to increase the level of immersion of virtual environment 1114 and in response increasing the level of immersion and moving audio components 1130b/1130c in a manner that tracks the rate of expansion of virtual environment 1114, in accordance with some embodiments.

In FIG. 11G, while audio components 1130b/1130c are at their illustrated spatial locations and are being presented, computer system 101 detects an event (e.g., an input from the hand 1119 of the user, which as illustrated is an optional input, directed at one or more buttons, knobs, digital crowns of computer system 101, an event corresponding to an initiation of playing of content of user interface 1102, or another type of event, such as described with reference to method 1200) corresponding to a request to increase the immersion level of the virtual environment 1114 from 15% (e.g., 40.5 degrees (e.g., of a 360-degree field of view) if full immersion is 270 degrees (e.g., of a 360-degree field of view) or 54 degrees (e.g., of a 360-degree field of view) if full immersion is 360 degrees (e.g., of a 360-degree field of view)) to 25% (e.g., 67.5 degrees (e.g., of a 360-degree field of view) if full immersion is 270 degrees (e.g., of a 360-degree field of view) or 90 degrees (e.g., of a 360-degree field of view) if full immersion is 360 degrees (e.g., of a 360-degree field of view)). In response, in FIG. 11H, computer system 101 changes the immersion level to 20% in accordance with the change of immersion and moves audio components 1130b/1130c such that they maintain being located on the edge of the virtual environment 1114 in FIG. 11H. Similarly, from FIG. 11H to 11I, in response to an event (e.g., an input from the hand 1119 of the user, which as illustrated is an optional input, directed at one or more buttons, knobs, digital crowns of computer system 101, an event corresponding to an initiation of playing of content of user interface 1102, or another type of event, such as described with reference to method 1200) corresponding to the request to increase the immersion level of the virtual environment 1114 (e.g., expand the virtual environment 1114) from 20% to 25%, the computer system 101 changes the immersion level to 25% in accordance with the change of immersion and moves audio components 1130b/1130c such that they are located along the edge of the virtual environment 1114 in FIG. 11I. In some embodiments, audio components 1130b and 1130c are presented at the edge of the virtual environment 1114 as they track the edge of the virtual environment 1114. As such, in some embodiments, movement of audio components track the location of the edge of the virtual environment 1114 and/or is the same in rate as the rate of expansion of virtual environment 1114.

Alternatively, FIGS. 11G and 11J through 11L illustrate computer system 101 detecting an event corresponding to a request to increase the level of immersion of virtual environment 1114 and in response increasing the level of immersion and moving audio components 1130b/1130c in a manner that is slower than the rate of expansion of virtual environment 1114, in accordance with some embodiments.

For example, in FIG. 11G, while audio components 1130b/1130c are at their illustrated spatial locations and are being presented, computer system 101 optionally detects an event (e.g., an input from the hand 1119 of the user, which as illustrated is an optional input, directed at one or more buttons, knobs, digital crowns of computer system 101, an event corresponding to an initiation of playing of content of user interface 1102, or another type of event, such as described with reference to method 1200) corresponding to a request to increase the immersion level of the virtual environment 1114 from 15% to 25%. In response, in FIG. 11J, computer system 101 changes the immersion level to 20% (e.g., transiently in accordance with the change of immersion from 15% to 25%) and moves audio components 1130b/1130c in a manner that is slower than the change of immersion level, as the audio component 1130b/1130c are not located on the edge of the virtual environment 1114 (e.g., boundary of the portal of the virtual environment 1114) in FIG. 11J. Similarly, in continuance, from FIG. 11J to 11K, computer system 101 changes the immersion level to 25% (e.g., moves the boundary of virtual environment 1114 to correspond to the immersion level at 25%) and moves audio components 1130b/1130c in a manner that is slower than the change of immersion level, as the audio component 1130b/1130c are not located on the boundary of the portal of the virtual environment 1114 in FIG. 11K. Finally, audio components 1130b/1130c optionally reach the edge of the virtual environment 1114 as shown in FIG. 11L. As such, in some embodiments, movement of audio components do not track the location of the edge of the virtual environment 1114 and/or is the different in rate from the rate of expansion of virtual environment 1114.

In some embodiments, the movement of audio components tracks the location of the boundary of the virtual environment 1114 and/or is the same in rate as the rate of expansion of virtual environment 1114 when the event further corresponds to a request to change the level of immersion by a first amount within a first amount of time (e.g., corresponding to a first rate of change of immersion level), greater than a second amount of time. In some embodiments, the movement of audio components does not track the location of the boundary of the virtual environment 1114 and/or is the different in rate from the rate of expansion of virtual environment 1114 when the event further corresponds to a request to change the level of immersion by the first amount within the second amount of time (e.g., corresponding to a second rate of change of immersion level that is faster than the first rate).

It should be noted that in FIGS. 11I, 11K, and 11L computer system 101 initiates presentation of audio components 1130a optionally because the portal edges of virtual environment 1114 intersects with the stimulated spatial location of the audio components 1130a.

As shown in FIG. 11L, the curved path connected to audio component 1130b and the curved path connected to audio component 1130c is dotted on one side and unbroken on the other side of the respective curved path. In some embodiments, the unbroken line part of a curved path connected to a respective audio component 1130a through 1130c illustrates a region in which the respective audio component 1130a through 1130c is permitted to be presented from while the dotted line illustrates a region from which the respective audio component 1130a through 1130c is not permitted to be presented. For example, in FIG. 11L, audio component 1130c includes a bidirectional arrow signifying that the audio component 1130c is permitted to be presented and/or move anywhere along the unbroken line of the curved path connected to audio component 1130c while the virtual environment 1114 is at the illustrated immersion level, but the audio component 1130c in FIG. 11L is optionally not configured to be presented and/or move along the dotted line of the curved path connected to audio component 1130c while the virtual environment 1114 is at the illustrated immersion level.

FIGS. 11M and 11N illustrate computer system 101 detecting and responding to an event (e.g., an input from the hand 1119 of the user, which as illustrated is an optional input, directed at one or more buttons, knobs, digital crowns of computer system 101, an event corresponding to an initiation of playing of content of user interface 1102, or another type of event, such as described with reference to method 1200) corresponding to a request to increase the level of immersion of virtual environment 1114 from 25% (e.g., 67.5 degrees (e.g., of a 360-degree field of view) if full immersion is 270 degrees (e.g., of a 360-degree field of view) or 90 degrees (e.g., of a 360-degree field of view) if full immersion is 360 degrees (e.g., of a 360-degree field of view) to 50% (e.g., 135 degrees (e.g., of a 360-degree field of view) if full immersion is 270 degrees (e.g., of a 360-degree field of view) or 180 degrees (e.g., of a 360-degree field of view) if full immersion is 360 degrees (e.g., of a 360-degree field of view), such as to expand the view of virtual environment 1114) in accordance with some embodiments. In response to the event detected in FIG. 11M, the computer system 101 increases the level of immersion (e.g., expands the virtual environment) and moves audio components 1130a through 1130c, as shown in FIG. 11N. The movement of audio component 1130a through 1130c optionally tracks the movement of the edge of the virtual environment 1114. In some embodiments, audio component 1130c moves in space along the illustrated path 1129 over time (e.g., moving along a loop or back and forth along the path over time). In some embodiments, the audio component 1130c moves along the path 1129, including moving along portions of the path that are inside of a current boundary of the visual portion of the environment and that extend outside of the current boundary of the visual portion of the environment (e.g., solid line 1129a is the portion of the path 1129 that is inside the current boundary and dotted line 1129b is the portion of the path that extend outside of the current boundary in FIG. 11M). In some embodiments, the audio component 1130c moves along the path 1129 but stops at a current boundary of the visual portion of the environment, so that portions of the path 1129 that extend outside of the visual portion of the environment are not travelled by the audio component 1130c (e.g., the audio component 1130c travels along solid line 1129a of the path 1129 in FIGS. 11H-11Y without travelling along dotted line 1129b the path 1129 in FIGS. 11F-11M). In some embodiments, when the virtual environment is at a lower immersion level, the range of motion of the audio component 1130c is smaller than when the virtual environment is at a higher immersion level (e.g., the range of motion of the audio component 1130c is smallest in FIG. 11G, larger in FIGS. 11H and 11J, even larger in FIGS. 11I, 11L, and 11K, and even larger in FIGS. 11N-11R). In some embodiments, the range of motion of the audio component 1130c remains the same even as the level of immersion changes when the level of immersion has expanded so that the entire path of movement for the audio component 1130c (e.g., path 1129 in FIGS. 11N-11Y, which includes just solid line 1129a) is included in the visual portion of the environment (e.g., as shown in FIGS. 11N-11Y where the entire path of movement (e.g., solid line 1129a) for the audio component 1130c is in the visual portion of the environment). Audio components 1130a/1130b are illustrated as having respective movement trajectories and these audio components may behave similarly as described with reference to audio component 1130c above (e.g., each of the audio components 1130a/1130b may move or not move under specific conditions, such as the conditions enumerated above with reference to audio component 1130c but applicable to audio components 1130a/1130b and their illustrated paths).

In addition, in FIG. 11N, computer system 101 is not presenting audio component 1130d. FIGS. 11G through 11N show audio component 1130d, which the computer system 101 presents conditioned that the level of immersion of the virtual environment is below 50%, decreasing in audio level (e.g., volume level) as the immersion level of the virtual environment is increasing towards 50%, as shown by the volume level of audio component 1130d illustrated in schematics 1118g through 1118n. As such, in some embodiments, the computer system 101 fades out audio components as immersion level changes. Further, as described elsewhere herein, audio component 1130g is presented only when the immersion level of virtual environment 1114 is below 50%. Additionally, FIGS. 11N through 11P illustrate another example of computer system 101 fading out presentation of an audio component while the immersion level is the same. For example, from FIG. 11N to 11P, though the immersion level has not changed, computer system 101 fades out presentation of audio component 1130g while at the threshold immersion level. As such, the computer system 101 optionally fades out different audio components in different manners or fades out different audio components in the same manner.

FIG. 11Q illustrates the computer system 101 displaying virtual environment 1114 when user 1108 has rotated their viewpoint in the three-dimensional environment 1100 while the level of immersion of virtual environment 1114 is 50%, in accordance with some embodiments. For example, while computer system 101 is displaying virtual environment 1114 as shown in FIG. 11P from the viewpoint of the user in FIG. 11P, the computer system 101 optionally detects an event (e.g., head rotation left, right, up, and/or down, touch inputs, and/or voice inputs and corresponds one or more of these inputs to the event) corresponding to a change in viewpoint of the user relative to a reference of physical environment and/or virtual environment, and in response displays virtual environment 1114 from the viewpoint of the user illustrated in FIG. 11Q.

As shown in FIG. 11Q, though the user has rotated the user's head, the location of virtual environment 1114 is fixed. For example, virtual environment 1114 in FIGS. 11A through 11Y is optionally world-locked. Similarly, the spatial audio positions of audio components between FIGS. 11P and 11Q have not changed in the top-down view 1112q, and all the sounds that were being presented in FIG. 11P are optionally likewise presented in FIG. 11Q. It should be noted that the computer system 101 can detect changes in viewpoint in any of FIGS. 11A through 11Y and in response can update that which is displayed in display generation component 120 to correspond to the change in viewpoint.

FIGS. 11R and 11S illustrate computer system 101 detecting and responding to an event (e.g., an input from the hand 1119 of the user, which as illustrated is an optional input, directed at one or more buttons, knobs, digital crowns of computer system 101, an event corresponding to an initiation of playing of content of user interface 1102, or another type of event, such as described with reference to method 1200) corresponding to a request to increase the level of immersion of virtual environment 1114 from 50% (e.g., 135 degrees (e.g., of a 360-degree field of view) if full immersion is 270 degrees (e.g., of a 360-degree field of view) or 180 degrees (e.g., of a 360-degree field of view) if full immersion is 360 degrees (e.g., of a 360-degree field of view) to 75% (e.g., 202.5 degrees (e.g., of a 360-degree field of view) if full immersion is 270 degrees (e.g., of a 360-degree field of view) or 270 degrees (e.g., of a 360-degree field of view) if full immersion is 360 degrees (e.g., of a 360-degree field of view)), in accordance with some embodiments. The computer system 101 optionally detects the event in FIG. 11R, and in response increases the level of immersion to 75% and moves audio components 1130a and 1130c without moving audio component 1130c as shown in FIG. 11S. The computer system 101 optionally moves audio components 1130a and 1130c without moving audio component 1130c because the audio component 1130c has already reached the target position of the audio component for the respective immersion level of the virtual environment 1114, which was reached while the immersion level of the virtual environment was 50%. As such, the computer system 101 optionally stops moving an audio component when the audio component has reached its target location.

FIGS. 11S through 11V illustrate the computer system 101 initiating in presentation audio components 1130h/1130k at different times based on timers associated with the audio components 1130h/1130k in accordance with some embodiments. As described elsewhere herein, audio components 1130h and 1130k are optionally presented conditioned that the immersion level of the virtual environment 1114 being at or above a threshold immersion level, which, for purpose of illustration in FIGS. 11S-11V is 75%. In some embodiments, the computer system presents audio component 1130h when (e.g., conditioned that) the immersion level of the virtual environment 1114 is at or above 75% and further conditioned that a first respective amount of time has passed since detection of the immersion level being at or above 75%. In some embodiments, the computer system 101 presents audio component 1130h when the immersion level of the virtual environment 1114 is at or above 75% and further when that a second respective amount of time has passed since detection of the immersion level being at or above 75%. The first and second respective amounts of time are optionally generated by one or more random (e.g., and/or deterministic) timers. In some embodiments, the computer system initiates the timers when the computer system detects that the immersion level is at 75%. As shown in FIG. 11S, though the immersion level is 75%, the computer system 101 is not presenting audio components 1130h or 1130k because the timers associated with these audio components 1130h or 1130k have not ended in time. In some embodiments, FIG. 11S further illustrates the audio levels of the virtual environment when the computer system detects that the immersion level is at 75% and/or initiates the timers. In some embodiments, FIG. 11S further illustrates the audio levels of the virtual environment after the computer system has initiated the timers and while neither of the timers have ended. In response to detection that the timer associated with audio component 1130h has ended in time, the computer system 101 initiates presentation of audio component 1130h, as shown from schematic 1118s of FIG. 11S to schematic 1118t of FIG. 11T. Additionally in FIG. 11T, the computer system initiates presentation of audio component 1130h without initiates in presentation audio component 1130k optionally because the timer associated with audio component 1130k has not ended in time. For example, the timer associated with audio component 1130h was optionally shorter in time than the timer associated with audio component 1130k. In response to detection that the timer associated with audio component 1130k has ended in time, the computer system 101 initiates presentation (e.g., increase in volume level from a mute volume level) of audio component 1130k, as shown from schematic 1118t of FIG. 11T to schematic 1118u of FIG. 11U. FIG. 11V illustrates the computer system 101 presenting audio components 1130h/1130k at the target volume levels of the audio components.

FIGS. 11W and 11X illustrate a flow of computer system 101 detecting an event (e.g., an input from the hand 1119 of the user, which as illustrated is an optional input, directed at one or more buttons, knobs, digital crowns of computer system 101, an event corresponding to a ceasing of playing of content of user interface 1102, an event corresponding to an initiation of playing of content of user interface 1102, or another type of event, such as described with reference to method 1200) corresponding to a request to decrease the level of immersion of virtual environment 1114 (e.g., contract the virtual environment 1114), as shown in FIG. 11W, and in response to detecting the event decreasing the level of immersion (e.g., contracting the virtual environment 1114) and moving audio components 1130a/1130b, as shown in FIG. 11X, in accordance with some embodiments. In some embodiments, audio components 1130a/1130b are moved in first directions along their respective paths when the event corresponds to a request to increase the level of immersion, such as shown from FIG. 11R to FIG. 11S, and are moved in second directions, different from the first directions, along their respective paths when the event corresponds to a request to decrease the level of immersion, such as shown from FIG. 11W to FIG. 11X. As such, in some embodiments, directions of movement of audio components depend on the direction of the requested change of immersion.

FIG. 11Y illustrates the computer system 101 displaying virtual environment 1114 while the virtual environment 1114 is set to a maximum immersion level and presenting audio components at the maximum immersion level. As discussed previously, the computer system 101 optionally presents audio component 1130j when the level of immersion of virtual environment 1114 is a maximum level of immersion (e.g., 100% immersion which would optionally correspond to 270 degrees (e.g., of a 360-degree field of view) if full immersion is 270 degrees (e.g., of a 360-degree field of view) or 360 degrees (e.g., of a 360-degree field of view) if full immersion is 360 degrees (e.g., of a 360-degree field of view)). For example, when the level of immersion of virtual environment 1114 is not the maximum level of immersion, the computer system optionally does not present audio component 1130j and when the level of immersion of virtual environment 1114 is the maximum level of immersion, the computer system optionally presents audio component 1130j. Since the level of immersion of the virtual environment 1114 in FIG. 11Y is the maximum level of immersion, the computer system 101 presents audio component 1130j.

FIG. 12 is a flow diagram illustrating a method 1200 for changing a level of audio of an audio component associated with a virtual environment in response to a request to change a level of immersion of the virtual environment in accordance with some embodiments. In some embodiments, the method 1200 is performed at a computer system (e.g., computer system 101 in FIG. 1A such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1200 is governed by instructions that are stored in a non-transitory computer-readable storage medium and that are executed by one or more processors of a computer system, such as the one or more processing units 202 of computer system 101 (e.g., control unit 110 in FIG. 1A). Some operations in method 1200 are, optionally, combined and/or the order of some operations is, optionally, changed.

In some embodiments, method 1200 is performed at a computer system in communication with one or more input devices and a display generation component. For example, the computer system, the one or more input devices, and/or the display generation component optionally have one or more characteristics similar to or the same as the computer system(s), one or more input devices, and/or display generation component(s), respectively described with reference to methods 800 and/or 1000. In some embodiments, the computer system is in communication with one or more output devices, including one or more audio output devices, such as a speaker device, dual speaker device, another type of speaker device, earphones, or headphones that can provide audio to a user.

In some embodiments, while a virtual environment of a user of the computer system is visible via the display generation component at a first level of immersion (e.g., optionally from a viewpoint of a user of the computer system), such as virtual environment 1114 at the immersion level indicated by schematic 1116h in FIG. 11H, and while presenting a first audio component of the virtual environment with a first value for a respective property (e.g., a volume level or simulated spatial location) relative to a current value for the respective property of a second audio component of the virtual environment, such as presentation of audio component 1130d relative to presentation of audio component 1130b as indicated by schematic 1118h in FIG. 11H, the computer system detects (1202a) an event corresponding to a trigger (e.g., or request) to change the level of immersion of the virtual environment from the first level of immersion to a second level of immersion, different from the first level of immersion, such as input from hand 1119 of the user directed at the computer system 101 in FIG. 11H. In some embodiments, detecting the event includes receiving, via the one or more input devices, an input (e.g., direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice, voice inputs, and/or other input devices described herein). For example, the event is optionally rotation of a digital crown and the direction of the rotation corresponds to the direction of the immersion level change. In another example, the event is optionally an air pinch and drag where the direction of the drag corresponds to the direction of the immersion level change. In some embodiments, the computer system detecting the event includes the computer system automatically determining that the level of immersion should change, such as when content is paused or starts playing or when another part of the real-world breaks through virtual elements. The event corresponding to the trigger (e.g., or request) to change the level of immersion of the virtual environment from the first level of immersion to the second level of immersion is optionally different from (e.g., is not) a dedicated input to change the volume of the audio of the virtual environment, which, if detected, would optionally result in a change in volume of the audio of the virtual environment without changing the level of immersion of the virtual environment. Further, the event corresponding to the trigger (e.g., or request) to change the level of immersion of the virtual environment from the first level of immersion to the second level of immersion is optionally different from (e.g., is not) a dedicated input to change the detail of the audio (e.g., the degree or level of detail, such as the level of detail described with reference to method 1000) of the virtual environment, which, if detected, would optionally result in a change in detail of the audio of the virtual environment without changing the level of immersion of the virtual environment. In some embodiments, the virtual environment includes one or more characteristics of the three-dimensional and/or virtual environments described with reference to methods 800 and/or 1000. In some embodiments, the virtual environment is a three-dimensional environment. In some embodiments, the virtual environment is displayed by the display generation component as part of a three-dimensional environment. In some embodiments, the three-dimensional environment is an extended reality (XR) environment, such as a virtual reality (VR) environment, a mixed reality (MR) environment, or an augmented reality (AR) environment. In some embodiments, the three-dimensional environment includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, a particular level of immersion corresponds to the angular range of the three-dimensional environment that is occupied by the virtual environment displayed via the display generation component (e.g., 9 degrees, 15 degrees, 30 degrees, 45 degrees, 60 degrees, 80 degrees, 100 degrees, 120 degrees, 160 degrees, 240 degrees, 275 degrees, 360 degrees, or another angular distance between opposite edges of the virtual environment from a location of the user in the three-dimensional environment), optionally independent of whether an edge of the virtual environment is visible in a current viewpoint of the user. In some embodiments a particular level of immersion corresponds to minimum immersion, low immersion, medium immersion, high immersion, or maximum immersion (e.g., 60 degrees of content displayed at low immersion, 120 degrees of content displayed at medium immersion, 180 degrees of content displayed at high immersion, or 360 degrees of content displayed at maximum immersion). In some embodiments, the maximum level of immersion corresponds to an angular range of the three-dimensional environment that is occupied by the virtual environment displayed via the display generation component that is a value less than 360 degrees, such as 180 degrees. In some embodiments, the computer system displays, via the display generation component, the virtual environment at a respective level of immersion. In some embodiments, the respective level of immersion corresponds to a respective amount of field of view that the virtual environment consumes (e.g., is bounded within) relative to a total amount of field of view of the virtual environment (e.g., a total amount of field of view of the user of the computer system, a total amount of field of view of the computer system, or a total amount of field of view that corresponds to a 360-degree field of view relative to a position of the user of the computer system in the physical environment of the user). For example, when the computer system displays the virtual environment at a first level of immersion (e.g., optionally from a viewpoint of a user of the computer system), the virtual environment optionally consumes (e.g., is bounded within) a first amount of field of view of the three-dimensional environment that is visible via the display generation component, and when the computer system displays the virtual environment at a second level of immersion (e.g., optionally from the viewpoint of the user of the computer system), different from the first level of immersion, the virtual environment optionally consumes (e.g., is bounded within) a second amount of field of view different from the first amount of field of view of the three-dimensional environment that is visible via the display generation component. In some embodiments, when the computer displays the virtual environment at a maximum level of immersion, the virtual environment optionally consumes (e.g., is bounded within) a maximum amount of field of view (e.g., a physical environment of the computer system is not visible via the display generation component when the computer displays the virtual environment at a maximum level of immersion). In some embodiments, when the computer displays the virtual environment at a minimum level of immersion, the virtual environment optionally consumes (e.g., is bounded within) a minimum amount of field of view (e.g., optionally including no display of the virtual environment). In some embodiments, the first level of immersion is the maximum level of immersion. In some embodiments, the first level of immersion is the minimum level of immersion. In some embodiments, the first level of immersion is different from the maximum level of immersion and is different from the minimum level of immersion. In some embodiments, the virtual environment includes or corresponds to an environmental atmosphere (e.g., an atmospheric effect) applied to a view of the physical environment of the computer system that is visible via the display generation component, such as described with reference to method 800, and the respective level of immersion corresponds to the degree to which the environmental atmosphere or atmospheric effect is applied to the view of the physical environment (e.g., an amount of tinting applied to the physical environment and/or a magnitude of sound effects presented by the computer system). In some embodiments, the respective level of immersion corresponds an associated degree to which the virtual environment displayed by the computer system (e.g., the virtual environment and/or the virtual content) obscures background content (e.g., content that the three-dimensional environment includes that is other than the virtual environment), optionally including the number of items of background content displayed and/or the visual characteristics (e.g., colors, contrast, and/or opacity) with which the background content is displayed. In some embodiments, at a low level of immersion (e.g., a first level of immersion), the background, virtual and/or real objects are displayed in an unobscured manner. For example, a virtual environment displayed at a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, the virtual environment is associated with one or more audio components, such as the first audio component of the virtual environment and the second audio component of the virtual environment. For example, the virtual environment is optionally associated with audio components (e.g., wind, birds, waves, construction sites, and/or horns in a metropolitan city) that correspond to a location to which the virtual environment corresponds. In some embodiments, the computer system is configured to present, via an audio output device, audio components of the virtual environment with similar or different values of a respective property (e.g., values of gains, volumes, tones, level of detail, bass, treble, or another type of a respective property of an audio component), and optionally in similar or different manners (e.g., spatial, non-spatial, moving, or another manner), such as described further with reference to methods 800 and/or 1000. In some embodiments, presenting an audio component of the virtual environment includes presenting the audio component at a mute level (e.g., volume is at 0 level). In some embodiments, presenting an audio component of the virtual environment does not include presenting the audio component at the mute level. In some embodiments, the computer system presents audio components differently at different immersion levels of the virtual environment, and/or presents different audio components of the virtual environment at different immersion levels of the virtual environment, independent of whether a total volume level of the virtual environment is changed. For example, the computer system optionally does not necessarily change a volume level of the virtual environment as a function of immersion level of the virtual environment. As such, changing levels of audio components of the virtual environment optionally does not include changing a volume level of the virtual environment.

In some embodiments, in response to detecting the event corresponding to the trigger (e.g., or request) to change the level of immersion of the virtual environment from the first level of immersion to the second level of immersion (1202b), the computer system displays (1202c), via the display generation component, the virtual environment at the second level of immersion, such as virtual environment 1114 at the immersion level indicated by schematic 1116i in FIG. 11I. In some embodiments, when the computer system displays the virtual environment at the second level of immersion, the virtual environment obscures a greater amount of the field of view than when the computer system displays the virtual environment at the first level of immersion. In some embodiments, when the computer system displays the virtual environment at the second level of immersion, the virtual environment obscures a lesser amount of the field of view than when the computer system displays the virtual environment at the first level of immersion. Additionally or alternatively, in some embodiments, the computer system visually animates changing the level of immersion of the virtual environment from the first level of immersion to the second level of immersion, such that the computer system visually shows the view of the virtual environment expanding or contracting, corresponding to the amount of field of view that the virtual environment covers from a viewpoint of the user of the computer system. In some embodiments, the second level of immersion is the maximum level of immersion. In some embodiments, the second level of immersion is the minimum level of immersion. In some embodiments, the second level of immersion is different from the maximum level of immersion and is different from the minimum level of immersion.

In some embodiments, in response to detecting the event corresponding to the trigger (e.g., or request) to change the level of immersion of the virtual environment from the first level of immersion to the second level of immersion (1202b), the computer system presents (1202d) the first audio component with a second value of the respective property relative to the current value for the respective property of the second audio component, different from the first value of the respective property for the first audio component, such as presentation of audio component 1130d relative to presentation of audio component 1130b as indicated by schematic 1118i in FIG. 11I. As such, in response to an event to change the level of immersion of the virtual environment, the computer system optionally changes the level of visual immersion of the virtual environment and changes one or more values of a respective property of one or more first audio components of the virtual environment relative to one or more current values of a respective property of one or more second audio components of the virtual environment. In some embodiments, a change in a level of immersion of the virtual environment is visually observable to a user of the computer system when a position of an edge of the virtual environment visually shifts (e.g., in the viewpoint of the user) in the three-dimensional environment, such as when opposite edges of the virtual environment moves or has moved in the three-dimensional environment in a manner that causes a change (e.g., an increase or decrease) in the distance between the opposite edges of the virtual environment in the three-dimensional environment. In some embodiments, opposite edges (e.g., or one or more or all edges) of the virtual environment are not in the viewpoint of the user when the event is detected and when the computer system displays the virtual environment at the second level of immersion. As such, in some embodiments, display of the virtual environment at the second level of immersion is the same as display of the virtual environment at the first level of immersion, such as when opposite edges (e.g., or one or more or all edges) of the virtual environment are not in the viewpoint of the user when the event is detected and when the computer system displays the virtual environment at the second level of immersion. Thus, the changes in audio that are due to changes of level of immersion of the virtual environment optionally provides more accurate information about the level of immersion optionally until the user moves the viewpoint around to determine a current level of immersion. In some embodiments, the computer system corresponds respective presentation of audio components of the virtual environment with respective levels of immersion of the virtual environment, such that presentation of different audio components of the virtual environment is a function of (e.g., is based on) the level of immersion of the virtual environment. For example, while presenting the virtual environment at a first level of immersion, the computer system optionally presents a first amount of audio components in a first manner (e.g., at a first range of locations in the three-dimensional environment (e.g., as sounds perceived as sourcing from different positions in three-dimensional space)), and at a second level of immersion of the virtual environment, the computer system optionally presents the first amount of audio components in a second manner (e.g., at a second range of locations in audio-spatial space different from the first range of locations in audio-spatial space), different from the first manner. As another example, when the computer system displays the virtual environment at a first level of immersion, the computer system optionally presents a first set of audio components of the virtual environment (e.g., optionally without presenting a second set of audio components of the virtual environment), and when the computer system displays the virtual environment at the second level of immersion of the virtual environment, the computer system optionally presents a second set of audio components of the virtual environment, different from the first set of audio components, optionally with or without presenting one or more (e.g., or all) of the first set of audio components. As another example, presentation of audio components of the virtual environment is optionally based on corresponding positions of the audio components relative to the field of view consumed by the virtual environment at the respective level of immersion that the computer system displays the virtual environment. For example, when the computer system displays the virtual environment at a first level of immersion in which the virtual environment is bounded within a first amount of field of view relative to a total amount of field of view (e.g., optionally from the viewpoint of the user), the computer system optionally presents audio components based on whether the audio components in audio-spatial space are within or beyond the spatial boundary of the virtual environment (e.g., that corresponds to the respective level of immersion). For example, when the virtual environment is associated with a first respective audio component and a second respective audio component and the first respective audio component of the virtual environment is within the spatial boundary of the virtual environment and the second respective audio component of the virtual environment is not within the spatial boundary of the virtual environment, the computer system optionally presents the first respective audio component without presenting the second respective audio component. In some embodiments, when the event corresponding to the trigger (e.g., or request) to change the level of immersion of the virtual environment from the first level of immersion to the second level of immersion is received, the viewpoint of the user is a first viewpoint, and when the computer system displays the virtual environment at the second level of immersion and presents the first audio component at the second level relative to the level of the second audio component, the viewpoint of the user is the first viewpoint. In some embodiments, when the event corresponding to the trigger (e.g., or request) to change the level of immersion of the virtual environment from the first level of immersion to the second level of immersion is received, the viewpoint of the user is a first viewpoint, and when the computer system displays the virtual environment at the second level of immersion and presents the first audio component at the second level relative to the level of the second audio component, the viewpoint of the user is a second viewpoint, different from the first viewpoint. In addition, it should be noted that method 1200 optimally results in improvement of a user's spatial awareness of the user's environment, which can help provide a desirable (e.g., comfortable) XR experience even when the XR experience includes visual changes in a displayed environment, such as when the XR experience includes visually showing a virtual environment changing in immersion level (e.g., movement of edges of the virtual environment). Changing visual immersion of a virtual environment and a level of audio of a first audio component of the virtual environment relative to a second audio component of the virtual environment in response to detecting a request to change a level of immersion of the virtual environment improves the user's spatial awareness of the user's environment, which can improve user comfort, such as user comfort when the edges of the virtual environment move relative to the viewpoint of the user, reduces user errors associated with mismatches between audio levels and immersion, maps presentation of specific audio components of the virtual environment to different levels of immersion of the virtual environment and maps different manners of presentation of specific audio components of the virtual environment to different amounts of field of views that the virtual environment covers, thus creating a correspondence between audio components of the virtual environment and the displayed virtual environment on an immersion level basis and providing better feedback to the user that the immersion level is changing.

In some embodiments, the first audio component comprises one or more ambient sounds (e.g., of the selected virtual environment), such as ambient sounds corresponding to audio component 1130l in FIG. 11I. In some embodiments, the ambient sounds (e.g., background noise) correspond to the location and/or type of scene to which the virtual environment corresponds. For example, if the virtual environment is a creek, the ambient sounds include sounds that would be associated with a creek environment such as the sound of wind, frogs croaking, bird chirping, wind, and/or sound of the water moving at the creek. In some embodiments, in accordance with a determination that the virtual environment is a first virtual environment, the one or more audio components of the virtual environment include one or more first ambient sounds of the virtual environment (e.g., without including one or more second ambient sounds of a second virtual environment), and in accordance with a determination that the virtual environment is a second virtual environment, different from the first virtual environment, the one or more audio components of the second virtual environment include one or more second ambient sounds of the second virtual environment (e.g., without including the one or more first ambient sounds of the first virtual environment). In some embodiments, the first audio component includes one or more first ambient sounds of the virtual environment, and the second audio component includes one or more second ambient sounds of the virtual environment. Changing visual immersion of a virtual environment and changing levels of presentation of ambient sounds of the virtual environment in response to detecting a request to change a level of immersion of the virtual environment corresponds specific ambient sound presentations to specific levels of immersion and environments, which provides an audio indication to the user that the level of immersion has changed. Including presentation of ambient sounds in the audio components of the virtual environment provides the user with auditory feedback regarding the currently selected virtual environment, which minimizes input errors associated with misunderstanding their environment, and improves the user's spatial awareness of the user's environment, which can improve user comfort, such as user comfort when the edges of the virtual environment move relative to the viewpoint of the user.

In some embodiments, the first audio component comprises one or more point sources of audio (e.g., of the selected virtual environment), such as audio component 1130d and/or audio component 1130e in FIG. 11I. In some embodiments, the point sources of audio correspond to the location to which the virtual environment corresponds and/or correspond to audio associated virtual objects displayed in the virtual environment. For example, when the virtual environment includes a meadow in the morning time, bugs and birds are optionally displayed in the meadow. The point sources of audio of the first type optionally correspond to audio emerging from the bugs and the point sources of audio of the second type optionally corresponds to audio emerging from the birds, at the respective locations that the bugs and birds occupy in the virtual environment. For example, the virtual environment is optionally a forest, and the point sources of audio includes audio of virtual bugs, optionally including a specific amount of virtual bugs. For example, the computer system optionally presents a first amount of point sources of audio (e.g., 5, 10, 13, 25, or 35 point sources of audio) or a second amount of point sources of audio, different from the first amount of point sources of audio. In some embodiments, in accordance with a determination that the virtual environment is a first virtual environment, the one or more point sources of audio of the virtual environment include one or more first point sources of audio of the virtual environment (e.g., without including one or more second point sources of audio of a second virtual environment), and in accordance with a determination that the virtual environment is a second virtual environment, different from the first virtual environment, the one or more audio components of the second virtual environment include one or more second point sources of audio of the second virtual environment (e.g., without including the one or more first point sources of audio of the first virtual environment). In some embodiments, one or more or all of the point sources of audio are not clearly visible and/or are hidden from view from the viewpoint of the user of the computer system and/or are not associated with displayed objects in the three-dimensional environment. In some embodiments, the point sources of audio are associated with displayed objects in the virtual environment. For example, the point sources of audio optionally correspond to virtual crickets in a pile of virtual tall grass in the virtual environment. Though the point sources of audio are optionally hidden from view from the viewpoint of the user, the point sources of audio nevertheless are optionally associated with various positions in the virtual environment. In some embodiments, the first audio component includes one or more first point sources of audio the virtual environment and the second audio component includes one or more second point sources of audio of the virtual environment. Including presentation of specific point sources of audio, in the audio components of the virtual environment, that correspond to the visual component of the virtual environment indicates to the user the virtual environment via audio. In some embodiments, the computer system presents a respective point source of audio as if it is emanating from a certain direction with reference to a respective viewpoint of the user. For example, if the point sources of audio include birds chirping and the birds are to the left of the viewpoint of the user, the computer system presents the point sources of audio as if it is emanating from the left of the viewpoint of the user. Changing visual immersion of a virtual environment and changing levels of presentation of ambient sounds of the virtual environment in response to detecting a request to change a level of immersion of the virtual environment corresponds specific point source of audio presentations to specific levels of immersion, which provides an audio indication to the user that the level of immersion has changed. Including presentation of point sources of audio in the audio components of the virtual environment provides the user with auditory feedback regarding the currently selected virtual environment, which minimizes input errors associated with a user misunderstanding their environment and improves the user's spatial awareness of the user's environment, which can improve user comfort, such as user comfort when the edges of the virtual environment move relative to the viewpoint of the user.

In some embodiments, the respective property is a volume level, the first value for the respective property is a first volume level, such as the volume level of audio component 1130b indicated by schematic 1118c in FIG. 11C, and the second value for the respective property is a second volume level, greater than the first volume level, such as the volume level of audio component 1130b indicated by schematic 1118d in FIG. 11D. Thus, in some embodiments, while the virtual environment of the user of the computer system is visible via the display generation component at the first level of immersion and while presenting the first audio component at the first volume level, the computer system detects the event, and in response, the computer system increases the volume of the first (e.g., and/or second) audio component (e.g., optionally relative to the current volume level of the second audio component when the event was detected) in addition to changing the level of immersion of the virtual environment to the second level. In some embodiments, the second level of immersion is greater than the first level of immersion, and the volume of first (e.g., and/or second) audio component is increased (e.g., increased in volume relative to the volume of the second audio component when the event is detected) in response to detection of the event. In some embodiments, the second level of immersion is less than the first level of immersion, and the volume of first (e.g., and/or second) audio component is increased in response to detection of the event. The audio changes due to changes of level of immersion optionally provide more accurate information about the level of immersion until the user moves the viewpoint around to determine a current level of immersion, as the edges of the virtual environment might not be in the viewpoint when the event is detected and/or when the level of immersion of the virtual environment is changed, such as described with reference to step(s) 1202. Increasing a volume of the first audio component in response to detecting the event corresponding to the trigger to change to change the level of immersion improves the user's spatial awareness of the user's environment, which can improve user comfort, such as user comfort when the edges of the virtual environment move relative to the viewpoint of the user and provides a mechanism for changing the volume of the first audio component without input specifically directed to a volume control element of the first audio component and may reduce an amount of erroneous inputs provided by the user (e.g., and corresponding computing resources associated with correcting erroneous inputs) because the computer system provides this specific type of audio indication that the level of immersion of the virtual environment has changed-even the increase in volume of a specific audio component (e.g., the first audio component).

In some embodiments, the respective property is a volume level, the first value for the respective property is a first volume level, such as the volume level of audio component 1130g indicated by schematic 1118m in FIG. 11M, and the second value for the respective property is a second volume level, less than the first volume level, such as the volume level of audio component 1130g indicated by schematic 1118o in FIG. 11O. Thus, in some embodiments, while the virtual environment of the user of the computer system is visible via the display generation component at the first level of immersion and while presenting the first audio component at the first volume level (e.g., optionally relative to the current volume level of the second audio component when the event was detected), the computer system detects the event, and in response, the computer system decreases the volume of the first (e.g., and/or second) audio component (e.g., relative to the current volume level of the second audio component when the event was detected) in addition to changing the level of immersion of the virtual environment to the second level. In some embodiments, the second level of immersion is greater than the first level of immersion, and the volume of first (e.g., and/or second) audio component is decreased in response to detection of the event. In some embodiments, the second level of immersion is less than the first level of immersion, and the volume of first (e.g., and/or second) audio component is decreased (e.g., decreased in volume relative to the volume of the second audio component when the event is detected) in response to detection of the event. The audio changes due to changes of level of immersion optionally provide more accurate information about the level of immersion until the user moves the viewpoint around to determine a current level of immersion, as the edges of the virtual environment might not be in the viewpoint when the event is detected and/or when the level of immersion of the virtual environment is changed, such as described with reference to step(s) 1202. Decreasing a volume of the first audio component in response to detecting the event corresponding to the trigger to change to change the level of immersion improves the user's spatial awareness of the user's environment, which can improve user comfort, such as user comfort when the edges of the virtual environment move relative to the viewpoint of the user and provides a mechanism for changing the volume of the first audio component without input specifically directed to a volume control element of the first audio component and may reduce an amount of erroneous inputs provided by the user (e.g., and corresponding computing resources associated with correcting erroneous inputs) because the computer system provides this specific type of audio indication that the level of immersion of the virtual environment has changed-even the decrease in volume of a specific audio component (e.g., the first audio component).

In some embodiments, a first respective audio component is not presented while the virtual environment is at the first level of immersion, such as audio component 1130a in FIG. 11H, and in response to detecting the event corresponding to the trigger (e.g., or request) to change the level of immersion of the virtual environment from the first level of immersion to the second level of immersion, the computer system presents the first respective audio component with a first respective value for the respective property relative to the current value for the respective property of the second audio component, such as audio component 1130a in FIG. 11I now being presented in response to the level of immersion changing from 20% to 25%. Additionally, in some embodiments, further in response to the event, the computer system presents the first respective audio component and a second respective audio component with a second respective value for the respective property relative to the current value for the respective property of the second audio component. As such, the computer system optionally presents additional audio components that were not previously presented as the immersion level of the virtual environment changes (e.g., increases or decreases). In some embodiments, while the virtual environment is at the first level of immersion (e.g., optionally from a viewpoint of the user of the computer system), and optionally while presenting the first audio component of the virtual environment with the first value for the respective property (e.g., a volume level or simulated spatial location) relative to the current value for the respective property of the second audio component of the virtual environment), the first and second respective audio components are not presented (e.g., are mute), and in response to detection of the event, the computer system presents the first and second respective audio components along with the first (e.g., and/or second) audio component(s). In some embodiments, the computer system presents the first and second respective audio components as emanating from first and second respective simulated locations, respectively. In some embodiments, the computer system ceasing presentation of the first and second respective audio components in response to a return of the level of immersion of the virtual environment to the first level, and then, in response to a return of the level of immersion of the virtual environment to the second level, the computer system presents the first and second respective audio components. In some embodiments, in response to detecting the event, the computer system sets the level of immersion of the virtual environment to the second level of immersion, which, includes changing the level of immersion of the virtual environment from the first level of immersion to the second level of immersion. In some embodiments, in between the first and second levels of immersion are a third level of immersion and a fourth level of immersion, different from the third level of immersion, and setting the level of immersion of the virtual environment to the second level of immersion includes the level of immersion of the virtual environment passing through (e.g., being at and then passing through) the third and fourth levels of immersion to get to the second level of immersion. In some embodiments, setting the level of immersion of the virtual environment to the second level of immersion includes initiating a process to display the virtual environment at the second level of immersion (e.g., optionally including progressively providing visual feedback of immersion change until the virtual environment is at the second level of immersion) and displaying the virtual environment at the second level of immersion. In some embodiments, setting the level of immersion of the virtual environment to the second level of immersion includes configuring the display generation component to display the virtual environment at the second level of immersion when the viewpoint of the user is facing a location corresponding to display of the virtual environment at the second level of immersion. In some embodiments, initiation of presentation of the first respective audio component is performed at the same time as initiation of presentation of the second respective audio component. In some embodiments, initiation of presentation of the first respective audio component is performed independently of initiation of presentation of the second respective audio component. In some embodiments, initiation of presentation of the first respective audio component is performed at a different time than initiation of presentation of the second respective audio component. In some embodiments, in between the first and second levels of immersion are a third respective level of immersion and a fourth respective level of immersion, different from the third respective level of immersion. In some embodiments, the first respective audio component is associated with the third respective level of immersion such that the first respective audio component is initiated in presentation when the virtual environment is at (e.g., or passes through) the third respective level of immersion and the second respective audio component is associated with the fourth respective level of immersion such that the second respective audio component is initiated in presentation when the virtual environment is at (e.g., or passes through) the fourth respective level of immersion. In some embodiments, setting the level of immersion of the virtual environment to the second level of immersion includes passing through the third and fourth respective levels of immersion of the virtual environment, and presenting the first respective audio component is performed (e.g., or at least initiated) when the third respective level of immersion is passed through and presenting the second respective audio component is performed (e.g., or at least initiated) when the fourth respective level of immersion is passed through. In some embodiments, the second respective level of immersion is greater than the first respective level of immersion. In some embodiments, the second respective level of immersion is less than the first respective level of immersion. In some embodiments, the first respective value and the second respective value are equal (e.g., equal in volume level). In some embodiments, the first respective value and the second respective value are not equal in value (e.g., unequal in volume level). Presenting specific audio components that were not being presented at the first level of immersion in response to detecting the event corresponding to the trigger to change to change the level of immersion to the second level of immersion improves the user's spatial awareness of the user's environment, which can improve user comfort, such as user comfort when the edges of the virtual environment move relative to the viewpoint of the user, provides audio feedback that the level of immersion has changed via the introduction of the presentation of the specific audio components, which reduces errors associated with interaction with the computer system, and may more specifically indicate to the user that the virtual environment is at the second level of immersion.

In some embodiments, presenting the first respective audio component with the first respective value for the respective property relative to the current value for the respective property of the second audio component includes in accordance with a determination that that the virtual environment is at the second level of immersion at a first time (e.g., and/or the event corresponding to the trigger (e.g., or request) to change the level of immersion of the virtual environment to the second level of immersion was detected at the first time), such as shown with virtual environment 1114 in FIG. 11T at 75% immersion, presenting the first respective audio component with the first respective value for the respective property relative to the current value for the respective property of the second audio component when a first duration of time starting from the first time (e.g., and/or starting from when the event was detected) has elapsed, such as audio component 1130h not being presented in FIG. 11S and then being presented in FIG. 11T after a first time duration has elapsed while the immersion level of virtual environment 1114 is the same. In some embodiments, presenting the first respective audio component with the first respective value for the respective property relative to the current value for the respective property of the second audio component includes in accordance with a determination that the virtual environment is at the second level of immersion at a second time, different from the first time (e.g., and/or the event corresponding to the trigger (e.g., or request) to change the level of immersion of the virtual environment to the second level of immersion was detected at the second time), such as shown with virtual environment 1114 in FIG. 11U at 75% immersion, presenting the first respective audio component with the first respective value for the respective property relative to the current value for the respective property of the second audio component when a second duration of time, different from the first duration of time, starting from the second time (e.g., and/or starting from when the event was detected) has elapsed, such as audio component 1130k not being presented in FIG. 11S and then being presented in FIG. 11U after a second time duration, different from the first time duration, has elapsed while the immersion level of virtual environment 1114 is the same. The first and second durations of time are optionally generated by a random timer generator. As such, an audio component is optionally associated with different timers (e.g., random timers) at different times, corresponding to respective amounts of time until the respective audio component is to be presented, from when the determination that the virtual environment is at the second level of immersion. As such, while the virtual environment is at the second level of immersion, the first respective audio component is optionally not being presented for different amounts of times corresponding to the respective timer associated with the first respective audio component at the particular time. In some embodiments, while the virtual environment is at the second level of immersion, the computer system presents the first respective audio component with the first respective value for the respective property relative to the current value for the respective property of the second audio component at a first time, ceases presentation of the first respective audio component at a second time after the first time, and presents the first respective audio component with the first respective value for the respective property relative to the current value for the respective property of the second audio component at a third time after the second time. Additionally or alternatively, in some embodiments, in response to detecting the event corresponding to the trigger (e.g., or request) to change the level of immersion of the virtual environment from the first level of immersion to the second level of immersion, the computer system presents the first respective audio component with the first respective value for the respective property relative to the current value for the respective property of the second audio component when a first duration of time starting from detection of the virtual environment being at the second level of immersion (e.g., at or after the detection of the event corresponding to the trigger to change the level of immersion of the virtual environment from the first level of immersion to the second of immersion) has elapsed. In some embodiments, the computer system presents a second respective audio component with the second respective value for the respective property relative to the current value for the respective property of the second audio when a second duration of time, different from the first duration of time, starting from detection of the virtual environment being at the second level of immersion (e.g., at or after the detection of the event corresponding to the trigger to change the level of immersion of the virtual environment from the first level of immersion to the second of immersion) has elapsed. As such, in some embodiments, the first and second respective audio components are optionally associated with timers (e.g., random timers), respectively, corresponding to respective amounts of time until the respective audio component is to be presented, from when the event is detected. Thus, the computer system optionally presents the first and second respective audio components at different times in response to detecting the event corresponding to the trigger (e.g., or request) to change the level of immersion of the virtual environment from the first level of immersion to the second level of immersion. For example, the first and second audio respective components are optionally configured to be presented while the virtual environment is at the second level of immersion, and when the virtual environment is set to the second level of immersion (e.g., such as described herein elsewhere with reference to setting the virtual environment to the second level of immersion), the computer system optionally triggers the respective timers associated with the first and second audio respective components (e.g., in response to detection of the event corresponding to the trigger or request to change in the level of immersion) and initiates presentation of the first and second audio respective components, independently (e.g., separately), when each respective timer crosses their respective threshold (e.g., time limits). In some embodiments, a timer associated with a specific audio component (e.g., audio source) is triggered when a threshold level of immersion associated with the audio component is crossed. For instance, in between the first level of immersion and the second level of immersion is optionally a third respective level of immersion different from the first respective level and the second respective level. Continuing with this example, the first and second respective audio components are optionally associated with the third respective level of immersion (e.g., instead of the second level of immersion) such that the respective timers are triggered when, while going from the first level to the second level, the level of immersion of the virtual environment crosses through (e.g., and/or is at) the third respective level, and in response to detecting that the first amount of time associated with the first timer has elapsed, the computer system initiates presentation of the first respective audio component and in response to detecting that the second amount of time associated with the second timer has elapsed, the computer system initiates presentation of the second respective audio component. In some embodiments, the first respective audio component and the second respective audio component are presented independently, at different times depending on when the time corresponding to the corresponding timer has elapsed. In some embodiments, one or more audio components are associated with the same level of immersion and have timers having the same amounts of time, such that the computer system initiates presentation of the one or more audio components at the same time. In some embodiments, the computer system ceases presentation of a respective audio component when a second timer associated with the respective audio component lapses. Initiating presentation at different times of different audio components that are associated with the second level of immersion of the virtual environment in accordance with respective timers associated with the different audio components, such that the audio components do not all abruptly initiate in presentation at the same time once the virtual environment is at the second level of immersion, provides audio feedback that the virtual environment is at (e.g., or has passed through) the respective level of immersion, which provides a more accurate indication of the change in immersion level, especially (e.g., though not exclusively) when the change in immersion level is not visible in the current viewpoint of the user when the event is detected, which reduces errors in interaction with the computer system. Initiating presentation of the first respective audio component in accordance with elapsing of a respective timer associated with the first respective audio component at a respective time when the virtual environment is at the second level of immersion improves the user's spatial awareness of the user's environment, which can improve user comfort, such as user comfort when the edges of the virtual environment move relative to the viewpoint of the user, increases a realism of the virtual environment at the second level of immersion, and provides audio feedback that the virtual environment is at the respective level of immersion, which provides a more accurate indication of the change in immersion level, especially (e.g., though not exclusively) when the change in immersion level is not visible in the current viewpoint of the user when the event is detected, which reduces errors in interaction with the computer system.

In some embodiments, while the first respective audio component is moving prior to being presented, and in response to detecting the event corresponding to the trigger (e.g., or request) to change the level of immersion of the virtual environment from the first level of immersion to the second level of immersion, in accordance with detecting the event at a first time, the computer system presents (e.g., initiates presentation of) the first respective audio component with a simulated spatial audio that corresponds to a first location relative to the virtual environment (e.g., relative to a point of reference (e.g., a position, object, and/or location) in the virtual environment or in the physical environment of the user and/or the first location being within the virtual environment), such as shown with audio component 1130f in FIG. 11D, and in accordance with detecting the event at a second time, different from the first time, the computer system presents (e.g., initiates presentation of) the first respective audio component with a simulated spatial audio that corresponds to a second location, different from the first location, relative to the virtual environment (e.g., relative to a point of reference (e.g., a position, object, and/or location) in the virtual environment or in the physical environment of the user and/or the second location being within the virtual environment), such as shown with audio component 1130f in FIG. 11F. For example, the first respective audio component is optionally associated with a path (e.g., a fixed path) such that the first respective audio component, optionally independent of whether the first respective audio component is being presented or not, is moving along the path such that when the first respective audio component is presented it is presented based on a position of the first respective audio component along the path when the trigger to change the level of immersion is detected. The first and second locations are optionally different positions relative to the viewpoint of the user. In some embodiments, the audio components of the virtual environment further includes a second respective audio component, and the first and second respective audio components are moving (e.g., independently moving optionally in different paths that optionally intersect atone or more locations in the virtual environment of the user or that optionally do not intersect) prior to being presented, and in response to detecting the event corresponding to the trigger to change the level of immersion of the virtual environment from the first level of immersion to the second level of immersion, in accordance with detecting the event at the first time, the computer system further presents (e.g., initiating presentation of) the second respective audio component with a simulated spatial audio that corresponds to a third location relative to the virtual environment, and in accordance with detecting the event at the second time, different from the first time, the computer system further presents the first second audio component with a simulated spatial audio that corresponds to a fourth location, different from the third location, relative to the virtual environment. In some embodiments, the computer system maintains the movement of the second respective audio component while presenting the second respective audio component. A s such, audio components of the virtual environment optionally maintain an animation of movement even while the computer system is not presenting the audio components, such that the audio components are presented at different locations based on when the level of immersion changes (e.g., increases or decreases). In some embodiments, the first and second respective audio components maintain their respective movement animations independent of immersion change. For example, the first and second respective audio components optionally correspond to a gust of wind moving across a forest, and based on when the immersion level changes, the gust of wind is at different locations in the virtual environment, and the computer system presents the first and second respective audio component based on their location when the immersion level changes. Maintaining a respective movement animation of a respective audio component while the respective audio component is not being presented so that the respective audio component is initiated in presentation as emanating from different locations based on a respective location of the respective audio component when the event corresponding to the change in immersion level is detected maintains the audio movement animation independent of immersion level change, which may indicate to the user the content and context of the virtual environment via audio, improves the user's spatial awareness of the user's environment, which can improve user comfort, such as user comfort when the edges of the virtual environment move relative to the viewpoint of the user, and reduces errors associated with interaction with the computer system.

In some embodiments, detecting the event corresponding to the trigger (e.g., or request) to change the level of immersion of the virtual environment from the first level of immersion to the second level of immersion is further performed while presenting a first respective audio component with a first respective value for the respective property relative to the current value for the respective property of the second audio component (e.g., and optionally a second respective audio component with a second respective value for the respective property relative to the current value for the respective property of the second audio component), such as audio component 1130d in FIG. 11G, and in response to detecting the event corresponding to the trigger (e.g., or request) to change the level of immersion of the virtual environment from the first level of immersion to the second level of immersion, the computer system ceases presentation (e.g., abruptly ceases presentation or fades out presentation) of the first respective audio component (e.g., and, optionally ceases presentation (e.g., abruptly ceases presentation or fades out presentation) of the second respective audio component), such as audio component 1130d in FIG. 11N. Thus, in some embodiments, when the level of immersion is changed from the first level to the second level, certain audio components that were being presented at the first level of immersion are no longer presented when the virtual environment is displayed at the second level of immersion. In some embodiments, ceasing of presentation of the first respective audio component is performed at the same time as ceasing of presentation of the second respective audio component. In some embodiments, ceasing of presentation of the first respective audio component is performed independently of ceasing of presentation of the second respective audio component. In some embodiments, ceasing of presentation of the first respective audio component is performed at a different time than ceasing of presentation of the second respective audio component. In some embodiments, in between the first and second levels of immersion are a third respective level of immersion and a fourth respective level of immersion, different from the third respective level of immersion. In some embodiments, the first respective audio component is associated with the third respective level of immersion such that the computer system ceases presentation of the first respective audio component when the virtual environment is at (e.g., or passes through) the third respective level of immersion and the second respective audio component is associated with the fourth respective level of immersion such that the second respective audio component is ceased in presentation when the virtual environment is at (e.g., or passes through) the fourth respective level of immersion. In some embodiments, setting the level of immersion of the virtual environment to the second level of immersion (e.g., such as described herein elsewhere with reference to setting the virtual environment to the second level of immersion) includes passing through the third and fourth respective levels of immersion of the virtual environment, and ceasing presentation of the first respective audio component is performed (e.g., or at least initiated) when the third respective level of immersion is passed through and presenting the second respective audio component is performed (e.g., or at least initiated) when the fourth respective level of immersion is passed through. In some embodiments, a ceasing of presentation of the first and second respective audio components is based on respective timers associated with the first and second respective audio components, such as described with reference to the second timer associated with the respective audio component. Ceasing presenting the first respective audio component that was being presented at the first level of immersion when the level of immersion of the virtual environment is at the second level of immersion improves the user's spatial awareness of the user's environment, which can improve user comfort, such as user comfort when the edges of the virtual environment move relative to the viewpoint of the user, provides audio feedback that the level of immersion has changed, reduces errors associated with interaction with the computer system, and may more specifically indicate that the virtual environment is set to the second level of immersion.

In some embodiments, the event corresponding to the trigger to change the level of immersion of the virtual environment from the first level of immersion to the second level of immersion is further detected while presenting the first audio component of the virtual environment with a simulated spatial location that corresponds to a first location (e.g., a first simulated spatial location) relative to the virtual environment (e.g., relative to a point of reference (e.g., a position, object, and/or location) in the virtual environment or in the physical environment of the user and/or the first location being with the virtual environment), such as audio component 1130a in FIG. 11M. For example, the first audio component is presented as if emanating from the first location. In some embodiments, in response to detecting the event corresponding to the trigger (e.g., or request) to change the level of immersion of the virtual environment from the first level of immersion to the second level of immersion, in accordance with a determination that change of the level of immersion of the virtual environment from the first level of immersion to the second level of immersion is a first amount of change (e.g., a first amount of increase or decrease of immersion such as 5, 10, 20, 50, 75 percent, or another amount), the computer system moves the first audio component to a second location relative to the virtual environment (e.g., relative to the point of reference (e.g., position, object, and/or location) in the virtual environment or in the physical environment of the user and/or the second location being with the virtual environment), such as moving audio component 1130a to the location of audio component 1130a in FIG. 11N. For example, the first audio component is presented as if emanating from the second location. In some embodiments, moving the first audio component to the second location includes presenting the first audio component while moving the first audio component. In some embodiments, the respective value for the respective property is a simulated spatial location, presenting the first audio component with the first value of the respective property relative to the current value for the respective property of the second audio component is presenting the first audio component at the first location, and when the change is the first amount of change, presenting the first audio component with the second value of the respective property relative to the current value for the respective property of the second audio component is presenting the first audio component at the second location.

In some embodiments, in response to detecting the event corresponding to the trigger (e.g., or request) to change the level of immersion of the virtual environment from the first level of immersion to the second level of immersion, in accordance with a determination that the change of the level of immersion of the virtual environment from the first level of immersion to the second level of immersion is a second amount of change (e.g., a second amount of increase or decrease of immersion such as 2, 5, 10, 20, 50, 75 percent, or another amount), different from the first amount of change, the computer system moves the first audio component to a third location relative to the virtual environment (e.g., relative to the point of reference (e.g., position, object, and/or location) in the virtual environment or in the physical environment of the user and/or the third location being with the virtual environment), different from the second location, such as moving audio component 1130a to the location of audio component 1130a in FIG. 11S. For example, the first audio component is presented as if emanating from the third location. The second and third locations are optionally different in location relative to the viewpoint of the user. In some embodiments, if the first audio component is being presented while moving the first audio component, the first audio component will sound to the user as if the first audio component is moving. Additionally, or alternatively, in some embodiments, the event corresponding to the trigger to change the level of immersion of the virtual environment from the first level of immersion to the second level of immersion is further detected while presenting a second audio component of the virtual environment with a simulated spatial location that corresponds to a fourth location (e.g., a fourth simulated spatial location) relative to the virtual environment (e.g., relative to the point of reference (e.g., position, object, and/or location) in the virtual environment or in the physical environment of the user). For example, the second audio component is presented as if emanating from the fourth location. In some embodiments, if the second audio component is being presented while moving the second audio component, the second audio component will sound to the user as if the second audio component is moving. In some embodiments, the respective value for the respective property is a simulated spatial location, presenting the first audio component with the first value of the respective property relative to the current value for the respective property of the second audio component is presenting the first audio component at the first location, and when the change is the first amount of change, presenting the first audio component with the second value of the respective property relative to the current value for the respective property of the second audio component is presenting the first audio component at the third location. In some embodiments, in response to detecting the event corresponding to the trigger (e.g., or request) to change the level of immersion of the virtual environment from the first level of immersion to the second level of immersion, the computer system moves presentation of the second audio component from the third location (e.g., third simulated spatial location) to a fourth location (e.g., fourth simulated spatial location), different from the third location, including presenting the second audio component at the fourth location, such that in accordance with a determination that change of the level of immersion of the virtual environment from the first level of immersion to the second level of immersion is a first amount of change, the fourth location is a third respective location, and in accordance with a determination that the change of the level of immersion of the virtual environment from the first level of immersion to the second level of immersion is a second amount of change, different from the first amount of change, the fourth location is a fourth respective location, different from the third respective location. In some embodiments, the amount of movement of the first (e.g., and/or second) audio component is proportional and/or inversely proportional to the amount of change in level of immersion is proportional and/or inversely proportional to the amount of movement of the first (e.g., and/or second) audio component. As such, the computer system optionally moves the first (e.g., and/or second) audio components based on the change in level of immersion (e.g., increase or decrease in immersion) and/or based on the amount of change in level of immersion. Moving the first audio component based on the change in level of immersion improves the user's spatial awareness of the user's environment, which can improve user comfort, such as user comfort when the edges of the virtual environment move relative to the viewpoint of the user, provides spatial audio feedback that the immersion level has changed, as the location from which the first audio component is being presented is changed, and further, provides feedback of the extent of the change of immersion level, as the location from which the first audio component is being presented changes differently in accordance with different amounts of change of immersion level, which may reduce errors in user interaction with the computer system.

In some embodiments, moving the first audio component from the first location to the second or third location occurs gradually over time by moving the first audio component through a plurality of intermediate locations at different points in time, such as shown with the movement of audio component 1130a through the intermediate locations along the illustrated trajectory of audio component 1130a from its location in FIG. 11M to its location in FIG. 11N as shown in top-down view 1112m and top-down view 1112n. When the movement of the first audio component is from the first location to the second location, the plurality of intermediate locations are optionally locations in between the first and second locations, and when the movement of the first audio component is from the first location to the third location, the plurality of intermediate locations are optionally locations in between the first and third locations. For example, a rate of movement of the first audio component from the first location to the second location or third location is optionally not constant throughout the movement of presentation of the first audio component from the first location to the second location or third location. Rather, the rate of movement of the first audio component from the first location to the second location or third location optionally gradually changes (e.g., gradually increases and/or gradually decreases and/or occurs slowly over time) as the immersion level of the virtual environment changes. For example, while moving the first audio component from the first location to the second location, the first audio component optionally passes through fourth and fifth locations that are in between the first and second locations, where the fourth location is closer than the fifth location to the first location and the fifth location is closer than the fourth location to the second location. Continuing with this example, moving the first audio component from the first location to the second location optionally includes a first rate of movement from the first location to the fourth location, a second rate of movement from the fourth location to the fifth location, and a third rate of movement from the fifth location to the second location, and one or more or all of the first through third rates of movement are unequal in magnitude to the other of the first through third rates of movement. Alternatively, in some embodiments, the rate of movement of the first audio component from the first location to the second location is constant throughout the moving of the first audio component from the first location to the second location. In some embodiments, a maximum rate of movement is based on a distance between the first location and the second location such that in accordance with a determination that the distance is a first distance, the maximum rate of movement is a first rate, and in accordance with a determination that the rate of movement is a second distance, greater than the first distance, the maximum rate of movement is a second rate, faster than the first rate. Gradually changing movement of the first audio component as the level of immersion of the virtual environment changes indicates to the user that the level of immersion of the virtual environment is changing, improves the user's spatial awareness of the user's environment, which can improve user comfort, such as user comfort when the edges of the virtual environment move relative to the viewpoint of the user, and provides the user with opportunity to correct errors associated with changing the immersion level even during the changing of the immersion level of the virtual environment, resulting in more efficient operations of the computer system as the computer system can respond to corrective immersion level changes detected during the changing of the immersion level.

In some embodiments, the event corresponding to the trigger to change the level of immersion of the virtual environment from the first level of immersion to the second level of immersion is further detected while presenting the second audio component of the virtual environment with a simulated spatial location that corresponds to a fourth location relative to the virtual environment (e.g., relative to the point of reference (e.g., the position, object, and/or location) in the virtual environment or in the physical environment of the user). For example, the second audio component is optionally presented as if emanating from the fourth location. For example, audio component 1130a is optionally being presented (e.g., or is configured (e.g., placed) to be presented) from its illustrated location in FIG. 11G while audio component 1130c is being presented in FIG. 11G. In some embodiments, in response to detecting the event corresponding to the trigger (e.g., or request) to change the level of immersion of the virtual environment from the first level of immersion to the second level of immersion, in accordance with a determination that the virtual environment is at a third level of immersion while changing the level of immersion of the virtual environment from the first level of immersion to the second level of immersion, the computer system initiates movement of the first audio component, without initiating movement of the second audio component, such as shown with audio component 1130c moving from FIG. 11G to 11H, without movement of audio component 1130a and in accordance with a determination that the virtual environment is at a fourth level of immersion, different from the third level of immersion, while changing the level of immersion of the virtual environment from the first level of immersion to the second level of immersion, initiating movement of the second audio component, such as shown with audio component 1130a initiating in movement from FIG. 11M to 11N. For example, in between the first and second levels of immersion are optionally a third level of immersion and a fourth level of immersion, different from the third level of immersion. In some embodiments, the first audio component is optionally associated with the third level of immersion such that movement of the first audio component is initiated when the virtual environment is at (e.g., or passes through) the third level of immersion and the second audio component is associated with the fourth level of immersion such that movement of the second audio component is initiated when the virtual environment is at (e.g., or passes through) the fourth level of immersion. In some embodiments, changing the level of immersion of the virtual environment from the first level of immersion to the second level of immersion (e.g., in response to the event corresponding to the trigger (e.g., or request) to change the level of immersion of the virtual environment from the first level of immersion to the second level of immersion) optionally includes passing through the third and fourth levels of immersion of the virtual environment, and initiating movement of the first audio component is optionally performed when the third level of immersion is passed through and initiating movement of the second audio component is optionally performed when the fourth level of immersion is passed through (e.g., while the computer system is changing the immersion level from the first level of immersion to the second level of immersion). In some embodiments, the second level of immersion is greater than the first level of immersion, and while increasing the level of immersion to the second level from the first level, the computer system initiates movement of the first audio component without initiating movement of the second audio component, and then the computer system initiates movement of the second audio component (e.g., when the level of immersion for initiating movement of the second audio component is reached) while the first audio component is moving. In some embodiments, while the computer system is changing the level of immersion from the first level of immersion to the second level of immersion, the immersion level of the virtual environment passes through (e.g., passes through transiently to get to the second level of immersion) the third level of immersion before passing through the fourth level of immersion, and when virtual environment is going from being at the third level of immersion to being at the fourth level of immersion, the first audio component continues in movement, and continues in movement even after the computer system passes through the fourth level of immersion of the virtual environment. As such, the computer system optionally independently moves different audio components such that the different audio components are presented at different levels of immersion of the virtual environment. Initiating movement of presentation of different audio components (e.g., the first and second audio components) of the virtual environment at different levels of immersion while changing the level of immersion of the virtual environment provides specific audio indications that specific levels of immersion have been reached or passed through during the changing of the level of immersion of the virtual environment, which reduces errors associated with user interaction with the computer system, improves the user's spatial awareness of the user's environment, which can improve user comfort, such as user comfort when the edges of the virtual environment move relative to the viewpoint of the user, and provides user with opportunity to correct errors associated with changing the immersion level.

In some embodiments, the event corresponding to the trigger to change the level of immersion of the virtual environment from the first level of immersion to the second level of immersion is further detected while presenting the second audio component of the virtual environment with a simulated spatial location that corresponds to a fourth location relative to the virtual environment (e.g., relative to the point of reference (e.g., position, object, and/or location) in the virtual environment or in the physical environment of the user). For example, the second audio component is optionally presented as if emanating from the fourth location. For example, audio component 1130b is optionally being presented in FIG. 11M as if emanating from its illustrated location in top-down view 1112m.

In some embodiments, in response to detecting the event corresponding to the trigger (e.g., or request) to change the level of immersion of the virtual environment from the first level of immersion to the second level of immersion, the computer system moves the first audio component away from the first location, such as shown with the movement of audio component 1130c from FIG. 11M to FIG. 11N, and moves the second audio component away from the fourth location, such as shown with the movement of audio component 1130b from FIG. 11M to FIG. 11N. For example, moving (e.g., independently and/or concurrently moving) the first and second audio components away from the first and fourth locations, respectively, is optionally performed such as described with reference to moving the first audio component to the second location relative to the virtual environment. In some embodiments, the movement of the first and second audio components includes one or more characteristics of movement of audio sources described elsewhere herein.

In some embodiments, in response to detecting the event corresponding to the trigger (e.g., or request) to change the level of immersion of the virtual environment from the first level of immersion to the second level of immersion, in accordance with a determination that the virtual environment is at a third level of immersion while changing the level of immersion of the virtual environment from the first level of immersion to the second level of immersion, the computer system stops movement the first audio component, without stopping movement of the second audio component (e.g., stopping movement of the first audio component while continuing movement of the second audio component based on the continuing changing of the immersion to the second level), such as shown with the movement of audio component 1130c stopping in FIG. 11N (e.g., from FIG. 11N to FIG. 11S, audio component 1130c optionally does not track the edge of the virtual environment 1114 as it did from FIG. 11M to FIG. 11N), while movement of audio component 1130b is maintained from FIG. 11N to FIG. 11S (e.g., audio component 1130b tracks the edge of the virtual environment 1114 as it did from FIG. 11M to FIG. 11N). Additionally, the computer system optionally maintains presentation of the first audio component at the location that the movement of the first audio component stopped.

In some embodiments, in response to detecting the event corresponding to the trigger (e.g., or request) to change the level of immersion of the virtual environment from the first level of immersion to the second level of immersion, in accordance with a determination that the virtual environment is at a fourth level of immersion, different from the third level of immersion, while changing the level of immersion of the virtual environment from the first level of immersion to the second level of immersion, the computer system stops movement of the second audio component, such as shown with the movement of audio component 1130b stopping in FIG. 11W (e.g., from FIG. 11N to FIG. 11Y, audio component 1130b optionally does not track the edge of the virtual environment 1114 as it did from FIG. 11M to FIG. 11N and optionally maintains the same location). Additionally, the computer system optionally maintains presentation of the second audio component at the location that the movement of the second audio component stopped. In some embodiments, while the computer system is changing the immersion level from the first level to the second level, the immersion level of the virtual environment is at the third level before being at the fourth level, and from the third to the fourth level, the first audio component remains at the location that first audio component had when the first audio component stopped in movement. In an example, in between the first and second levels of immersion is optionally a third level of immersion and a fourth level of immersion, different from the third level of immersion. In some embodiments, the first audio component is optionally associated with the third level of immersion such that the movement of the first audio component is stopped when the virtual environment is at (e.g., or passes through) the third level of immersion and the second audio component is associated with the fourth level of immersion such that the second audio component is optionally stopped when the virtual environment is at (e.g., or passes through) the fourth level of immersion. In some embodiments, changing the level of immersion of the virtual environment from the first level of immersion to the second level of immersion (e.g., in response to the event) optionally includes passing through the third and fourth levels of immersion of the virtual environment and stopping movement of the first audio component is optionally performed when the third level of immersion is passed through and stopping movement of the second audio component is optionally performed when the fourth level of immersion is passed through. In some embodiments, the second level of immersion is greater than the first level of immersion, and while increasing the level of immersion to the second level from the first level, the computer system stops movement of the first audio component without stopping movement of the second audio component, and then the computer system stop movement of the second audio component (e.g., when the level of immersion for stopping movement of the second audio component is reached) while the first audio component has already stopped in movement. As such, the computer system optionally independently stops different movements of different audio components at different levels of immersion. In some embodiments, after stopping the movement of the first and second audio components, the computer system detects an event corresponding to a trigger to change the immersion level from the second level to the first level, and in response, the computer system optionally initiates movement of the first and second audio components when the virtual environment is at (e.g., or passes through) the third and fourth immersion levels, respectively. Ceasing movement of different audio components (e.g., the first audio component and the second audio component) of the virtual environment at different levels of immersion while changing the level of immersion of the virtual environment improves the user's spatial awareness of the user's environment, which can improve user comfort, such as user comfort when the edges of the virtual environment move relative to the viewpoint of the user, provides specific audio indications that specific levels of immersion have been reached or passed through during the changing of the level of immersion of the virtual environment, which reduces errors associated with user interaction with the computer system relating to the change of immersion, and provides the user with opportunity to correct errors associated with changing the immersion level.

In some embodiments, movement of the first audio component of the virtual environment from the first location to the second location or the third location is animated over time (e.g., 0.3, 0.5, 1, 3, 5, 10, 20 or 30 seconds, or another amount of time), such as shown with movement of audio component 1130b in FIGS. 11I through 11L. For example, movement of the first audio component from the first location to the second or third location optionally includes a path of movement of the first audio component from the first location to the second or third location. For example, the path is optionally a connecting path between the first and the second or third location, and movement of presentation of the first audio component animated over time includes the presentation of the first audio component as the first audio component is moving along the connecting path from the first location to the second or third location. Animating the movement of presentation of the first audio component over time improves the user's spatial awareness of the user's environment, which can improve user comfort, such as user comfort when the edges of the virtual environment move relative to the viewpoint of the user, and indicates that the level of immersion is changing by way of actual movement of the location of presentation first audio component, which provides the user with opportunity to correct errors associated with changing the immersion level.

In some embodiments, in response to detecting the event corresponding to the trigger (e.g., or request) to change the level of immersion of the virtual environment from the first level of immersion to the second level of immersion, in accordance with a determination that the event corresponds to changing the level of immersion of the virtual environment from the first level of immersion to the second level of immersion within a first amount of time (e.g., 0.1, 0.3, 0.5, 1, 3, 5, 10, 20 or 30 seconds, or another amount of time), the computer system moves the first audio component from the first location to the second location over the first amount of time, such as shown with movement of audio component 1130b tracking the edge of the virtual environment 1114 in FIGS. 11G through 11I, and in accordance with a determination that the event further corresponds to changing the level of immersion of the virtual environment from the first level of immersion to the second level of immersion within a second amount of time (e.g., 0.1, 0.3, 0.5, 1, 2, 3, 5, 10 or 20 seconds, or another amount of time), less than the first amount of time, the computer system moves the first audio component from the first location to the second location over a third amount of time that is greater than the second amount of time, such as shown with movement of audio component 1130b in FIGS. 11I through 11L. In some embodiments, a threshold amount of time (e.g., 1, 3, 6, 10, 15, 20 s, 40 or 50 s, or another amount of time) is between the first amount of time and the second amount of time and/or a threshold difference in level of immersion (e.g., 3%, 5%, 15%, 25%, 40%, 50% difference, or another percent difference) is between the first level and second level, such that the rate of movement of the first audio component is controlled by the above-described movement descriptions depending on whether the event corresponds to changing the level of immersion in a manner that is above or below such threshold(s). Thus, in some embodiments, for slower change in level of immersion, a rate of movement of the first audio component tracks the rate of change of immersion in that the change of immersion level and the movement of the first audio component are both performed over the first amount of time, and for faster change in level of immersion, the rate of movement of the first audio component is animated over time more slowly than the change in level of immersion (e.g., the change of immersion level is performed over a first time that is less than an amount of time of the animated movement of the first audio component from the first location to the second location). In some embodiments, the faster the change of immersion level, the slower the movement of the first audio component from the first to the second location. Moving the first audio component at different rates based on an amount of time for changing the level of immersion indicates a requested rate of change of the level of immersion, which reduces errors associated with user interaction with the computer system relating to the change of immersion and conserves computing resources, improves the user's spatial awareness of the user's environment, which can improve user comfort, such as user comfort when the edges of the virtual environment move relative to the viewpoint of the user, and provides for smooth movement of presentation of the first audio component when the level of immersion changes.

In some embodiments, in accordance with a determination that the first level of immersion of the virtual environment is a first respective level of immersion and while the virtual environment is initially displayed at the first level of immersion, the computer system presents the first audio component with a simulated spatial location that corresponds to a first respective location relative to the virtual environment (e.g., relative to a point of reference (e.g., a position, object, and/or location) in the virtual environment or in the physical environment of the user and/or the first location being within the virtual environment), such as the virtual environment being initially displayed at the immersion level indicated by schematic 1116g in FIG. 11G and audio component 1130b being presented at its illustrated location in FIG. 11G.

In some embodiments, in accordance with a determination that the first level of immersion of the virtual environment is a second respective level of immersion, different from the first respective level of immersion, the computer system presents the first audio component with a simulated spatial location that corresponds to a second respective location, different from the first respective location, relative to the virtual environment (e.g., relative to the point of reference (e.g., the position, object, and/or location) in the virtual environment or in the physical environment of the user and/or the first location being within the virtual environment), such as the virtual environment being initially displayed at the immersion level indicated by schematic 1116n in FIG. 11N and audio component 1130b being presented at its illustrated location in FIG. 11N. As such, the computer system optionally presents the first audio component at a location that is the respective location of the first audio component for the respective level of immersion. In some embodiments, when the virtual environment is initially displayed, the computer system presents the first audio component at the respective location for the respective immersion level of the virtual environment at which the virtual environment is displayed. For example, when the virtual environment is initially displayed at the first immersion level, and optionally provided that the first audio component is associated with a first location when the virtual environment is at the first immersion level, the computer system optionally presents (e.g., without moving) the first audio component at the first location for the first immersion level of the virtual environment, and when the virtual environment is initially displayed at a second immersion level, different from the first immersion level, and optionally provided that the first audio component is associated with a second location, different from the first location, when the virtual environment is at the second immersion level, the computer system optionally presents (e.g., without moving) the first audio component at the second location for the second immersion level of the virtual environment (e.g., without moving the first audio component from the first location to the second location). In some embodiments, when the virtual environment is initially displayed, the computer system determines the respective location for the first audio component for the respective immersion level at which the virtual environment is initially displayed (e.g., or presented), and presents the first audio component at the respective location optionally such that regardless of the viewpoint of the user while the virtual environment is at respective level of immersion, the computer system presents the first audio component as emanating from the respective location. Additionally or alternatively, in some embodiments, a placement of an audio component is based on the immersion level with which the audio component is associated. For example, when the audio component is associated with a first immersion level, the computer system optionally places the audio component at a first location relative to the viewpoint of the user and/or the virtual environment and when the audio component is associated with a second immersion level, different from the first immersion level, the computer system optionally places the audio component at a second location different from the first location relative to the viewpoint of the user and/or the virtual environment. Presenting the first audio component at a respective location relative to the virtual environment that corresponds to the respective level of immersion of the virtual environment of the virtual environment when the event was detected maintains a correspondence of the respective location to the respective level of immersion of the virtual environment, reduces errors in interaction with the computer system, and improves the user's spatial awareness of the user's environment, which can improve user comfort, such as user comfort when the edges of the virtual environment move relative to the viewpoint of the user.

In some embodiments, the event corresponding to the trigger to change the level of immersion of the virtual environment from the first level of immersion to the second level of immersion is further detected while presenting the first audio component of the virtual environment with the simulated spatial location that corresponds to the first location relative to the virtual environment (e.g., relative to the point of reference (e.g., the position, object, and/or location) in the virtual environment or in the physical environment of the user), such as audio component 1130b in FIG. 11M, and while presenting the second audio component of the virtual environment with a simulated spatial location that corresponds to a fourth location relative to the virtual environment (e.g., relative to the point of reference (e.g., position, object, and/or location) in the virtual environment or in the physical environment of the user), such as audio component 1130c in FIG. 11M, and in response to detecting the event corresponding to the trigger (e.g., or request) to change the level of immersion of the virtual environment from the first level of immersion to the second level of immersion, the computer system moves the first audio component away from the first location, and the computer system moves the second audio component away from the fourth location, such as the movement of audio component 1130b and audio component 1130c from FIG. 11M to 11N. As such, the computer system optionally moves the first and second audio components (e.g., multiple sounds) optionally based on the change in level of immersion (e.g., increase or decrease in immersion) and/or optionally based on the amount of change in level of immersion of the virtual environment. The first and fourth locations are optionally the same location or are different locations. In some embodiments, the audio of the first and second audio component corresponds to the same sounds at different locations or different sounds at different locations. In some embodiments, the movement of the first and second audio components includes one or more characteristics of movement of audio sources described elsewhere herein. Moving the first and second audio components in response to the event provides spatial audio feedback that the immersion level has changed, as the locations from which the first and second audio components are being presented are changed, which may reduce errors in user interaction with the computer system, and improves the user's spatial awareness of the user's environment, which can improve user comfort, such as user comfort when the edges of the virtual environment move relative to the viewpoint of the user.

In some embodiments, moving the first audio component away from the first location includes moving the first audio component a first distance (e.g., 0.2, 0.7, 2, 5, 10, 20 m, or another distance), and moving the second audio component away from the fourth location includes moving the second audio component a second distance (e.g., 0.2, 0.7, 2, 5, 10, 20, 25 m, or another distance), different from the first distance, such as shown with the movement of audio component 1130b being greater than the movement of audio component 1130c from FIG. 11M to 11N. For example, in response to detecting the event corresponding to the trigger or request to change the level of immersion of the virtual environment from the first level to the second level, the computer system optionally moves the first audio component the first distance and moves the second audio component the second distance. In some embodiments, the movement of the first and second audio components includes one or more characteristics of movement of audio component(s) described elsewhere herein. As such, the computer system optionally moves different audio components by different amounts optionally based on the change in level of immersion (e.g., increase or decrease in immersion). Moving the first and second audio components by different amounts in response to the event provides spatial audio feedback that the immersion level has changed, as the locations from which the first and second audio components are being presented are changing by different amounts, which may reduce errors in user interaction with the computer system, and improves the user's spatial awareness of the user's environment, which can improve user comfort, such as user comfort when the edges of the virtual environment move relative to the viewpoint of the user.

In some embodiments, moving the first audio component away from the first location includes moving the first audio component in a first direction (e.g., north, east, south, west, up, down, or another direction in three-dimensional space relative to the point of reference (e.g., position, object, and/or location) in the virtual environment or in the physical environment of the user), such as shown with the movement of audio component 1130a being in a first direction from FIG. 11R to 11S (e.g., as shown with its counterclockwise movement in top-down views 1112r and 1112s) and moving the second audio component away from the fourth location includes moving the second audio component in a second direction (e.g., north, east, south, west, up, down, or another direction in three-dimensional space relative to the point of reference (e.g., position, object, and/or location) in the virtual environment or in the physical environment of the user), different from the first direction, such as shown with the movement of audio component 1130b being in a second direction from FIG. 11R to 11S (e.g., as shown with its clockwise movement in top-down views 1112r and 1112s). The first and second directions are optionally different directions relative to the viewpoint of the user. For example, in response to detecting the event corresponding to the trigger or request to change the level of immersion of the virtual environment from the first level to the second level, the computer system optionally moves the first audio component in the first direction and moves the second audio component in the second direction. In some embodiments, the movement of the first and second audio components includes one or more characteristics of movement of audio component(s) described elsewhere herein. As such, the computer system optionally moves different audio components in different directions optionally based on the change in level of immersion (e.g., increase or decrease in immersion). Additionally or alternatively, in some embodiments, the computer system optionally moves different audio components in different directions (e.g., optionally while or while not presenting the different audio components) independent of a change in level of immersion, optionally such as described herein with reference to audio components of the virtual environment optionally maintaining an animation of movement even while the computer system is not presenting the audio components, such that the audio components are presented at different locations based on when the level of immersion changes (e.g., increases or decreases). Moving the first and second audio components in different directions in response to the event provides spatial audio feedback that the immersion level has changed, as the locations from which the first and second audio components are being presented being changed in different directions, which may reduce error in user interaction with the computer system, and improves the user's spatial awareness of the user's environment, which can improve user comfort, such as user comfort when the edges of the virtual environment move relative to the viewpoint of the user.

In some embodiments, in response to detecting the event corresponding to the trigger (e.g., or request) to change the level of immersion of the virtual environment from the first level of immersion to the second level of immersion, in accordance with a determination that the second level of immersion is greater than the first level of immersion, moving the first audio component is in a first direction (e.g., north, east, south, west, up, down, and/or another direction in a three-dimensional coordinate system (e.g., a three-dimensional Cartesian coordinate system) relative to the point of reference (e.g., position, object, and/or location) in the virtual environment or in the physical environment of the user), such as shown with the movement of audio component 1130a being in a first direction from FIG. 11R to 11S (e.g., as shown with its counterclockwise movement in top-down views 1112r and 1112s) and in accordance with a determination that the second level of immersion is less than the first level of immersion, moving the first audio component is in a second direction (e.g., north, east, south, west, up, down, and/or another direction in the three-dimensional coordinate system relative to the point of reference (e.g., position, object, and/or location) in the virtual environment or in the physical environment of the user), different from (e.g., opposite from and/or otherwise different from) the first direction, such as shown with the movement of audio component 1130a being in a second direction from FIG. 11W to 11X (e.g., as shown with its clockwise movement in top-down views 1112w and 1112x). The first and second directions are optionally different directions relative to the viewpoint of the user. As such, the computer system optionally moves presentation of the first audio component in different directions based on the direction of change in level of immersion (e.g., increase or decrease in immersion) of the virtual environment. In some embodiments, the computer system stops moving the first audio component once it reaches its target location, and then the computer system begin moving the first audio component again if the immersion level is changed so that the first audio component moves in the opposite direction. For example, in response to a first increase in immersion level, the computer system moves the first audio component to the right eventually hitting its target location (e.g., if the computer system detects further request to increase immersion, the first audio component will not move, but if the computer system detects request to decease immersion, the computer system will eventually start moving the first audio component again but to the left). Moving the first audio component in a direction based on the direction of change in level of immersion improves the user's spatial awareness of the user's environment, which can improve user comfort, such as user comfort when the edges of the virtual environment move relative to the viewpoint of the user and provides spatial audio feedback that the immersion level has changed, as the locations from which the first and second audio components are being presented are changing in different directions, minimizing error in user interaction with the computer system.

In some embodiments, in response to detecting the event corresponding to the trigger (e.g., or request) to change the level of immersion of the virtual environment from the first level of immersion to the second level of immersion, and in accordance with a determination that the second level of immersion is a respective level of immersion, the computer system presents a respective audio component (e.g., a bell, a chime, one or more specific point sources of audio of the virtual environment, one or more specific ambient sounds of the virtual environment, or another respective audio component) indicating the respective level of immersion, such as illustrated and described with reference to audio component 1130j (e.g., in FIG. 11Y). For example, the respective immersion level is optionally full immersion, and when the virtual environment is at full immersion, the computer system optionally presents an audio component to indicate that the virtual environment is at full immersion. As another example, the respective immersion level is optionally minimum immersion, and when the virtual environment is at minimum immersion, the computer system optionally presents an audio component to indicate that the virtual environment is at minimum immersion. As another example, the respective immersion level is optionally a specific immersion level that is different from full immersion and different from minimum immersion, and when the virtual environment is at the specific immersion level, the computer system optionally presents an audio component to indicate that the virtual environment is at the specific immersion level. The computer system optionally presents the respective audio component indicating the respective level of immersion even if there is not a visual indication of the respective level of immersion from the current viewpoint of the user. For example, while the virtual environment is at the respective level of immersion, the current viewpoint of the user optionally includes display of the virtual environment or does not include display of the virtual environment, and presenting the respective audio component indicating the respective level of immersion provides an indication of the respective level of immersion even if the current viewpoint of the user does not include a visual indication of the respective level of immersion. As such, the computer system optionally presents an audio component to indicate that the virtual environment is at a respective immersion level. If the virtual environment is not at the respective level of immersion, the computer system does not present the respective audio component. If the virtual environment is at a level of immersion different from the respective level of immersion, the computer system optionally presents a different audio component marking that different level of immersion. Presenting an audio component to indicate that the virtual environment is at a respective immersion level improves the user's spatial awareness of the user's environment, which can improve user comfort, such as user comfort when the edges of the virtual environment move relative to the viewpoint of the user and provides audio feedback that the virtual environment is at the respective immersion level, which provides the user with an alternative method for knowing that a particular level of immersion is reached when, in the current viewpoint of the user, there is not a visual indication of the respective immersion level, and which optionally provides opportunity for the user to determine whether the user should change the immersion level to another desired immersion level, thus minimizing error in user interaction with the computer system.

In some embodiments, the respective audio component indicating the respective level of immersion is a simulated natural sound corresponding to the virtual environment, such as audio component 1130j in FIG. 11Y. For example, the virtual environment is optionally a beach, and the respective audio component is the sound of waves crashing on the seashore. In another example, the virtual environment is optionally a jungle, and the respective audio component is a buzzing sound of bugs. In another example, the virtual environment includes a river, and the respective audio component is noise corresponding to movement of the river down a stream. In another example, the virtual environment is optionally an office, and the respective audio component is noise corresponding to busy office noise (e.g., printers, persons talking, air condition blowing, ringing of phones, and/or other office noises). Presenting an audio component that is a natural sound corresponding to the virtual environment to indicate that the virtual environment is at a respective immersion level corresponds the audio component to the selected virtual environment, improves the user's spatial awareness of the user's environment, which can improve user comfort, such as user comfort when the edges of the virtual environment move relative to the viewpoint of the user, and provides audio feedback that the virtual environment is at the respective immersion level, which optionally provides opportunity for the user to determine whether the user should change the immersion level to another desired immersion level and/or change the selected virtual environment to another virtual environment, and reduces error in interaction with the computer system.

In some embodiments, presenting the respective audio component indicating the respective level of immersion includes in accordance with a determination that the virtual environment is a first virtual environment, the respective audio component indicating the respective level of immersion being a first respective audio component, such as audio component 1130j in FIG. 11Y being an audio component specifically for indicating full immersion in virtual environment 1114 and in accordance with a determination that the virtual environment is a second virtual environment, different from the first virtual environment, the respective audio component indicating the respective level of immersion being a second respective audio component, different from the first respective audio component, such as FIG. 11Y illustrating a virtual environment different from virtual environment 1114 and including audio component 1130j, but audio component 1130j having a different sound and/or location and being specifically for indicating full immersion in the virtual environment that is different from virtual environment 1114. The first and second respective audio components are optionally the different respective audio components provided as examples of different virtual environments and respective audio components with reference to the respective audio component indicating the respective level of immersion is a simulated natural sound corresponding to the virtual environment. As such, the computer system optionally presents different audio components that indicates the respective level of immersion for different virtual environments. Presenting different audio components to indicate that the virtual environment is at a respective immersion level, for different virtual environments, corresponds specific audio components to specific virtual environments, improves the user's spatial awareness of the user's environment, which can improve user comfort, such as user comfort when the edges of the virtual environment move relative to the viewpoint of the user and indicates the selected virtual environment in addition to indicating the immersion level of the selected virtual environment, which optionally provides opportunity for the user to determine whether the user should change the immersion level to another desired immersion level and/or change the selected virtual environment to another virtual environment.

In some embodiments, the respective audio component indicating the respective level of immersion repeats (e.g., continuously plays) while the virtual environment is at the respective level of immersion, such as audio component 1130j in FIG. 11Y repeating while virtual environment 1114 is at full immersion. For example, the respective audio component is optionally a sound that repeats one or more times over a given period of time (e.g., 0.1, 0.2, 0.5, 1, 2, 5 s, 10 s, 20 s, 40 s, 2 min, 5 min, or another period of time). For example, the virtual environment is optionally a beach, and the respective audio component is the sound of waves crashing on the seashore, and the computer system repeats presentation of sounds of waves crashing on the seashore. In another example, the virtual environment is optionally a jungle, and the respective audio component is a buzzing sound of bugs, and the computer system repeats presentation of the buzzing sound. In some embodiments, the repetition of the respective audio component is periodic (e.g., having a frequency that is constant) or is random/pseudorandom (e.g., not periodic, not having regular intervals, and/or not constant). In some embodiments, the respective audio component is a one-time sound that plays once in response to the event corresponding to the trigger (e.g., or request) to change the level of immersion of the virtual environment from the first level to the second level, and does not repeat. Presenting different audio components to indicate that the virtual environment is at a respective immersion level, for different virtual environments, corresponds specific audio components to specific virtual environments, improves the user's spatial awareness of the user's environment, which can improve user comfort, such as user comfort when the edges of the virtual environment move relative to the viewpoint of the user, and indicates the selected virtual environment in addition to indicating the immersion level of the selected virtual environment, which optionally provides opportunity for the user to determine whether the user should change the immersion level to another desired immersion level and/or change the selected virtual environment to another virtual environment.

In some embodiments, while displaying the virtual environment at the respective level of immersion, the computer system detects an event corresponding to a trigger (e.g., or request) to change the level of immersion of the virtual environment from the respective level of immersion to a third level of immersion, different from the respective level of immersion, such as event triggering change of the level of immersion from full immersion in FIG. 11Y to less than full immersion in FIG. 11X, and in response to detecting the event corresponding to the trigger (e.g., or request) to change the level of immersion of the virtual environment from the respective level of immersion to the third level of immersion, the computer system displays, via the display generation component, the virtual environment at the third level of immersion, such as virtual environment 1114 in FIG. 11X and in response to displaying the virtual environment at the third level of immersion, the computer system ceases presentation of the respective audio component, such as shown with the ceasing of presentation of audio component 1130j from FIG. 11Y to FIG. 11X. For example, while the virtual environment is at the respective level of immersion, the computer system optionally presents the respective audio component (e.g., optionally on repeat), and when the virtual environment is no longer at the respective level of immersion (e.g., the computer system detects an event corresponding to a trigger (e.g., or request) to change the level of immersion of the virtual environment from the respective level of immersion to a different (e.g., higher or lower) level of immersion), the computer system optionally ceases presentation (e.g., makes mute) the respective audio component. In some embodiments, displaying the virtual environment at the third level of immersion in response to detecting the event corresponding to the trigger (e.g., or request) to change the level of immersion of the virtual environment from the respective level of immersion to the third level of immersion is visually detectable in the viewpoint of the user. For example, visual confirmation that the virtual environment is changing to the third level of immersion (e.g., and is being displayed at the third level of immersion) is optionally provided by way of an edge of the virtual environment being in the viewpoint of the user, such as by movement of the edge while the edge is in the viewpoint of the user. In some scenarios, if an edge of the virtual environment is not in the viewpoint of the user, the user of the computer system may only see the edge by looking around (e.g., rotating the user's head and the corresponding viewport) to different areas of the virtual environment to find an edge of the virtual environment. Continuing with this example, when the edge of the virtual environment is in the viewpoint of the user, the user can optionally visually observe the computer system displaying the virtual environment at the third level of immersion in response to detecting the event corresponding to the trigger (e.g., or request) to change the level of immersion of the virtual environment from the respective level of immersion to the third level of immersion. That is, the user can optionally observe the computer system displaying the virtual environment at the third level of immersion (e.g., moving an edge of the virtual environment from an edge location corresponding to the respective level of immersion to an edge location corresponding to the third level of immersion and/or displaying the edge at the edge location corresponding to the third level of immersion) in response to detecting the event corresponding to the trigger (e.g., or request) to change the level of immersion of the virtual environment from the respective level of immersion to the third level of immersion. In some embodiments, a difference in level of immersion required from the respective level of immersion to cause the respective audio component to cease to be presented is more than a threshold percentage, such as more than (e.g., 2, 5, 6, 8, 10, 12, 15 percent, or another percent difference), higher or lower than the respective level of immersion (e.g., to avoid the respective audio component rapidly appearing and disappearing when the level of immersion is near the respective level of immersion). Ceasing presenting the respective audio component that is presented to indicate that the virtual environment is at a respective immersion level when the virtual environment ceases being at the respective level of immersion provides audio feedback that the virtual environment is no longer at the respective immersion level and improves the user's spatial awareness of the user's environment, which can improve user comfort, such as user comfort when the edges of the virtual environment move relative to the viewpoint of the user.

In some embodiments, the computer system moves the first audio component outside of a visually displayed area (e.g., and optionally displayed volume) of the virtual environment at the second level of immersion, such as audio component 1130a from FIG. 11X to FIG. 11Y moving outside of a region that is displayed in display generation component 120 based on the viewpoint of the user. In some embodiments, moving the first audio component outside of the visually displayed area (e.g., and optionally displayed volume) of the virtual environment at the second level of immersion includes moving the first audio component into a passthrough region of the viewport of the user that includes a representation of a physical environment of the user. As such, audio components can spatially move outside of the location or region where the virtual environment is located, optionally such that an audio component can be presenting from a location that is outside of display area of the virtual environment. In some embodiments, the event corresponding to the trigger to change the level of immersion of the virtual environment from the first level of immersion to the second level of immersion is further detected while presenting the first audio component with a simulated spatial location that corresponds to a first location relative to the virtual environment that is visible via the display generation component at the first level of immersion, and in response to detecting the event corresponding to the trigger (e.g., or request) to change the level of immersion of the virtual environment from the first level of immersion to the second level of immersion, the computer system moves the first audio component from the first location to a second location (e.g., a second simulated spatial location), different from the first location, wherein the second location is outside of a visually displayed area (e.g., and optionally displayed volume) of the virtual environment at the second level of immersion. In some embodiments, the first audio component is outside the visually displayed area (e.g., and optionally displayed volume) of the virtual environment at the first and/or second levels of immersion. In some embodiments, after moving the first audio component from the first location to the second location, the computer system detects an event corresponding to trigger (e.g., or request) to change the viewpoint of the user. For example, the event optionally includes rotation of the user's head (e.g., or viewpoint) toward the second location. In response, in accordance with a determination that the event corresponds to a trigger (e.g., or request) to change the viewpoint of the user to include the second location within the visually displayed area of the virtual environment at the second level of immersion, the second location is located with the visually displayed area (e.g., and optionally displayed volume) of the virtual environment at the second level of immersion. Permitting an audio component to move outside of a visually displayed area of the virtual environment reduces a cluttering of spatial audio provides the user with an indication that the immersion level is changing, maintains a location-based correspondence of the audio component to specific locations even when the audio component is outside of the visually displayed area of the virtual environment which may reduce computing resources of the computing system, improves the user's spatial awareness of the user's environment, which can improve user comfort, such as user comfort when the edges of the virtual environment move relative to the viewpoint of the user, and increases an amount of available potential simulated spatial locations for which to present audio corresponding to the virtual environment.

It should be understood that the particular order in which the operations in method 1200 have been described is merely exemplary and is not intended to indicate that the described order is the only order in which the operations could be performed. One of ordinary skill in the art would recognize various ways to reorder the operations described herein.

In some embodiments, aspects/operations of methods 800, 1000, and/or 1200 may be interchanged, substituted, and/or added between these methods. For example, the virtual objects of methods 800, 1000, and/or 1200, the three-dimensional environments of methods 800, 1000, and/or 1200, the moving of a location corresponding to spatial audio of methods 800, 1000, and/or 1200, the changing of level of detail of audio of method 1000, and/or the inputs for initiating and/or changing display of virtual content and/or moving viewpoints of a user, of methods 800, 1000, and/or 1200, are optionally interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, social media IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

What is claimed is:

1. A method comprising:
at a computer system in communication with one or more input devices and a display generation component:
while a virtual environment of a user of the computer system is visible via the display generation component at a first level of immersion, and while presenting a first audio component of the virtual environment with a first value for a respective property relative to a current value for the respective property of a second audio component of the virtual environment:
detecting an event corresponding to a trigger to change the level of immersion of the virtual environment from the first level of immersion to a second level of immersion, different from the first level of immersion; and
in response to detecting the event corresponding to the trigger to change the level of immersion of the virtual environment from the first level of immersion to the second level of immersion:
displaying, via the display generation component, the virtual environment at the second level of immersion; and
presenting the first audio component with a second value of the respective property relative to the current value for the respective property of the second audio component, different from the first value of the respective property for the first audio component.

2. The method of claim 1, wherein the first audio component comprises one or more ambient sounds.

3. The method of claim 1, wherein the first audio component comprises one or more point sources of audio.

4. The method of claim 1, wherein the respective property is a volume level, and wherein:
the first value for the respective property is a first volume level; and
the second value for the respective property is a second volume level, greater than the first volume level.

5. The method of claim 1, wherein the respective property is a volume level, and wherein:
the first value for the respective property is a first volume level; and
the second value for the respective property is a second volume level, less than the first volume level.

6. The method of claim 1, wherein a first respective audio component is not presented while the virtual environment is at the first level of immersion, and wherein the method further comprises:
in response to detecting the event corresponding to the trigger to change the level of immersion of the virtual environment from the first level of immersion to the second level of immersion:
presenting the first respective audio component with a first respective value for the respective property relative to the current value for the respective property of the second audio component.

7. The method of claim 6, wherein presenting the first respective audio component with the first respective value for the respective property relative to the current value for the respective property of the second audio component includes:
in accordance with a determination that that the virtual environment is at the second level of immersion at a first time:
presenting the first respective audio component with the first respective value for the respective property relative to the current value for the respective property of the second audio component when a first duration of time starting from the first time has elapsed; and
in accordance with a determination that that the virtual environment is at the second level of immersion at a second time, different from the first time:
presenting the first respective audio component with the first respective value for the respective property relative to the current value for the respective property of the second audio component when a second duration of time, different from the first duration of time, starting from the second time has elapsed.

8. The method of claim 6, wherein the method further comprises:
while the first respective audio component is moving prior to being presented, and in response to detecting the event corresponding to the trigger to change the level of immersion of the virtual environment from the first level of immersion to the second level of immersion:
in accordance with detecting the event at a first time, presenting the first respective audio component with a simulated spatial audio that corresponds to a first location relative to the virtual environment; and
in accordance with detecting the event at a second time, different from the first time, presenting the first respective audio component with a simulated spatial audio that corresponds to a second location, different from the first location, relative to the virtual environment.

9. The method of claim 1, wherein detecting the event corresponding to the trigger to change the level of immersion of the virtual environment from the first level of immersion to the second level of immersion is further performed while presenting a first respective audio component with a first respective value for the respective property relative to the current value for the respective property of the second audio component, and wherein the method further comprises:
in response to detecting the event corresponding to the trigger to change the level of immersion of the virtual environment from the first level of immersion to the second level of immersion:
ceasing presentation of the first respective audio component.

10. The method of claim 1, wherein the event corresponding to the trigger to change the level of immersion of the virtual environment from the first level of immersion to the second level of immersion is further detected while presenting the first audio component of the virtual environment with a simulated spatial location that corresponds to a first location relative to the virtual environment, and wherein the method further comprises:
in response to detecting the event corresponding to the trigger to change the level of immersion of the virtual environment from the first level of immersion to the second level of immersion:
in accordance with a determination that change of the level of immersion of the virtual environment from the first level of immersion to the second level of immersion is a first amount of change, moving the first audio component to a second location relative to the virtual environment; and
in accordance with a determination that the change of the level of immersion of the virtual environment from the first level of immersion to the second level of immersion is a second amount of change, different from the first amount of change, moving the first audio component to a third location relative to the virtual environment, different from the second location.

11. The method of claim 10, wherein moving the first audio component from the first location to the second or third location occurs gradually over time by moving the first audio component through a plurality of intermediate locations at different points in time.

12. The method of claim 11, wherein the event corresponding to the trigger to change the level of immersion of the virtual environment from the first level of immersion to the second level of immersion is further detected while presenting the second audio component of the virtual environment with a simulated spatial location that corresponds to a fourth location relative to the virtual environment, and wherein the method further comprises:
in response to detecting the event corresponding to the trigger to change the level of immersion of the virtual environment from the first level of immersion to the second level of immersion:
in accordance with a determination that the virtual environment is at a third level of immersion while changing the level of immersion of the virtual environment from the first level of immersion to the second level of immersion, initiating movement of the first audio component, without initiating movement of the second audio component; and
in accordance with a determination that the virtual environment is at a fourth level of immersion, different from the third level of immersion, while changing the level of immersion of the virtual environment from the first level of immersion to the second level of immersion, initiating movement of the second audio component.

13. The method of claim 11, wherein the event corresponding to the trigger to change the level of immersion of the virtual environment from the first level of immersion to the second level of immersion is further detected while presenting the second audio component of the virtual environment with a simulated spatial location that corresponds to a fourth location relative to the virtual environment, and wherein the method further comprises:
in response to detecting the event corresponding to the trigger to change the level of immersion of the virtual environment from the first level of immersion to the second level of immersion:
moving the first audio component away from the first location;
moving the second audio component away from the fourth location;
in accordance with a determination that the virtual environment is at a third level of immersion while changing the level of immersion of the virtual environment from the first level of immersion to the second level of immersion, stopping movement the first audio component, without stopping movement of the second audio component; and
in accordance with a determination that the virtual environment is at a fourth level of immersion, different from the third level of immersion, while changing the level of immersion of the virtual environment from the first level of immersion to the second level of immersion, stopping movement of the second audio component.

14. The method of claim 10, wherein movement of the first audio component of the virtual environment from the first location to the second location or the third location is animated over time.

15. The method of claim 10, wherein the method further comprises:
in response to detecting the event corresponding to the trigger to change the level of immersion of the virtual environment from the first level of immersion to the second level of immersion:
in accordance with a determination that the event corresponds to changing the level of immersion of the virtual environment from the first level of immersion to the second level of immersion within a first amount of time, moving the first audio component from the first location to the second location over the first amount of time, and
in accordance with a determination that the event further corresponds to changing the level of immersion of the virtual environment from the first level of immersion to the second level of immersion within a second amount of time, less than the first amount of time, moving the first audio component from the first location to the second location over a third amount of time that is greater than the second amount of time.

16. The method of claim 10, wherein the method further comprises:
in accordance with a determination that the first level of immersion of the virtual environment is a first respective level of immersion and while the virtual environment is initially displayed at the first level of immersion:
presenting the first audio component with a simulated spatial location that corresponds to a first respective location relative to the virtual environment; and
in accordance with a determination that the first level of immersion of the virtual environment is a second respective level of immersion, different from the first respective level of immersion:
presenting the first audio component with a simulated spatial location that corresponds to a second respective location, different from the first respective location, relative to the virtual environment.

17. The method of claim 10, wherein the event corresponding to the trigger to change the level of immersion of the virtual environment from the first level of immersion to the second level of immersion is further detected while presenting the first audio component of the virtual environment with the simulated spatial location that corresponds to the first location relative to the virtual environment and while presenting the second audio component of the virtual environment with a simulated spatial location that corresponds to a fourth location relative to the virtual environment, and wherein the method further comprises:
in response to detecting the event corresponding to the trigger to change the level of immersion of the virtual environment from the first level of immersion to the second level of immersion:
moving the first audio component away from the first location; and
moving the second audio component away from the fourth location.

18. The method of claim 17, wherein:
moving the first audio component away from the first location includes moving the first audio component a first distance; and
moving the second audio component away from the fourth location includes moving the second audio component a second distance, different from the first distance.

19. The method of claim 17, wherein:
moving the first audio component away from the first location includes moving the first audio component in a first direction; and
moving the second audio component away from the fourth location includes moving the second audio component in a second direction, different from the first direction.

20. The method of claim 10, wherein:
in response to detecting the event corresponding to the trigger to change the level of immersion of the virtual environment from the first level of immersion to the second level of immersion:
in accordance with a determination that the second level of immersion is greater than the first level of immersion, moving the first audio component is in a first direction; and
in accordance with a determination that the second level of immersion is less than the first level of immersion, moving the first audio component is in a second direction, different from the first direction.

21. The method of claim 1, wherein the method further comprises:
in response to detecting the event corresponding to the trigger to change the level of immersion of the virtual environment from the first level of immersion to the second level of immersion, and in accordance with a determination that the second level of immersion is a respective level of immersion, presenting a respective audio component indicating the respective level of immersion.

22. The method of claim 21, wherein the respective audio component indicating the respective level of immersion is a simulated natural sound corresponding to the virtual environment.

23. The method of claim 21, wherein presenting the respective audio component indicating the respective level of immersion includes:
in accordance with a determination that the virtual environment is a first virtual environment, the respective audio component indicating the respective level of immersion being a first respective audio component; and
in accordance with a determination that the virtual environment is a second virtual environment, different from the first virtual environment, the respective audio component indicating the respective level of immersion being a second respective audio component, different from the first respective audio component.

24. The method of claim 21, wherein the respective audio component indicating the respective level of immersion repeats while the virtual environment is at the respective level of immersion.

25. The method of claim 24, wherein the method further comprises:
while displaying the virtual environment at the respective level of immersion, detecting an event corresponding to a trigger to change the level of immersion of the virtual environment from the respective level of immersion to a third level of immersion, different from the respective level of immersion; and
in response to detecting the event corresponding to the trigger to change the level of immersion of the virtual environment from the respective level of immersion to the third level of immersion:
displaying, via the display generation component, the virtual environment at the third level of immersion; and
in response to displaying the virtual environment at the third level of immersion, ceasing presentation of the respective audio component.

26. The method of claim 1, wherein the method comprises:
moving the first audio component outside of a visually displayed area of the virtual environment at the second level of immersion.

27. A computer system that is in communication with a display generation component and one or more input devices, the computer system comprising:
one or more processors;
memory; and
one or more programs, wherein the one or more programs are stored in the memory and configured to be executed by the one or more processors, the one or more programs including instructions for:
while a virtual environment of a user of the computer system is visible via the display generation component at a first level of immersion, and while presenting a first audio component of the virtual environment with a first value for a respective property relative to a current value for the respective property of a second audio component of the virtual environment:
detecting an event corresponding to a trigger to change the level of immersion of the virtual environment from the first level of immersion to a second level of immersion, different from the first level of immersion; and
in response to detecting the event corresponding to the trigger to change the level of immersion of the virtual environment from the first level of immersion to the second level of immersion:
displaying, via the display generation component, the virtual environment at the second level of immersion; and
presenting the first audio component with a second value of the respective property relative to the current value for the respective property of the second audio component, different from the first value of the respective property for the first audio component.

28. A non-transitory computer readable storage medium storing one or more programs, the one or more programs comprising instructions, which when executed by one or more processors of a computer system that is in communication with a display generation component and one or more input devices, cause the computer system to perform a method comprising:
while a virtual environment of a user of the computer system is visible via the display generation component at a first level of immersion, and while presenting a first audio component of the virtual environment with a first value for a respective property relative to a current value for the respective property of a second audio component of the virtual environment:
detecting an event corresponding to a trigger to change the level of immersion of the virtual environment from the first level of immersion to a second level of immersion, different from the first level of immersion; and
in response to detecting the event corresponding to the trigger to change the level of immersion of the virtual environment from the first level of immersion to the second level of immersion:
displaying, via the display generation component, the virtual environment at the second level of immersion; and
presenting the first audio component with a second value of the respective property relative to the current value for the respective property of the second audio component, different from the first value of the respective property for the first audio component.
